(19) United States
(12) Patent Application Publication
(10) Pub. No.: US 2025/0355485 A1
(43) Pub. Date: Nov. 20, 2025

(54) Devices, Methods, And Graphical User Interfaces For Interacting With System User Interfaces Within Three-Dimensional Environments

(71) Applicant: Apple Inc., Cupertino, CA (US)

(72) Inventors: Christopher D. McKenzie, Burlingame, CA (US); Evgenii Krivoruchko, San Francisco, CA (US); Benjamin H. Boesel, Jackson, WY (US); Matan Stauber, San Francisco, CA (US); Tyler R. Calderone, Boulder, CO (US); Daniel J. Brewer, Redwood City, CA (US); Chase B. Lortie, San Francisco, CA (US); Yirong Tang, Sunnyvale, CA (US); Bharat C. Dandu, Santa Clara, CA (US); Danielle M. Price, Los Gatos, CA (US); Stephen O. Lemay, Palo Alto, CA (US); Zoey C. Taylor, San Francisco, CA (US); Jose A. Checa Oloriz, San Francisco, CA (US); Hugo D. Verweij, Portola Valley, CA (US); Hana Z. Wang, Novato, CA (US); William A. Sorrentino, III, Kentfield, CA (US); Richard D. Lyons, London (GB); Walden J. Davis, San Francisco, CA (US); Jay Moon, San Francisco, CA (US); Daniel M. Golden, San Jose, CA (US); John M. Nefulda, Oakville (CA); Scott M. Andrus, Sunnyvale, CA (US); Goh M. Noda, San Jose, CA (US); Kianoosh R. Salami, San Francisco, CA (US); Wesley M. Holder, Union City, CA (US); Karen El Asmar, San Francisco, CA (US); Katherine Stevo, Sunnyvale, CA (US)

(21) Appl. No.: 19/206,298

(22) Filed: May 13, 2025

Related U.S. Application Data
(60) Provisional application No. 63/649,262, filed on May 17, 2024.
(60) Provisional application No. 63/657,914, filed on Jun. 9, 2024.
(60) Provisional application No. 63/799,171, filed on May 2, 2025.

(51) Int. Cl. G06F 3/01; G06F 3/0346; G06F 3/16; G06F 11/32; G06V 40/10

(52) U.S. Cl. CPC G06F 3/011; G06F 3/017; G06F 3/0346; G06F 3/165; G06F 11/328; G06V 40/11

(57) ABSTRACT

While a view of an environment is visible via one or more display generation components of a computer system, and while the view of the environment includes a respective object that moves as a hand of a user moves, the computer system detects, via one or more input devices, a respective input. In response to detecting the respective input: in accordance with a determination that first criteria are met, the first criteria including a requirement that the hand of the user is holding a controller, the computer system displays, via the one or more display generation components, a first user interface object at a first location relative to the respective object; and, in accordance with a determination that the first criteria are not met, the computer system forgoes displaying the first user interface object at the first location.

### RELATED APPLICATIONS

This application claims the benefit of and priority to U.S. Patent Application No. 63/799,171, filed on May 2, 2025, U.S. Patent Application No. 63/657,914, filed on Jun. 9, 2024, and U.S. Patent Application No. 63/649,262, filed on May 17, 2024, each of which is hereby incorporated by reference in its entirety.

### TECHNICAL FIELD

The present disclosure relates generally to computer systems that are in communication with a display generation component and, optionally, one or more input devices that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with system user interfaces within environments that include at least some virtual elements (e.g., applications, augmented reality environments, mixed reality environments, and virtual reality environments) are cumbersome, inefficient, and limited. For example, systems that require extensive input to invoke system user interfaces and/or provide insufficient feedback for performing actions associated with system user interfaces, systems that require a series of inputs to display various system user interfaces in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for interacting with system user interfaces that make interaction with the computer systems more efficient and intuitive for a user. Such methods and interfaces optionally complement or replace conventional methods for interacting with system user interfaces when providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is a portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for invoking and interacting with system user interfaces within a three-dimensional environment. Such methods and interfaces may complement or replace conventional methods for invoking and interacting with system user interfaces with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In accordance with some embodiments, a method is performed at a computer system that is in communication with one or more display generation components and one or more input devices. The method includes, while a view of an environment is visible via the one or more display generation components, detecting, via the one or more input devices, that attention of a user is directed toward a location of a hand of the user. The method includes, in response to detecting that the attention of the user is directed toward the location of the hand: in accordance with a determination that the attention of the user is directed toward the location of the hand while first criteria are met, wherein the first criteria include a requirement that the hand is in a respective pose and oriented with a palm of the hand facing toward a viewpoint of the user in order for the first criteria to be met, displaying, via the one or more display generation components, a control corresponding to the location of the hand; and, in accordance with a determination that the attention of the user is directed toward the location of the hand while the first criteria are not met, forgoing displaying the control.

In accordance with some embodiments, a method is performed at computer system that is in communication with one or more display generation components and one or more input devices. The method includes, while a view of an environment is visible via the one or more display generation components, detecting, via the one or more input devices, a selection input performed by a hand of a user. The hand of the user can have a plurality of orientations including a first orientation with a palm of the hand facing toward the viewpoint of the user and a second orientation with the palm of the hand facing away from the viewpoint of the user. The selection input is performed while the hand is in the second orientation with the palm of the hand facing away from a viewpoint of the user. The method includes, in response to detecting the selection input performed by the hand while the hand is in the second orientation with the palm of the hand facing away from the viewpoint of the user: in accordance with a determination that the selection input was detected after detecting, via the one or more input devices, a change in orientation of the hand from the first orientation with the palm facing toward the viewpoint of the user to the second orientation with the palm facing away from the viewpoint of the user and that the change in orientation of the hand from the first orientation to the second orientation was detected while attention of the user was directed toward a location of the hand, displaying, via the one or more display generation components, a control user interface that provides access to a plurality of controls corresponding to different functions of the computer system.

In accordance with some embodiments, a method is performed at computer system that is in communication with one or more display generation components and one or more input devices. The method includes, while a view of an environment is visible via the one or more display generation components, detecting, via the one or more input devices, an input corresponding to a request to display a system user interface. The method includes, in response to detecting the input corresponding to the request to display the system user interface: in accordance with a determination that the input corresponding to the request to display a system user interface is detected while respective criteria are met, displaying the system user interface in the environment at a first location that is based on a pose of a respective portion of a torso of a user; and in accordance with a determination that the input corresponding to the request to display a system user interface is detected while the respective criteria are not met, displaying the system user interface in the environment at a second location that is based on a pose of a respective portion of a head of the user.

In accordance with some embodiments, a method is performed at computer system that is in communication with one or more display generation components and one or more input devices. The method includes, while a view of an environment is visible via the one or more display generation components, detecting, via the one or more input devices, a first air gesture that meets respective criteria. The respective criteria include a requirement that the first air gesture includes a selection input performed by a hand of a user and movement of the hand in order for the respective criteria to be met. The method includes, in response to detecting the first air gesture: in accordance with a determination that the first air gesture was detected while attention of the user was directed toward a location of the hand of the user, changing a respective volume level in accordance with the movement of the hand; and in accordance with a determination that the first air gesture was detected while attention of the user was not directed toward a location of the hand of the user, forgoing changing the respective volume level in accordance with the movement of the hand.

In accordance with some embodiments, a method is performed at computer system that is in communication with one or more display generation components and one or more input devices. The method includes, while the computer system is in a configuration state enrolling one or more input elements: in accordance with a determination that data corresponding to a first type of input element is not enrolled for the computer system, enabling a first system user interface; and in accordance with a determination that data corresponding to the first type of input element is enrolled for the computer system, forgoing enabling the first system user interface. The method includes, after enrolling the one or more input elements, while the computer system is not in the configuration state: in accordance with a determination that a first set of one or more criteria are met and that display of the first system user interface is enabled, displaying the first system user interface; and in accordance with a determination that the first set of one or more criteria are met and that display of the first system user interface is not enabled, forgoing displaying the first system user interface.

In accordance with some embodiments, a method is performed at computer system that is in communication with one or more display generation components and one or more input devices. The method includes, while a view of an environment is visible via the one or more display generation components, displaying, via the one or more display generation components, a user interface element corresponding to a location of a respective portion of a body. The method includes detecting, via the one or more input devices, movement of the respective portion of the body of the user corresponding to movement from a first location in the environment to a second location in the environment. The second location is different from the first location. The method includes, in response to detecting the movement of the respective portion of the body of the user: in accordance with a determination that the movement of the respective portion of the body of the user meets first movement criteria, moving the first user interface element relative to the environment in accordance with one or more movement parameters of the movement of the respective portion of the body of the user; and in accordance with a determination that the movement of the respective portion of the body of the user meets second movement criteria that are different from the first movement criteria, ceasing to display the user interface element corresponding to the location of the respective portion of the body of the user.

In accordance with some embodiments, a method is performed at computer system that is in communication with one or more display generation components, one or more input devices and one or more output generation components. The method includes, while a view of an environment is available for interaction, detecting, via the one or more input devices, a first set of one or more inputs corresponding to interaction with the environment. When the first set of one or more inputs are detected, an orientation of a first portion of the body of the user is used to determine where attention of the user is directed in the environment. The method includes, in response to detecting the first set of one or more inputs, performing a first operation associated with a respective user interface element in the environment based on detecting that attention of the user is directed toward the respective user interface element in the environment based on the orientation of the first portion of the body of the user. The method includes, after performing the operation associated with the respective user interface element, detecting, via the one or more input devices, a second set of one or more inputs; and in response to detecting the second set of one or more inputs: in accordance with a determination that the second set of one or more inputs is detected while an orientation of a second portion of the body of the user indicates that attention of the user is directed toward a third portion of the body of the user, performing an operation associated with the third portion of the body of the user.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing extended reality (XR) experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate an XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7BE illustrate example techniques for invoking and interacting with a control for a computer system, displaying a status user interface and/or accessing system functions of the computer system, accessing a system function menu when data is not stored for one or more portions of the body of a user of the computer system, and displaying a control for a computer system during or after movement of the user's hand, including while holding a controller, in accordance with some embodiments.

FIGS. 8A-8T illustrate example techniques for adjusting a volume level for a computer system, in accordance with some embodiments.

FIGS. 9A-9P illustrate example techniques for placing a home menu user interface based on characteristics of the user input used to invoke the home menu user interface and/or user posture when the home menu user interface is invoked, in accordance with some embodiments.

FIGS. 10A-10K are flow diagrams of methods of invoking and interacting with a control for a computer system, in accordance with various embodiments.

FIGS. 11A-11E are flow diagrams of methods for displaying a status user interface and/or accessing system functions of the computer system, in accordance with various embodiments.

FIGS. 12A-12D are flow diagrams of methods of placing a home menu user interface based on characteristics of the user input used to invoke the home menu user interface and/or user posture when the home menu user interface is invoked, in accordance with various embodiments.

FIGS. 13A-13G are flow diagrams of methods for adjusting a volume level for a computer system, in accordance with various embodiments.

FIGS. 14A-14L illustrate example techniques for switching between a wrist-based pointer and a head-based pointer, depending on whether certain criteria are met, in accordance with various embodiments.

FIGS. 15A-15F are flow diagrams of methods for accessing a system function menu when data is not stored for one or more portions of the body of a user of the computer system, in accordance with various embodiments.

FIGS. 16A-16F are flow diagrams of methods for displaying a control for a computer system during or after movement of the user's hand, in accordance with various embodiments.

FIGS. 17A-17D are flow diagrams of methods for switching between a wrist-based pointer and a head-based pointer, depending on whether certain criteria are met, in accordance with various embodiments.

FIG. 18 is a flow diagram of a method for invoking and interacting with a hand-based control or other user interface of a computer system while holding a controller, in accordance with various embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system allows a user to invoke a control for performing system operations within a three-dimensional environment (e.g., a virtual or mixed reality environment) by directing attention to a location of a hand of the user. Different user inputs are used to determine the operations that are performed in the three-dimensional environment, including when immersive applications are displayed. Using the attention-based method to invoke the control allows a more efficient and streamlined way for the user to access a plurality of different system operations of the computer system.

In some embodiments, a computer system allows a user to invoke display of a status user interface that includes system status information, and/or access system functions of the computer system (e.g., via a system function menu), within a three-dimensional environment (e.g., a virtual or mixed reality environment) by directing attention to a location of a hand of the user. Different user interface objects, such as different controls and/or different user interfaces, can be displayed depending on the detected hand orientation and/or pose (e.g., in combinations with the attention of the user), and/or can be used to determine different operations to be performed by the computer system. Using the attention-based methods to invoke the status user interface and/or system function menu allow a more efficient and streamlined way for the user to interact with the computer system.

In some embodiments, a computer system displays a home menu user interface that is invoked via an attention-based method based on a torso direction of the user instead of a head direction of the user when the user's head is lowered by a threshold angle with respect to a horizon while invoking the home menu user interface. Displaying the home menu user interface based on the torso direction of the user when the user's head is lowered by the threshold angle with respect to the horizon allows the home menu user interface to be automatically displayed at a more ergonomic position, without requiring additional user input.

In some embodiments, a computer system allows a user to use hand gestures (e.g., a pinch and hold gesture) that include movement (e.g., while the pinch and hold gesture is maintained) to adjust a volume level of the computer system (e.g., in accordance with movement of the hand gesture). The hand gestures are detected using cameras (e.g., cameras integrated with a head-mounted device or installed away from the user (e.g., in an XR room)), and optionally, volume adjustment is also enabled via mechanical input mechanisms (e.g., buttons, dials, switches, and/or digital crowns of the computer system). Allowing for volume adjustment via hand gestures provides quick and efficient access to commonly (e.g., and frequently) used functionality (e.g., volume control), which streamlines user interactions with the computer system.

In some embodiments, while the computer system is in a configuration state enrolling one or more input elements, the computer system enables a first system user interface if a first type of input element is not enrolled, and forgoes enabling the first system user interface if the first type of input element is enrolled. While the computer system is not in the configuration state, the computer system displays the first system user interface if first criteria are met, and the computer system forgoes displaying the first system user interface if the first criteria are not met. Conditionally displaying a first system user interface based on a particular type of input element not being enrolled for the computer system, such as a viewport-based user interface that is configured to be invoked using a different type of interaction (e.g., gaze or another attention metric instead of a user's hands), enables users who prefer not to or who are unable to use the particular type of input element to still use the computer system, which makes the computer system more accessible to a wider population.

In some embodiments, a computer system maintains a display location of a control if movement of the hand of the user does not meet respective criteria that change dynamically based on one or more parameters of the movement of the hand (e.g., speed, distance, acceleration, and/or other parameters). Allowing for respective criteria that change dynamically based on characteristics of the movement of the hand of the user allows the computer to suppress noise when the amount of movement of the hand is too low or cannot be determined with sufficient accuracy, while allowing the computer system to display the control at a location responsive to movement that meets respective criteria to provide quick and efficient access to respective user interfaces (e.g., home menu user interface, status user interface, volume control, and/or other user interfaces) of the computer system.

In some embodiments, a computer system enables operations based on detecting attention of the user based on a first portion of the body of a user, and in response to detecting that a second portion of the body of the user is directed toward a third portion of the body of the user, the computer system enables operations associated with the third portion of the body. Enabling different operations (e.g., based on and/or associated with different portions of the body of the user) when different criteria are met provides additional control options without cluttering the UI with additional displayed controls (e.g., additional displayed controls for performing the first operation and/or the operation corresponding to the third portion of the body of the user), and increases the efficiency of user interaction with a computer system by allowing different operations to be performed based on different portions of the body of the user (e.g., which allows effective interaction with the computer system even if one or more portions of the body of the user are unavailable or preoccupied), which also makes the computer system more accessible to a wider variety of users by supporting different input mechanisms besides hand- and/or gaze-based inputs.

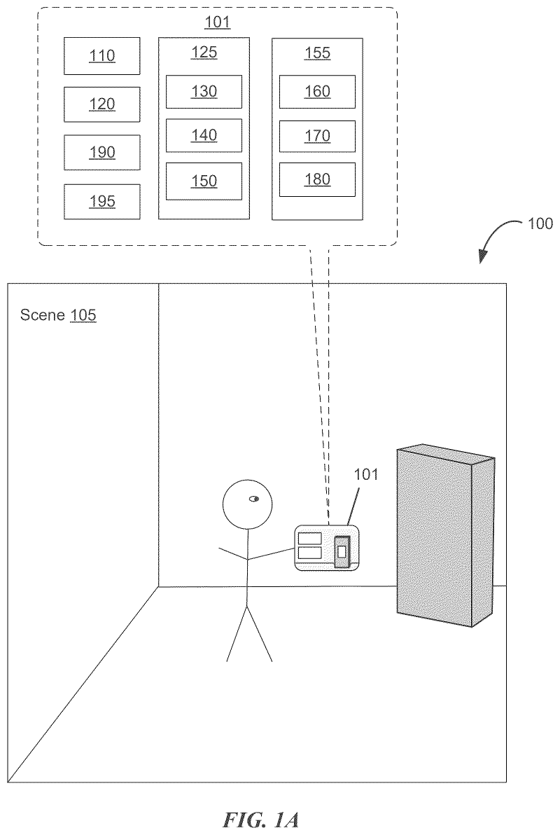

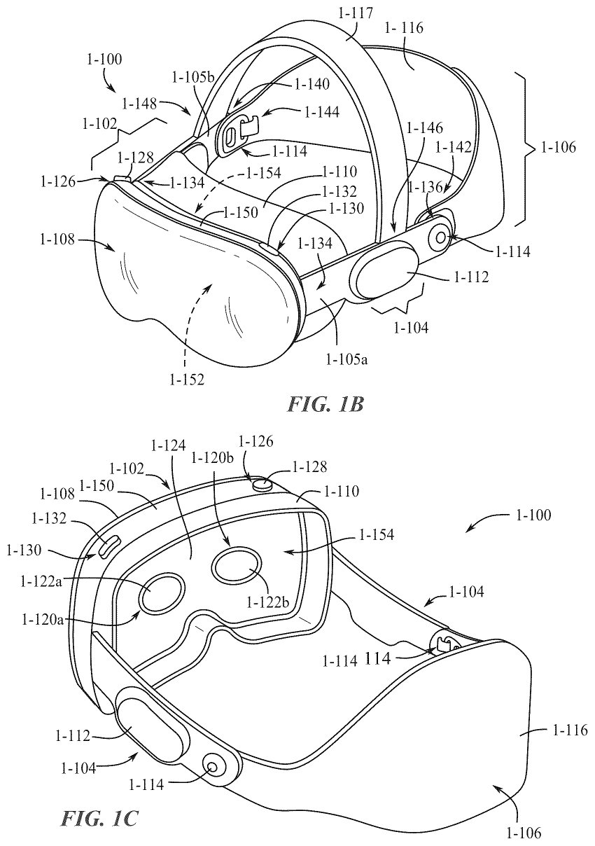

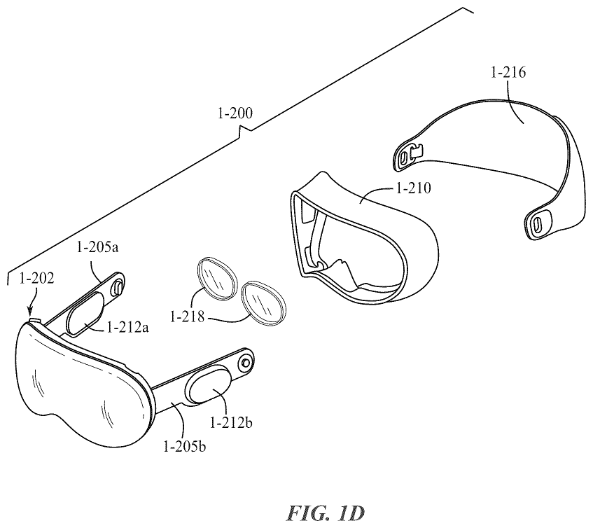

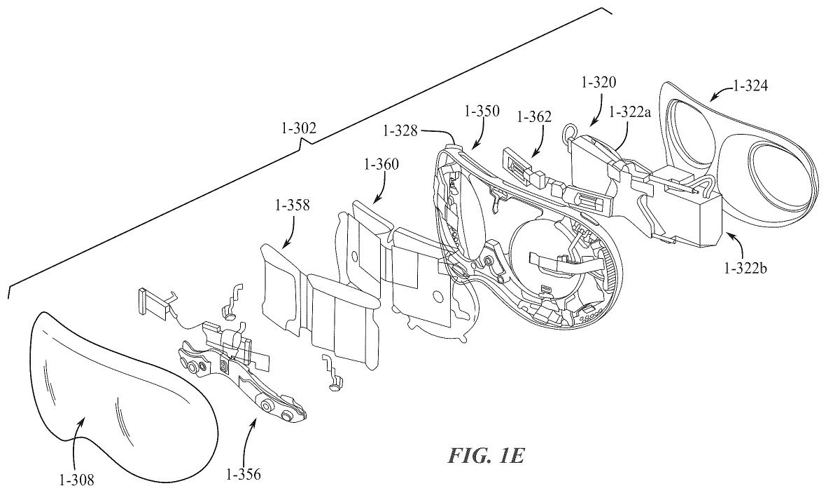

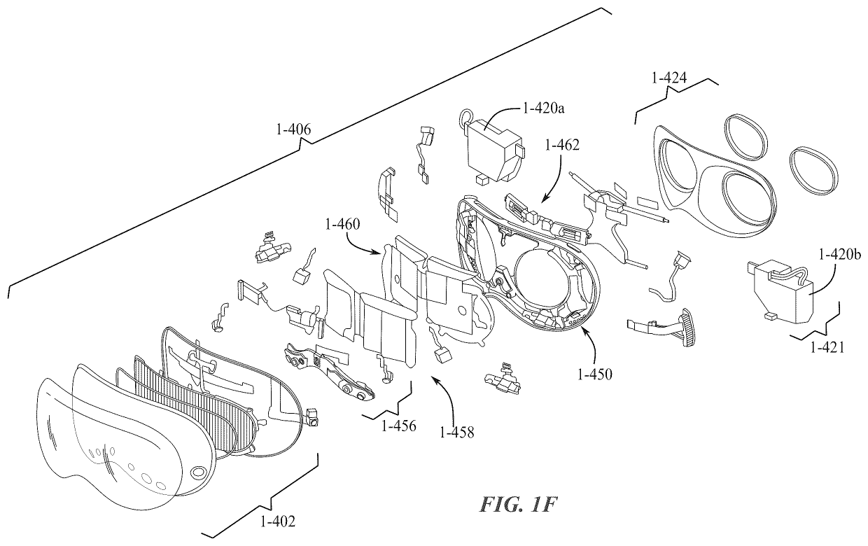

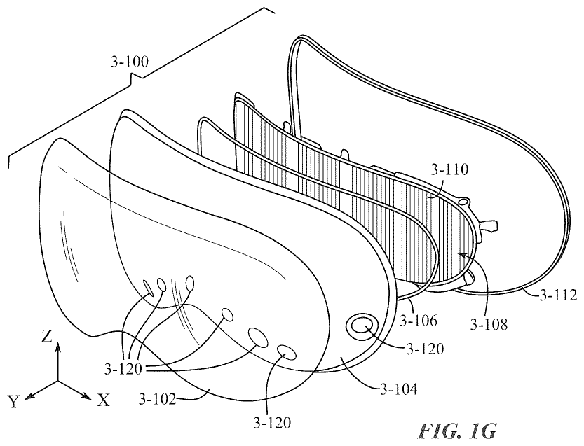

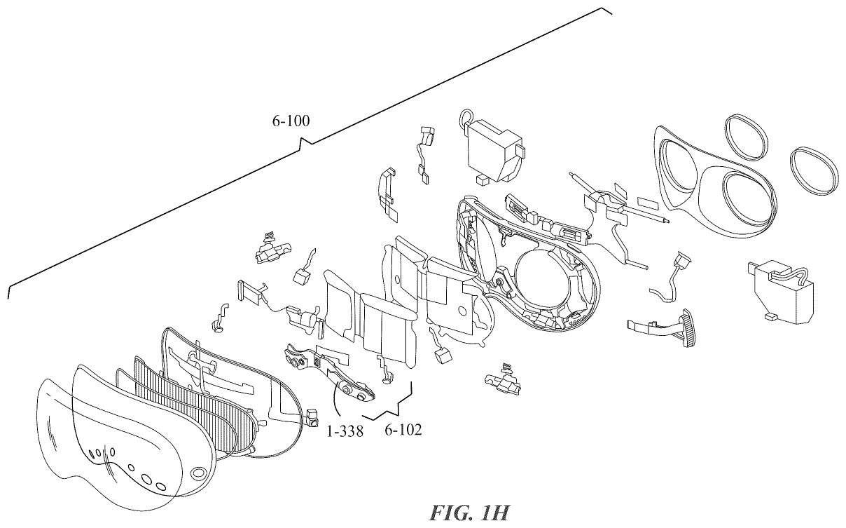

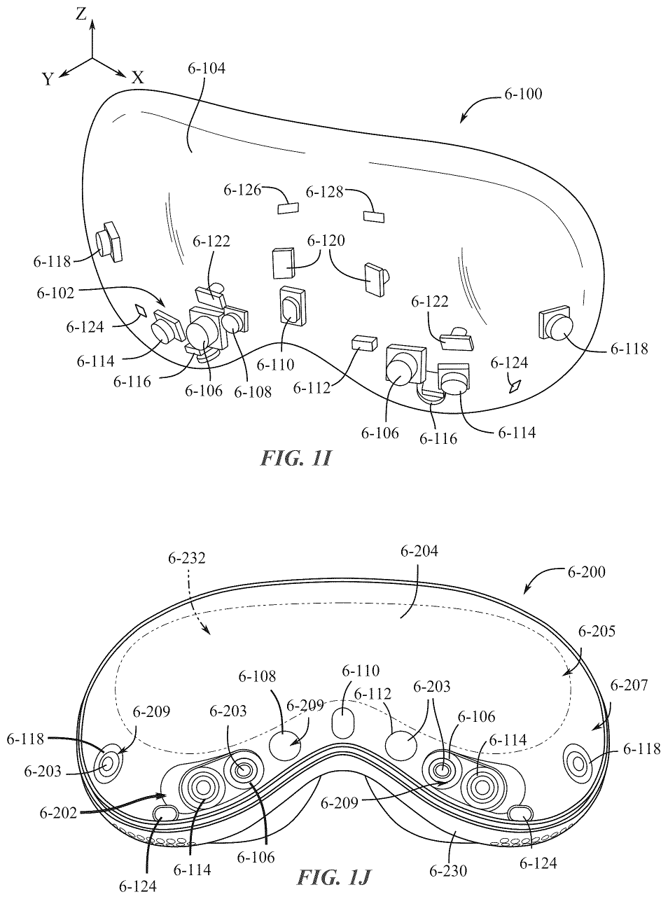

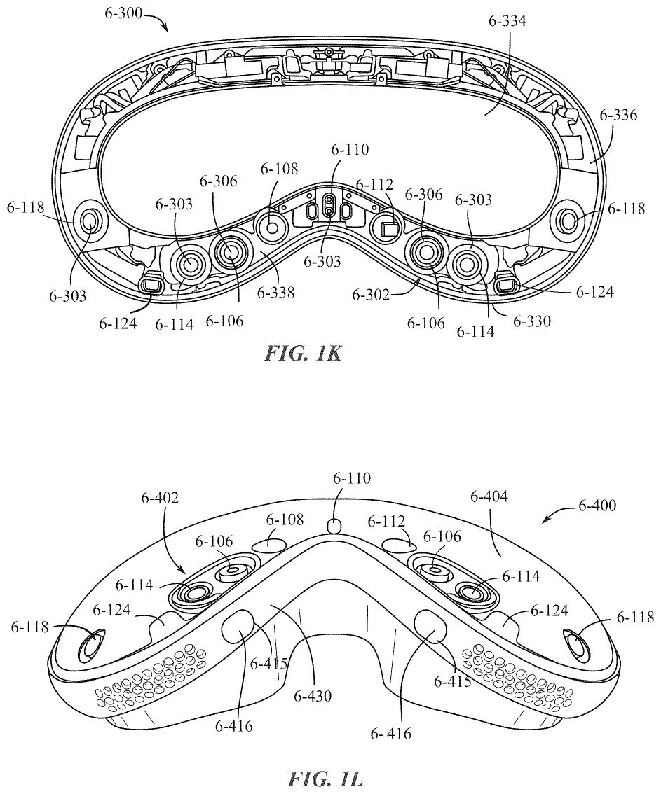

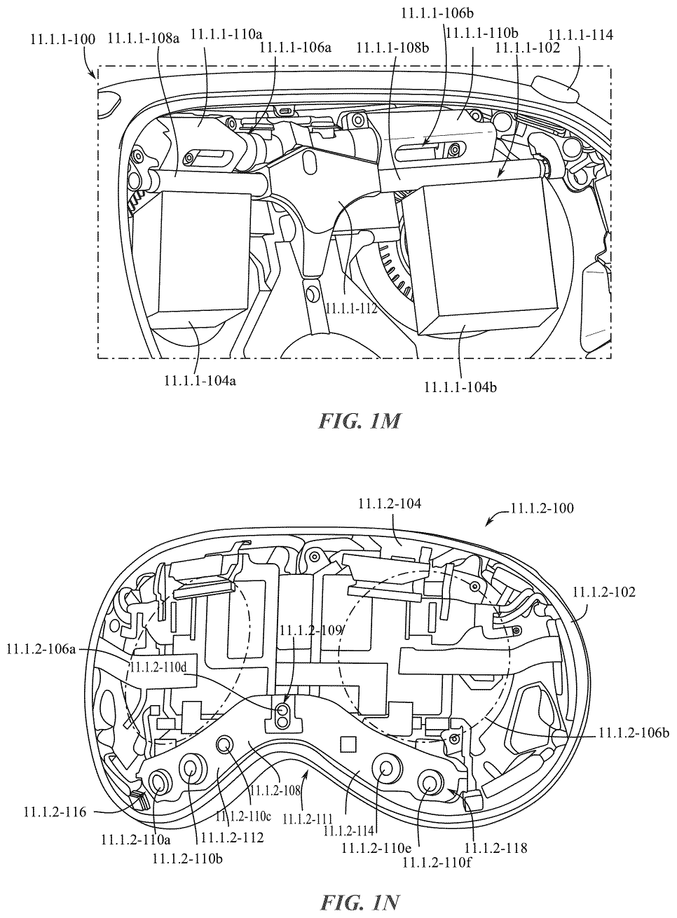

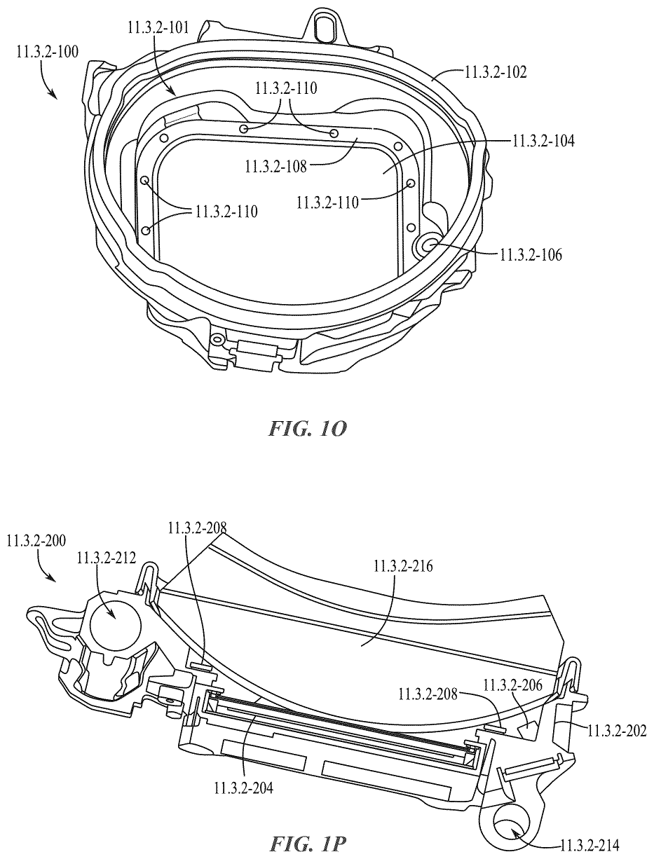

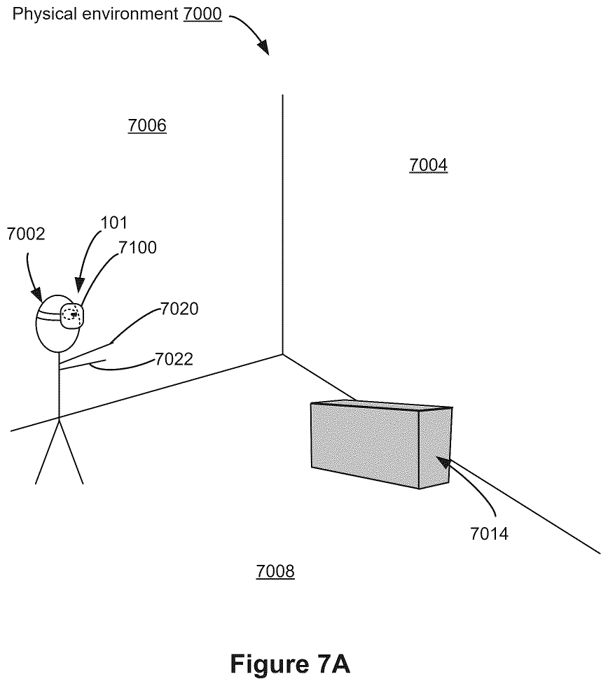

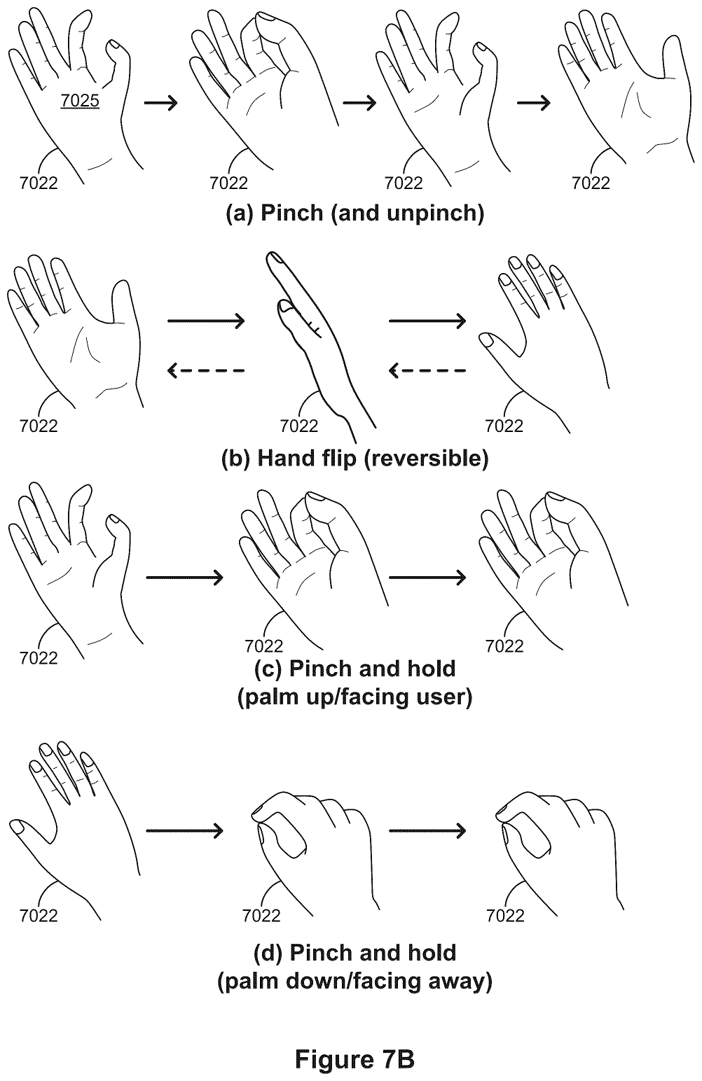

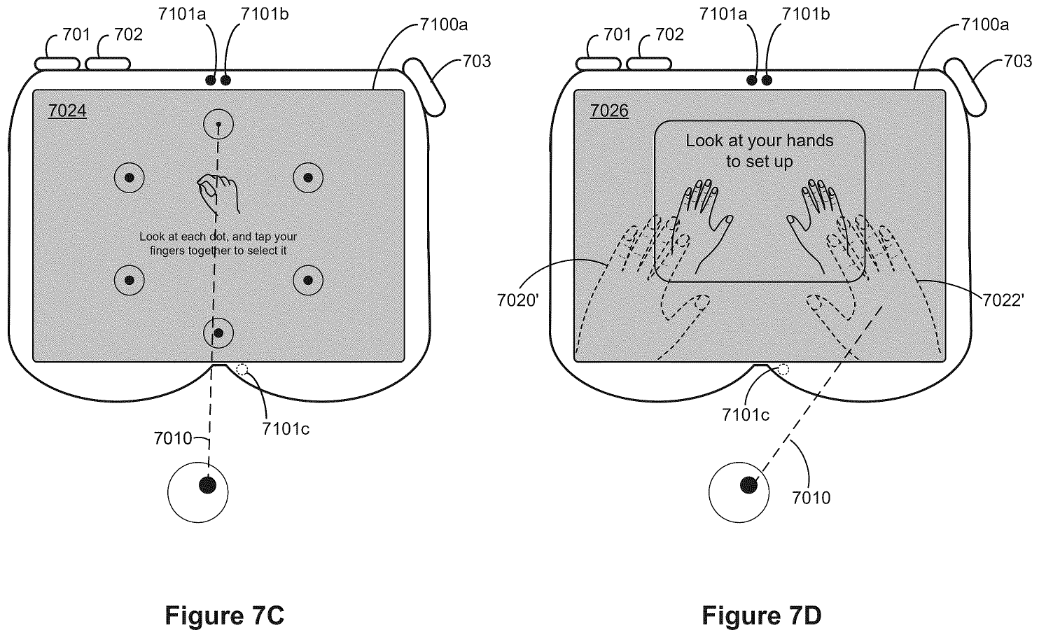

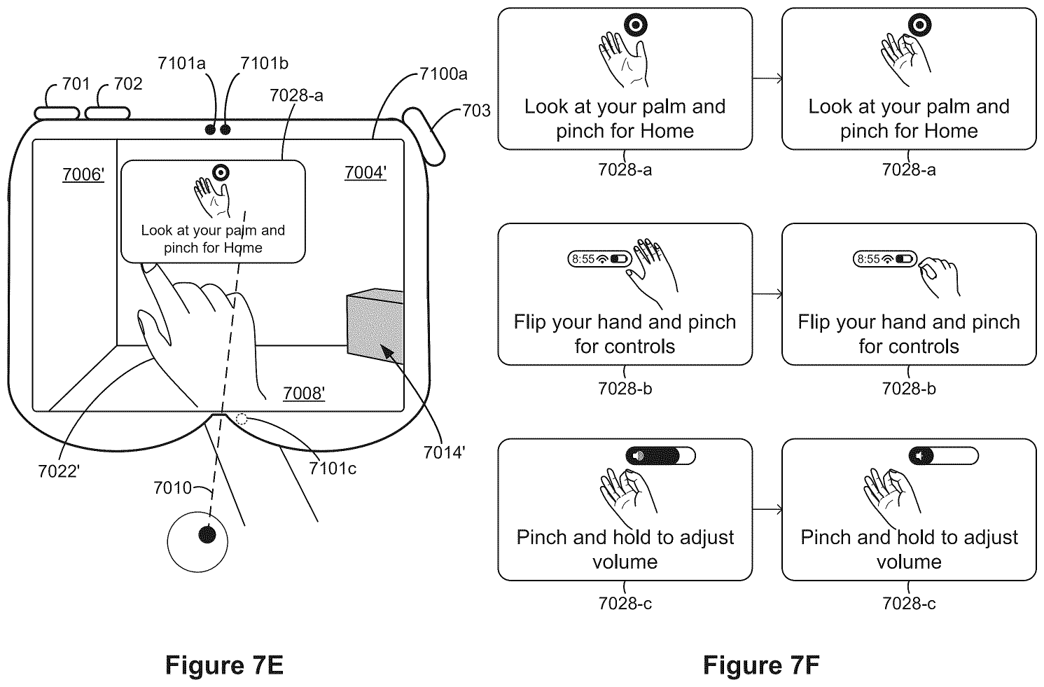

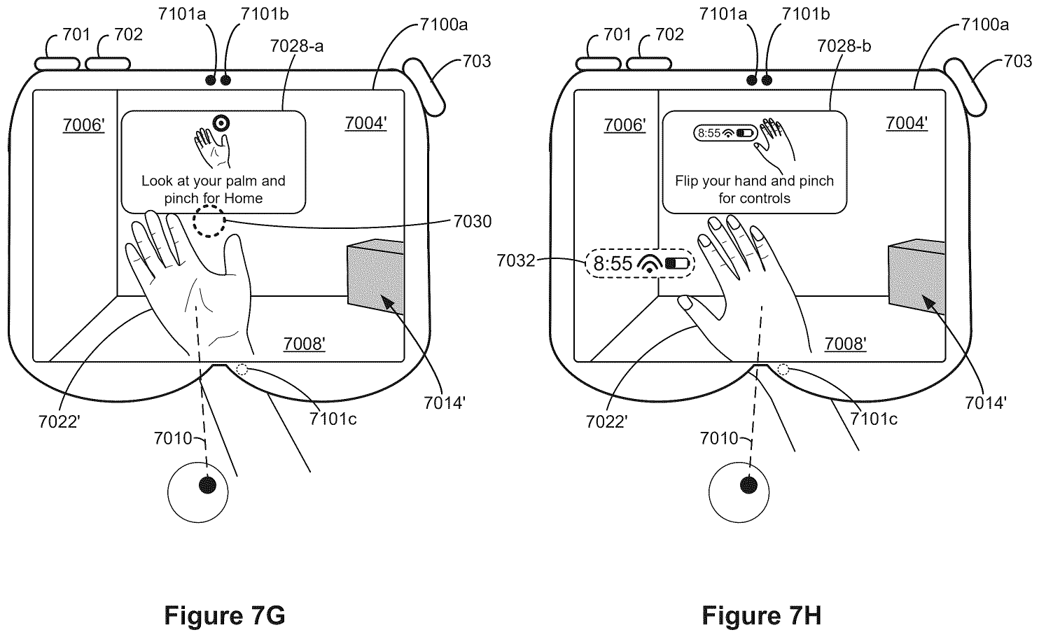

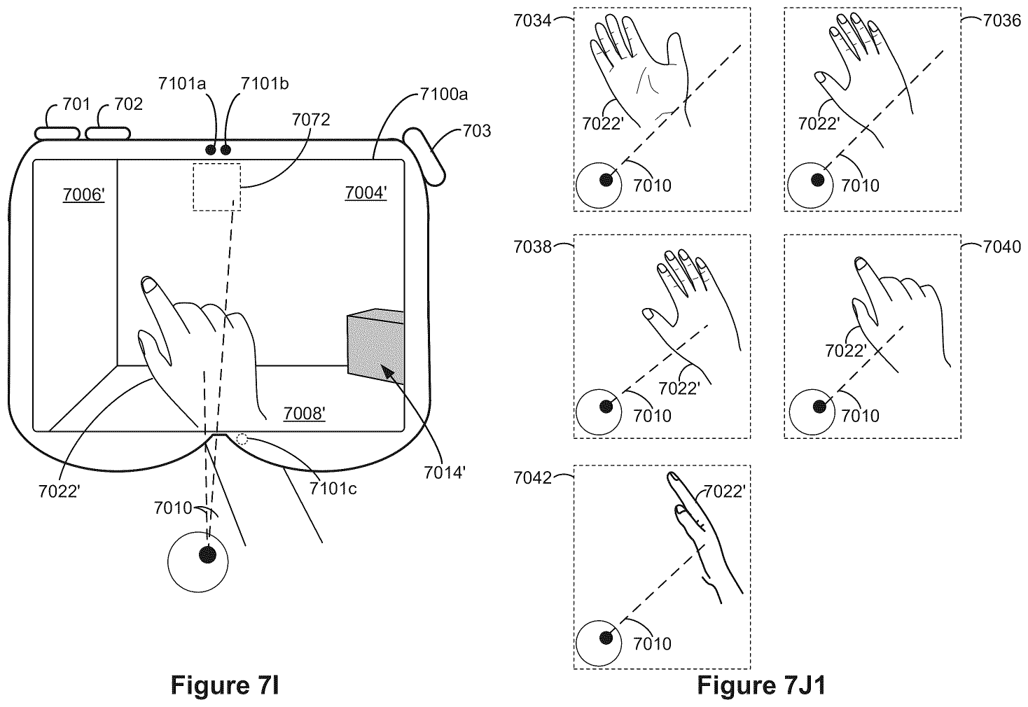

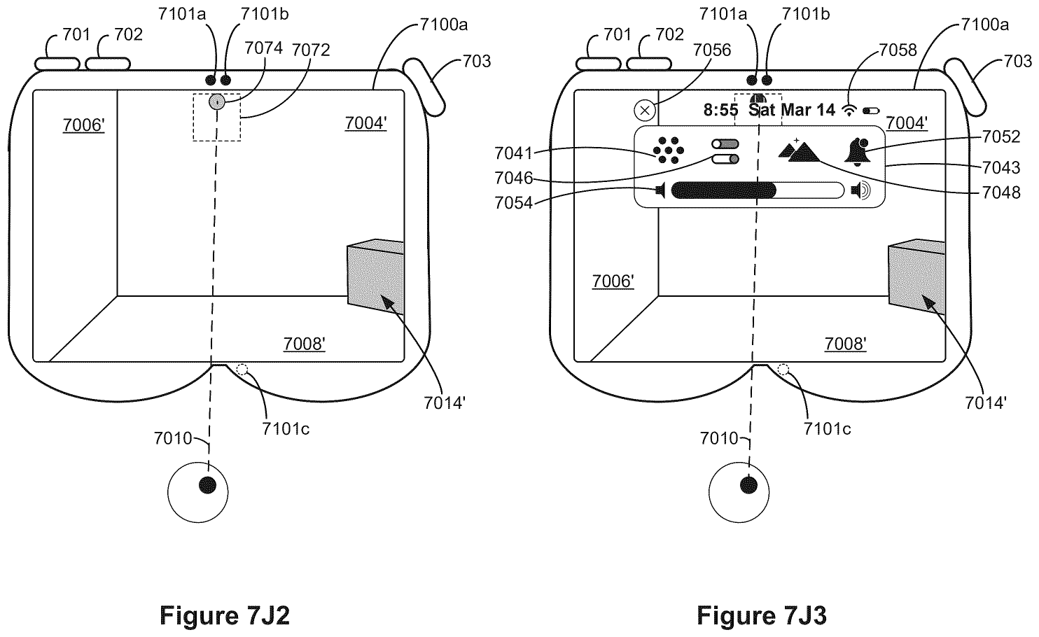

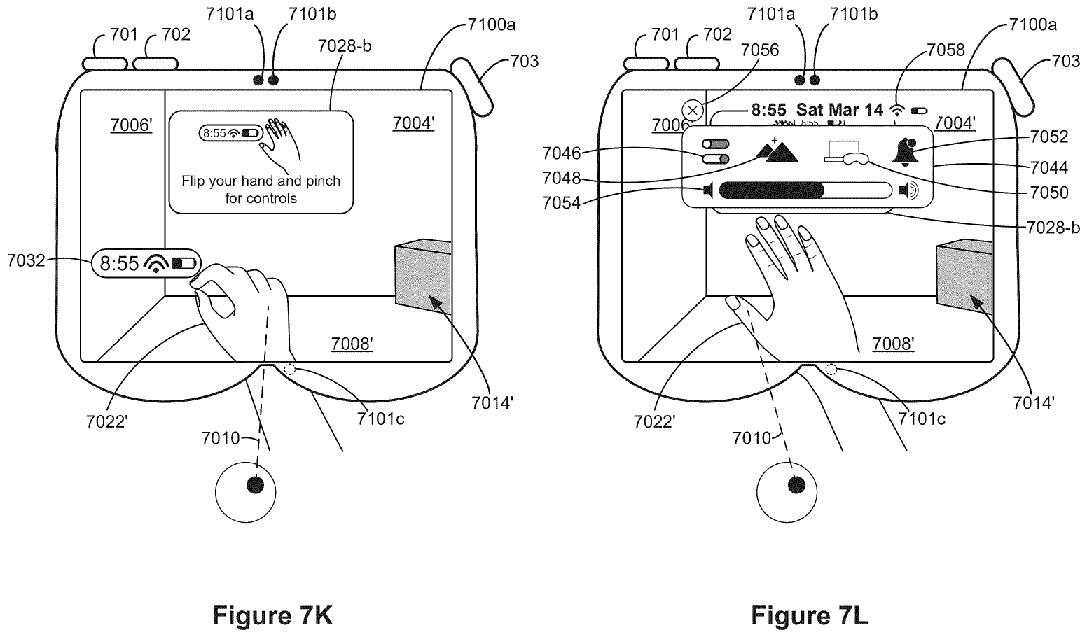

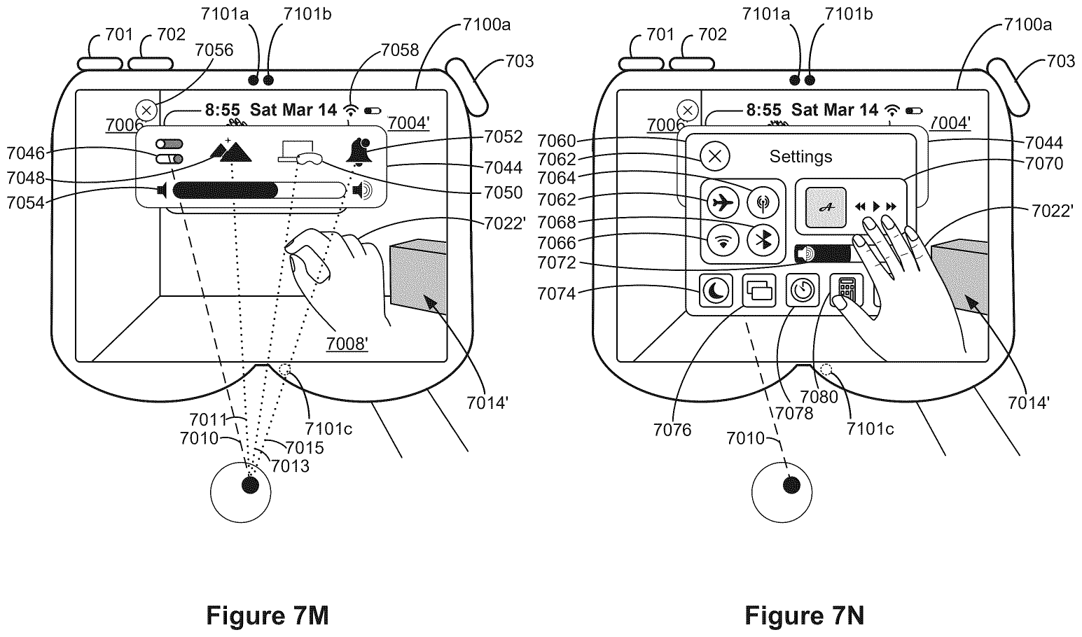

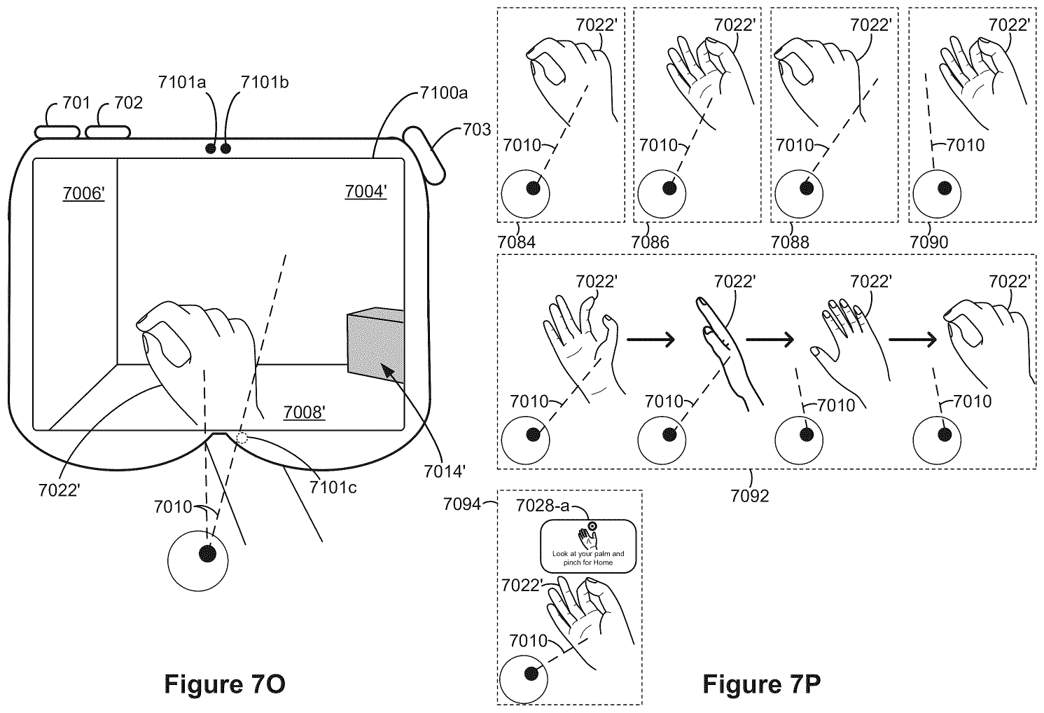

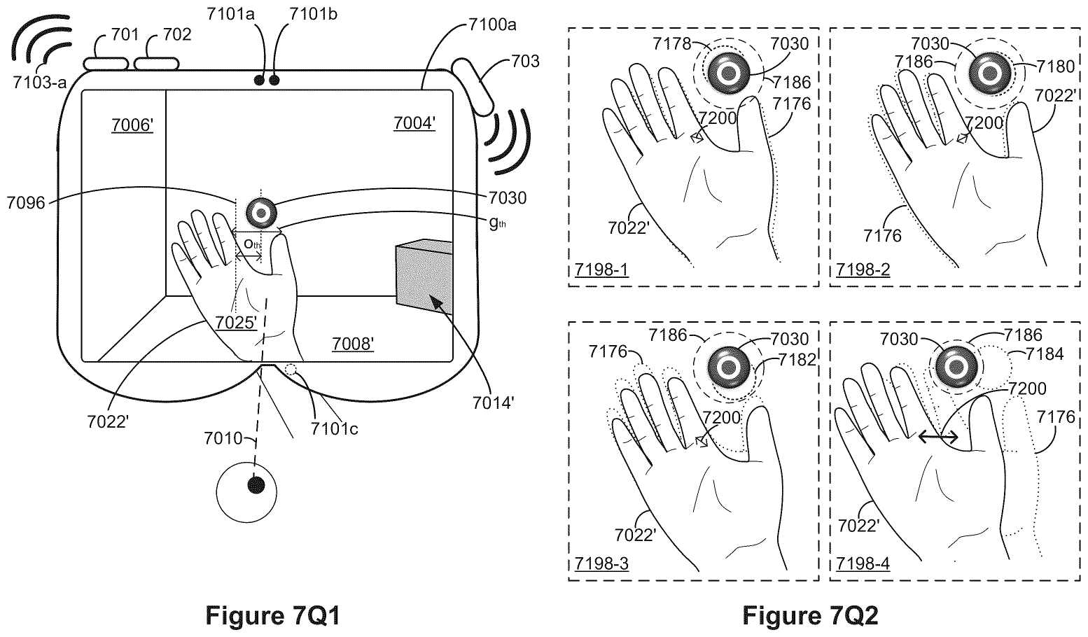

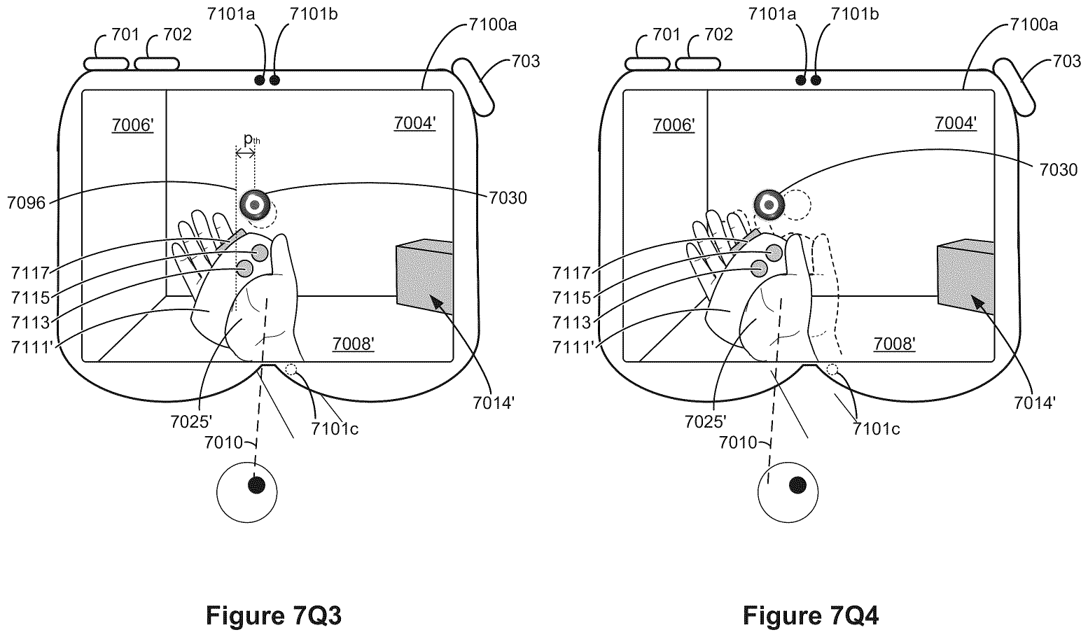

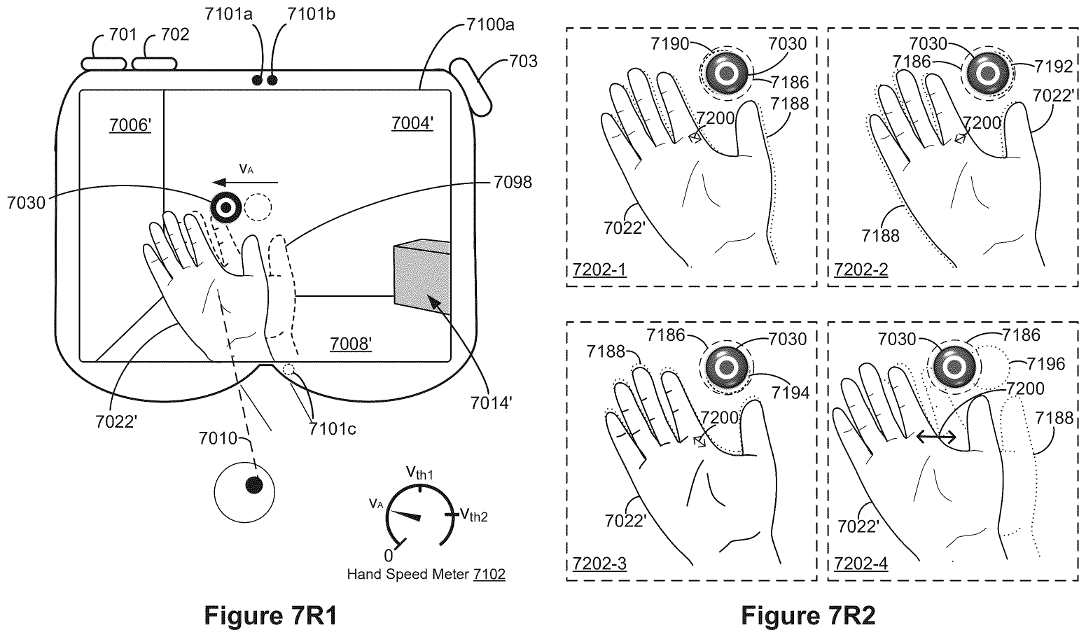

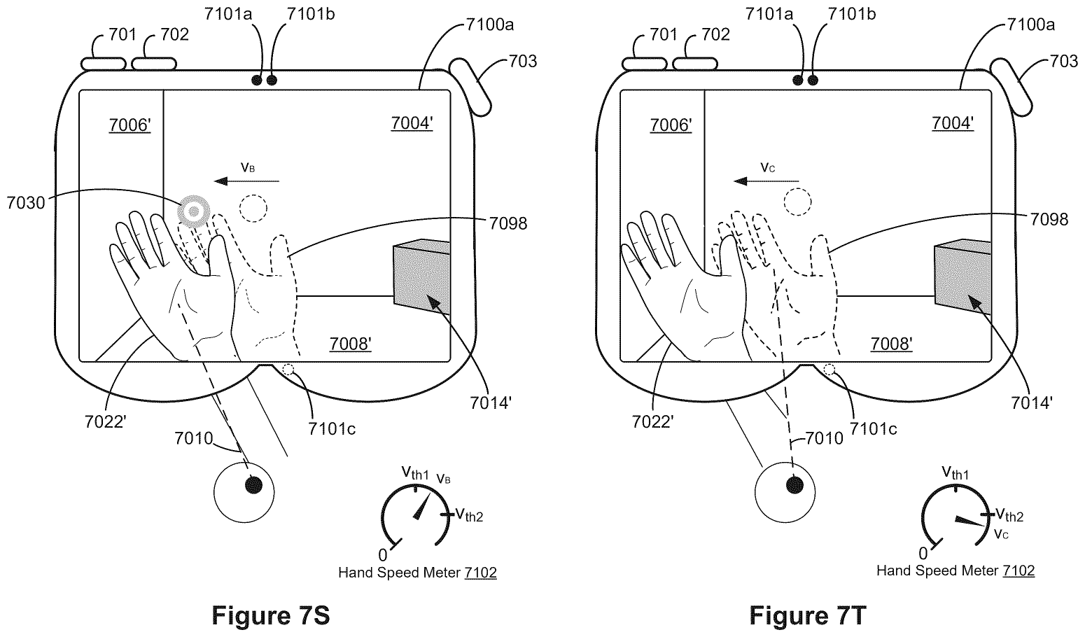

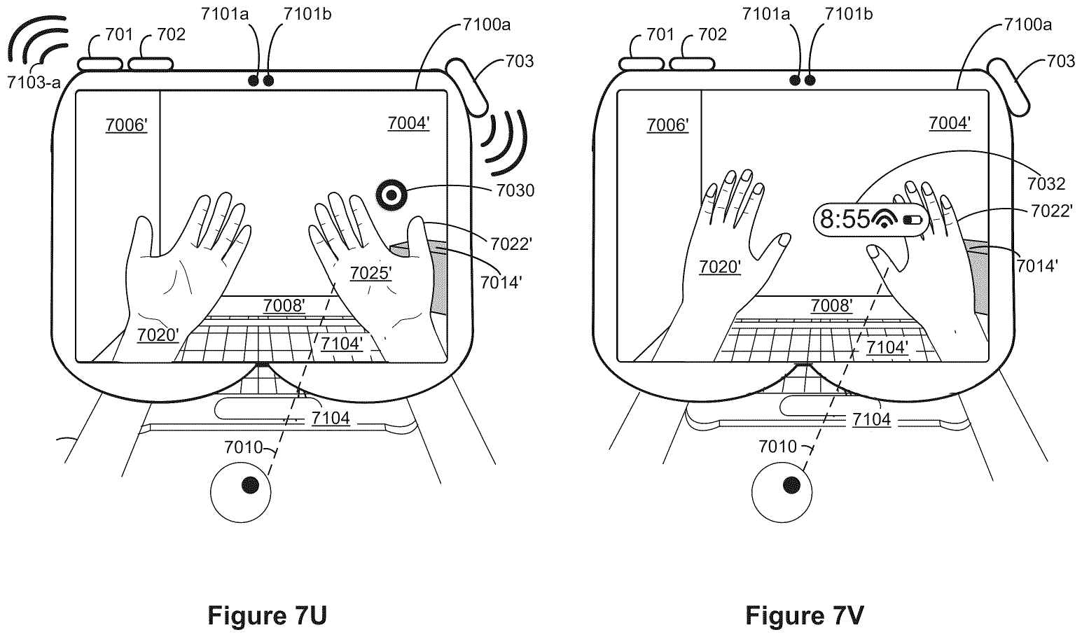

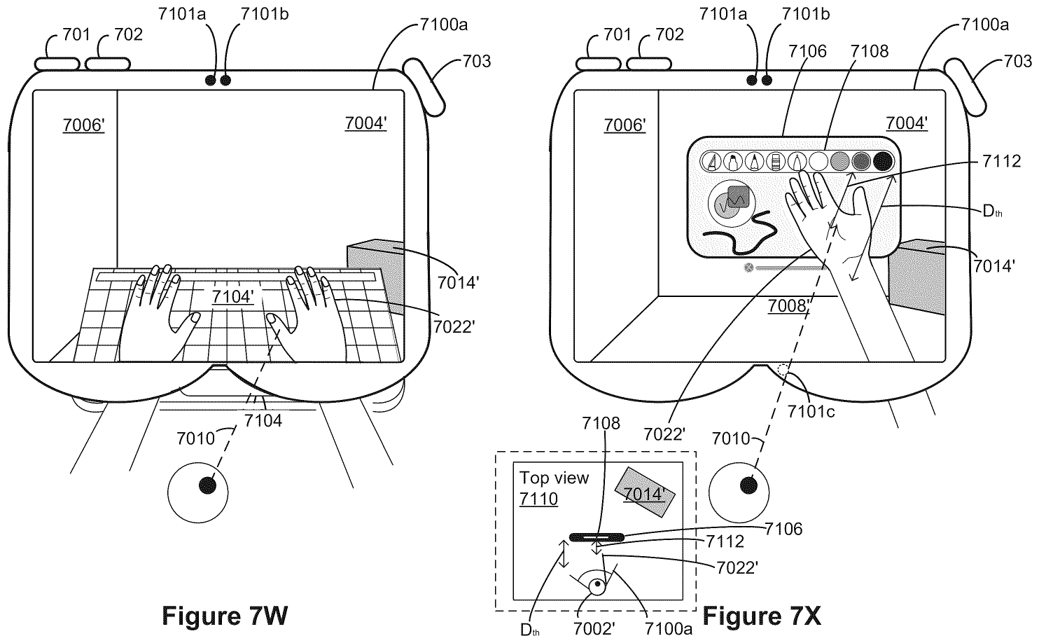

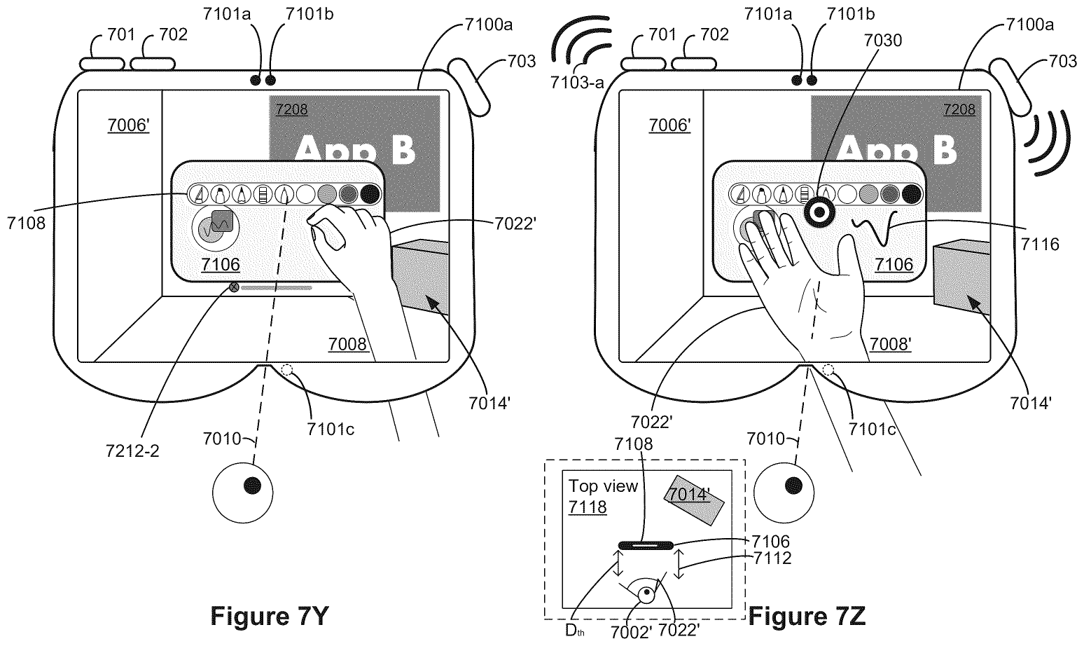

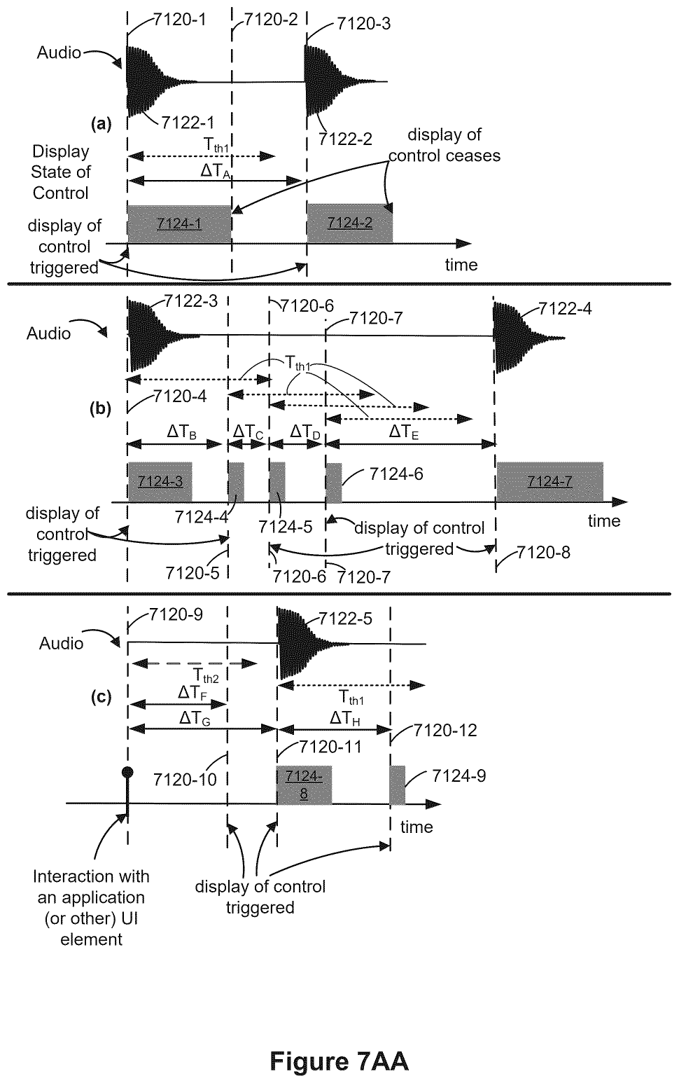

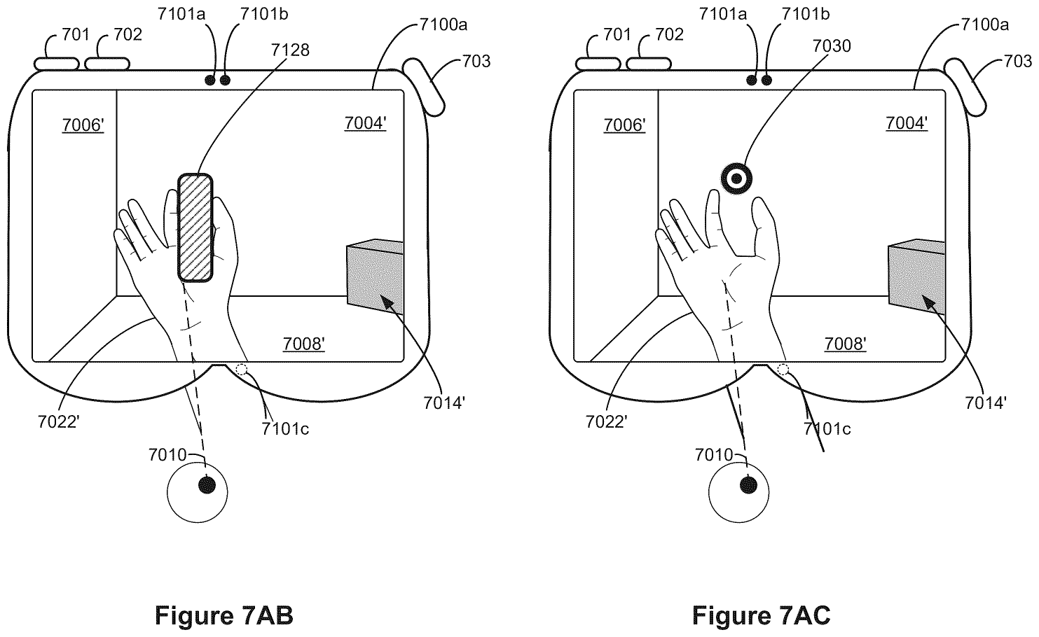

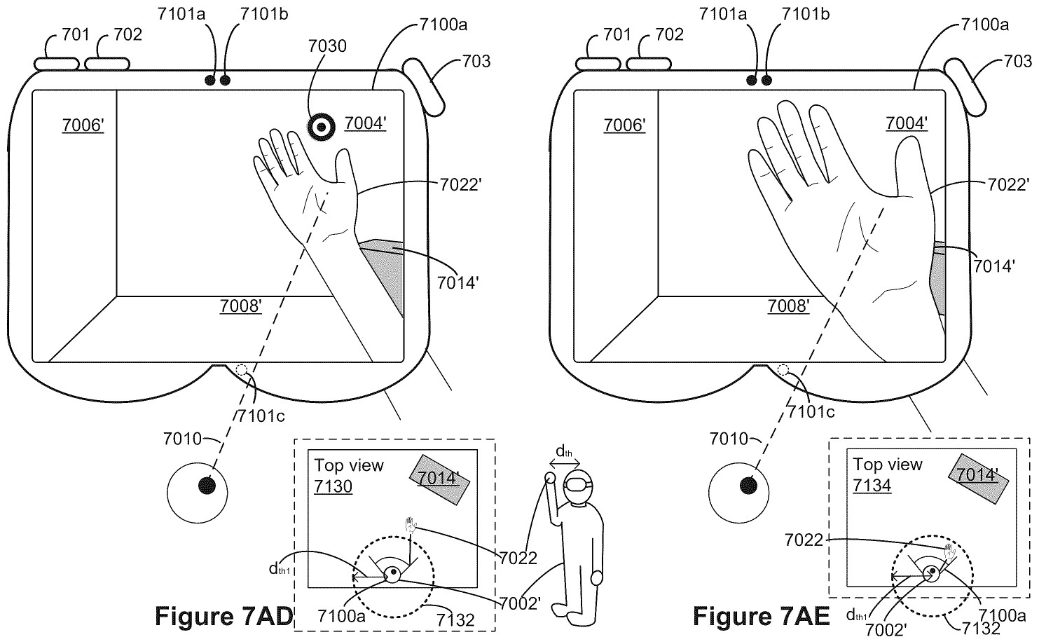

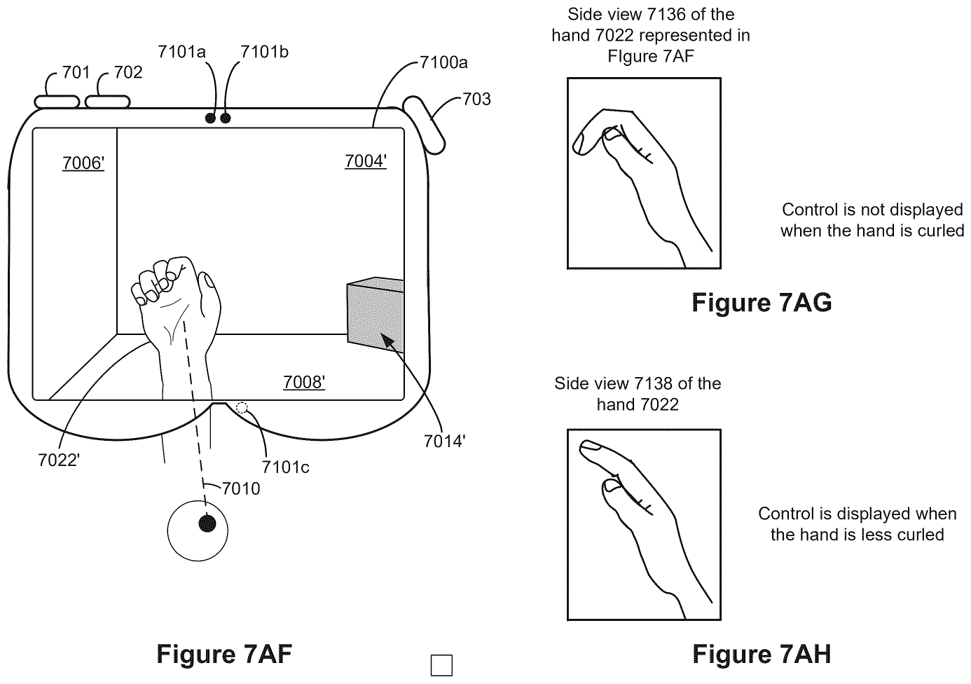

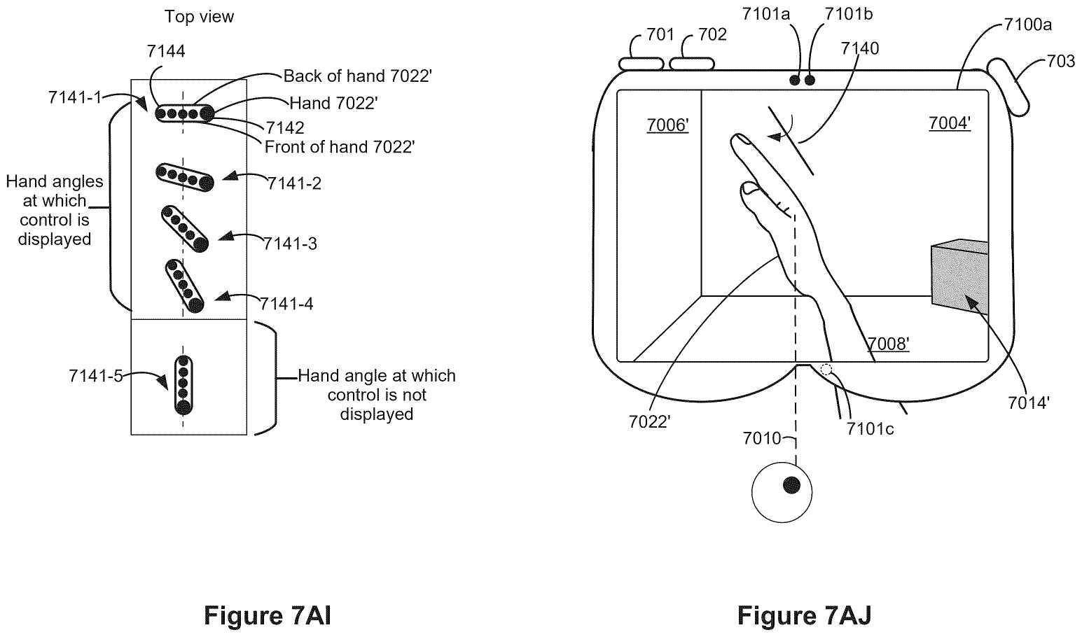

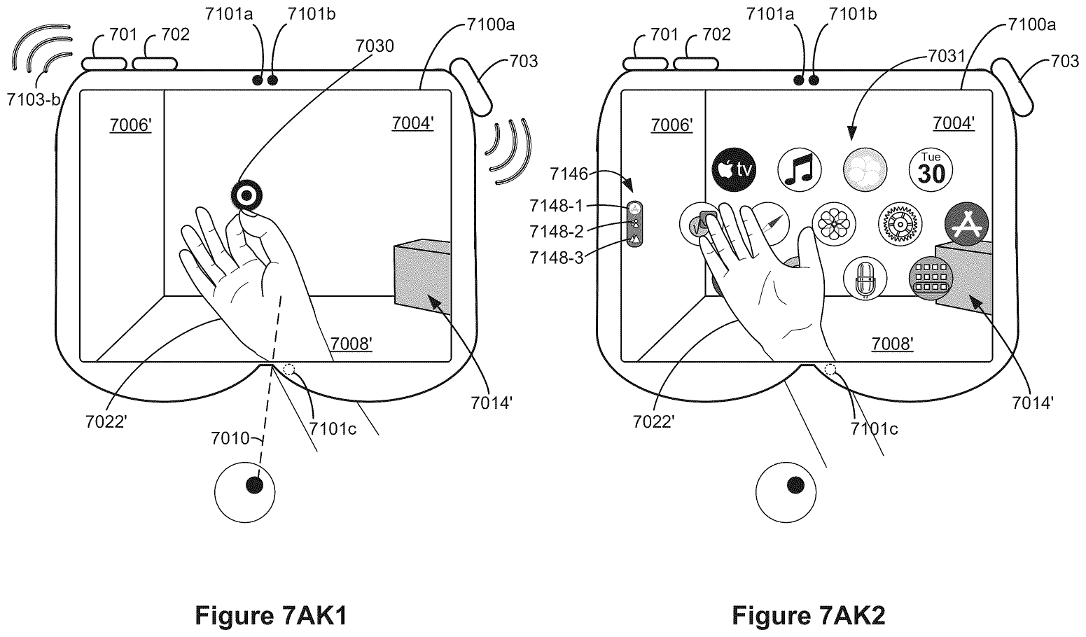

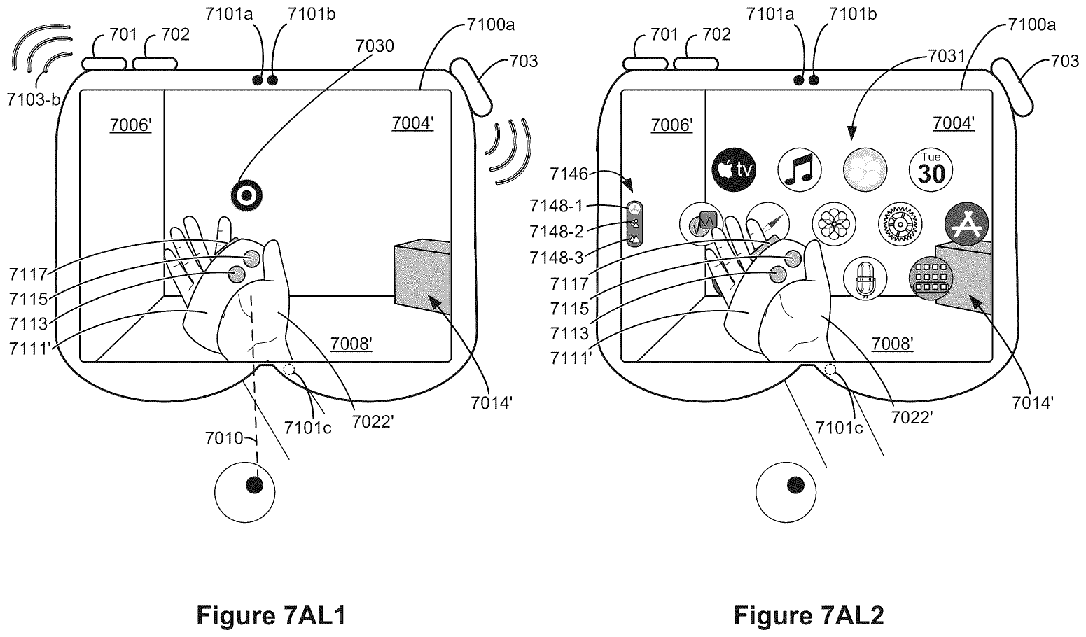

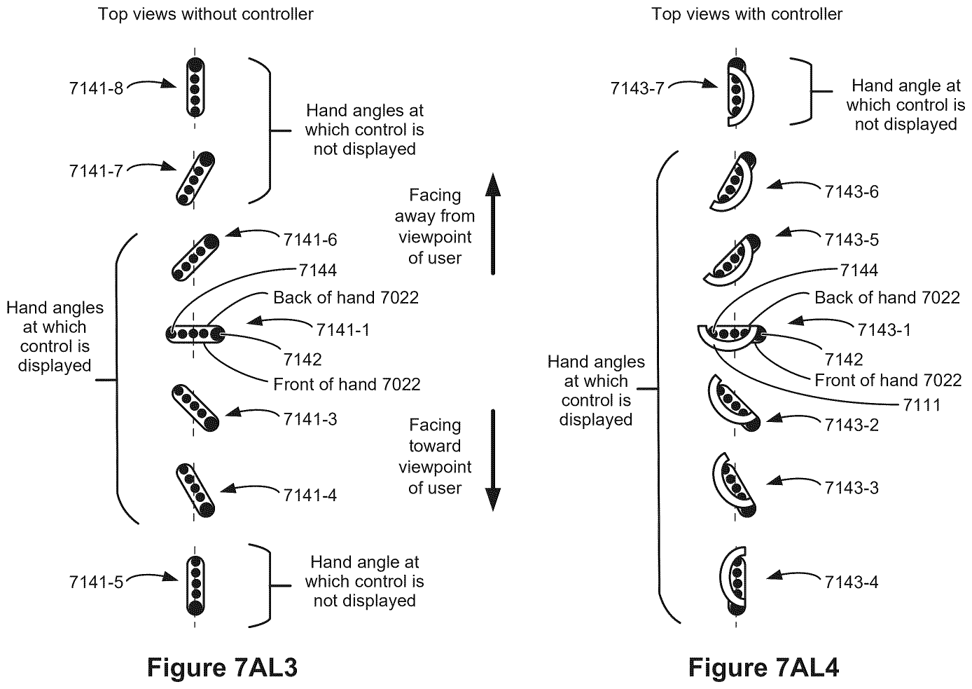

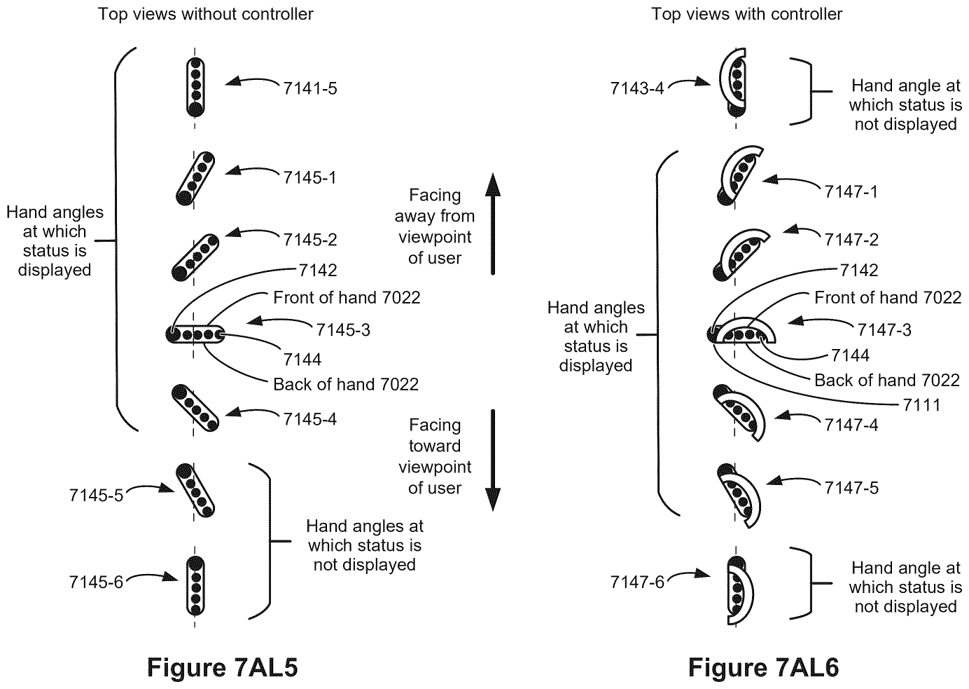

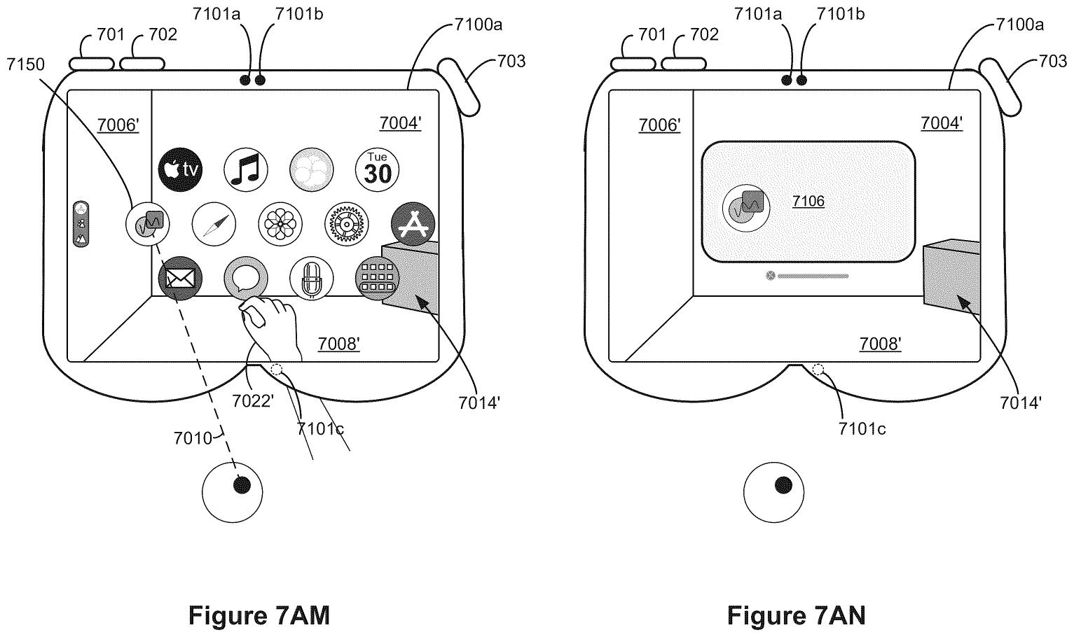

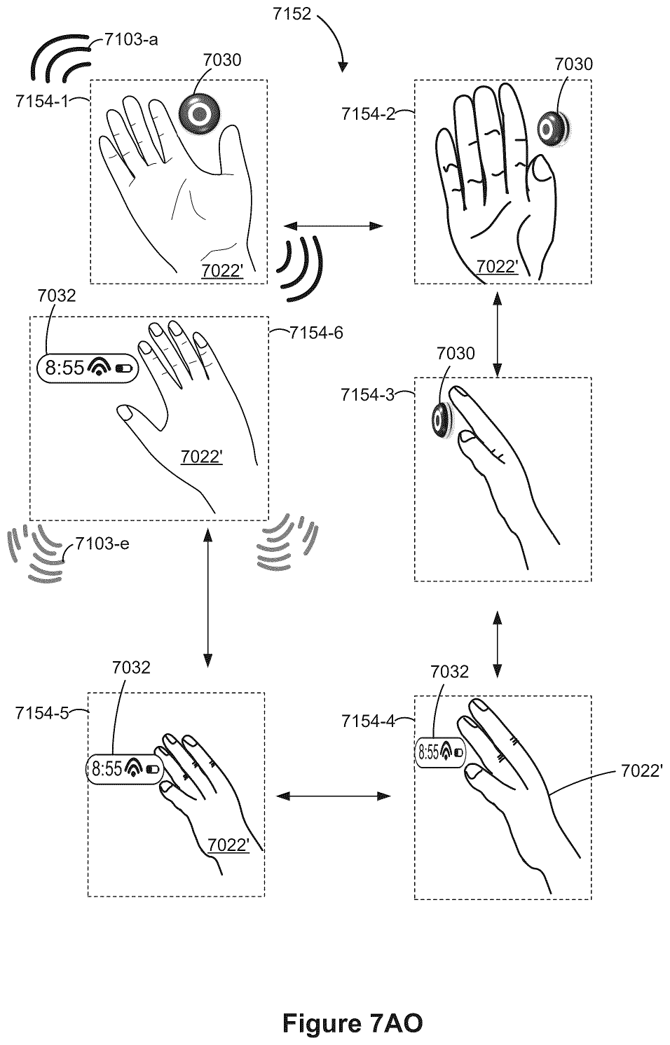

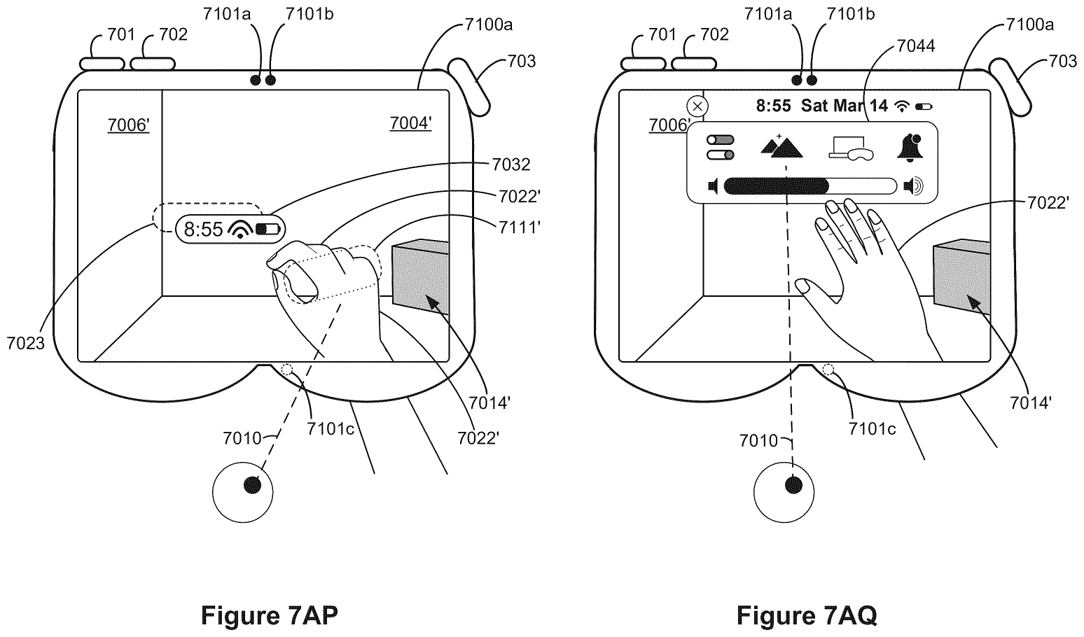

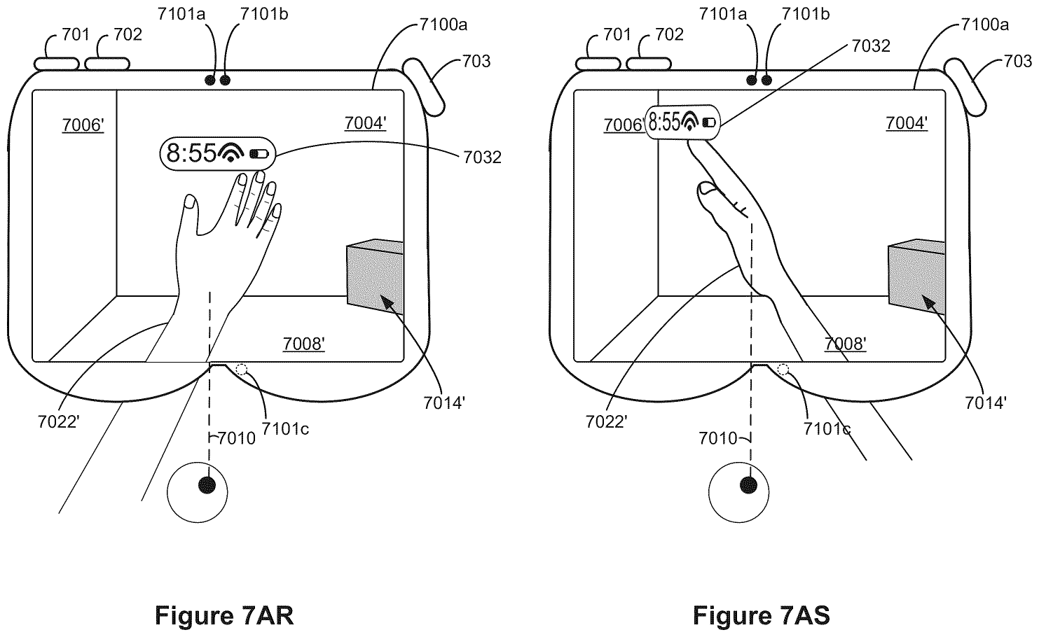

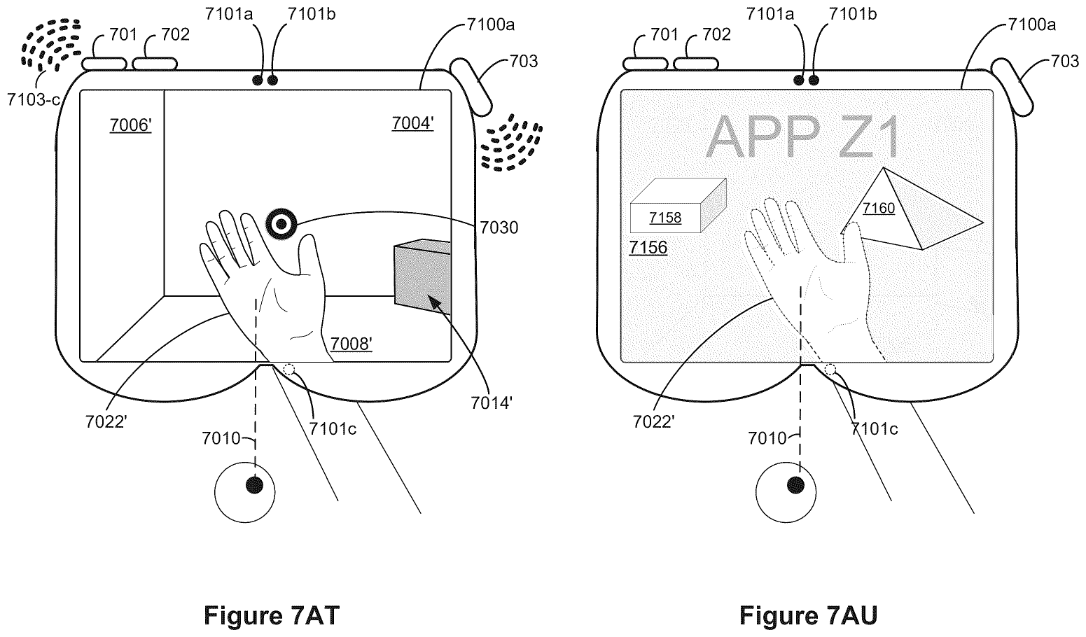

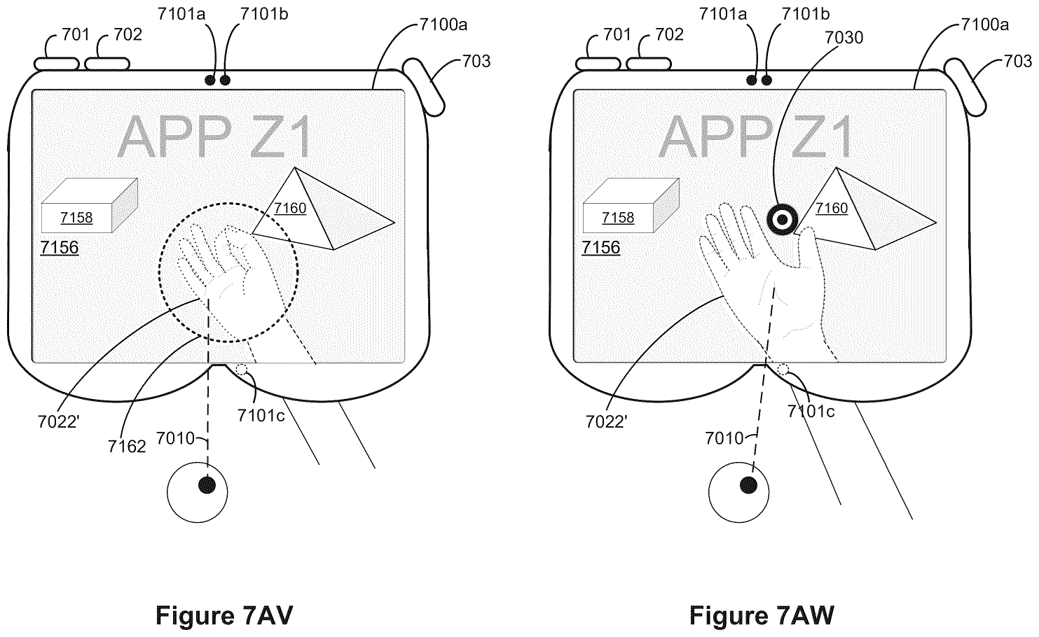

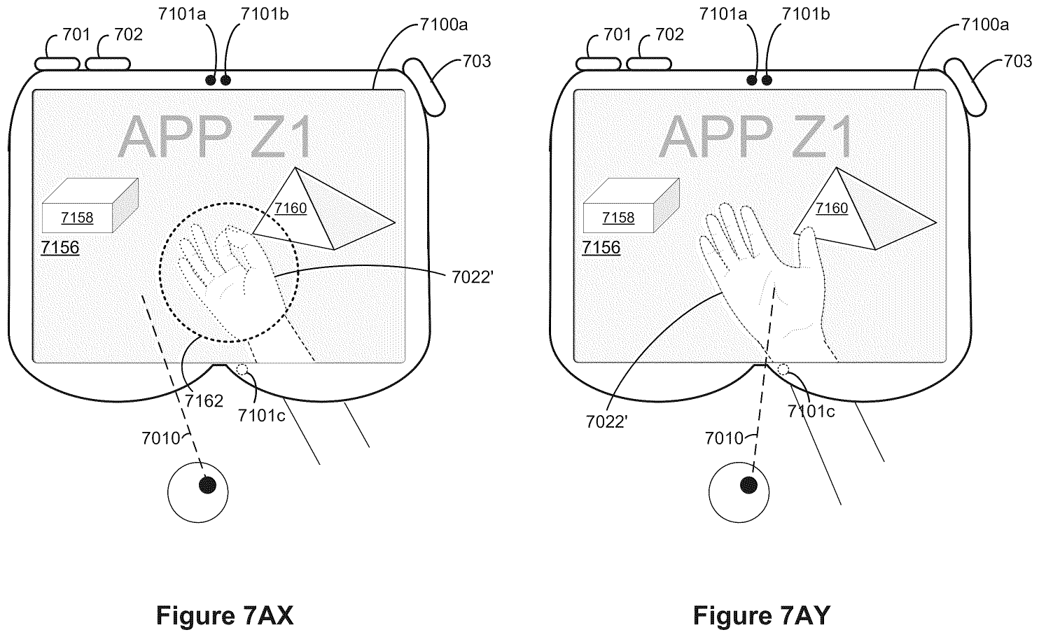

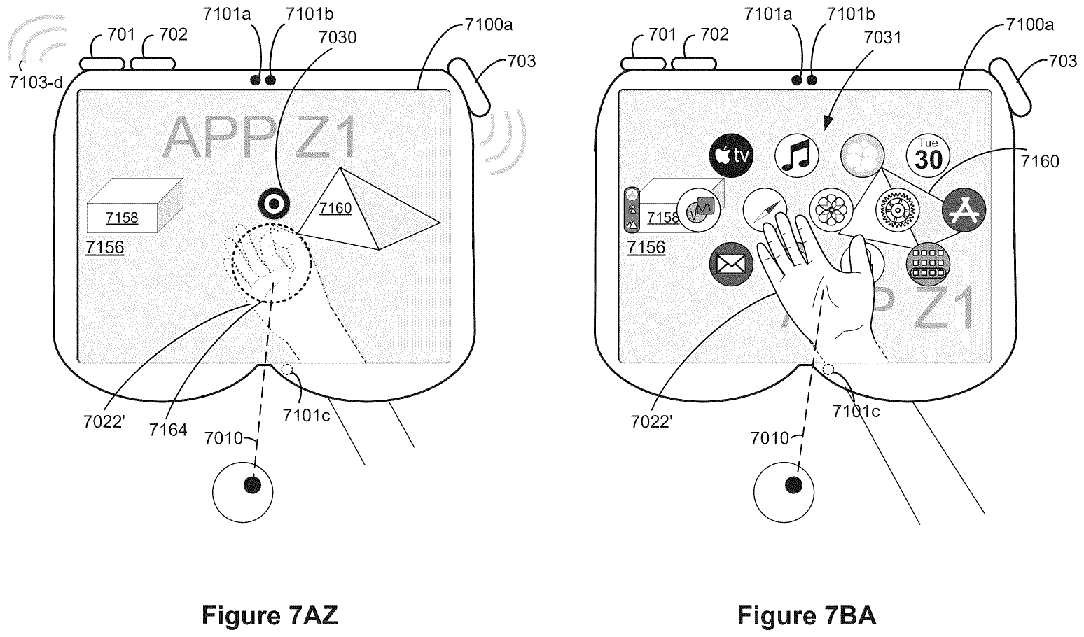

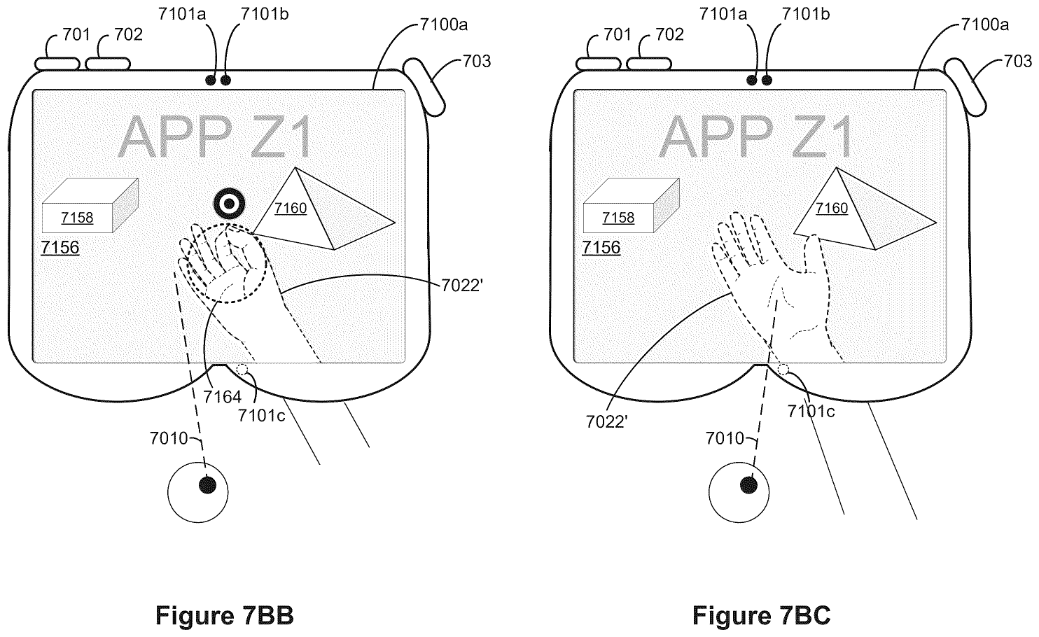

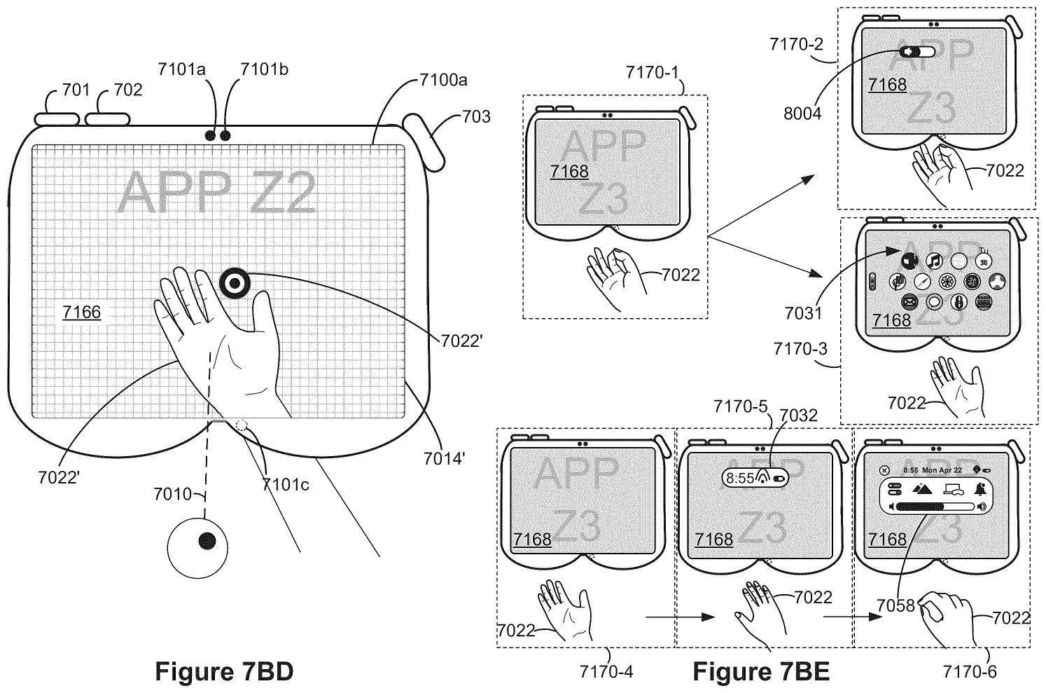

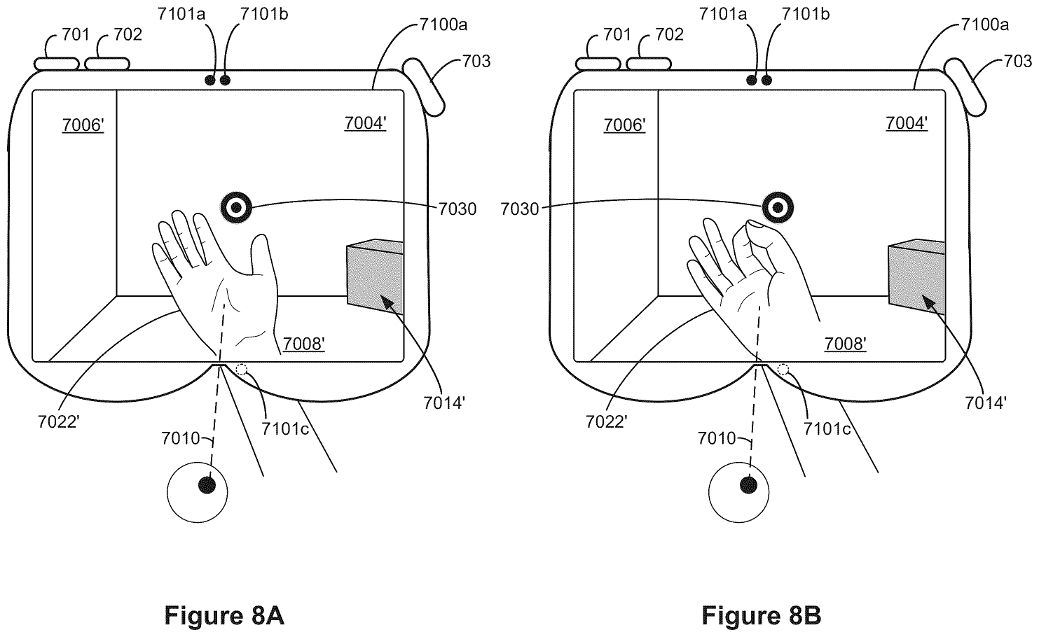

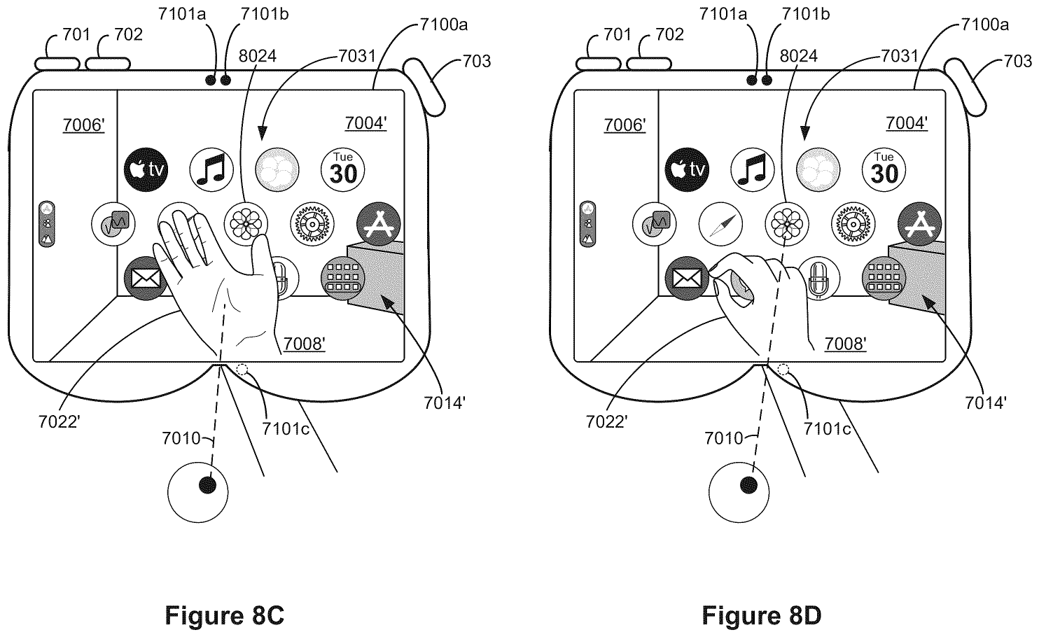

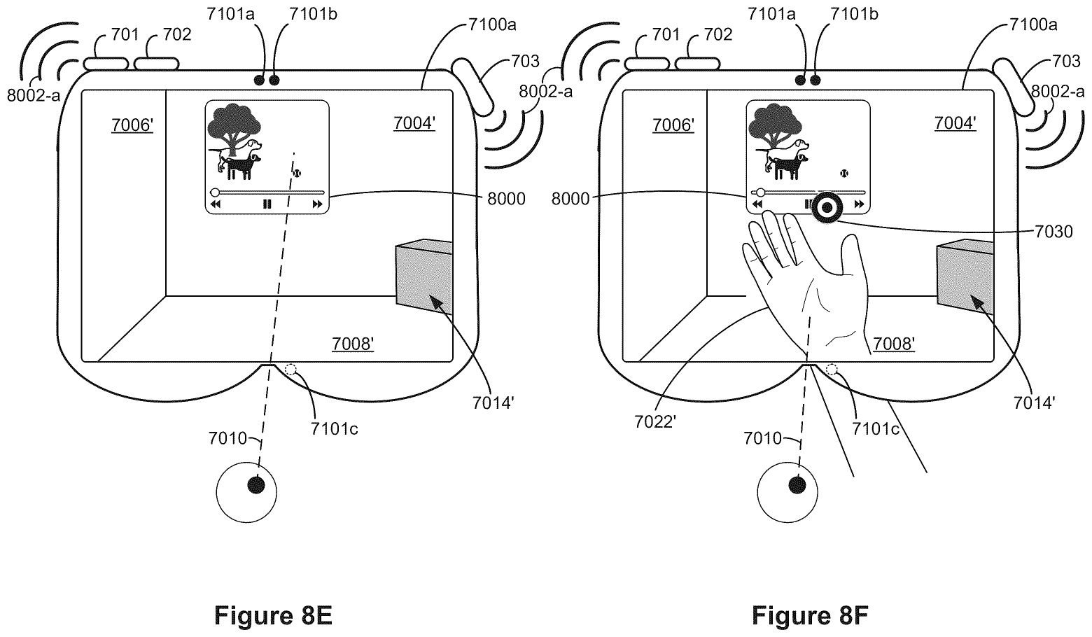

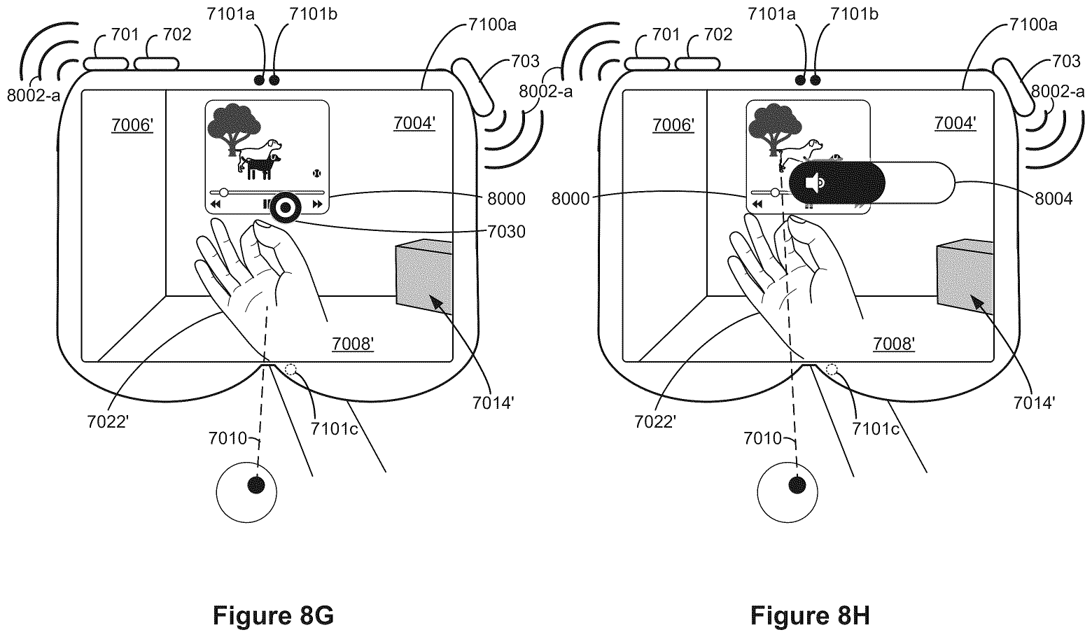

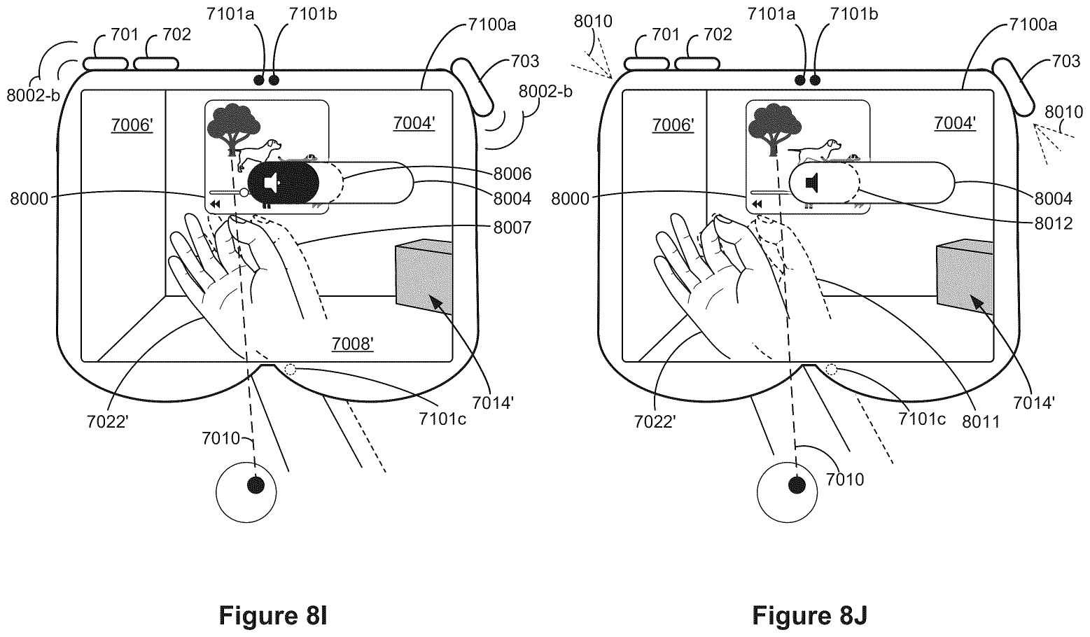

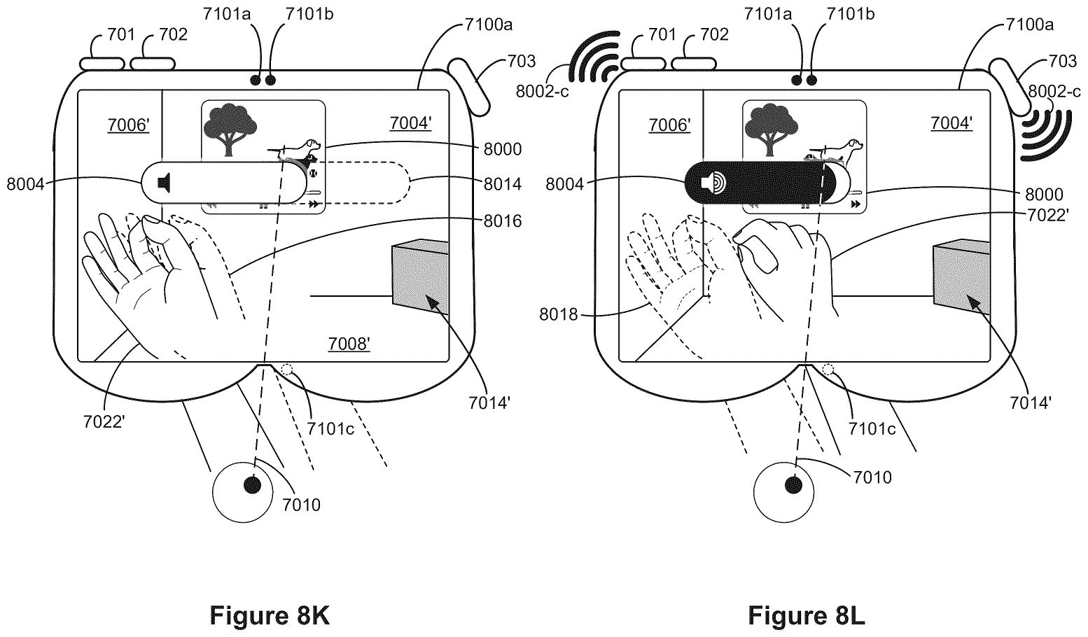

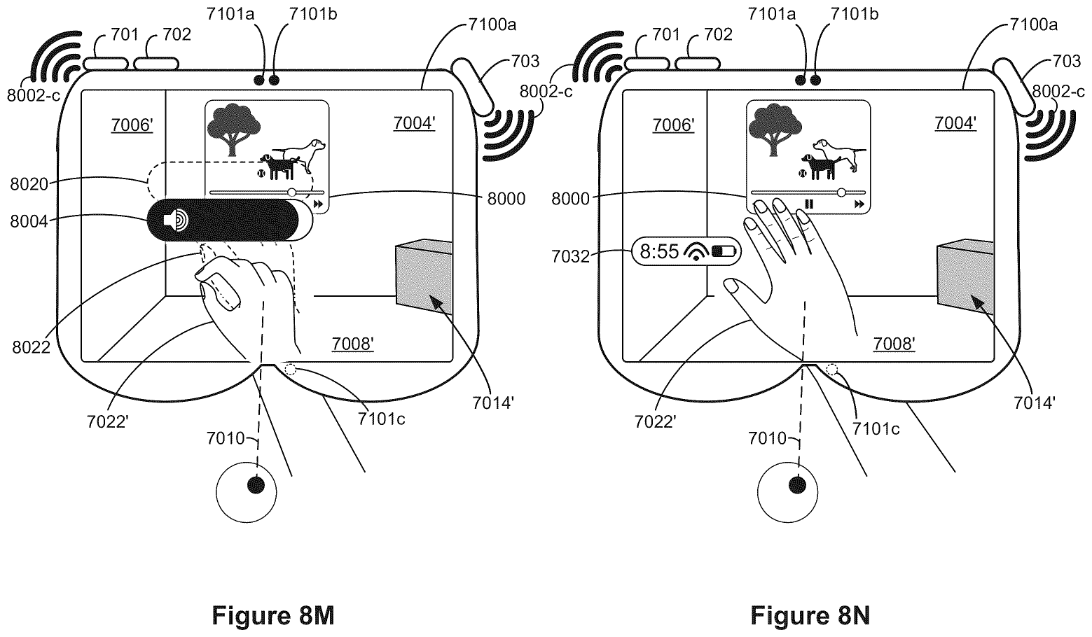

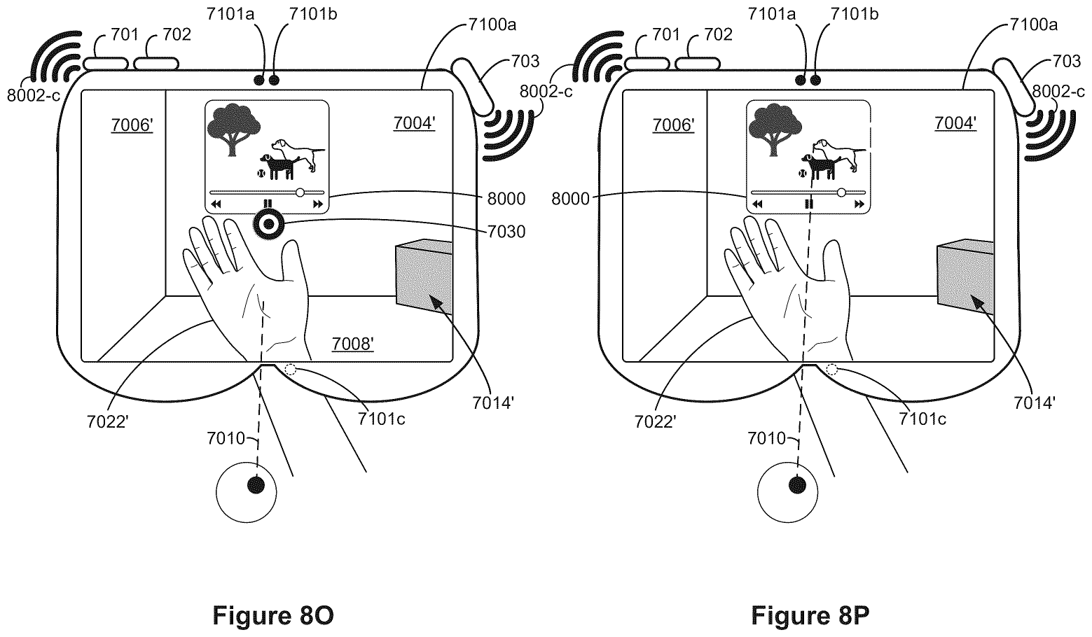

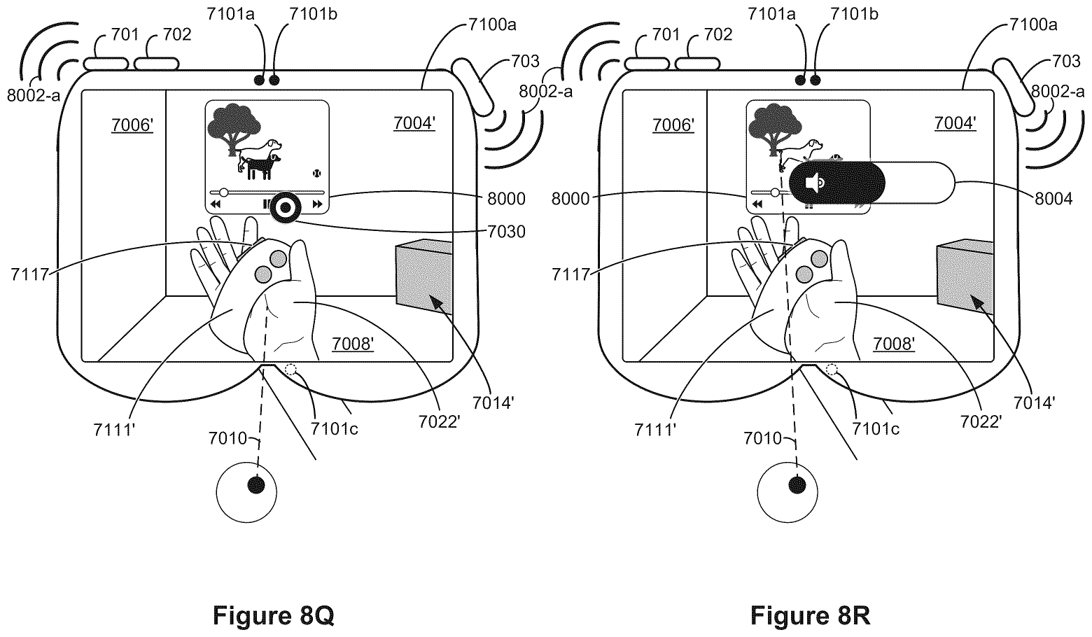

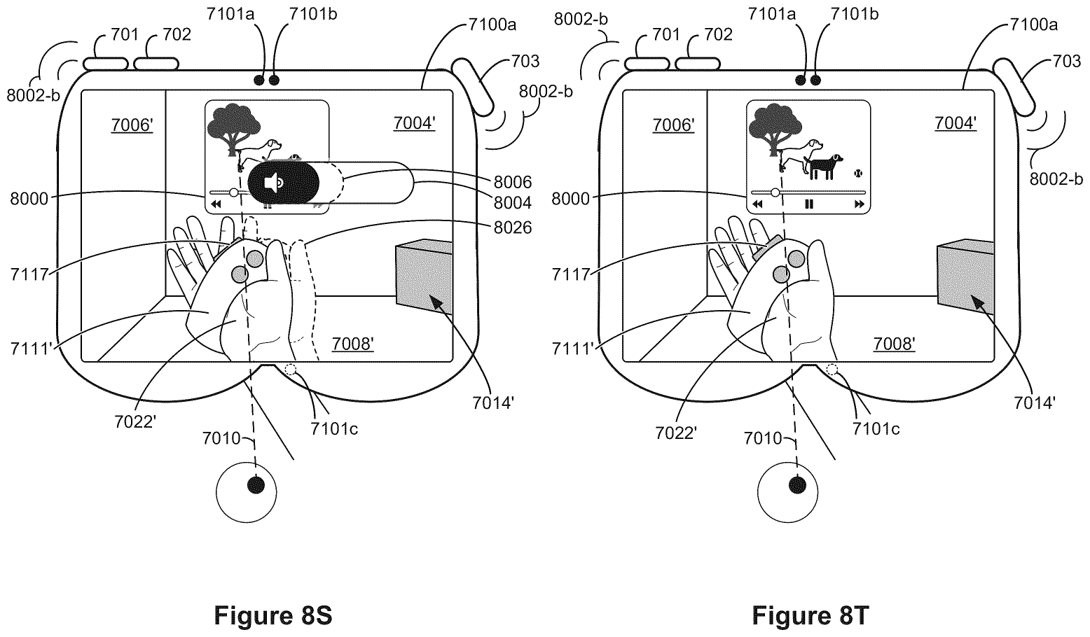

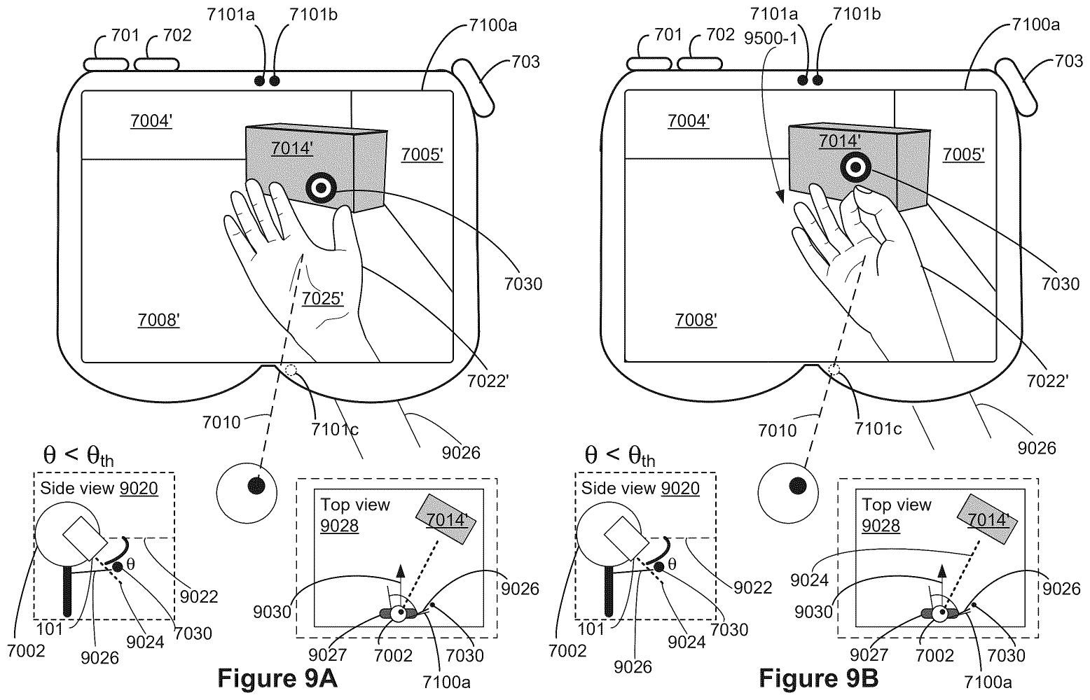

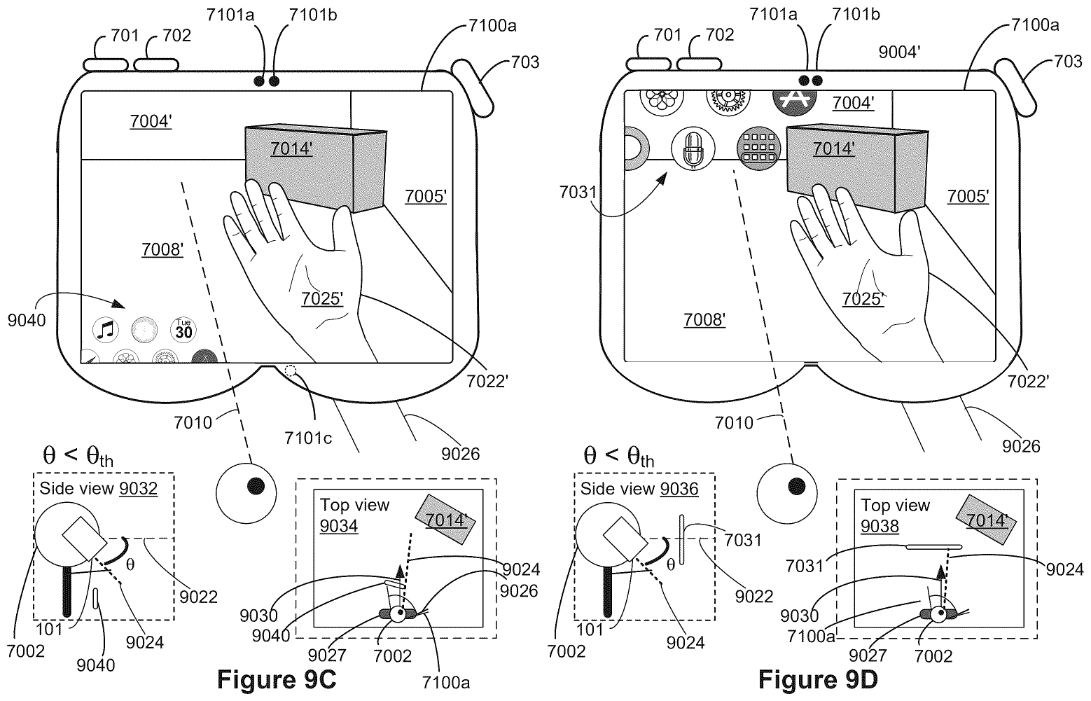

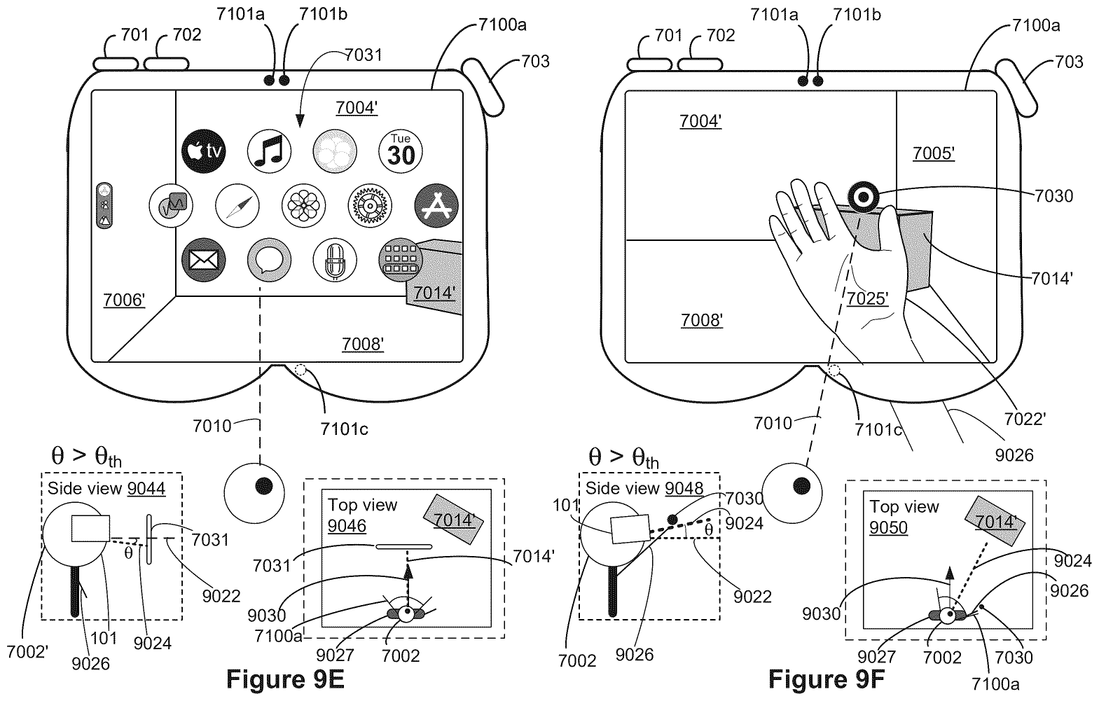

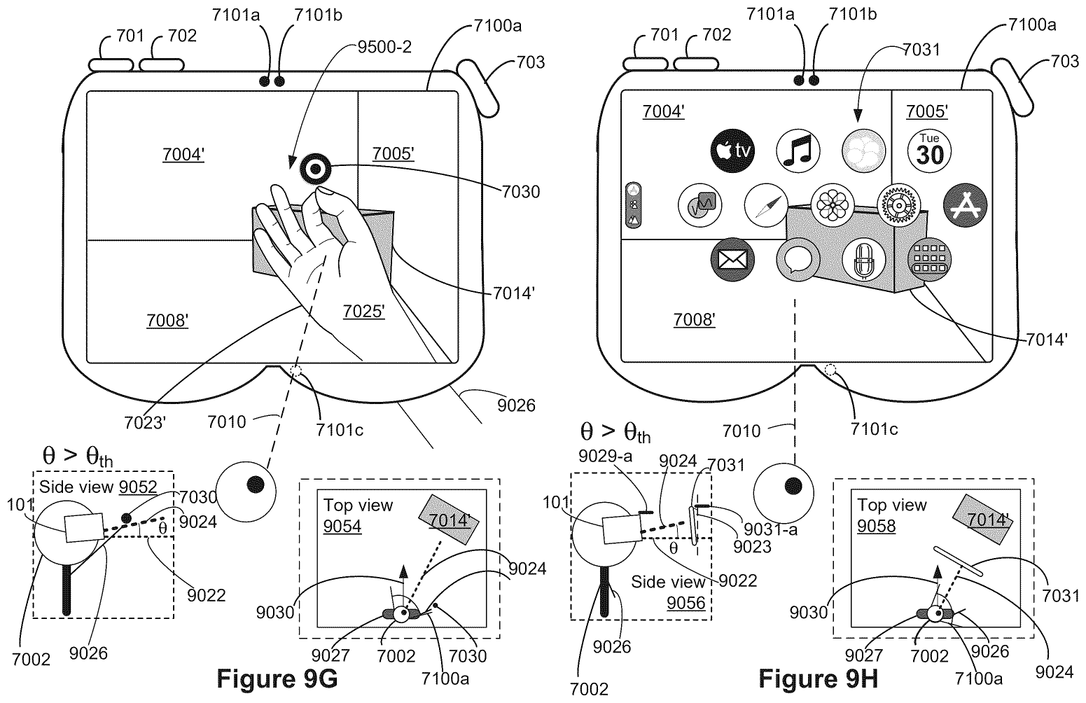

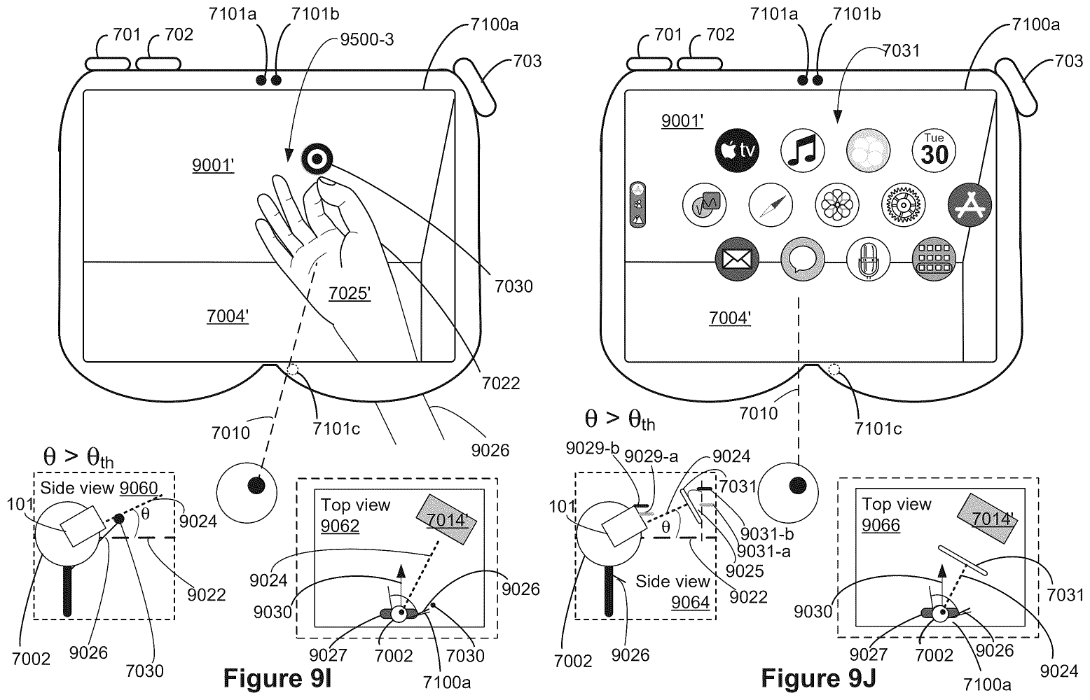

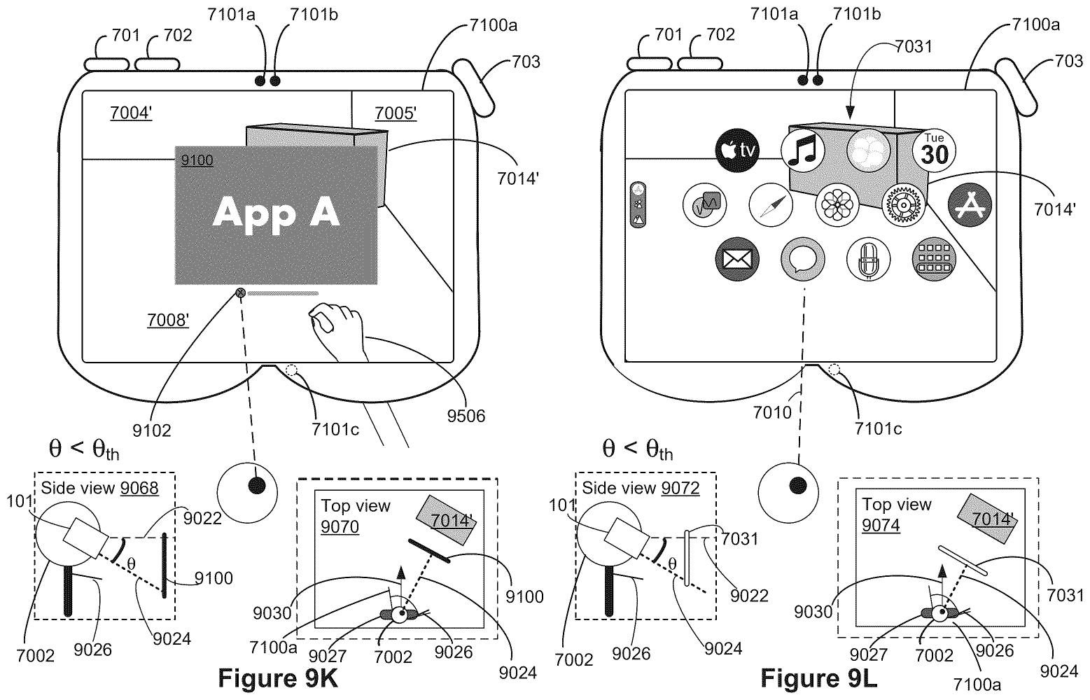

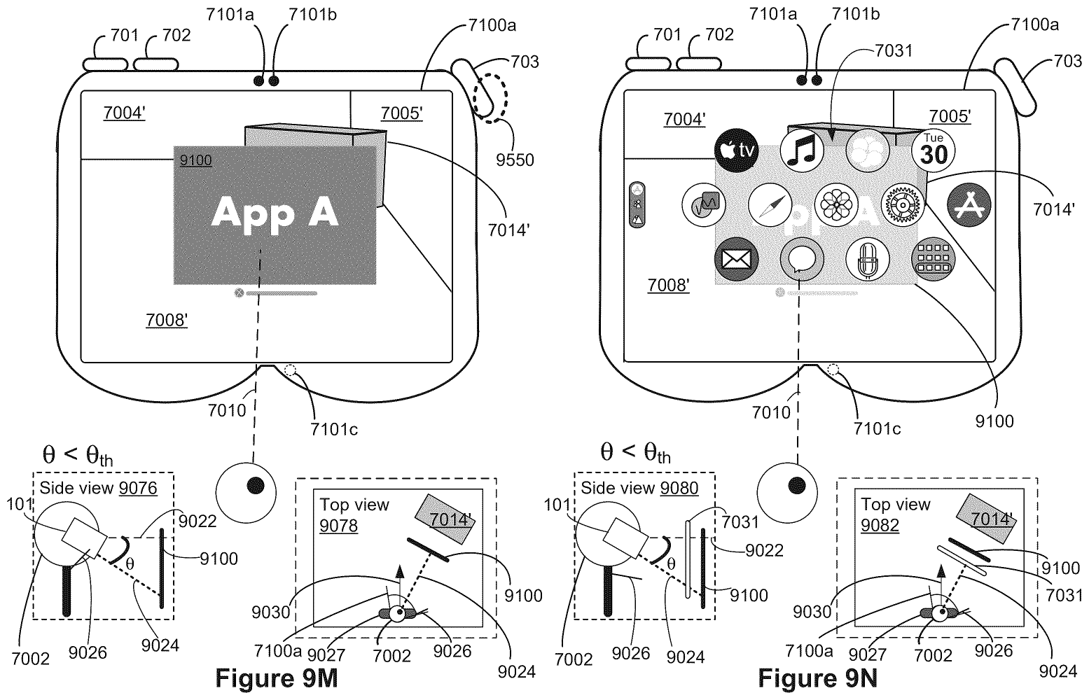

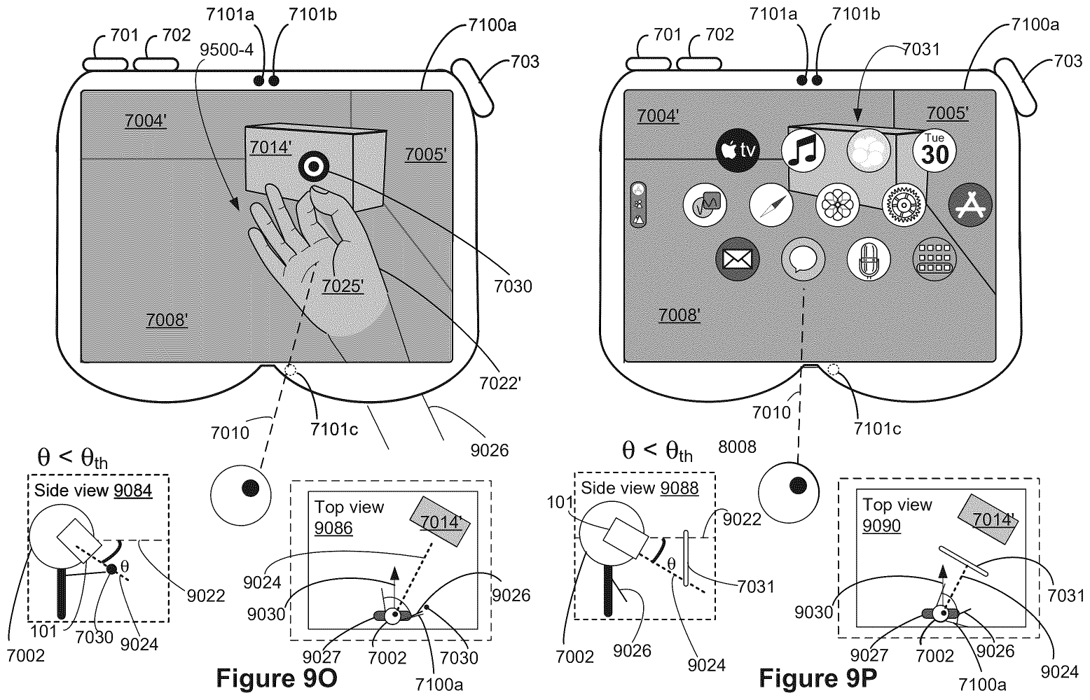

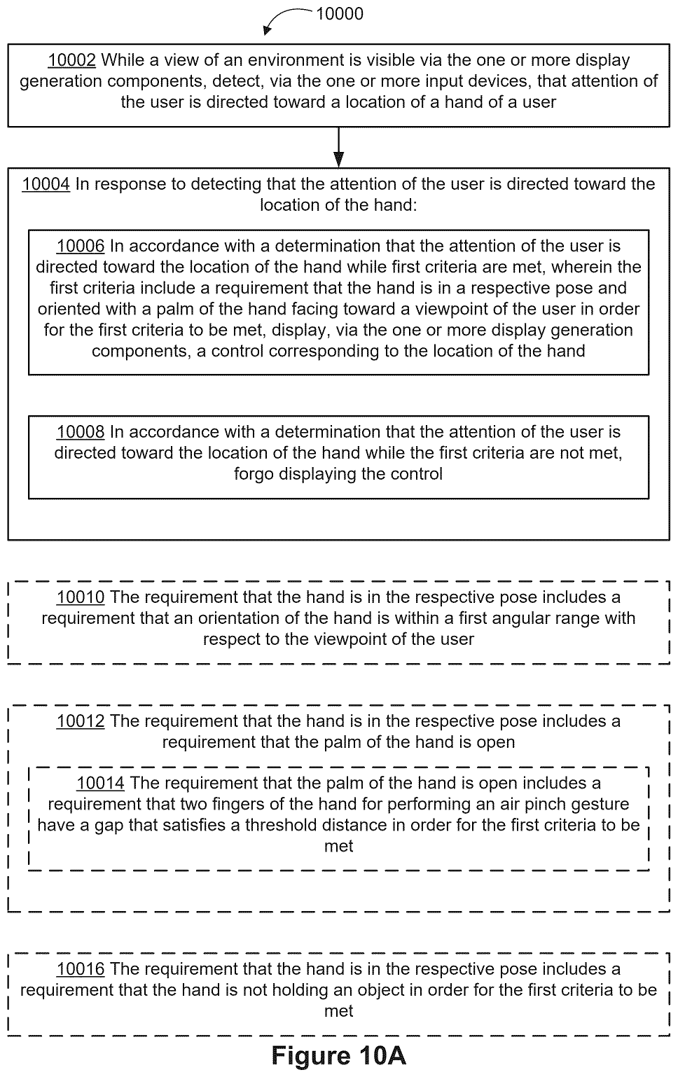

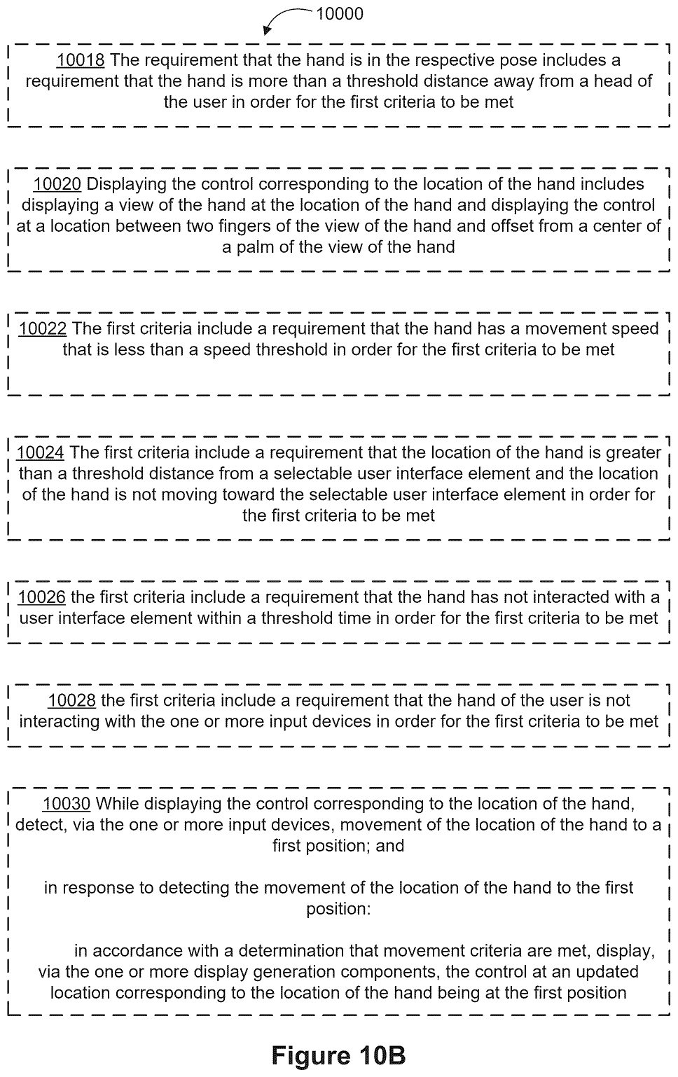

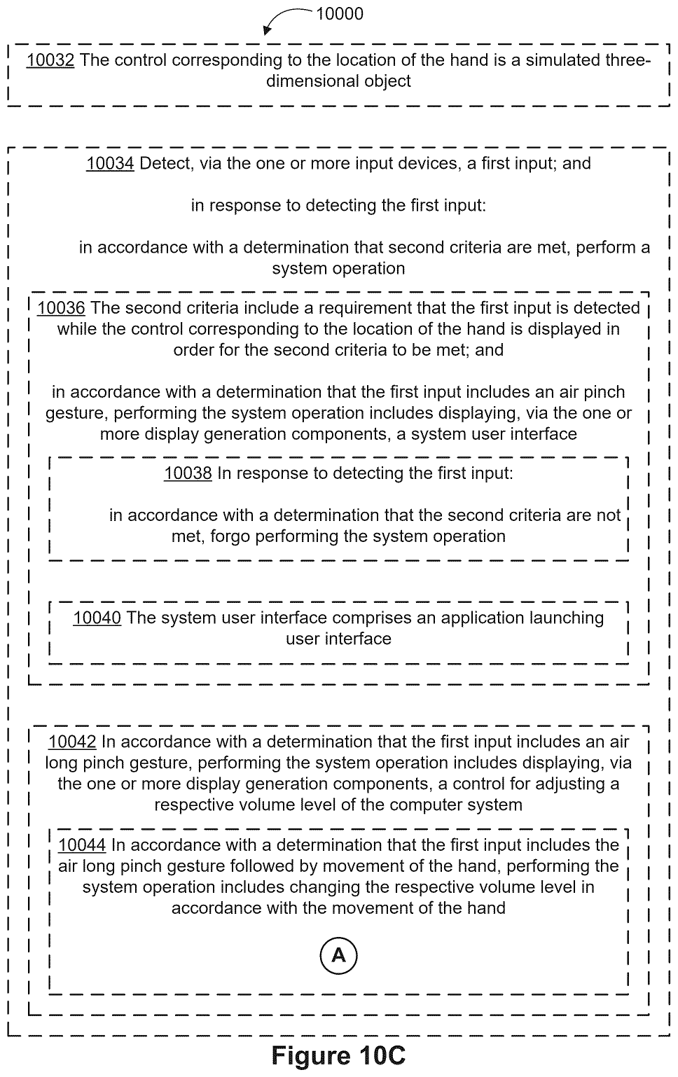

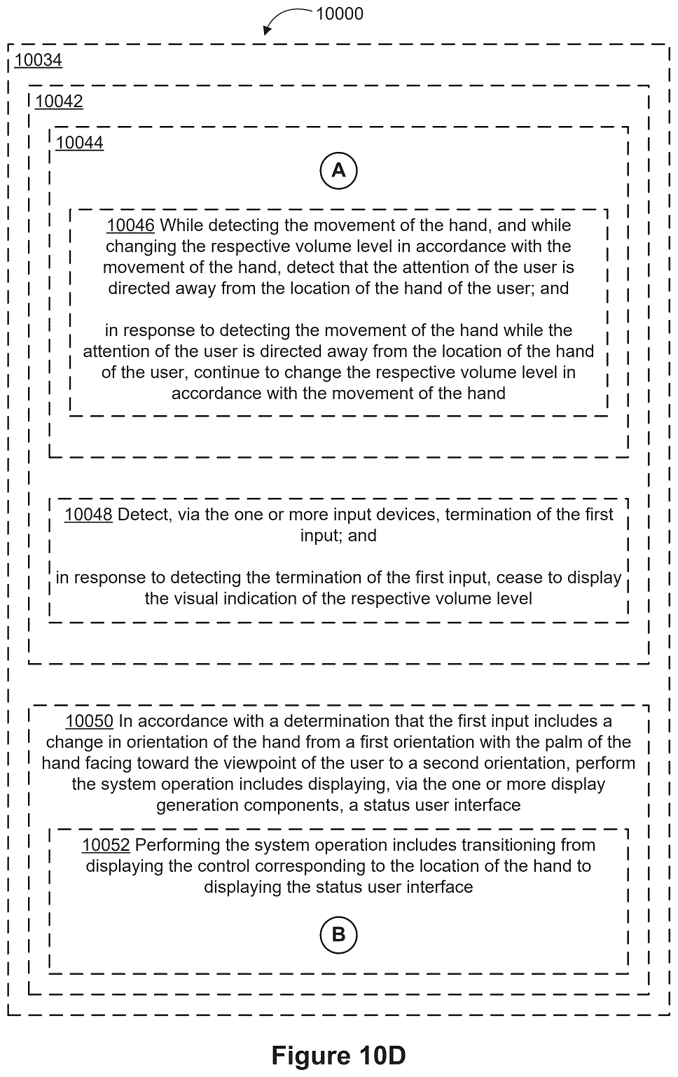

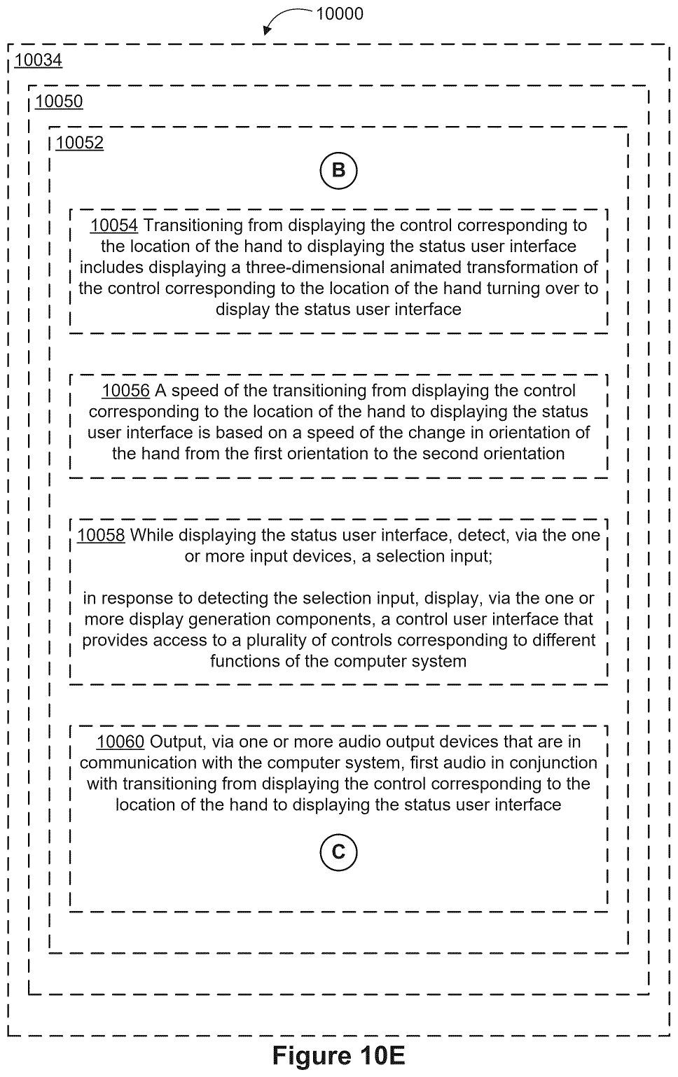

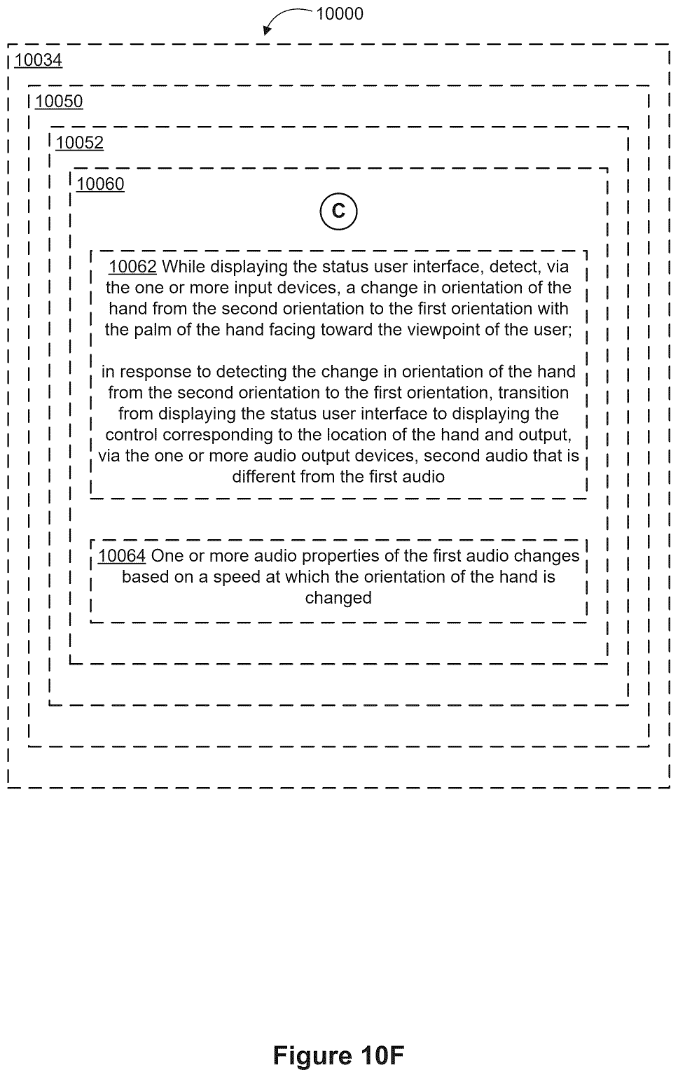

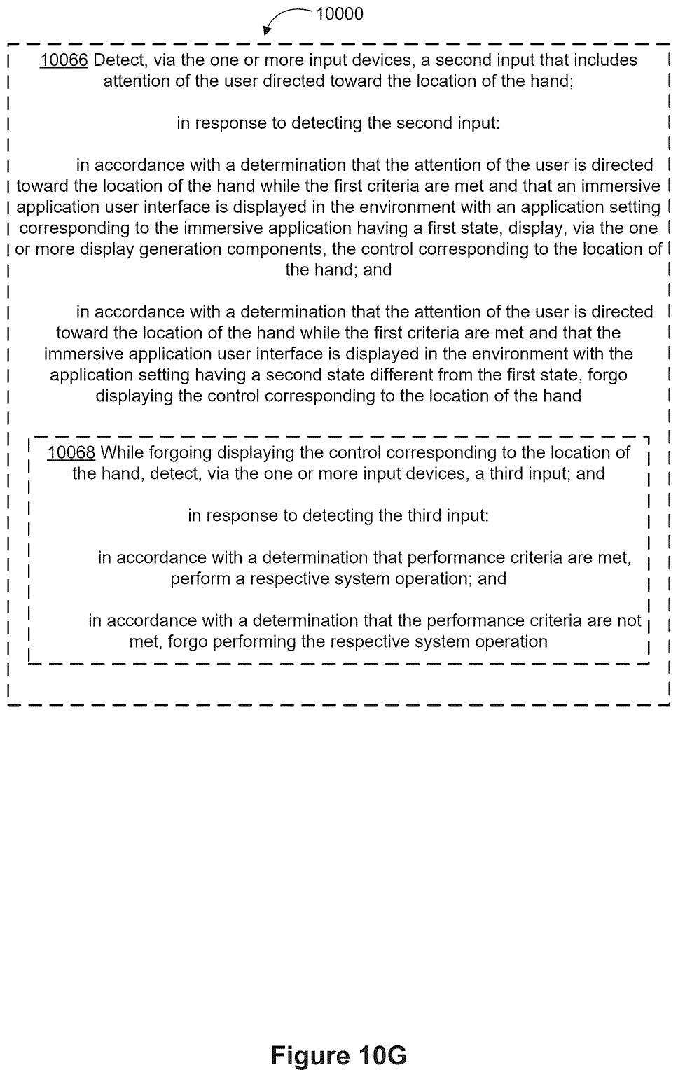

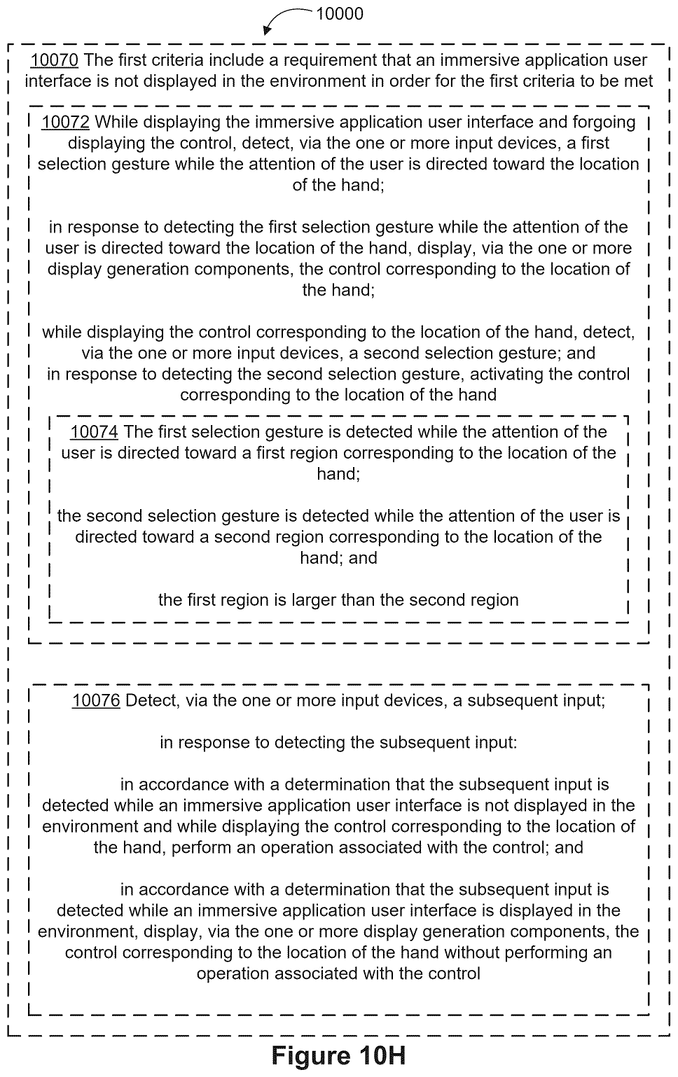

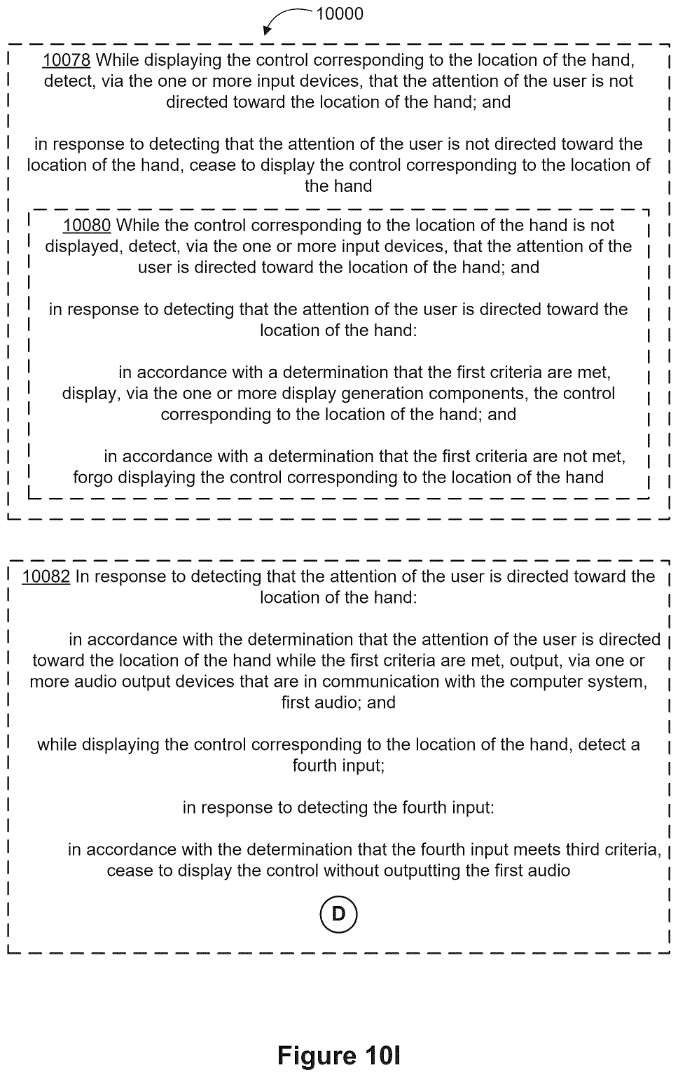

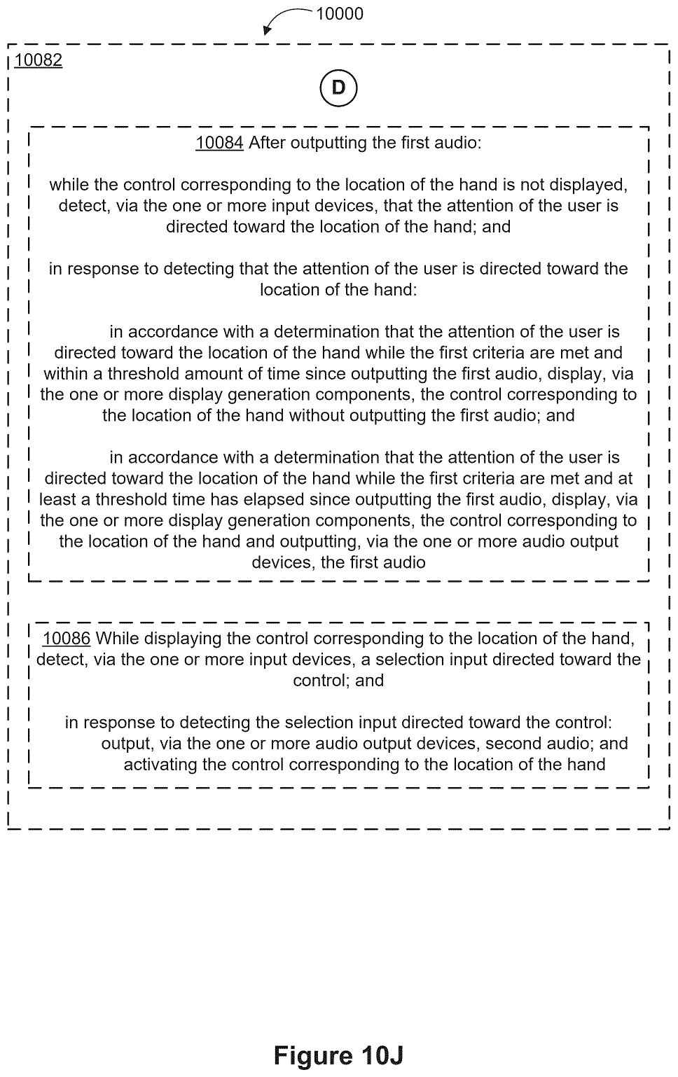

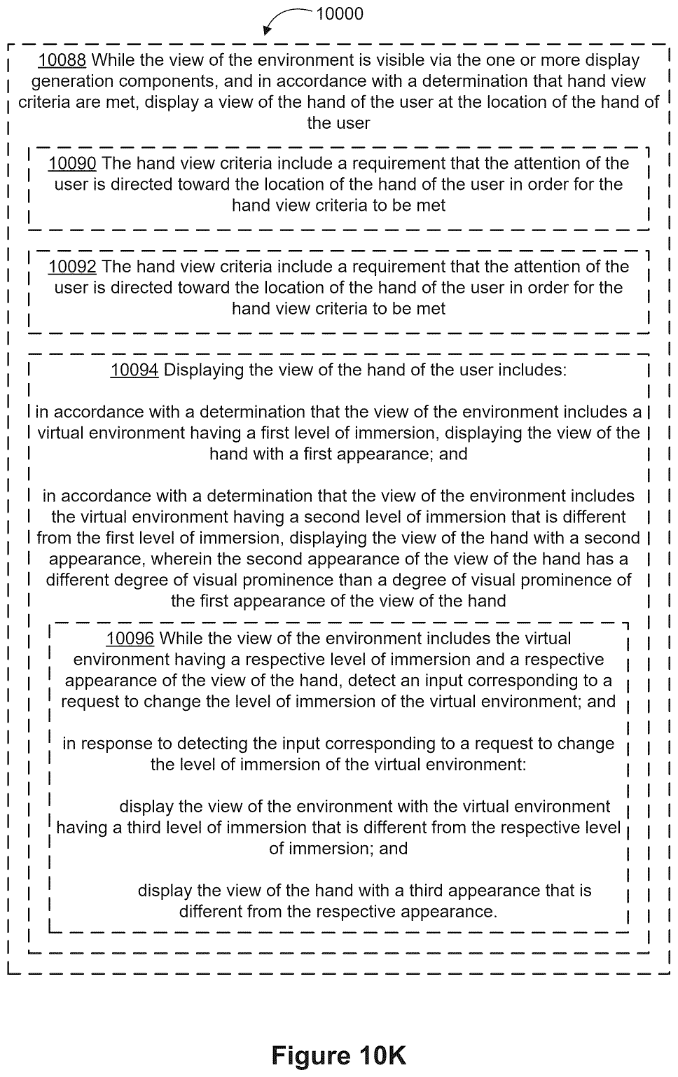

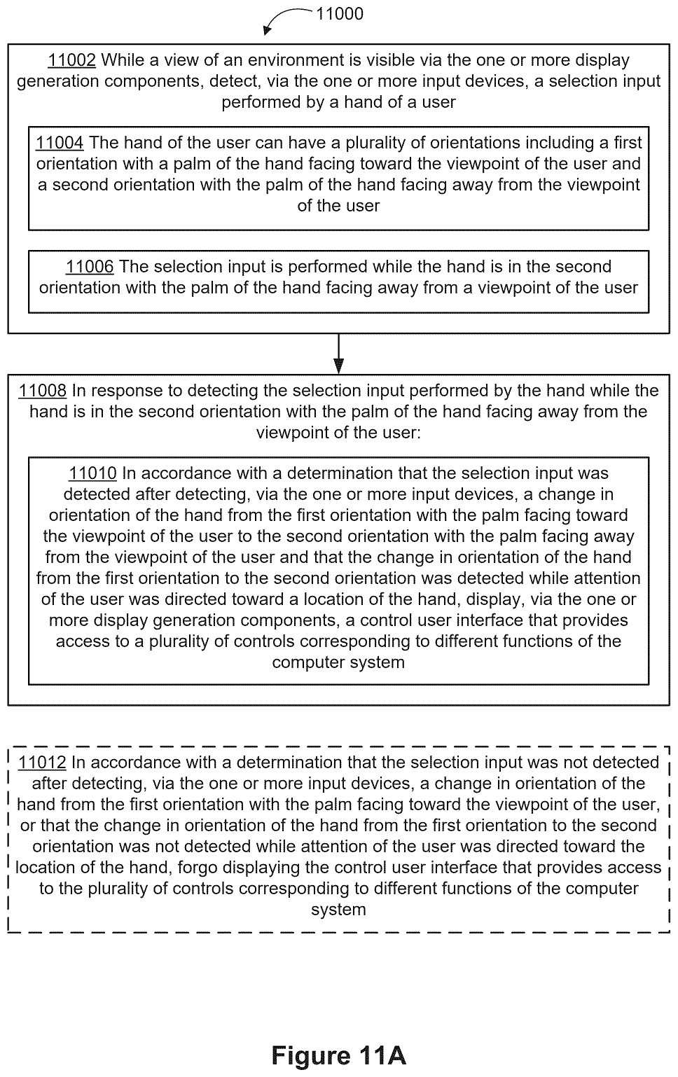

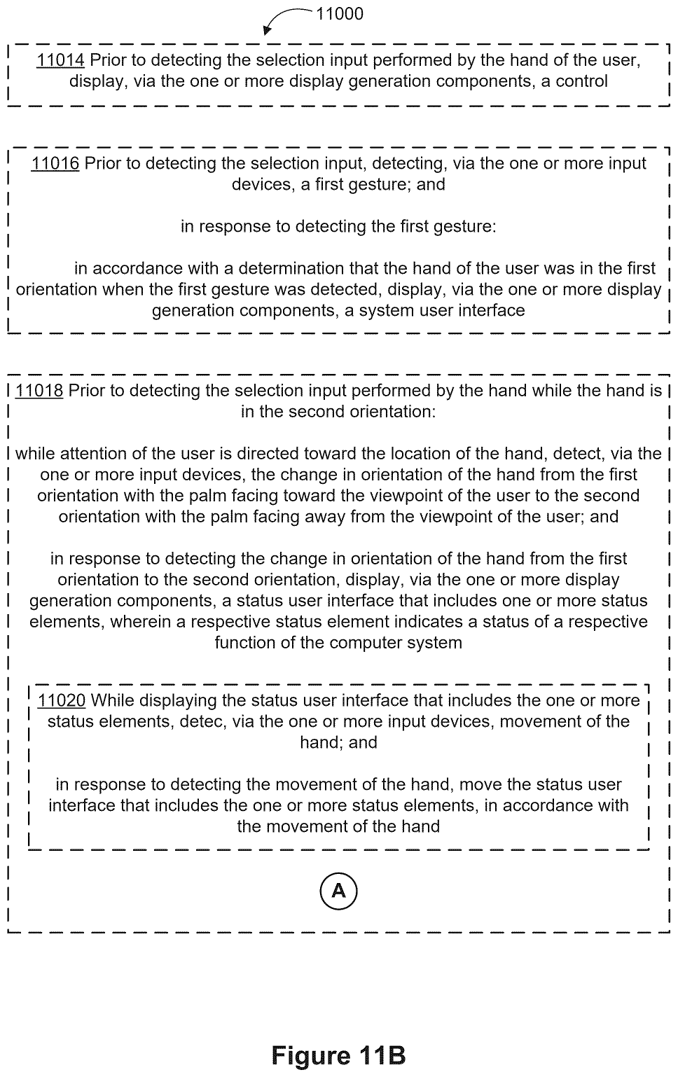

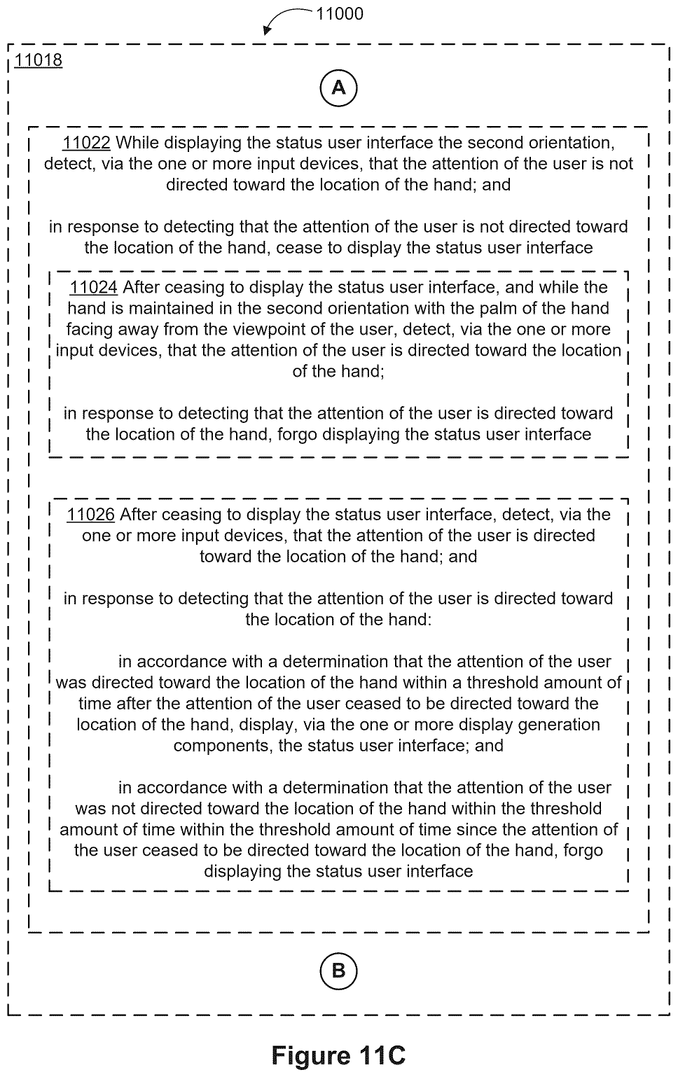

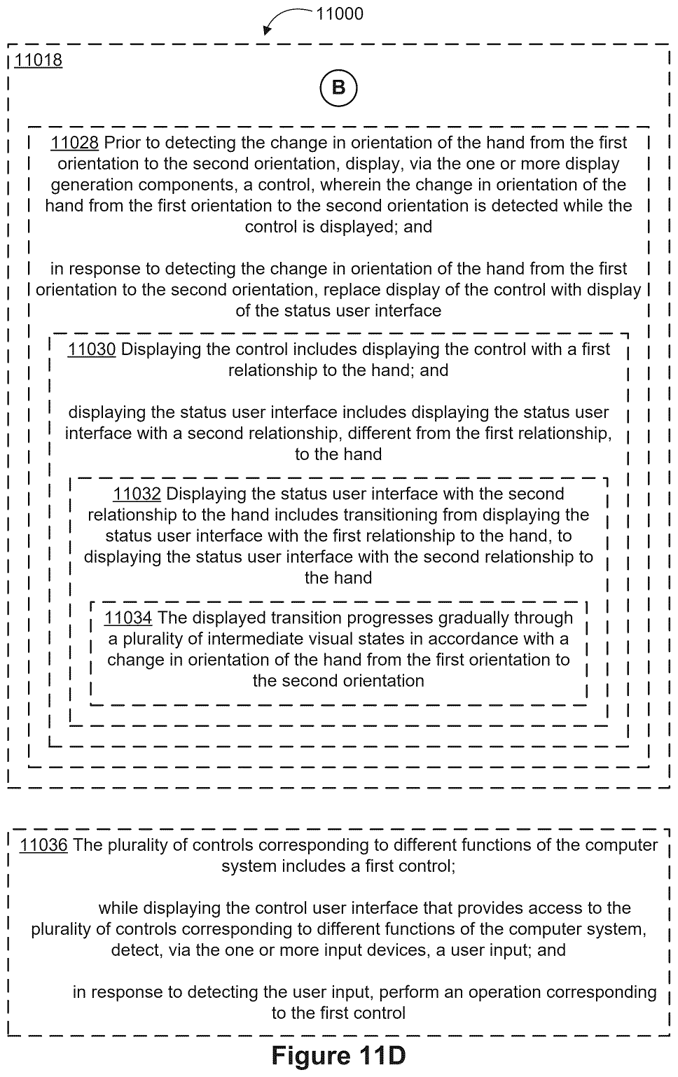

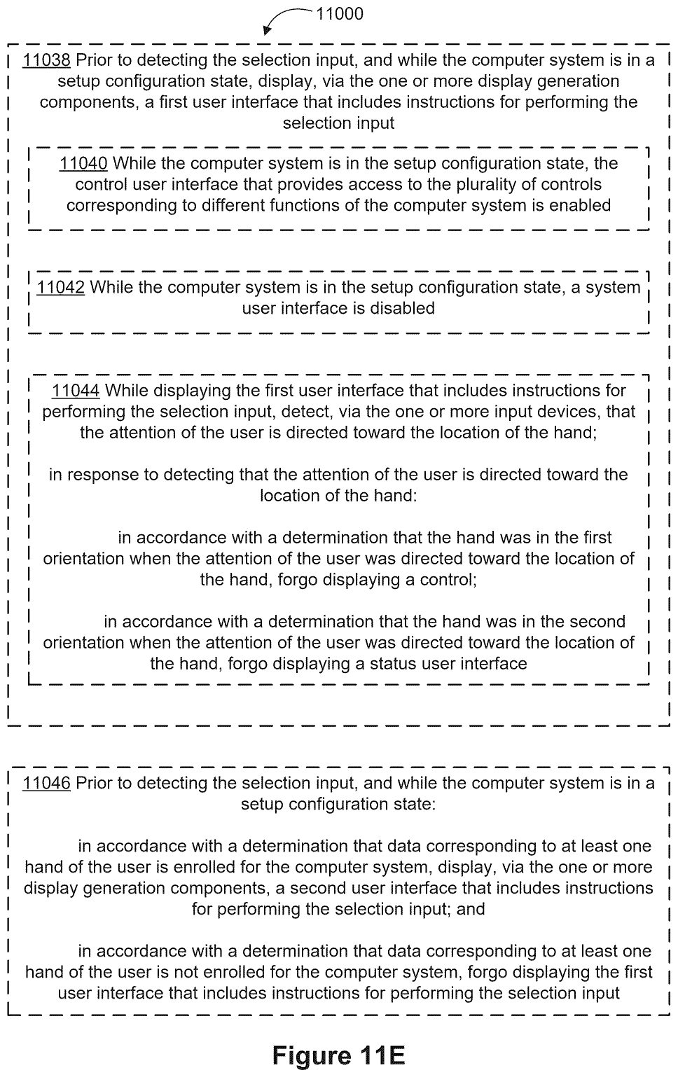

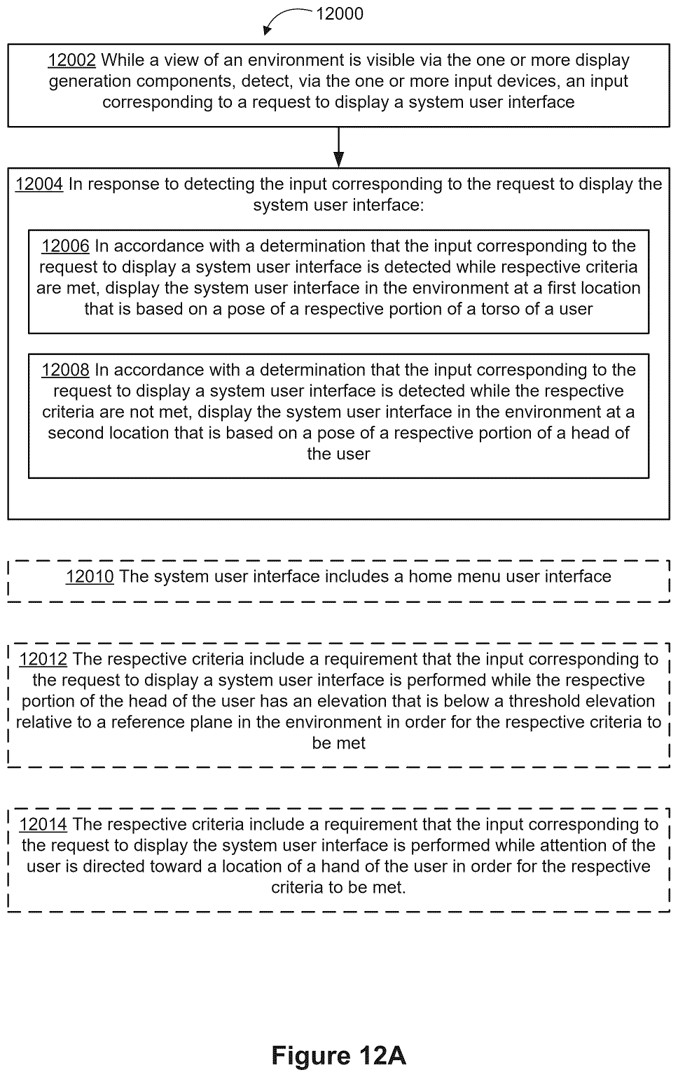

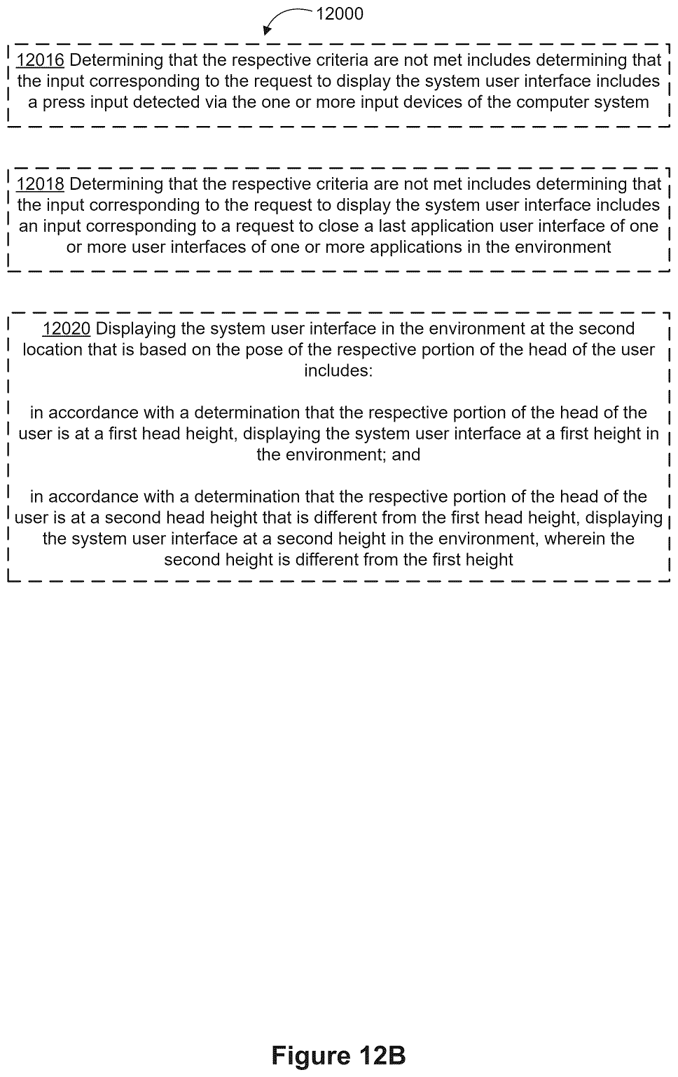

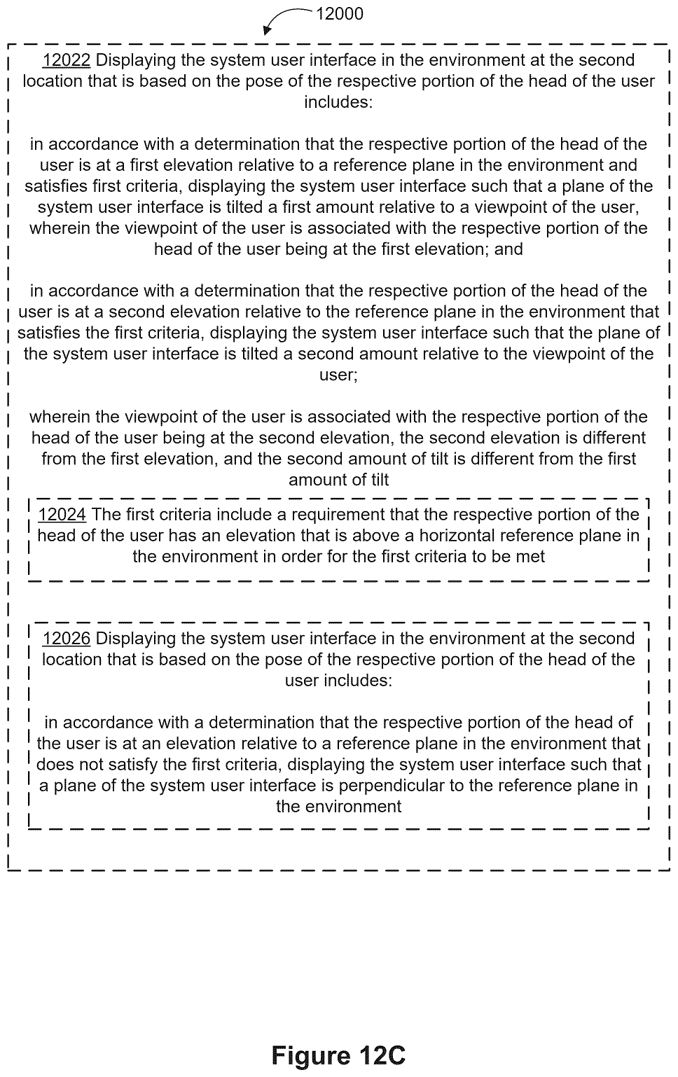

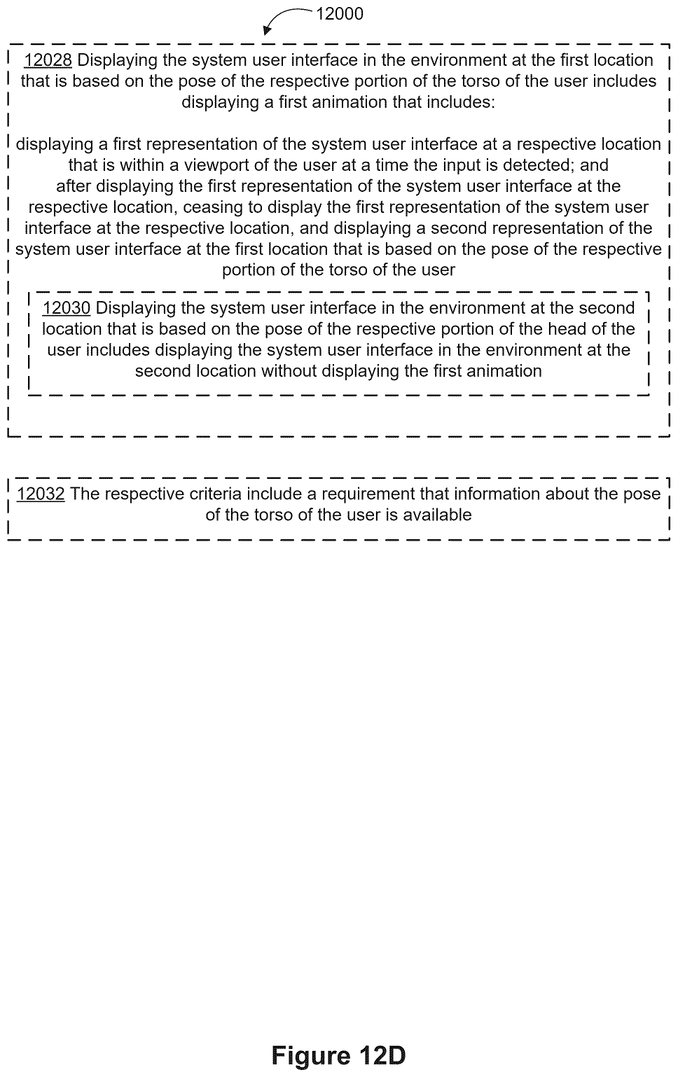

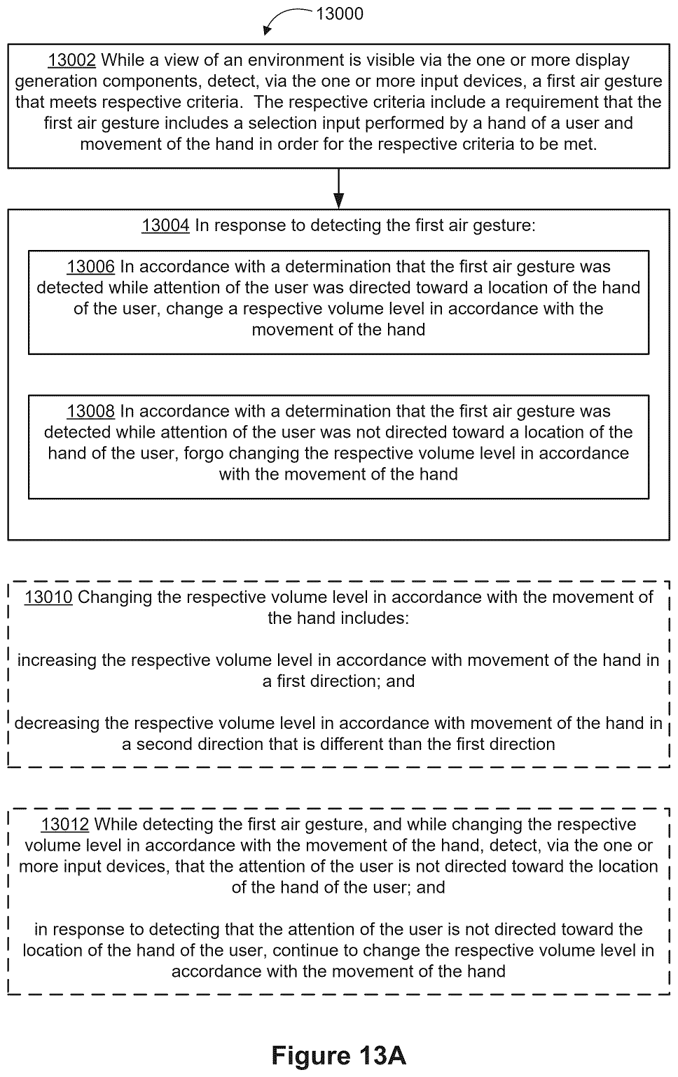

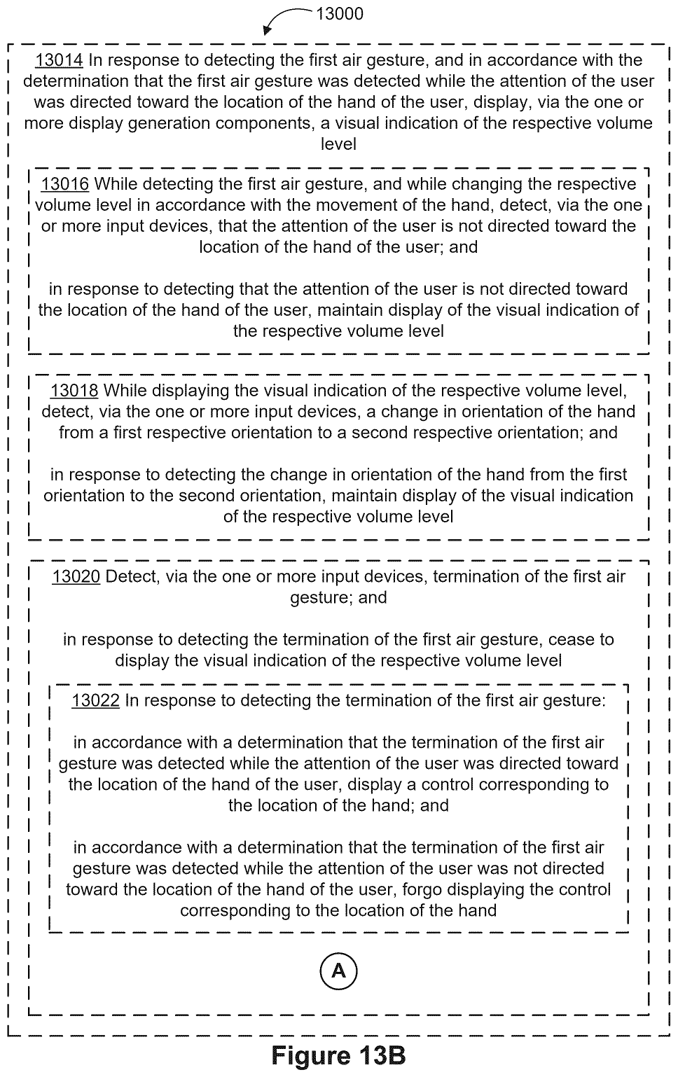

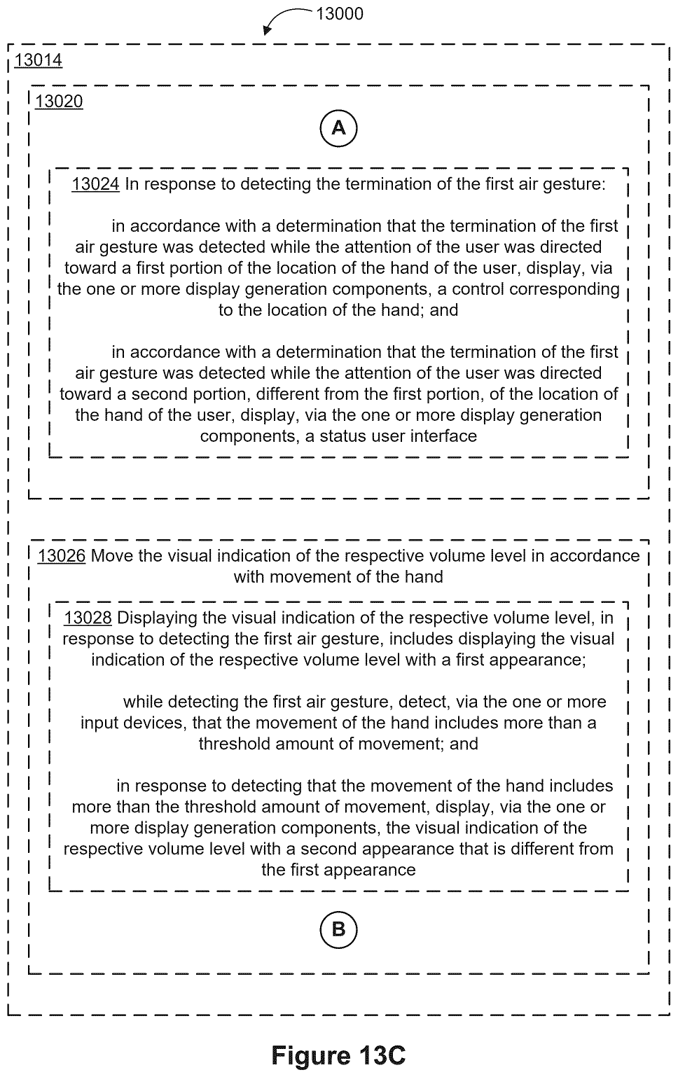

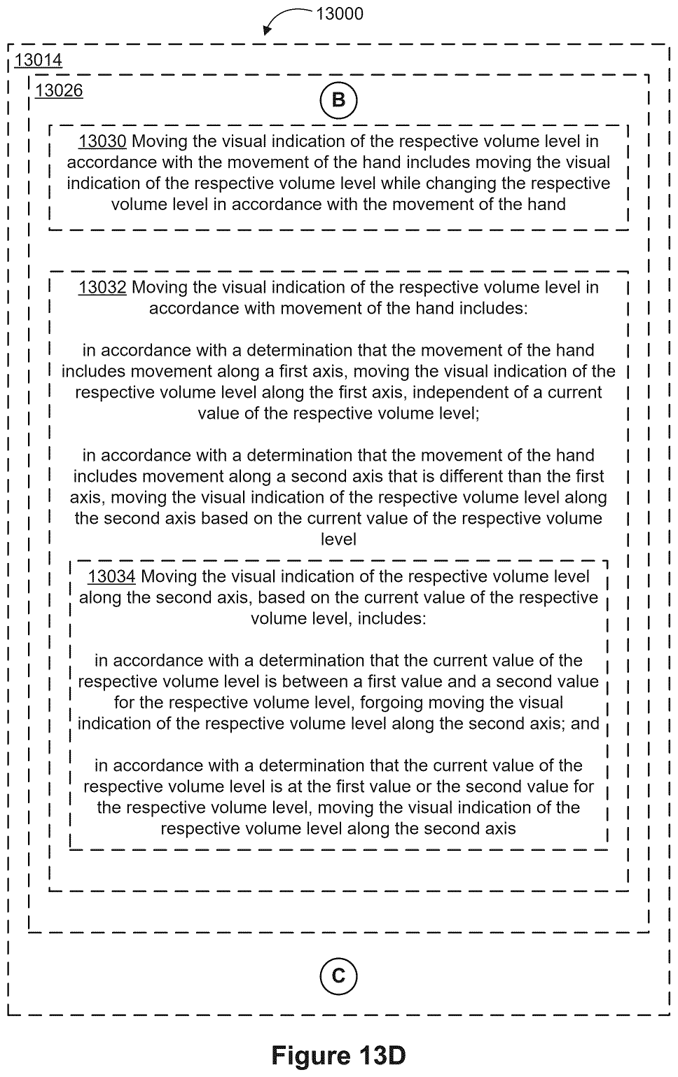

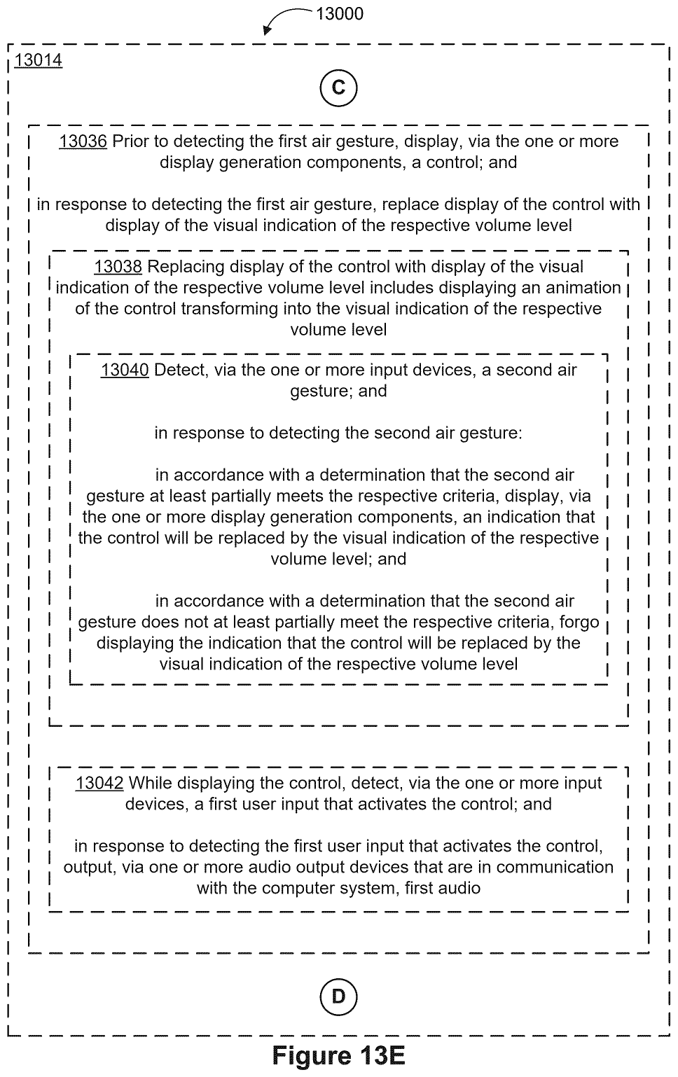

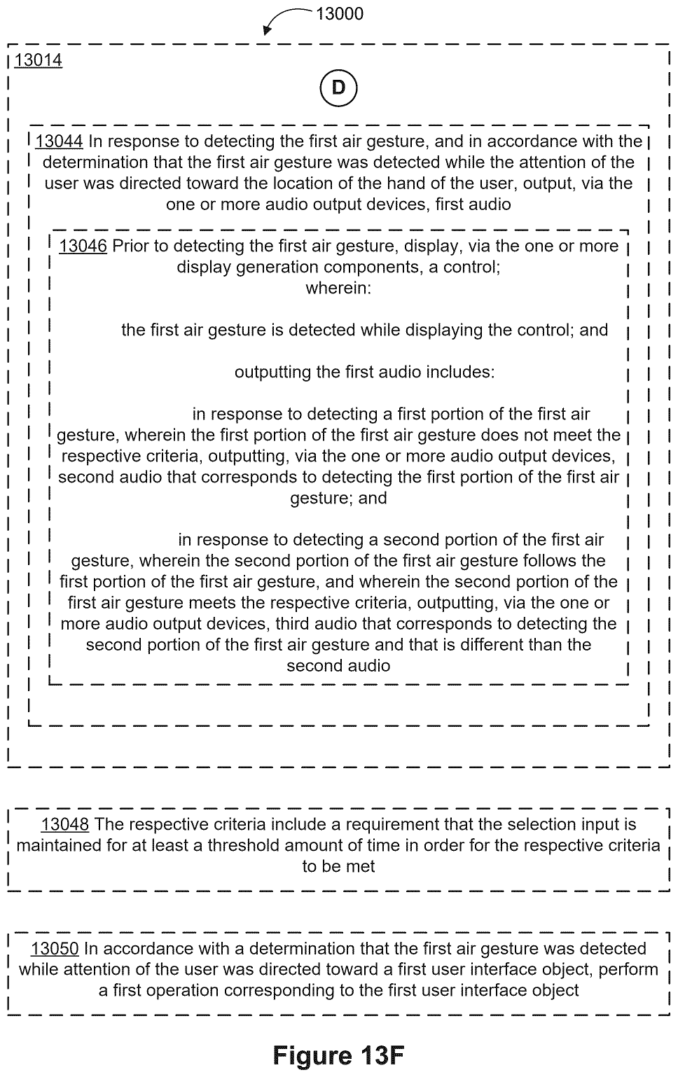

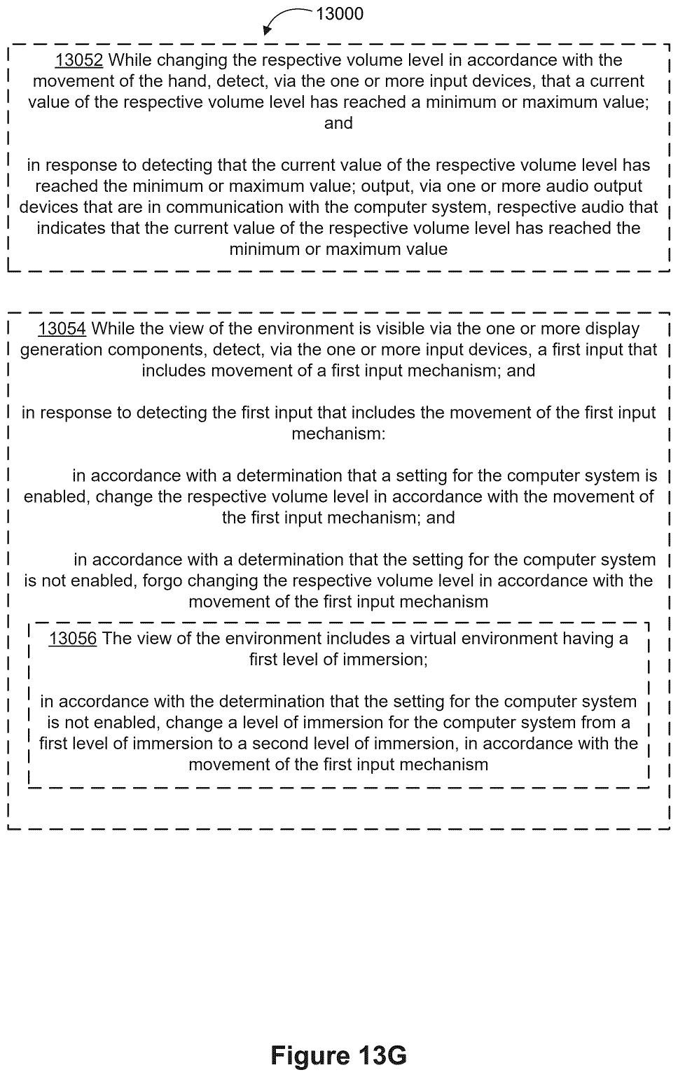

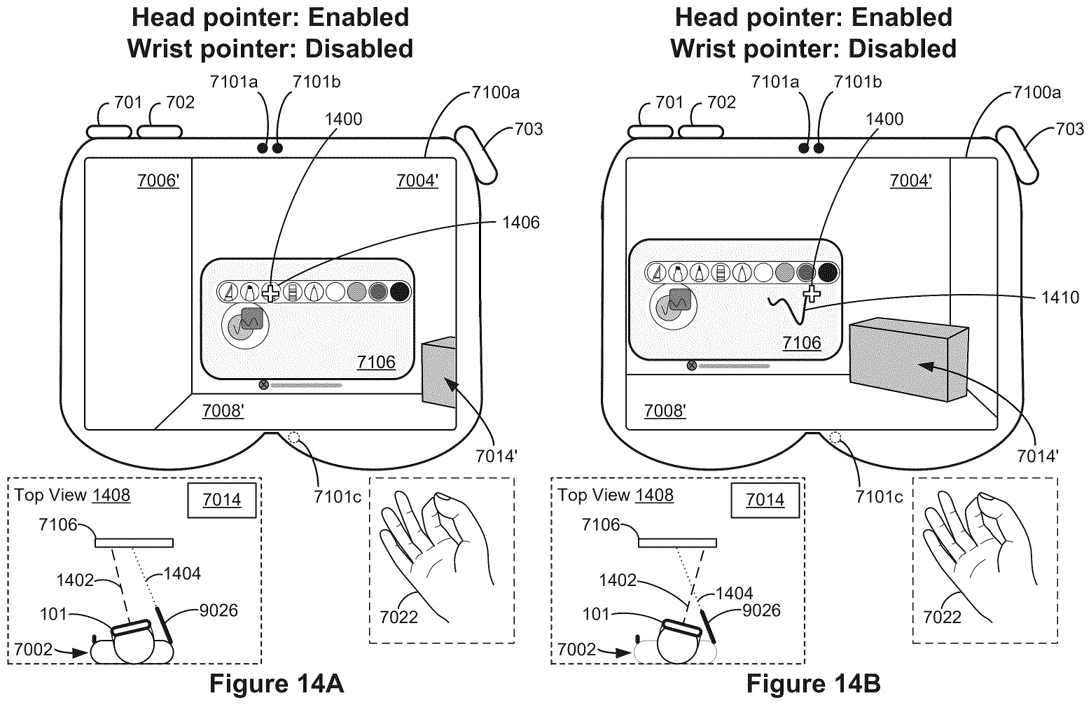

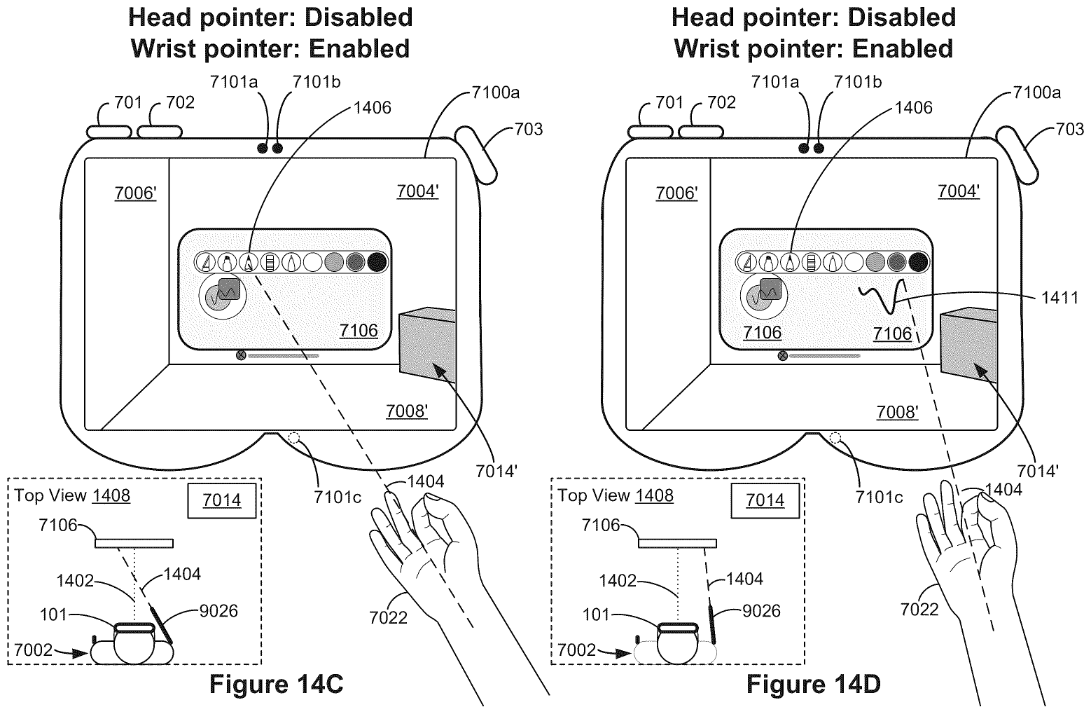

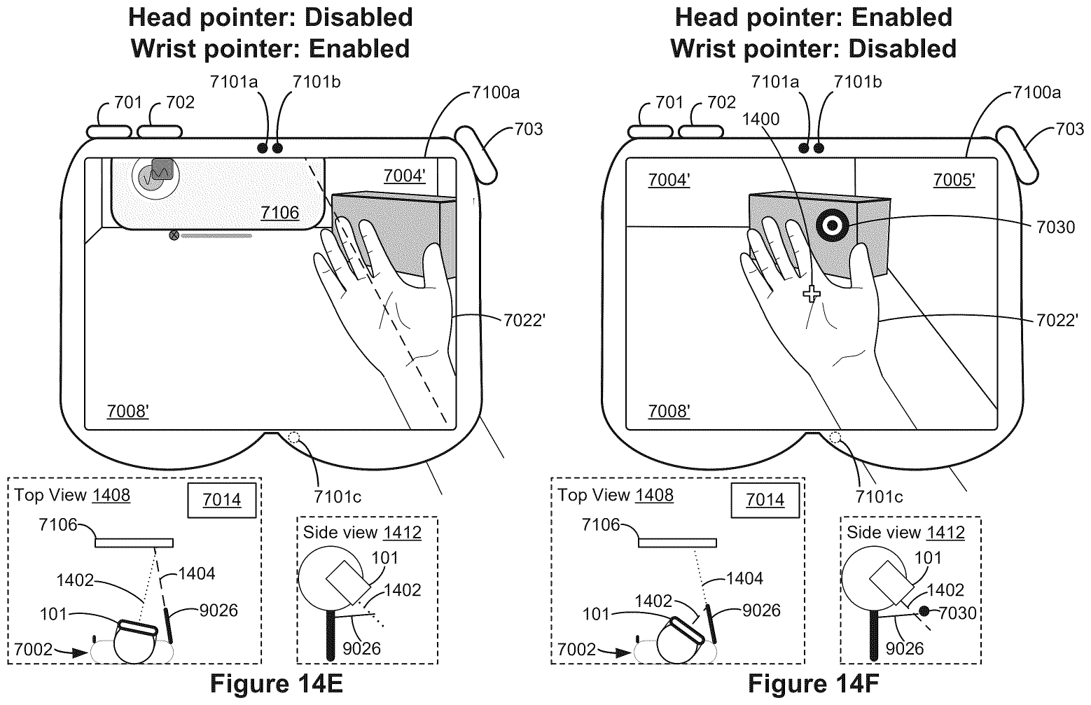

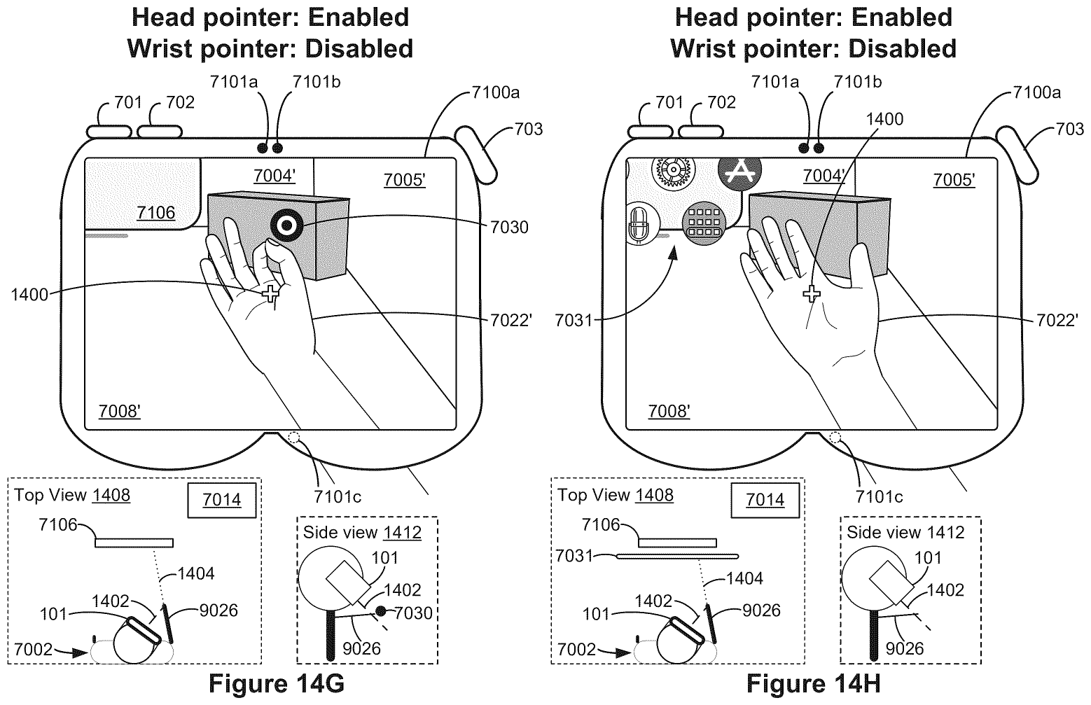

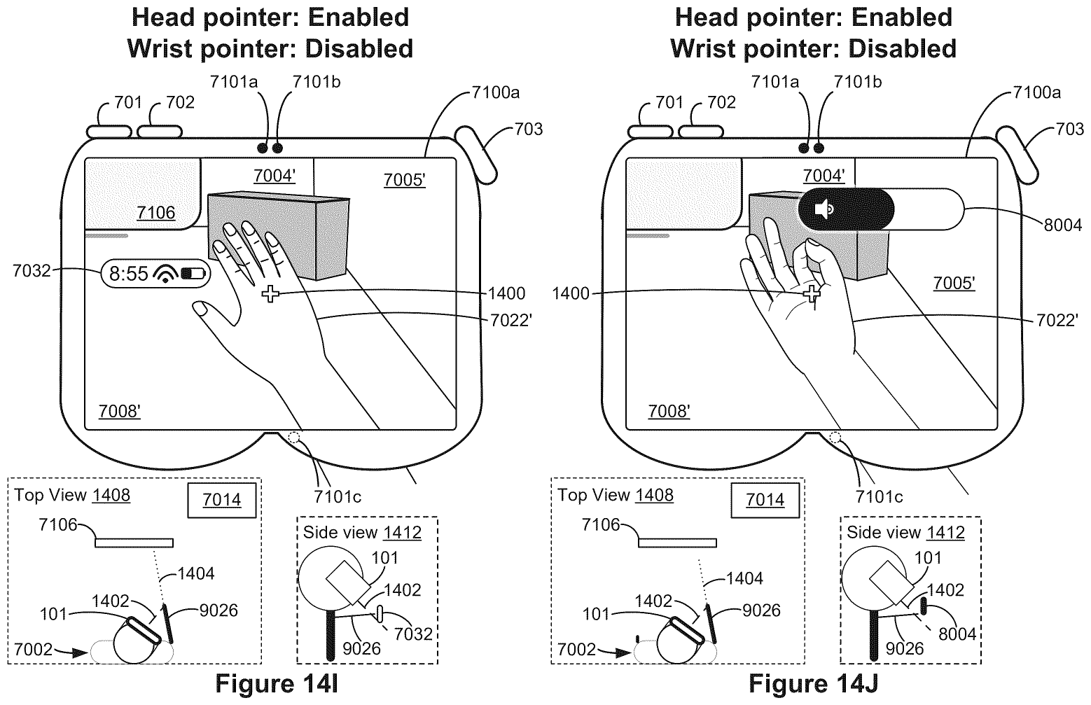

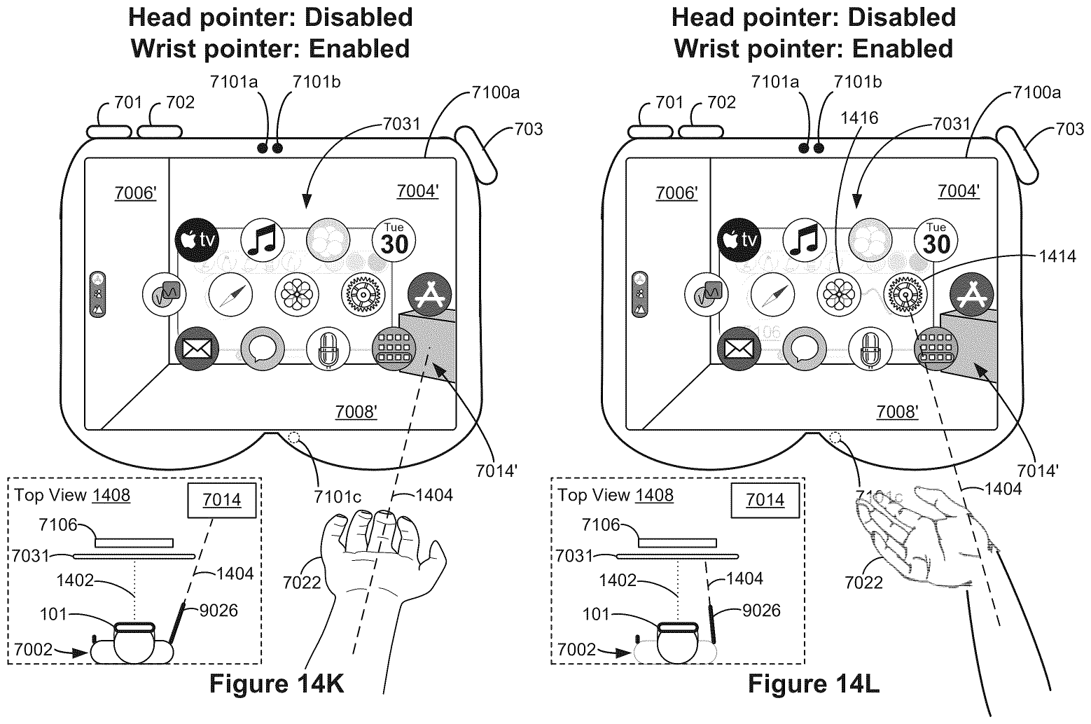

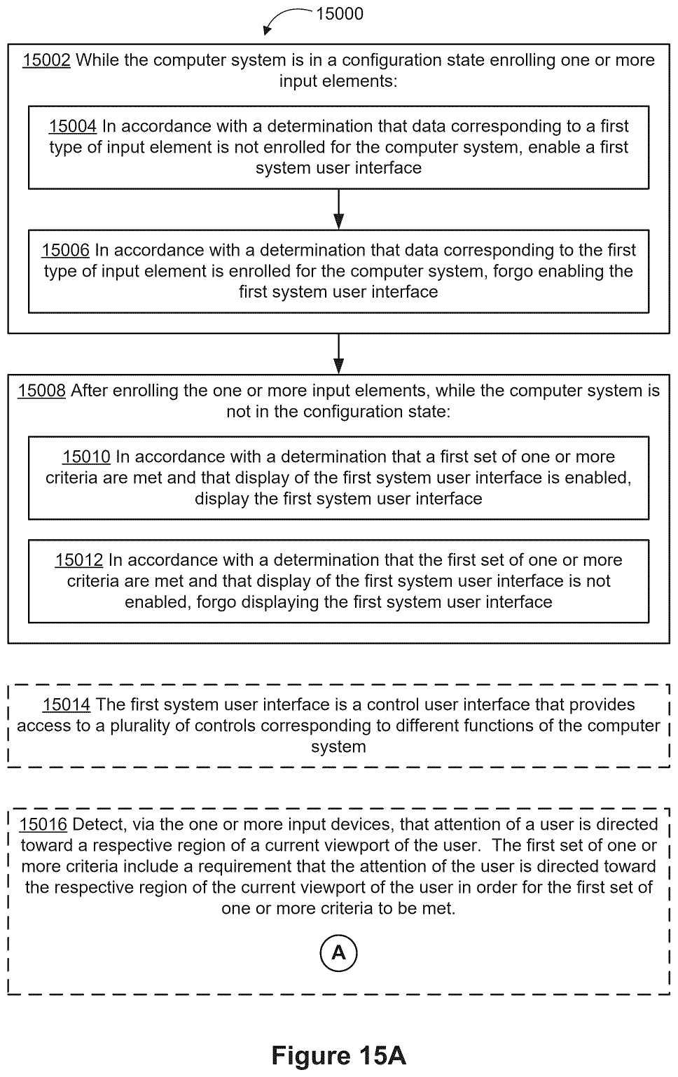

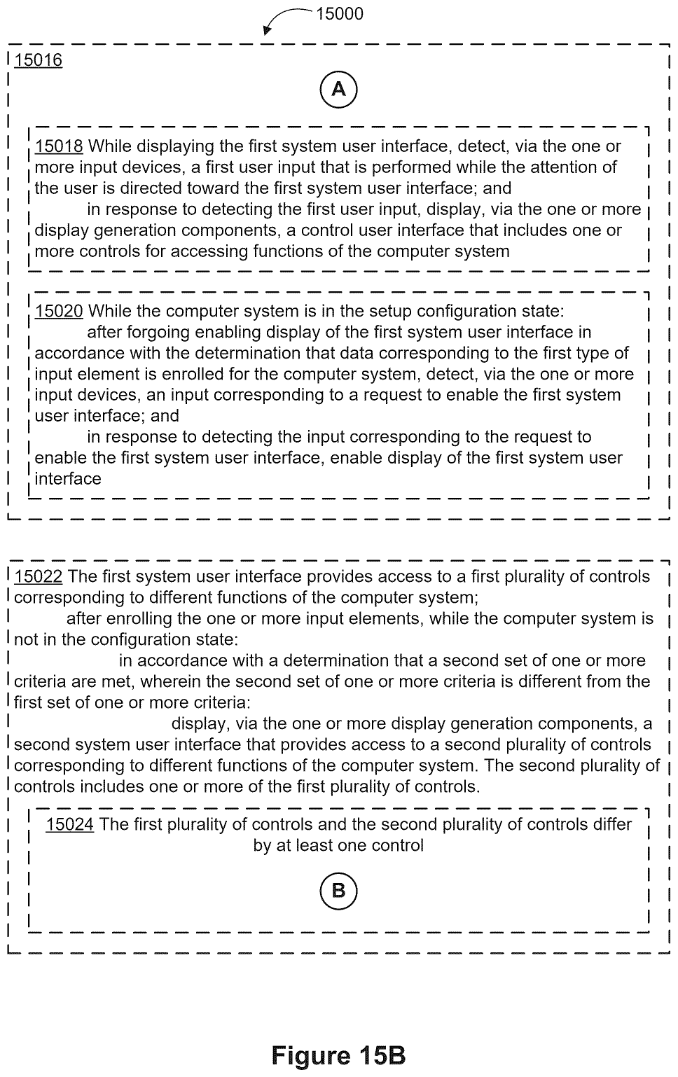

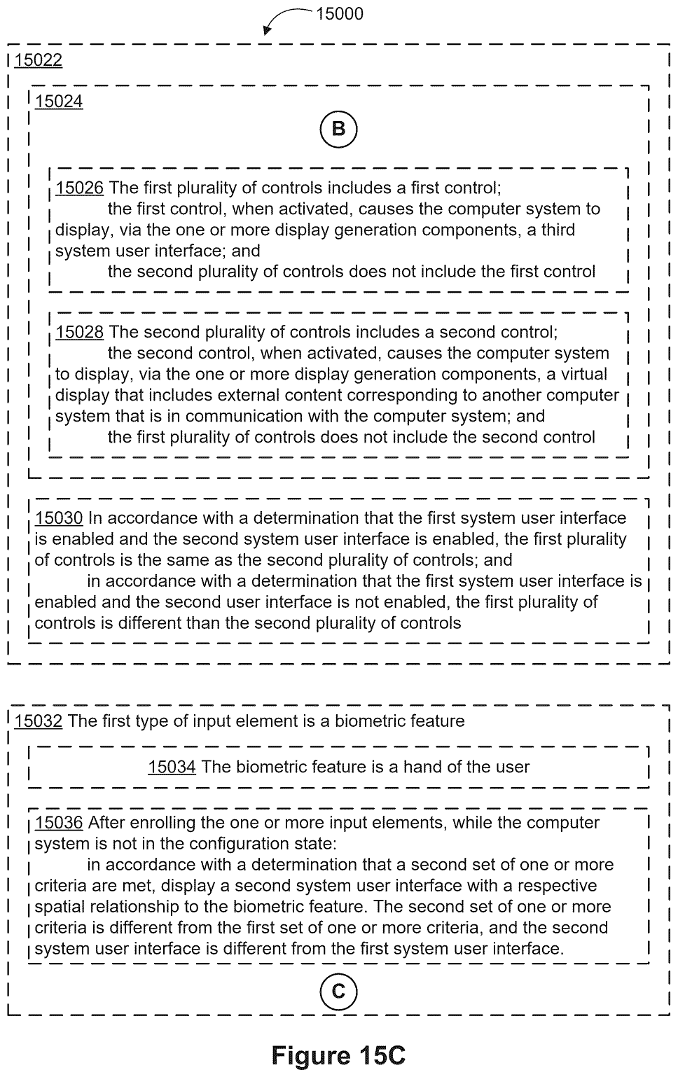

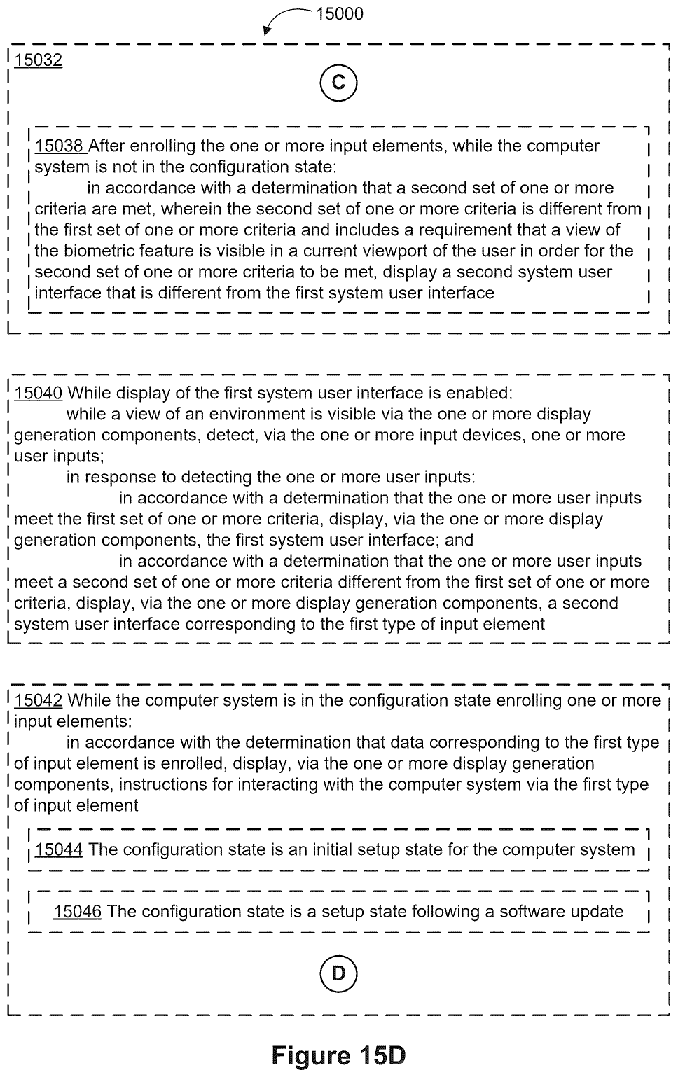

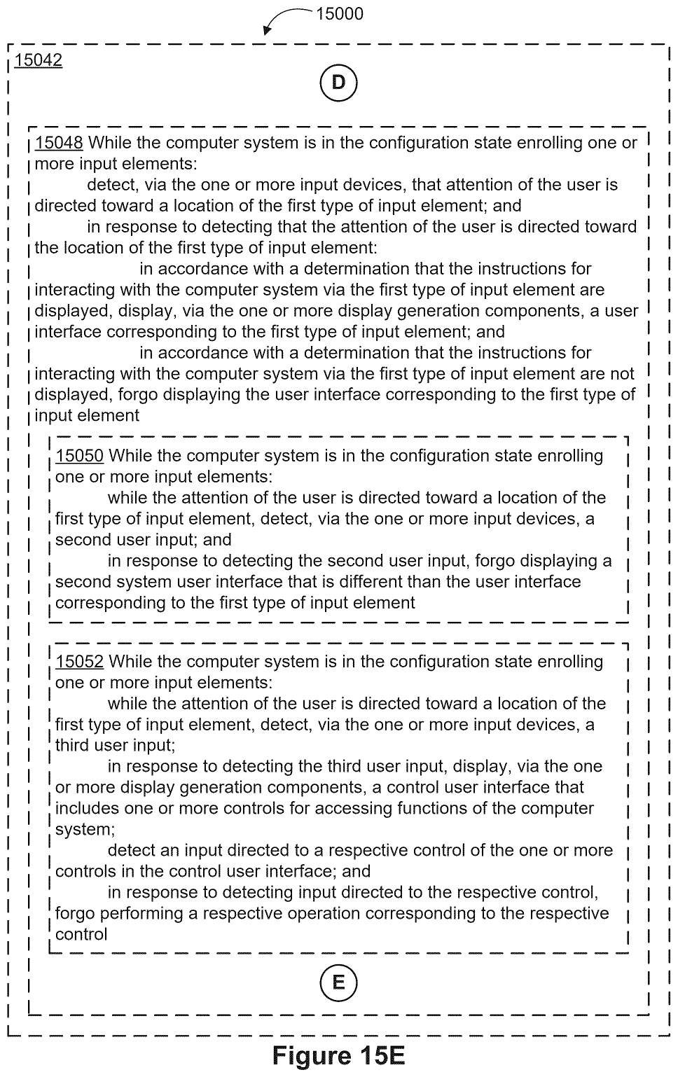

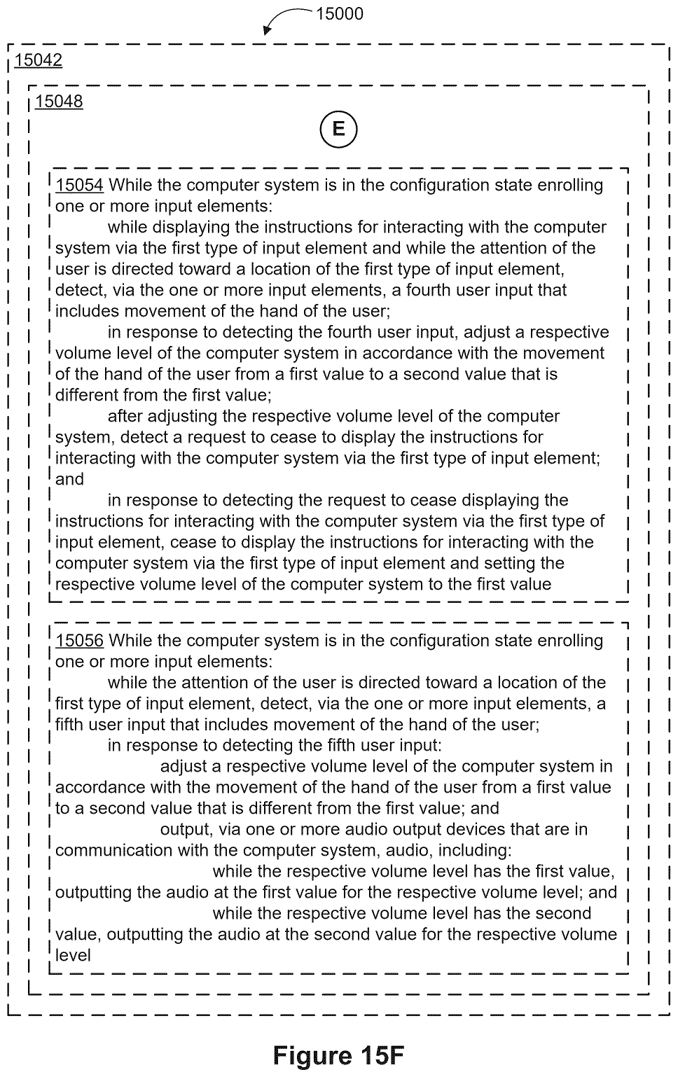

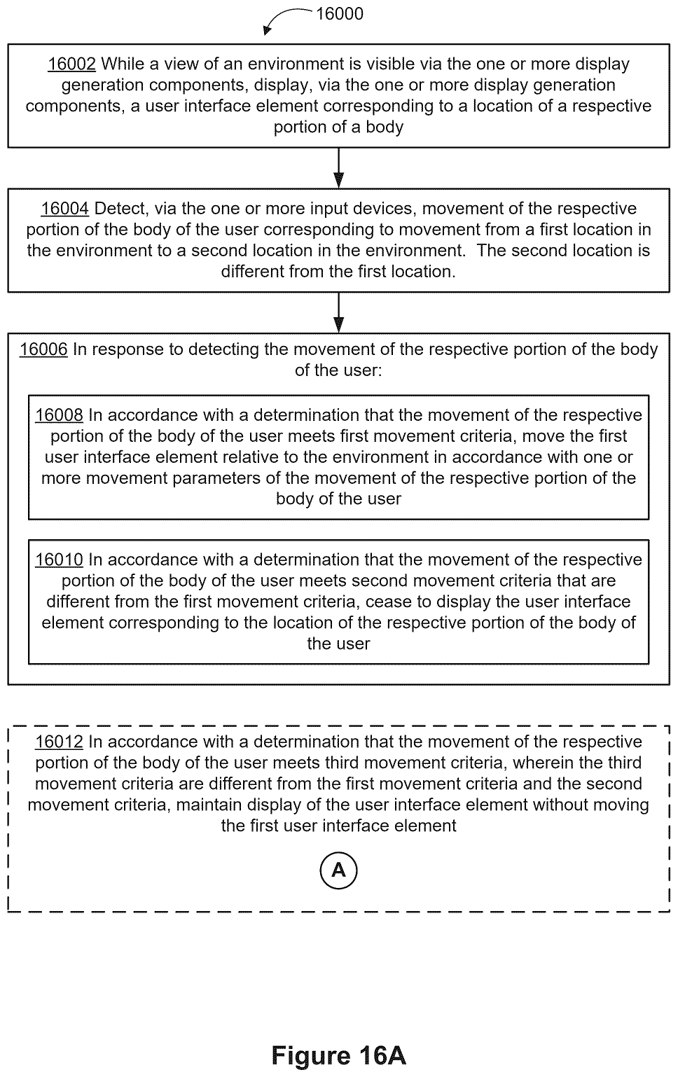

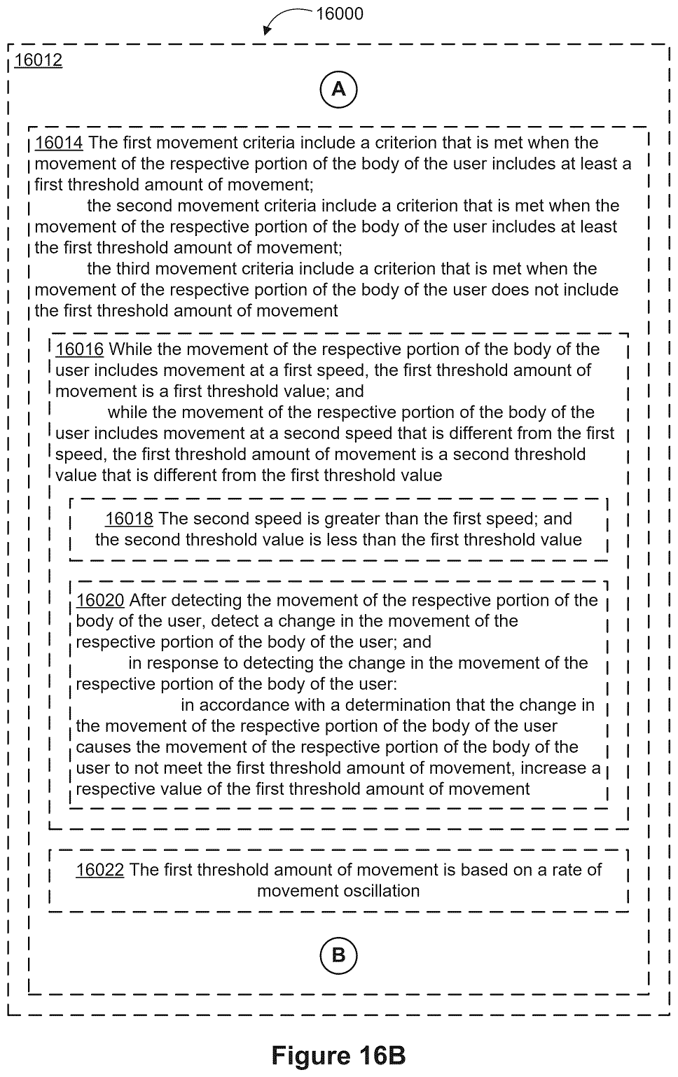

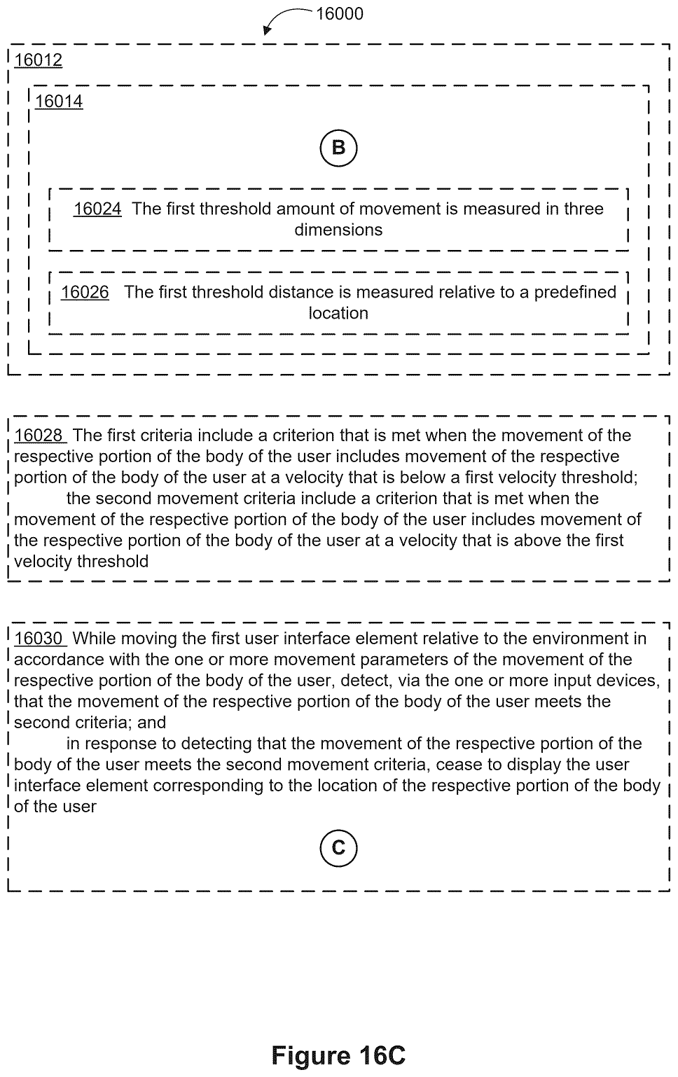

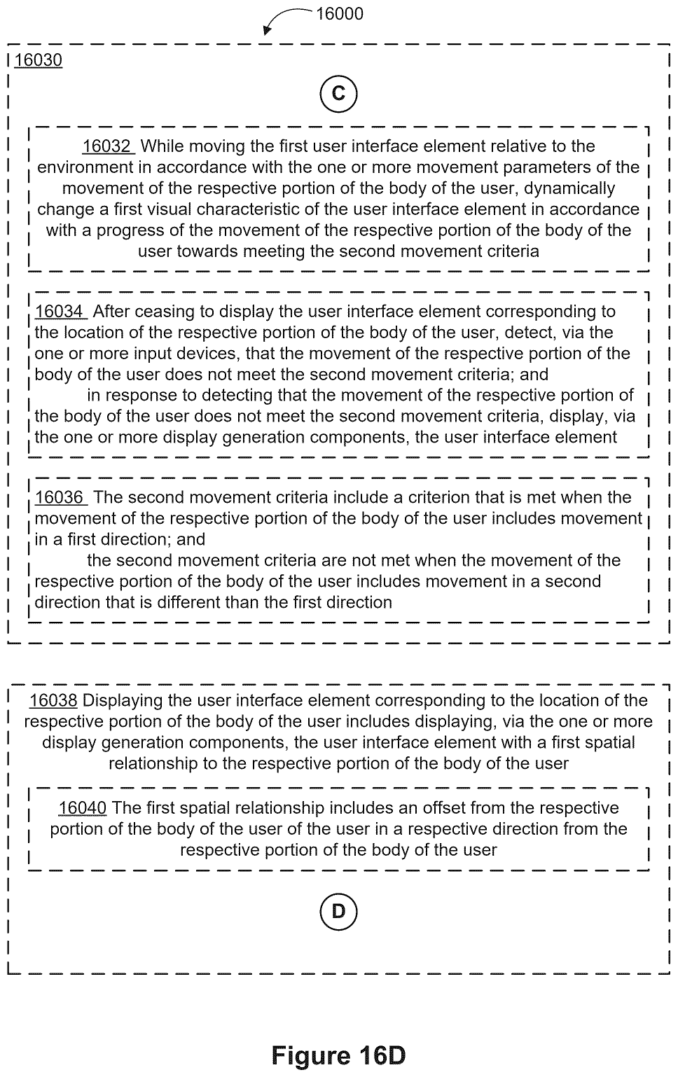

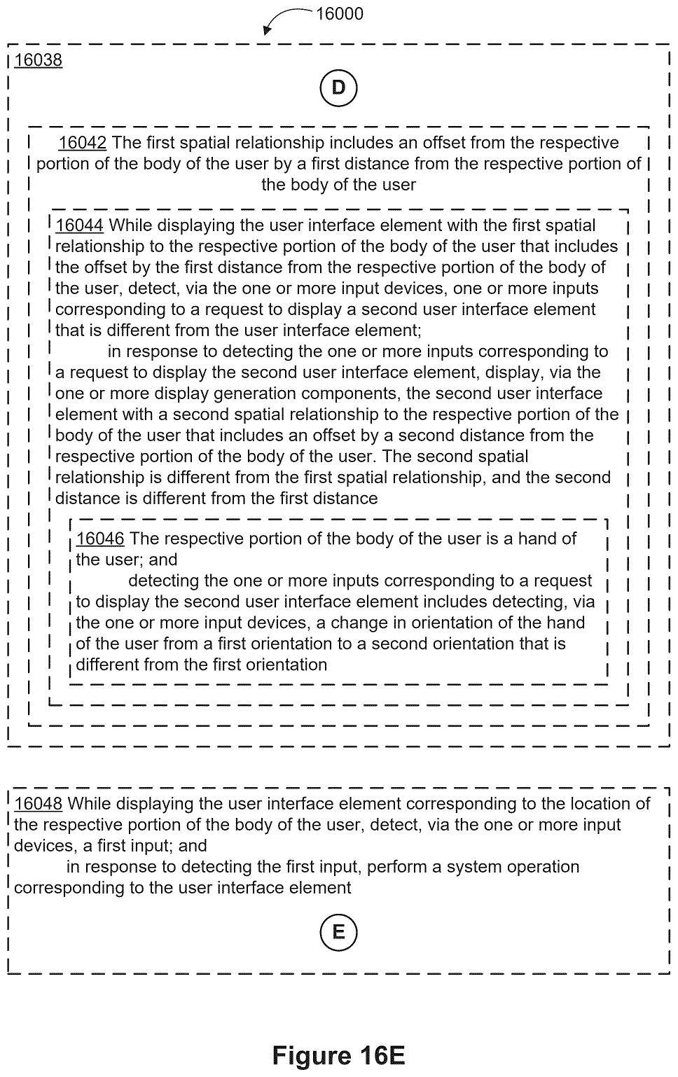

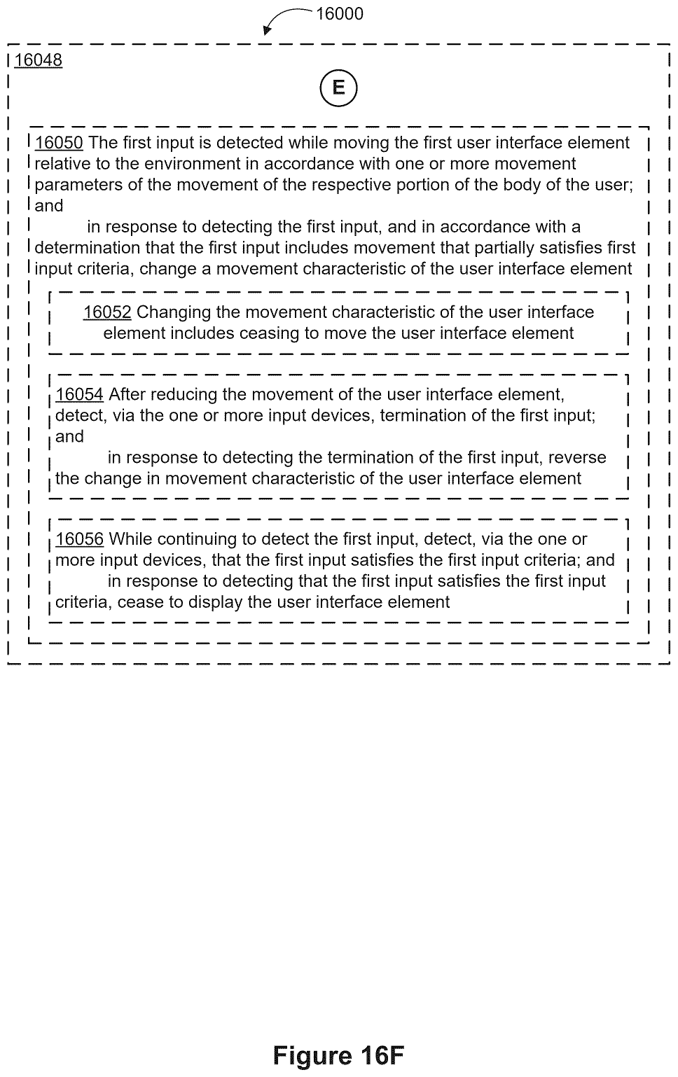

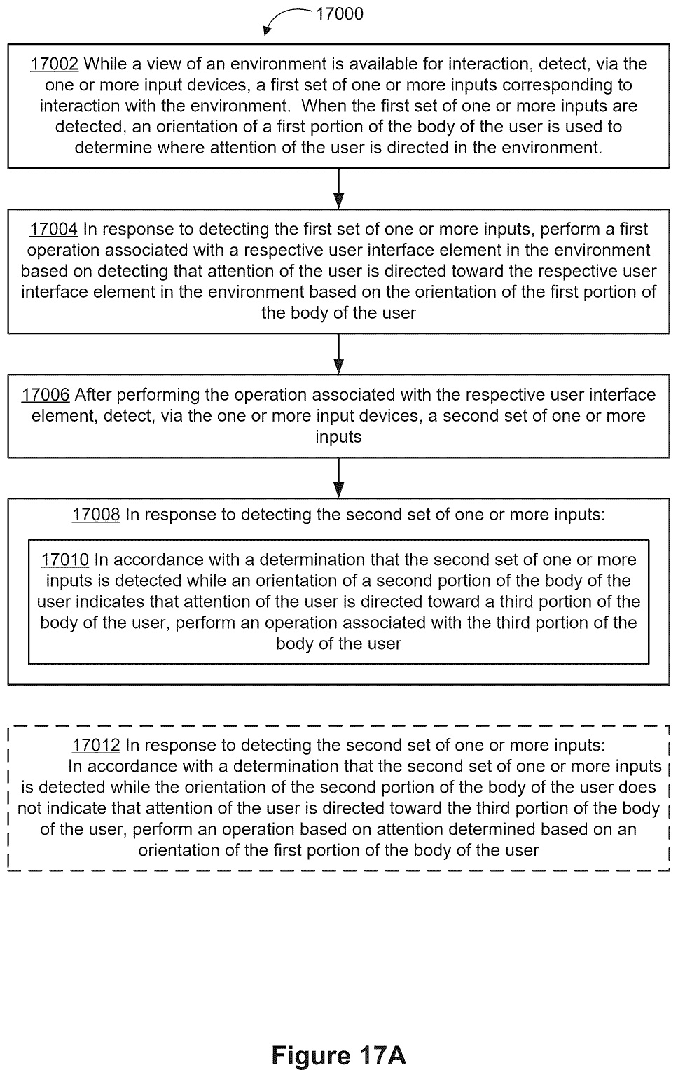

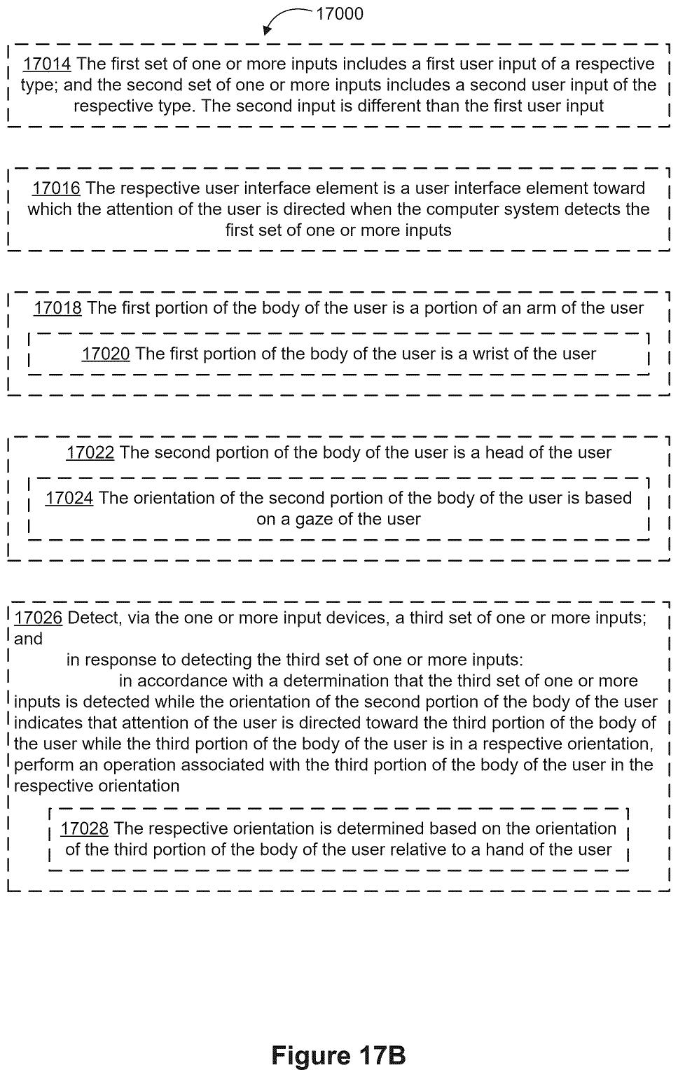

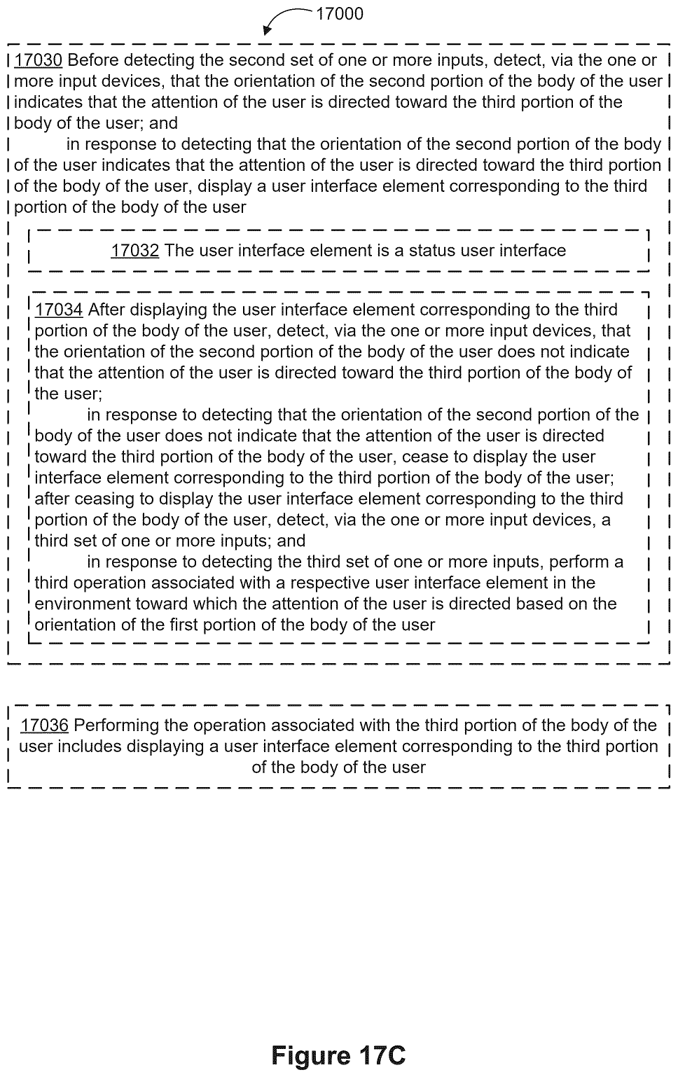

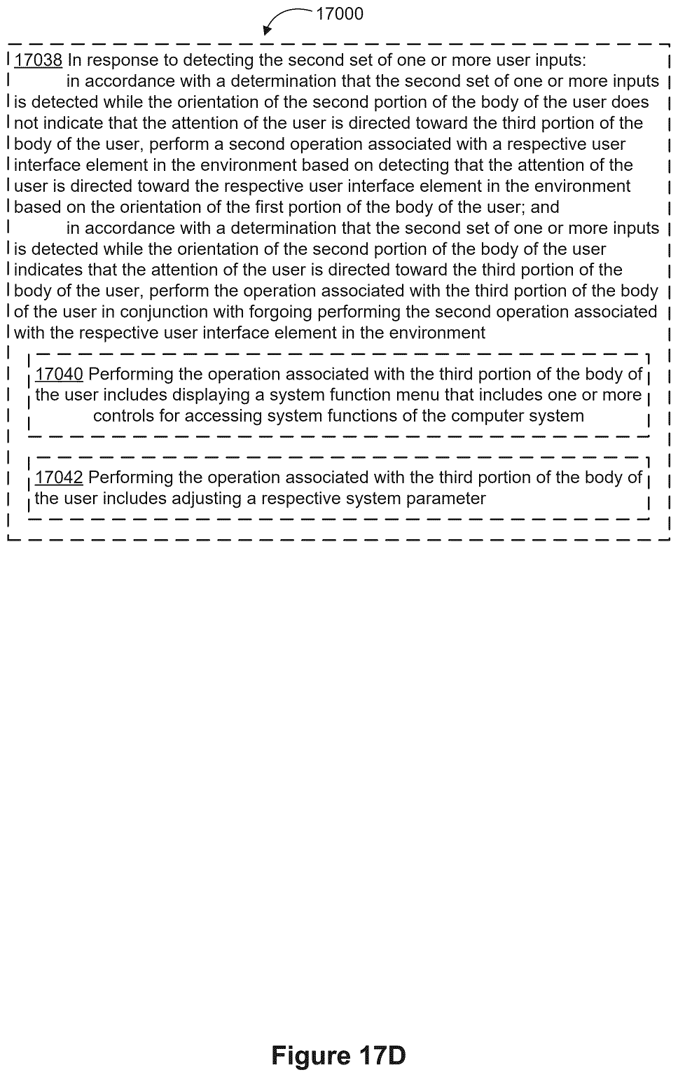

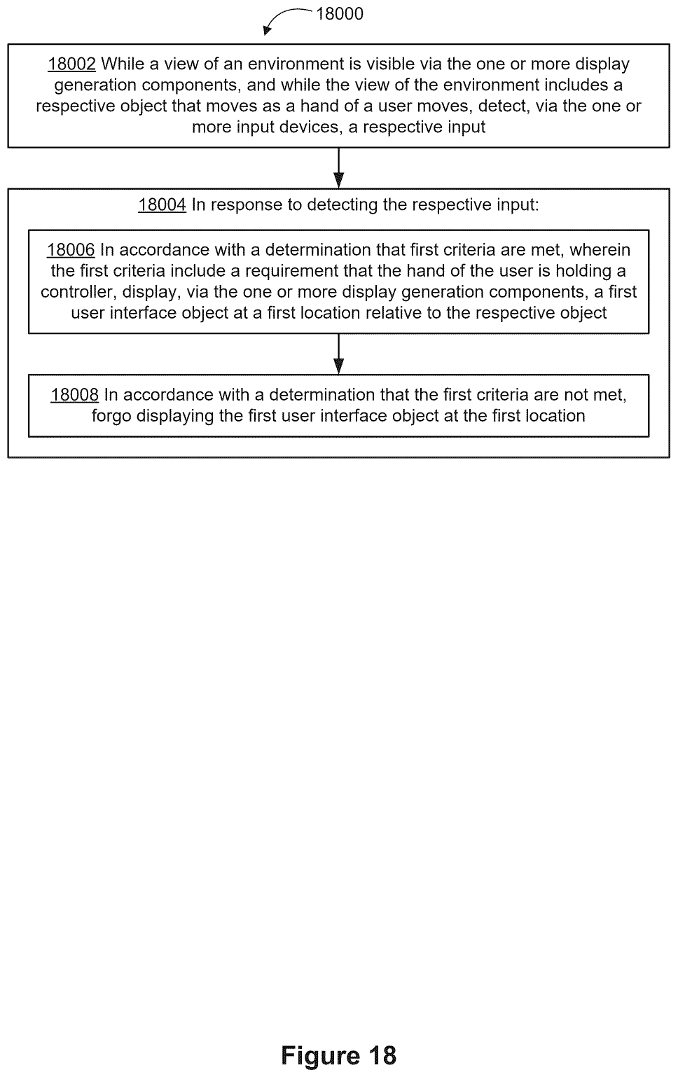

FIGS. 1A-6 provide a description of example computer systems for providing XR experiences to users (such as described below with respect to methods 10000, 11000, 12000, 13000, 15000, 16000, 17000, and/or 18000). FIGS. 7A-7BE illustrate example techniques for invoking and interacting with a control for a computer system, and displaying a status user interface and/or accessing system functions of the computer system, including while holding a controller, in accordance with some embodiments. FIGS. 10A-10K are flow diagrams of methods of invoking and interacting with a control for a computer system, in accordance with various embodiments. FIGS. 11A-11E are flow diagrams of methods of displaying a status user interface and/or accessing system functions of the computer system, in accordance with various embodiments. FIGS. 15A-15F are flow diagrams of methods of accessing a system function menu when data is not stored for one or more portions of the body of a user of the computer system, in accordance with various embodiments. FIGS. 16A-16F are flow diagrams of methods of displaying a control for a computer system during or after movement of the user's hand, in accordance with various embodiments. FIG. 18 is a flow diagram of a method for invoking and interacting with a hand-based control or other user interface of a computer system while holding a controller, in accordance with various embodiments. The user interfaces in FIGS. 7A-7BE are used to illustrate the processes in FIGS. 10A-10K, 11A-11E, 15A-15F, 16A-16F, and 18. FIGS. 8A-8P illustrate example techniques for adjusting a volume level for a computer system, in accordance with some embodiments. FIGS. 13A-13G are flow diagrams of methods of adjusting a volume level for a computer system, in accordance with various embodiments. The user interfaces in FIGS. 8A-8P are used to illustrate the processes in FIGS. 13A-13G and 18. FIGS. 9A-9P illustrate example techniques for placing a home menu user interface based on characteristics of the user input used to invoke the home menu user interface and/or user posture when the home menu user interface is invoked, in accordance with some embodiments. FIGS. 12A-12D are flow diagrams of methods of placing a home menu user interface based on characteristics of the user input used to invoke the home menu user interface and/or user posture when the home menu user interface is invoked, in accordance with various embodiments. The user interfaces in FIGS. 9A-9P are used to illustrate the processes in FIGS. 12A-12D. FIGS. 14A-14L illustrate example techniques for switching between a wrist-based pointer and a head-based pointer, depending on whether certain criteria are met, in accordance with some embodiments. FIGS. 17A-17D are flow diagrams of methods of switching between a wrist-based pointer and a head-based pointer, depending on whether certain criteria are met, in accordance with various embodiments. The user interfaces in FIGS. 14A-14L are used to illustrate the processes in FIGS. 17A-17D.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, an XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in an XR environment may be made in response to representations of physical motions (e.g., vocal commands). A person may sense and/or interact with an XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location and direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

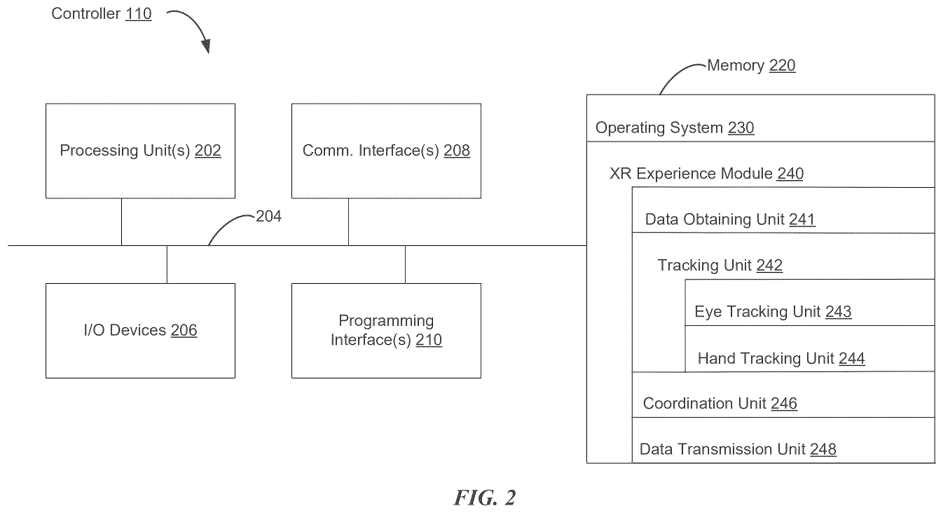

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate an XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

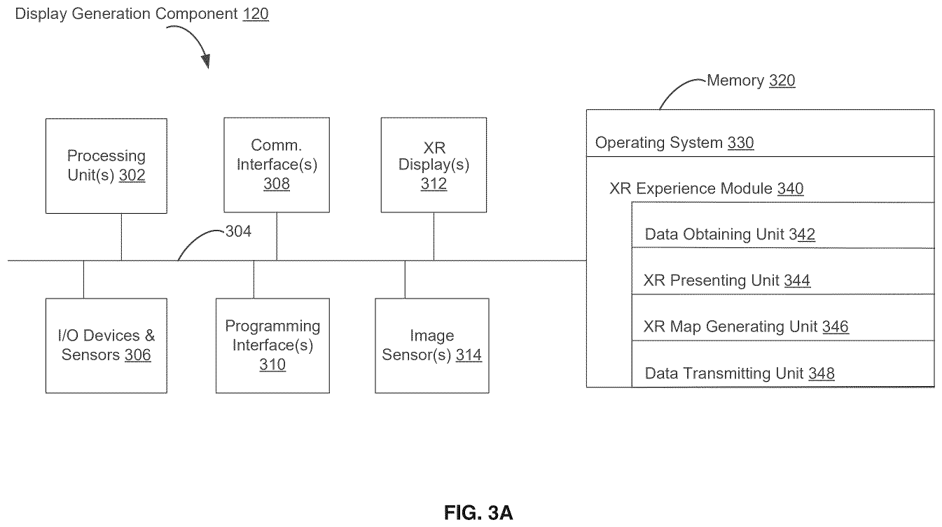

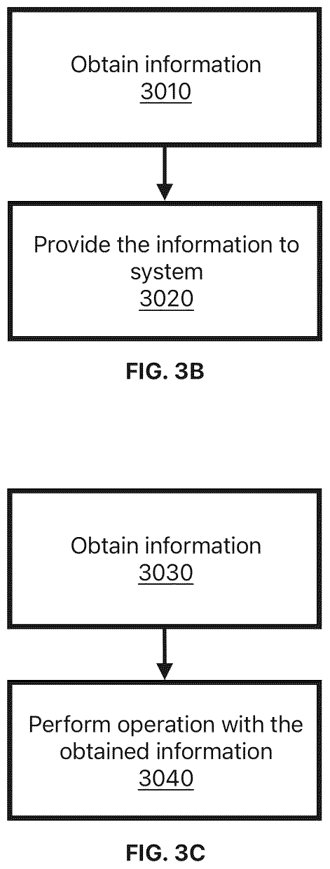

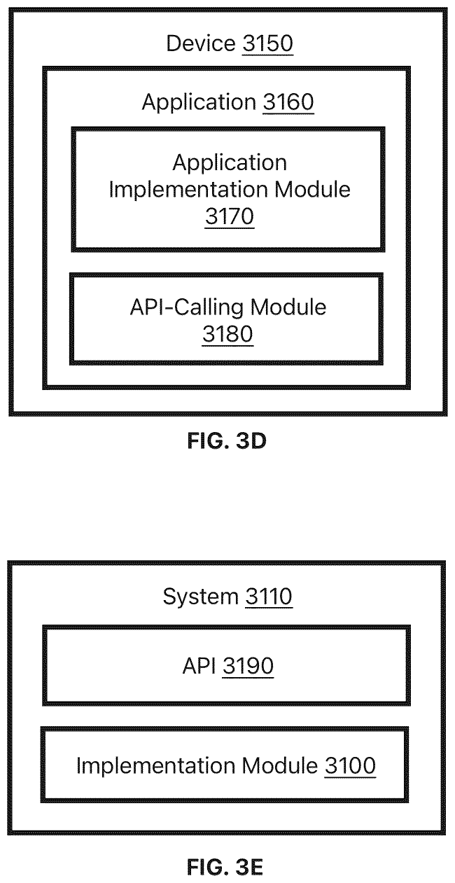

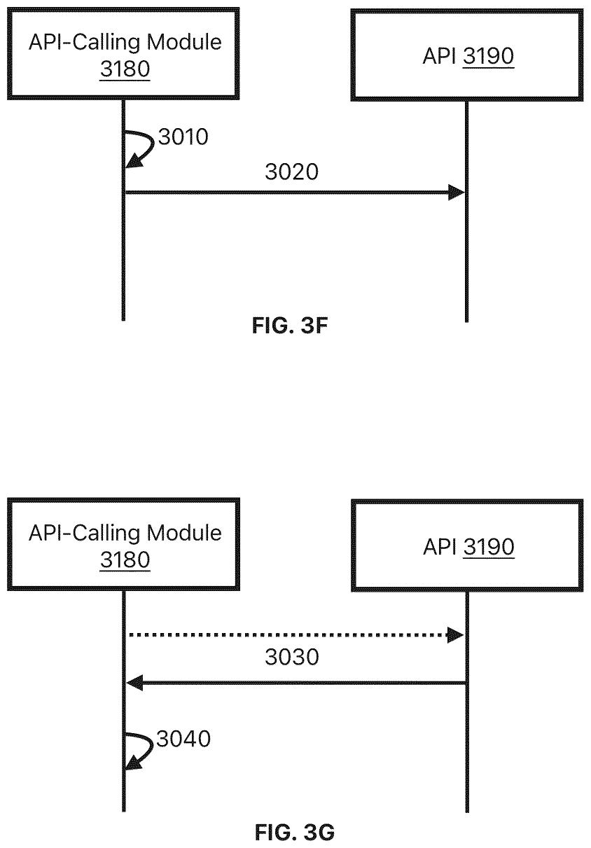

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is an XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of an HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of an HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HMD device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin.

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HMD 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HMD devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and an XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 242, a tracking unit 244, a coordination unit 246, and a data transmitting unit 248.

In some embodiments, the data obtaining unit 242 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 242 includes instructions and/or logic therefor, and heuristics and metadata therefor.

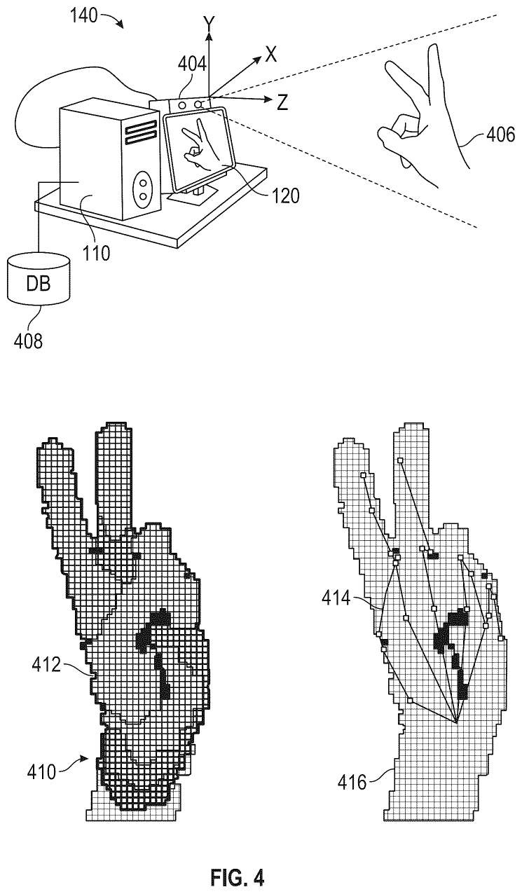

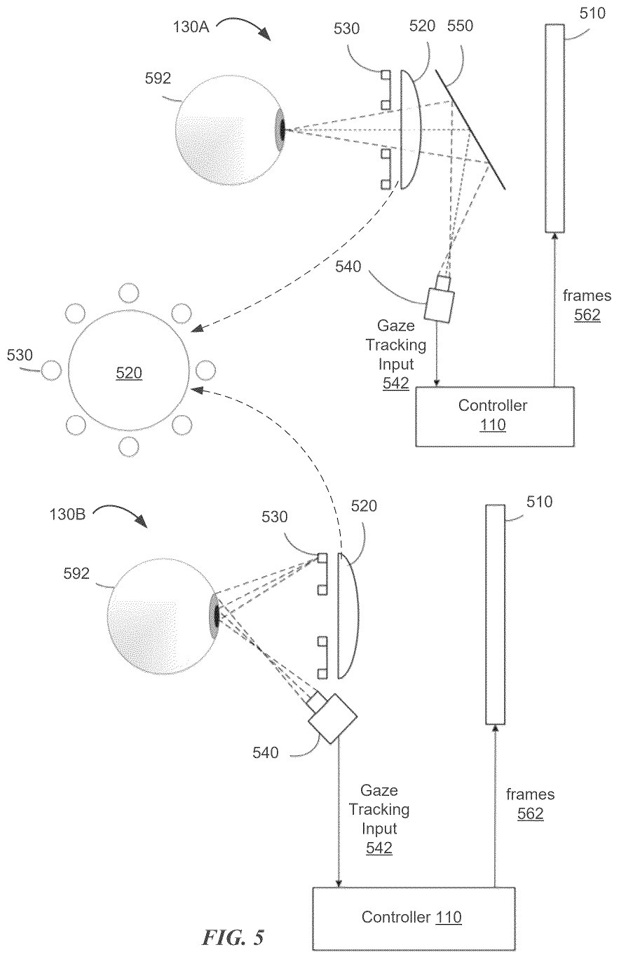

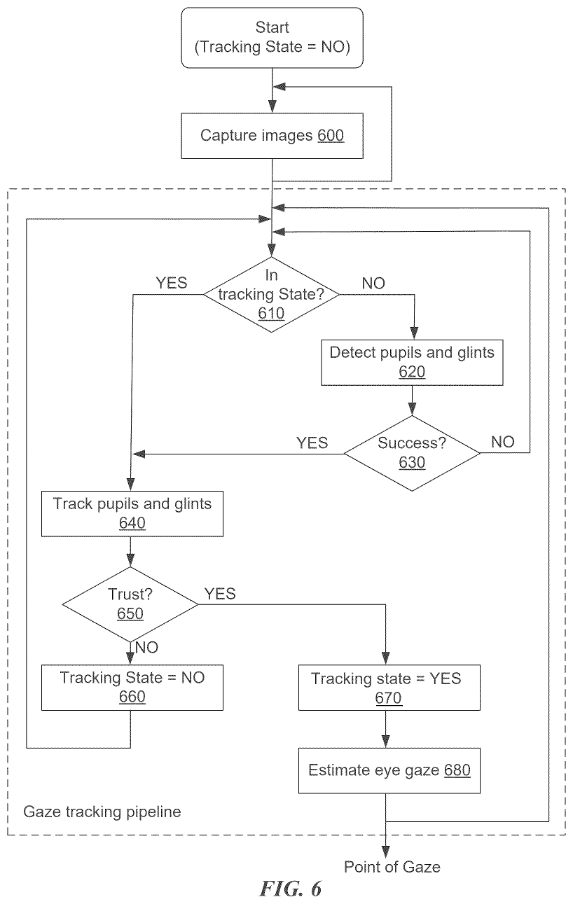

In some embodiments, the tracking unit 244 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 244 includes instructions and/or logic therefor, and heuristics and metadata therefor. In some embodiments, the tracking unit 244 includes hand tracking unit 245 and/or eye tracking unit 243. In some embodiments, the hand tracking unit 245 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 245 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 242, the tracking unit 244 (e.g., including the eye tracking unit 243 and the hand tracking unit 245), the coordination unit 246, and the data transmitting unit 248 are shown as residing on a single device (e.g., the controller 110), it should be understood that in other embodiments, any combination of the data obtaining unit 242, the tracking unit 244 (e.g., including the eye tracking unit 243 and the hand tracking unit 245), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes an XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and an XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, an XR presenting unit 344, an XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate an XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 10000 (e.g., as illustrated in FIGS. 10A-10K), method 11000 (e.g., as illustrated in FIGS. 11A-11E), method 12000 (e.g., as illustrated in FIGS. 12A-12D), method 13000 (e.g., as illustrated in FIGS. 13A-13G), method 15000 (e.g., as illustrated in FIGS. 15A-15F), method 16000 (e.g., as illustrated in FIGS. 16A-16F), method 17000 (e.g., as illustrated in FIGS. 17A-17D), and/or method 18000 (e.g., as illustrated in FIG. 18) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (e.g., as illustrated in FIG. 1A) is controlled by hand tracking unit 245 (e.g., as illustrated in FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environment of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving their hand 406 and/or changing their hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves their hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (e.g., as illustrated in FIG. 1A). In some embodiments, the eye tracking device 130 is controlled by the eye tracking unit 243 (e.g., as illustrated in FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or an XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs)), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real-world environment 602 are used to provide a XR experience to the user, for example, a mixed reality environment in which one or more virtual objects are superimposed over representations of real-world environment 602.

Thus, the description herein describes some embodiments of three-dimensional environments (e.g., XR environments) that include representations of real-world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one or more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with one or more display generation components, one or more input devices, and optionally one or more audio output devices.

FIGS. 7A-7BE, 8A-8T, 9A-9P, and 14A-14L include illustrations of three-dimensional environments that are visible via a display generation component (e.g., a display generation component 7100a or a display generation component 120) of a computer system (e.g., computer system 101) and interactions that occur in the three-dimensional environments caused by user inputs directed to the three-dimensional environments and/or inputs received from other computer systems and/or sensors. In some embodiments, an input is directed to a virtual object within a three-dimensional environment by a user's gaze detected in the region occupied by the virtual object, or by a hand gesture performed at a location in the physical environment that corresponds to the region of the virtual object. In some embodiments, an input is directed to a virtual object within a three-dimensional environment by a hand gesture that is performed (e.g., optionally, at a location in the physical environment that is independent of the region of the virtual object in the three-dimensional environment) while the virtual object has input focus (e.g., while the virtual object has been selected by a concurrently and/or previously detected gaze input, selected by a concurrently or previously detected pointer input, and/or selected by a concurrently and/or previously detected gesture input). In some embodiments, an input is directed to a virtual object within a three-dimensional environment by an input device that has positioned a focus selector object (e.g., a pointer object or selector object) at the position of the virtual object. In some embodiments, an input is directed to a virtual object within a three-dimensional environment via other means (e.g., voice and/or control button). In some embodiments, an input is directed to a representation of a physical object or a virtual object that corresponds to a physical object by the user's hand movement (e.g., whole hand movement, whole hand movement in a respective posture, movement of one portion of the user's hand relative to another portion of the hand, and/or relative movement between two hands) and/or manipulation with respect to the physical object (e.g., touching, swiping, tapping, opening, moving toward, and/or moving relative to). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from sensors (e.g., image sensors, temperature sensors, biometric sensors, motion sensors, and/or proximity sensors) and contextual conditions (e.g., location, time, and/or presence of others in the environment). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from other computers used by other users that are sharing the computer-generated environment with the user of the computer system (e.g., in a shared computer-generated experience, in a shared virtual environment, and/or in a shared virtual or augmented reality environment of a communication session). In some embodiments, the computer system displays some changes in the three-dimensional environment (e.g., displaying movement, deformation, and/or changes in visual characteristics of a user interface, a virtual surface, a user interface object, and/or virtual scenery) in accordance with inputs from sensors that detect movement of other persons and objects and movement of the user that may not qualify as a recognized gesture input for triggering an associated operation of the computer system.

In some embodiments, a three-dimensional environment that is visible via a display generation component described herein is a virtual three-dimensional environment that includes virtual objects and content at different virtual positions in the three-dimensional environment without a representation of the physical environment. In some embodiments, the three-dimensional environment is a mixed reality environment that displays virtual objects at different virtual positions in the three-dimensional environment that are constrained by one or more physical aspects of the physical environment (e.g., positions and orientations of walls, floors, surfaces, direction of gravity, time of day, and/or spatial relationships between physical objects). In some embodiments, the three-dimensional environment is an augmented reality environment that includes a representation of the physical environment. In some embodiments, the representation of the physical environment includes respective representations of physical objects and surfaces at different positions in the three-dimensional environment, such that the spatial relationships between the different physical objects and surfaces in the physical environment are reflected by the spatial relationships between the representations of the physical objects and surfaces in the three-dimensional environment. In some embodiments, when virtual objects are placed relative to the positions of the representations of physical objects and surfaces in the three-dimensional environment, they appear to have corresponding spatial relationships with the physical objects and surfaces in the physical environment. In some embodiments, the computer system transitions between displaying the different types of environments (e.g., transitions between presenting a computer-generated environment or experience with different levels of immersion, adjusting the relative prominence of audio/visual sensory inputs from the virtual content and from the representation of the physical environment) based on user inputs and/or contextual conditions.

In some embodiments, the display generation component includes a pass-through portion in which the representation of the physical environment is displayed or visible. In some embodiments, the pass-through portion of the display generation component is a transparent or semi-transparent (e.g., see-through) portion of the display generation component revealing at least a portion of a physical environment surrounding and within the field of view of a user (sometimes called “optical passthrough”). For example, the pass-through portion is a portion of a head-mounted display or heads-up display that is made semi-transparent (e.g., less than 50%, 40%, 30%, 20%, 15%, 10%, or 5% of opacity) or transparent, such that the user can see through it to view the real world surrounding the user without removing the head-mounted display or moving away from the heads-up display. In some embodiments, the pass-through portion gradually transitions from semi-transparent or transparent to fully opaque when displaying a virtual or mixed reality environment. In some embodiments, the pass-through portion of the display generation component displays a live feed of images or video of at least a portion of physical environment captured by one or more cameras (e.g., rear facing camera(s) of a mobile device or associated with a head-mounted display, or other cameras that feed image data to the computer system) (sometimes called “digital passthrough”). In some embodiments, the one or more cameras point at a portion of the physical environment that is directly in front of the user's eyes (e.g., behind the display generation component relative to the user of the display generation component). In some embodiments, the one or more cameras point at a portion of the physical environment that is not directly in front of the user's eyes (e.g., in a different physical environment, or to the side of or behind the user).

In some embodiments, when displaying virtual objects at positions that correspond to locations of one or more physical objects in the physical environment (e.g., at positions in a virtual reality environment, a mixed reality environment, or an augmented reality environment), at least some of the virtual objects are displayed in place of (e.g., replacing display of) a portion of the live view (e.g., a portion of the physical environment captured in the live view) of the cameras. In some embodiments, at least some of the virtual objects and content are projected onto physical surfaces or empty space in the physical environment and are visible through the pass-through portion of the display generation component (e.g., viewable as part of the camera view of the physical environment, or through the transparent or semi-transparent portion of the display generation component). In some embodiments, at least some of the virtual objects and virtual content are displayed to overlay a portion of the display and block the view of at least a portion of the physical environment visible through the transparent or semi-transparent portion of the display generation component.

In some embodiments, the display generation component displays different views of the three-dimensional environment in accordance with user inputs or movements that change the virtual position of the viewpoint of the currently displayed view of the three-dimensional environment relative to the three-dimensional environment. In some embodiments, when the three-dimensional environment is a virtual environment, the viewpoint moves in accordance with navigation or locomotion requests (e.g., in-air hand gestures, and/or gestures performed by movement of one portion of the hand relative to another portion of the hand) without requiring movement of the user's head, torso, and/or the display generation component in the physical environment. In some embodiments, movement of the user's head and/or torso, and/or the movement of the display generation component or other location sensing elements of the computer system (e.g., due to the user holding the display generation component or wearing the HMD), relative to the physical environment, cause corresponding movement of the viewpoint (e.g., with corresponding movement direction, movement distance, movement speed, and/or change in orientation) relative to the three-dimensional environment, resulting in corresponding change in the currently displayed view of the three-dimensional environment. In some embodiments, when a virtual object has a preset spatial relationship relative to the viewpoint (e.g., is anchored or fixed to the viewpoint), movement of the viewpoint relative to the three-dimensional environment would cause movement of the virtual object relative to the three-dimensional environment while the position of the virtual object in the field of view is maintained (e.g., the virtual object is said to be head locked). In some embodiments, a virtual object is body-locked to the user, and moves relative to the three-dimensional environment when the user moves as a whole in the physical environment (e.g., carrying or wearing the display generation component and/or other location sensing component of the computer system), but will not move in the three-dimensional environment in response to the user's head movement alone (e.g., the display generation component and/or other location sensing component of the computer system rotating around a fixed location of the user in the physical environment). In some embodiments, a virtual object is, optionally, locked to another portion of the user, such as a user's hand or a user's wrist, and moves in the three-dimensional environment in accordance with movement of the portion of the user in the physical environment, to maintain a preset spatial relationship between the position of the virtual object and the virtual position of the portion of the user in the three-dimensional environment. In some embodiments, a virtual object is locked to a preset portion of a field of view provided by the display generation component, and moves in the three-dimensional environment in accordance with the movement of the field of view, irrespective of movement of the user that does not cause a change of the field of view.

In some embodiments, the views of a three-dimensional environment sometimes do not include representation(s) of a user's hand(s), arm(s), and/or wrist(s). In some embodiments, as shown in FIGS. 7A-7BE, 8A-8T, 9A-9P, and 14A-14L the representation(s) of a user's hand(s), arm(s), and/or wrist(s) are included in the views of a three-dimensional environment. In some embodiments, the representation(s) of a user's hand(s), arm(s), and/or wrist(s) are included in the views of a three-dimensional environment as part of the representation of the physical environment provided via the display generation component. In some embodiments, the representations are not part of the representation of the physical environment and are separately captured (e.g., by one or more cameras pointing toward the user's hand(s), arm(s), and wrist(s)) and displayed in the three-dimensional environment independent of the currently displayed view of the three-dimensional environment. In some embodiments, the representation(s) include camera images as captured by one or more cameras of the computer system(s), or stylized versions of the arm(s), wrist(s) and/or hand(s) based on information captured by various sensors). In some embodiments, the representation(s) replace display of, are overlaid on, or block the view of, a portion of the representation of the physical environment. In some embodiments, when the display generation component does not provide a view of a physical environment, and provides a completely virtual environment (e.g., no camera view and no transparent pass-through portion), real-time visual representations (e.g., stylized representations or segmented camera images) of one or both arms, wrists, and/or hands of the user are, optionally, still displayed in the virtual environment. In some embodiments, if a representation of the user's hand is not provided in the view of the three-dimensional environment, the position that corresponds to the user's hand is optionally indicated in the three-dimensional environment, e.g., by the changing appearance of the virtual content (e.g., through a change in translucency and/or simulated reflective index) at positions in the three-dimensional environment that correspond to the location of the user's hand in the physical environment. In some embodiments, the representation of the user's hand or wrist is outside of the currently displayed view of the three-dimensional environment while the virtual position in the three-dimensional environment that corresponds to the location of the user's hand or wrist is outside of the current field of view provided via the display generation component; and the representation of the user's hand or wrist is made visible in the view of the three-dimensional environment in response to the virtual position that corresponds to the location of the user's hand or wrist being moved within the current field of view due to movement of the display generation component, the user's hand or wrist, the user's head, and/or the user as a whole.

FIGS. 7A-7BE illustrate examples of invoking and interacting with a control for a computer system. The user interfaces in FIGS. 7A-7BE are used to illustrate the processes described below, including the processes in FIGS. 10A-10K, FIGS. 11A-11E, FIGS. 15A-15F, FIGS. 16A-16F, and FIG. 18.

FIG. 7A illustrates an example physical environment 7000 that includes a user 7002 interacting with a computer system 101. Computer system 101 is worn on a head of the user 7002 and typically positioned in front of user 7002. In FIG. 7A, the left hand 7020 and the right hand 7022 of the user 7002 are free to interact with computer system 101. Physical environment 7000 includes a physical object 7014, physical walls 7004 and 7006, and a physical floor 7008. As shown in the examples in FIGS. 7B-7BE, display generation component 7100a of computer system 101 is a head-mounted display (HMD) worn on the head of the user 7002 (e.g., what is shown in FIGS. 7B-7BE as being visible via display generation component 7100a of computer system 101 corresponds to the viewport of the user 7002 into an environment when wearing a head-mounted display).

In some embodiments, the head mounted display (HMD) 7100a includes one or more displays that display a representation of a portion of the three-dimensional environment 7000′ that corresponds to the perspective of the user. While an HMD typically includes multiple displays including a display for a right eye and a separate display for a left eye that display slightly different images to generate user interfaces with stereoscopic depth, in FIGS. 7B-7BE, a single image is shown that corresponds to the image for a single eye and depth information is indicated with other annotations or description of the figures. In some embodiments, HMD 7100a includes one or more sensors (e.g., one or more interior- and/or exterior-facing image sensors 314), such as sensor 7101a, sensor 7101b and/or sensor 7101c (e.g., as illustrated in FIG. 7E) for detecting a state of the user, including facial and/or eye tracking of the user (e.g., using one or more inward-facing sensors 7101a and/or 7101b) and/or tracking hand, torso, or other movements of the user (e.g., using one or more outward-facing sensors 7101c). In some embodiments, HMD 7100a includes one or more input devices that are optionally located on a housing of HMD 7100a, such as one or more buttons, trackpads, touchscreens, scroll wheels, digital crowns that are rotatable and depressible or other input devices. In some embodiments, input elements are mechanical input elements; in some embodiments, input elements are solid state input elements that respond to press inputs based on detected pressure or intensity. For example, in FIGS. 7B-7BE, HMD 7100a includes one or more of button 701, button 702 and digital crown 703 for providing inputs to HMD 7100a. It will be understood that additional and/or alternative input devices may be included in HMD 7100a.

In some embodiments, the display generation component of computer system 101 is a touchscreen held by user 7002. In some embodiments, the display generation component is a standalone display, a projector, or another type of display. In some embodiments, the computer system is in communication with one or more input devices, including cameras or other sensors and input devices that detect movement of the user's hand(s), movement of the user's body as whole, and/or movement of the user's head in the physical environment. In some embodiments, the one or more input devices detect the movement and the current postures, orientations, and positions of the user's hand(s), face, and/or body as a whole. For example, in some embodiments, while the user's hand 7020 (e.g., a left hand) is within the field of view of the one or more sensors of HMD 7100a (e.g., within the viewport of the user), a representation of the user's hand 7020′ is displayed in the user interface displayed (e.g., as a passthrough representation and/or as a virtual representation of the user's hand 7020) on the display of HMD 7100a. In some embodiments, while the user's hand 7022 (e.g., a right hand) is within the field of view of the one or more sensors of HMD 7100a (e.g., within the viewport of the user), a representation of the user's hand 7022′ is displayed in the user interface displayed (e.g., as a passthrough representation and/or as a virtual representation of the user's hand 7022) on the display of HMD 7100a. In some embodiments, the user's hand 7020 and/or the user's hand 7022 are used to perform one or more gestures (e.g., one or more air gestures), optionally in combination with a gaze input. In some embodiments, the one or more gestures performed with the user's hand(s) 7020 and/or 7022 include a direct air gesture input that is based on a position of the representation of the user's hand(s) 7020′ and/or 7022′ displayed within the user interface on the display of HMD 7100a. For example, a direct air gesture input is determined as being directed to a user interface object displayed at a position that intersects with the displayed position of the representation of the user's hand(s) 7020′ and/or 7022′ in the user interface. In some embodiments, the one or more gestures performed with the user's hand(s) 7020 and/or 7022 include an indirect air gesture input that is based on a virtual object displayed at a position that corresponds to a position at which the user's attention is currently detected (e.g., and/or is optionally not based on a position of the representation of the user's hand(s) 7020′ and/or 7022′ displayed within the user interface). For example, an indirect air gesture is performed with respect to a user interface object while detecting the user's attention (e.g., based on gaze, wrist direction, head direction, and/or other indication of user attention) on the user interface object, such as a gaze and pinch (e.g., or other gesture performed with the user's hand).

In some embodiments, user inputs are detected via a touch-sensitive surface or touchscreen. In some embodiments, the one or more input devices include an eye tracking component that detects location and movement of the user's gaze. In some embodiments, the display generation component, and optionally, the one or more input devices and the computer system, are parts of a head-mounted device that moves and rotates with the user's head in the physical environment, and changes the viewpoint of the user in the three-dimensional environment provided via the display generation component. In some embodiments, the display generation component is a heads-up display that does not move or rotate with the user's head or the user's body as a whole, but, optionally, changes the viewpoint of the user in the three-dimensional environment in accordance with the movement of the user's head or body relative to the display generation component. In some embodiments, the display generation component (e.g., a touchscreen) is optionally moved and rotated by the user's hand relative to the physical environment or relative to the user's head, and changes the viewpoint of the user in the three-dimensional environment in accordance with the movement of the display generation component relative to the user's head or face or relative to the physical environment.

In some embodiments, one or more portions of the view of physical environment 7000 that is visible to user 7002 via display generation component 7100a are digital passthrough portions that include representations of corresponding portions of physical environment 7000 captured via one or more image sensors of computer system 101. In some embodiments, one or more portions of the view of physical environment 7000 that is visible to user 7002 via display generation component 7100a are optical passthrough portions, in that user 7002 can see one or more portions of physical environment 7000 through one or more transparent or semi-transparent portions of display generation component 7100a.

FIG. 7B shows examples of user inputs and/or gestures (e.g., air gestures, as described herein) that can be performed (e.g., by the user 7002) to interact with the computer system 101. For ease of explanation, the exemplary gestures are described as being performed by the hand 7022 of the user 7002. In some embodiments, analogous gestures can be performed by the hand 7020 of the user 7002. In addition, one of ordinary skill in the art will recognize that user interface behaviors described herein as being responsive to right-handed interactions (e.g., using the right hand 7022, right wrist, right forearm, or other right-sided portion of user 7002) can similarly be triggered by analogous left-handed interactions (e.g., using the left hand 7020, left wrist, left forearm, or other left-sided portion of user 7002).

FIG. 7B (a) shows an air pinch gesture (e.g., an air gesture that includes movement of two or more fingers of a hand to make contact with one another, that is, optionally, followed by an immediate (e.g., within 0-3 seconds) break in contact from each other, as described above with reference to exemplary air gestures, sometimes referred to herein as a “pinch gesture”). Optionally, the air pinch gesture is completed after the first three states of the sequence shown in FIG. 7B (a) (e.g., the fourth pose of hand 7022 in the sequence, requiring further separation between the thumb and index finger from the third pose in the sequence, is optionally not required as part of an air pinch gesture). In some embodiments (e.g., as shown in FIG. 7B (a)), the air pinch gesture is performed while the hand 7022 of the user 7002 is oriented with a palm 7025 of hand 7022 facing toward a viewpoint of the user 7002 (e.g., sometimes referred to as “palm up” or a “palm up” orientation). In some embodiments, the palm of the hand 7002 is detected as “palm up” or in the “palm up” orientation, in accordance with a determination that the computer system 101 detects (e.g., via one or more sensors, such as the sensor 7101a, 7101b, and/or 7101c, as described herein) that at least a threshold area or portion of the palm (e.g., at least 20%, at least 30%, at least 40%, at least 50%, more than 50%, more than 60%, more than 70%, more than 80%, or more than 90%) is visible from (e.g., facing toward) the viewpoint of the user 7002.

FIG. 7B (b) shows a hand flip gesture, which involves changing the orientation of the hand 7022. A hand flip gesture can include changing from the “palm up” orientation to an orientation with the palm of the hand 7022 facing away from the viewpoint of the user 7002 (e.g., sometimes referred to as “palm down” or a “palm down” orientation), as denoted by the sequence following the solid arrows in FIG. 7B (b). A hand flip gesture can include changing from the “palm down” orientation to the “palm up” orientation, as denoted by the sequence following the dotted arrows in FIG. 7B (b).

As described herein, the hand flip is sometimes referred to as “reversible” (e.g., flipping the hand 7022 from the “palm up” orientation to the “palm down” orientation can be reversed, by flipping the hand 7022 from the “palm down” orientation to the “palm up” orientation, which likewise can be reversed by flipping the hand 7022 from the “palm up” orientation back to the “palm down” orientation).

FIG. 7B (c) shows a pinch and hold gesture (e.g., a long pinch gesture that includes holding an air pinch gesture (e.g., with the two or more fingers making contact) until a break in contact between the two or more fingers is detected, as described above with reference to exemplary air gestures, also called an air long pinch gesture or long air pinch gesture) that is performed while the hand 7022 is in the “palm up” orientation.

FIG. 7B (d) is analogous to FIG. 7B (c) and shows a pinch and hold gesture that is performed while the hand 7022 is in the “palm down” orientation. Similarly, one of ordinary skill in the art will recognize that the air pinch gesture of FIG. 7B (a) may be performed while the hand 7022 is in the “palm down” orientation.

FIG. 7C shows an exemplary user interface 7024 (e.g., that is displayed via the display generation component 7100a) for configuring the computer system 101. In some embodiments, the user interface 7024 is a user interface for gathering and/or storing data relating to the eyes of the user 7002 (e.g., gathering and/or storing data to assist with detection and/or determination of where a user's gaze and/or attention is directed). In some embodiments, the user interface 7024 includes instructions for moving the gaze and/or attention of the user 7002 to different points within the user interface 7024. As shown in FIG. 7C, the attention 7010 of the user 7002 (e.g., attention is frequently based on gaze but is, in some circumstances based on an orientation of one or more body parts such as an orientation of a wrist of a user or an orientation of a head of a user which can be used as a proxy for gaze) is directed toward (e.g., sometimes referred to herein as “directed to”) a particular portion of the user interface 7024, optionally in combination with a gesture performed by one or more hands of the user 7002.

FIG. 7D shows an exemplary user interface 7026 (e.g., that is displayed via the display generation component 7100a) for configuring the computer system 101. In some embodiments, the user interface 7026 is a user interface for gathering and/or storing data relating to the hand 7020 and the hand 7022 of the user 7002 (e.g., gathering and/or storing data to assist with detection of the one or more hands of the user 7002 and/or gestures performed by the hand 7020 and/or the hand 7022). In some embodiments, the user interface 7026 includes instructions for positioning the computer system 101 and/or the one or more hands of the user 7002 such that the relevant data can be collected (e.g., by the sensor 7101a, the sensor 7101b, and/or the sensory 7101c). As shown in FIG. 7D, the hands of the user 7002 are visible (e.g., within the view of one or more cameras of the computer system 101), and the attention 7010 of the user 7002 is directed toward the hand 7022′.

The following figures show a representation 7022′ of the user's hand 7022. In some embodiments, the representation 7022′ is a virtual representation of the hand 7022 of the user 7002 (e.g., a video reproduction of the hand 7022 of the user 7002; a virtual avatar or model of the hand 7022 of the user 7002, or a simulated hand that is a replacement for the hand 7022 of the user), visible via and/or displayed via the display generation component 7100a of the computer system 101. In some embodiments, the representation 7022′ is sometimes referred to as “a view of the hand” (e.g., a view of the hand 7022 of the user 7002, corresponding to or representing a location of the hand 7022). While the user 7002 physically performs gestures and/or changes in orientation with the actual (e.g., physical) hand 7022 of the user 7002, for ease of description (e.g., and for easier reference with respect to the figures), such gestures and/or changes in orientation may be described with reference to the hand 7022′ (e.g., as the representation 7022′ of the hand 7022 of the user 7002 is what is visible via the display generation component 7100a). Similarly, reference is sometimes made to attention of the user being directed toward the hand 7022′, which is understood in some contexts to mean the view of the hand 7022 (e.g., in scenarios where the attention of the user 7002 is directed toward the virtual representation of the hand 7022′ that is visible via the display generation component 7100a, as the display generation component 7100a is between the actual eyes of the user 7002 and the physical hand 7022 of the user 7002). This also applies to a representation 7020′ of the user's hand 7020, where shown and described.

In some embodiments, the user interface 7024 (e.g., shown in FIG. 7C) and/or the user interface 7026 (e.g., shown in FIG. 7D) are displayed during an initial setup and/or configuration of the computer system 101 (e.g., the first time that the user 7002 uses the computer system 101). In some embodiments, the user interface 7024 and/or the user interface 7026 are displayed (e.g., are redisplayed) when accessed through a settings user interface of the computer system 101 (e.g., to allow for recalibration and/or updated of stored data relating to the eyes and/or hands of the user 7002, after the initial setup and/or configuration of the computer system 101). In some embodiments, the computer system 101 collects and/or stores data corresponding to multiple users (e.g., in separate user profiles).

FIG. 7E shows a user interface 7028-a, which includes instructions (e.g., a tutorial) for performing gestures for interacting with the computer system 101. In some embodiments, the user interface 7028-a includes text instructions (e.g., “Look at your palm and pinch for Home”). In some embodiments, the user interface 7028-a includes non-textual instructions (e.g., video, animations, and/or other visual aids), such as an image of hand in the “palm up” orientation (e.g., and/or an animation of a hand performing an air pinch gesture, as described in further detail below with reference to FIG. 7F).

FIG. 7F shows additional examples (e.g., and/or alternatives) of the user interface 7028-a. In some embodiments, the user interface 7028-a includes an animation of a hand performing an air pinch gesture (e.g., a “palm up” air pinch gesture as described above with reference to FIG. 7B (a)). While FIG. 7F shows only two states of the user interface 7028-a, in some embodiments, the user interface 7028-a plays a more detailed animation (e.g., shows more than the two states in FIG. 7F, optionally including one or more of the hand states shown in FIG. 7B (a)). In some embodiments, the animation shown in the user interface 7028-a is repeated (e.g., plays continuously, on a loop).

In some embodiments, the user interface 7028-a, the user interface 7028-b, and/or the user interface 7082-c are only displayed if the computer system 101 detects that data is stored for the hands of the current user (e.g., the computer system 101 detects that data is stored for the hand 7020 and the hand 7022 of the user 7002, while the user 7002 and/or the hand 7020 and/or the hand 7022 of the user 7002 are enrolled for the computer system 101). In some embodiments, if the computer system 101 detects that no data is stored for the hands of the current user (e.g., the current user's hands are not enrolled for the computer system 101), the computer system 101 does not display the user interface 7028-a, the user interface 7028-b, and/or the user interface 7082-c. In some embodiments, if the user interface 7028-a, the user interface 7028-b, and/or the user interface 7028-c are not displayed (e.g., because no data is stored for the hands of the current user), the functionality described below can be accessed via other means (e.g., through a settings user interface, or through alternate inputs that are not performed with the current user's hands (e.g., through attention-based inputs (e.g., gaze, head direction, wrist direction, and/or other attention metric(s)), through hardware button inputs, and/or through a controller or other external device in communication with the computer system 101).

In some embodiments, the user interface 7028-a, the user interface 7028-b, and the user interface 7028-c are displayed during an initial setup state or configuration state for the computer system 101 (e.g., the computer system 101 is in the same initial setup state or configurate state in FIGS. 7E-7N, as in FIGS. 7C-7D). In some embodiments, the user interface 7028-a, the user interface 7028-b, and the user interface 7028-c are displayed during a configuration state that follows a software update (e.g., or other event which may result in changes to, enabling, and/or disabling of different types of user interaction with the computer system 101).

In some embodiments, the computer system 101 transitions from displaying the user interface 7028-a to displaying a user interface 7028-b (e.g., automatically, after a preset amount of time; or in response to detecting a user input). The user interface 7028-b is analogous to the user interface 7028-a, but includes text instructions for performing a hand flip gesture (e.g., the hand flip described above with reference to FIG. 7B (b)), and an animation of an air pinch gesture while the hand is in a “palm down” orientation. In some embodiments, the animation in the user interface 7028-b also includes portions that correspond to the palm flip gesture (e.g., would show states similar to what is shown in FIG. 7B (b), prior to displaying the states shown in the user interface 7028-b in FIG. 7F).

In some embodiments, the computer system 101 transitions from displaying the user interface 7028-b to displaying a user interface 7028-c (e.g., automatically, after a preset amount of time; or in response to detecting a user input). The user interface 7028-c is analogous to the user interface 7028-a and the user interface 7028-b, but includes text instructions for performing a pinch and hold gesture (e.g., the pinch and hold while the hand is in a “palm up” orientation, as described above with reference to FIG. 7B (c)), and an animation of a hand performing a pinch and hold gesture.

In some embodiments, while displaying the user interface 7028-c, the computer system 101 transitions back to displaying the user interface 7028-a or the user interface 7028-b. For example, each of the transitions (e.g., from displaying the user interface 7028-a to displaying the user interface 7028-b; and from displaying the user interface 7028-b to displaying the user interface 7028-c) occurs automatically after the preset amount of time. After displaying the user interface 7082-c for the preset amount of time, the computer system 101 loops back to the beginning (e.g., redisplays the user interface 7028-a). Optionally, these transitions continue to occur after the preset amount of time (e.g., until the computer system 101 detects a user input requesting that the computer system 101 cease displaying the user interface 7028-a, the user interface 7028-b, and/or the user interface 7028-c).

For example, each of the transitions (e.g., from displaying the user interface 7028-a to displaying the user interface 7028-b; and from displaying the user interface 7028-b to displaying the user interface 7028-c) occurs in response to detecting a user input (e.g., a same type of user input and/or a user input including a same type of gesture, such as an air drag or an air swipe gesture, in a first direction, as described herein). In response to detecting the user input while the user interface 7028-c is displayed, the computer system 101 displays (e.g., redisplays) the user interface 7028-a (e.g., and the computer system 101 continues to transition between the user interface 7028-a, the user interface 7028-b, and the user interface 7028-c, in order, in response to detecting subsequent user inputs). In some embodiments, in response to detecting a different type of input (e.g., or user input including a different type of gesture), the computer system 101 displays the previous user interface (e.g., most recently displayed user interface). For example, while displaying the user interface 7028-c, the computer system 101 displays (e.g., redisplays) the user interface 7028-b in response to detecting the different type of input (e.g., an air drag gesture or an air swipe gesture, in a different or opposite direction than the first direction). This allows the user 7002 to freely navigate between the user interface 7028-a, the user interface 7028-b, and the user interface 7028-c, without being forced to cycle through each of the user interfaces in a preset order.

FIG. 7G shows the user 7002 following the instructions in the user interface 7028-a. In FIG. 7G, the user 7002 changes the orientation of the hand 7022′ to the “palm up” orientation. The attention 7010 of the user 7002 also moves to the palm of the hand 7022′. In some embodiments, in response to detecting that the attention 7010 of the user 7002 is directed toward the hand 7022′, the computer system 101 displays a control 7030 (e.g., at the position shown by the dotted outline in FIG. 7G). In some embodiments, the control 7030 is only displayed if the attention 7010 of the user 7002 is directed toward the hand 7022′ while the computer system 101 detects that the hand 7022′ is in the “palm up” orientation. In some embodiments, the control 7030 is not displayed, if the computer system 101 detects that the attention 7010 of the user 7002 is directed toward the hand 7022′ while the hand 7022′ is in the “palm up” orientation, before the computer system 101 displays (e.g., for a first time, during or following an initial setup and/or configuration state, or following a software update) the user interface 7028-a. The control 7030, and criteria for displaying the control 7030, are described in further detail below, with reference to FIGS. 7Q1-7BE. In some embodiments, the computer system 101 does not display a control 7030 in response to detecting the attention 7010 of the user 7002 directed toward the palm of the hand 7022′ (e.g., the computer system 101 does not display the control 7030 because and/or while the user interface 7028-a is displayed, or more generally during the initial setup and/or configuration process, even if the hand 7022′ is “palm up” and the attention 7010 of the user 7002 is directed toward the hand 7022′).

In FIG. 7H, the computer system 101 transitions to displaying the user interface 7028-b (e.g., because a threshold amount of time has passed while displaying the user interface 7028-a in FIG. 7G). The user 7002 also changes the orientation of the hand 7022′ to the “palm down” orientation (e.g., following the instructions in the user interface 7028-b) and the attention 7010 of the user 7002 is directed toward the hand 7022′. Because the attention 7010 of the user 7002 remains directed toward the hand 7022′ during the hand flip (e.g., from the “palm up” orientation in FIG. 7G, to the “palm down” orientation in FIG. 7G), the computer system 101 optionally displays the status user interface 7032 in response to detecting that the attention 7010 of the user 7002 is directed toward the hand 7022′. The status user interface 7032 displays summary of relevant information about the computer system 101 (e.g., a battery level, a wireless communication status, a current time, a current date, and/or a current status of notification(s) associated with the computer system 101). In some embodiments (e.g., even when the user interface 7028-a and/or the user interface 7028-b are displayed), the computer system 101 displays the status user interface 7032 in response to detecting a hand flip (e.g., in which the attention 7010 of the user 7002 remains directed to the hand 7022′) while the control 7030 is displayed (e.g., in response to detecting that the attention 7010 of the user 7002 is directed toward the hand 7022′ in the “palm up” orientation). In some embodiments, the status user interface 7032 is not displayed, if the computer system 101 detects that the attention 7010 of the user 7002 is directed toward the hand 7022′ during a hand flip from the “palm up” orientation to the “palm down” orientation, before the computer system 101 displays (e.g., for a first time, during or following an initial setup and/or configuration state, or following a software update) the user interface 7028-b. In some embodiments, the computer system 101 does not display the status user interface 7032 in response to detecting the hand flip (e.g., because the user interface 7028-b is displayed) (e.g., the computer system 101 does not display the status user interface 7032 during the initial setup and/or configuration process even if the hand 7022′ flipped from “palm up” to “palm down” while the attention 7010 of the user 7002 was directed toward the hand 7022′). In some embodiments, the computer system 101 does not display either the control 7030 or the status user interface 7032 when any of the user interface 7028-a, the user interface 7028-b, and/or the user interface 7028-c are displayed.

In some embodiments, while the user interface 7028-a, the user interface 7028-b, and/or the user interface 7028-c are displayed (or more specifically while the user interface 7028-c with instructions for adjusting volume level is displayed), the computer system allows adjusting of a volume level of the computer system 101 (e.g., via a pinch and hold gesture, as described in greater detail below with reference to FIGS. 8A-8T). In some embodiments, while the user 7002 is adjusting the volume level of the computer system 101 (e.g., while the computer system 101 continues to detect the pinch and hold gesture), the computer system 101 outputs audio (e.g., continuous or repeating audio, such as ambient sound, a continuous sound, or a repeating sound) to provide audio feedback regarding the current volume level, as it is adjusted (e.g., by changing the volume level of the audio being output as the volume level of the computer system is changed). In some embodiments, although the computer system 101 allows for adjustments to the volume level of the computer system 101 while the user interface 7028-a, the user interface 7028-b, and/or the user interface 7028-c are displayed, after ceasing to display the user interface 7028-a, the user interface 7028-b, and the user interface 7028-c (e.g., after the computer system 101 is no longer displaying instructions for performing gestures for interacting with the computer system 101; and/or after the computer system 101 is no longer in an initial setup and/or configuration state, in which the computer system 101 provides instructions for interacting with the computer system 101), the computer system 101 resets the current volume level of the computer system 101 to a default value (e.g., 50% volume). More specifically, in some embodiments, the computer system 101 allows for adjustments to the volume level of the computer system 101 while the user interface 7028-c is displayed, and resets the current volume level of the computer system 101 to a default value in conjunction with ceasing to display the user interface 7028-c (e.g., exiting the volume level adjustment instruction portion of the configuration state).

In some embodiments, the status user interface 7032 includes indicators of the computer system 101's system status (e.g., a current time for the computer system 101; a network connectivity status of the computer system 101; and/or a current battery status of the computer system 101; as shown in FIG. 7H). In some embodiments, the status user interface 7032 includes additional indicators (e.g., an indicator that the computer system 101 is currently charging and/or connected to a power source; an indicator corresponding to an active communication session, such as an active voice or video call; an indicator corresponding to an active sensor and/or other piece of hardware, such as a microphone or a camera; an indicator corresponding to other devices that are connected to and/or in communication with the computer system 101; and/or an indicator corresponding to whether the computer system 101 is sharing a screen, user interface, or other data with another device). In some embodiments, the status user interface 7032 can be configured to include additional (e.g., or fewer) indicators. In some embodiments, the user 7002 can customize the user interface 7032 by selecting one or more indicators for inclusion within the status user interface 7032.

In some embodiments, the status user interface 7032 is displayed with a spatial relationship (e.g., a fixed spatial relationship) to the hand 7022. For example, the status user interface 7032 may be displayed between the tip of the thumb and the tip of the pointer finger of the hand 7022′, optionally at a threshold distance from the palm of the hand 7022′ (e.g., or the center of the back of the hand 7022′), and/or at a threshold distance from a location on the thumb or pointer finger of the hand 7022′. In some embodiments, the computer system 101 displays the status user interface 7032 at a position that maintains the spatial relationship to the hand 7022′ (e.g., in case of movement of the hand 7022′).

In some embodiments, the computer system 101 ceases to display the status user interface 7032 if the attention 7010 of the user 7002 is no longer directed toward the hand 7022′. In some embodiments, the computer system 101 ceases to display the status user interface 7032 if the attention 7010 of the user 7002 is not directed toward the hand 7022′ for a threshold amount of time (e.g., 0.1 seconds, 0.2 seconds, 0.5 seconds, 1 second, 2 seconds, or 5 seconds), which reduces the risk of inadvertently ceasing to display the status user interface 7032 (e.g., and requiring the user 7002 to again direct the attention 7010 of the user 7002 to the hand 7022′ in the “palm up” orientation, and performing a hand flip, to redisplay the status user interface 7032) if the attention 7010 of the user 7002 temporarily and/or accidentally leaves the hand 7022′. In some embodiments, after ceasing to display the status user interface 7032, the computer system 101 redisplays the status user interface 7032 (e.g., without requiring the initial steps of first directing the attention 7010 of the user 7002 to the hand 7022′ in the “palm up” orientation, and performing a hand flip), if the attention 7010 of the user 7002 returns to the hand 7022′ within a threshold amount of time (e.g., 0.1 seconds, 0.2 seconds, 0.5 seconds, 1 second, 2 seconds, 5 seconds, or a different time threshold). In some embodiments, after ceasing to display the status user interface 7032, the user 7002 must perform the initial steps of first directing the attention 7010 of the user 7002 to the hand 7022′ in the “palm up” orientation, and performing a hand flip, in order to display (e.g., redisplay) the status user interface 7032 (e.g., the status user interface 7032 cannot be redisplayed without first performing the initial steps of first directing the attention 7010 of the user 7002 to the hand 7022′ in the “palm up” orientation, and performing a hand flip).

FIG. 7I-7J3 show scenarios where neither the control 7030 nor the status user interface 7032 are displayed. FIG. 7I shows the hand 7022′ in a configuration that is not recognized by the computer system 101 as a “palm up” orientation (e.g., the hand 7022′ is in not in a required configuration, where the required configuration is a configuration that is required to display a control, such as the control 7030 described above with reference to FIG. 7G). Since the hand 7022′ is not in the required configuration, the computer system 101 does not display the control 7030 (e.g., regardless of whether the attention 7010 is directed toward the hand 7022′ or not). In some embodiments, the control 7030 and the status user interface are not displayed because the attention 7010 of the user 7002 is directed toward a region 7072 (e.g., and not toward the hand 7022′, which is not in the region 7072).

FIG. 7J1 shows additional failure states, where the control 7030 is not displayed. The examples in FIG. 7J1 are analogous to the failure state shown in FIG. 7I, but for ease of illustration and description, the examples in FIG. 7J1 show only the hand 7022′ and the attention 7010 of the user 7002. In some embodiments, the computer system 101 displays the control 7030 only if the hand 7022′ is in the required configuration (e.g., has the “palm up” orientation) and the attention 7010 of the user 7002 is directed toward the hand 7022′.

In example 7034, the hand 7022′ is in the required configuration (e.g., has the “palm up” orientation), but the attention 7010 of the user 7002 is not directed toward the hand 7022′, so the computer system 101 does not display the control 7030. In example 7036, the hand 7022′ is not in the required configuration (e.g., has a “palm down” orientation) and the attention 7010 of the user 7002 is not directed toward the hand 7022′, so the computer system 101 does not display the control 7030. In example 7038, the hand 7022′ is not in the required configuration (e.g., has a “palm down” orientation) and although the attention 7010 of the user 7002 is directed toward the hand 7022′, the computer system 101 does not display the control 7030 (e.g., because the hand is in not in the required configuration). In example 7040, the hand 7022′ is not in the required configuration (e.g., has a “palm down” orientation) and although the attention 7010 of the user 7002 is directed toward the hand 7022′, the computer system 101 does not display the control 7030 (e.g., because the hand is not in the required configuration). In example 7042, the hand 7022′ is not in the required configuration (e.g., is between the “palm up” and the “palm down” orientation) and although the attention 7010 of the user 7002 is directed toward the hand 7022′, the computer system 101 does not display the control 7030 (e.g., because the hand is not in the required configuration).

While examples 7034, 7036, 7038, 7040, and 7042 show various configurations of the hand 7022 and/or the attention 7010 that do not meet display criteria for the computer system 101 to display the control 7030, in some embodiments, the hand 7020 is independently evaluated (e.g., using the same criteria as those used to evaluate whether the hand 7022 satisfies display criteria, or using different criteria) to determine if the hand 7020 meets display criteria for the computer system 101 to display the control 7030. For example, if the attention 7010 is directed to the hand 7020 while the configuration of the hand 7020 satisfies display criteria for displaying the control, the control 7030 is displayed corresponding to hand 7020′ (e.g., at a location having a fixed spatial relationship with the hand 7020′) even if the hand 7022 does not meet the display criteria. Conversely, if the hand 7022 satisfies the display criteria, the control 7030 is displayed at a location having a spatial relationship with the hand 7022′ even if the hand 7020 does not satisfy display criteria.

FIGS. 7J2-7J3 show a system function menu that is optionally accessible when the computer system 101 determines that data is not stored for the hands of the current user (e.g., the computer system 101 determines that no data is stored for the hand 7020 and the hand 7022 of the user 7002; and/or the computer system 101 determines that the hand 7020 and/or the hand 7022 are not enrolled for the computer system 101). FIG. 7J2 shows that in some embodiments, in response to detecting that the attention 7010 of the user 7002 is directed toward the region 7072 (e.g., as shown in FIG. 7I), the computer system 101 displays an indication 7074 of a system function menu 7043. FIG. 7J3 show that in response to detecting that the attention 7010 of the user 7002 is directed toward the indication 7074 of the system function menu 7043 (e.g., as shown in FIG. 7J2), the computer system 101 displays the system function menu 7043. In some embodiments, the system function menu 7043 is displayed directly in response to detecting that the attention 7010 of the user 7002 is directed toward the region 7072 (e.g., as shown in FIG. 7I), without intervening display of the indication 7074 (e.g., without requiring that the user 7002 first invoke display of the indication 7074 and/or direct the attention 7010 toward the indication 7074 as in FIG. 7J2). In some embodiments, the user 7002 can continue to access the system function menu 7043 as described above, when (e.g., and/or after) the computer system 101 is no longer in the initial setup and/or configuration state.

In some embodiments, the system function menu 7043 includes a plurality of affordances for accessing system functions of the computer system. Some examples of affordances for accessing system functions accessible via the system function menu 7043 include:
an affordance 7041 (e.g., for accessing a home menu user interface, which is described in greater detail below with reference to FIGS. 7AK1-7AM);
an affordance 7046 (e.g., for accessing one or more settings or additional system functions (e.g., not accessible directly from the system function menu 7043) of the computer system 101);
an affordance 7048 (e.g., for accessing and/or initiating display of one or more virtual experiences (e.g., an XR experience as described above with reference to FIG. 1A)); and
an affordance 7052 (e.g., for accessing and/or interacting with one or more notifications generated at, received by, and/or stored by the computer system 101).

In some embodiments, the system function menu 7043 includes status information 7058. In some embodiments, the status information 7058 includes a date, a time, a network connectivity status, and/or a current battery status. In some embodiments, at least some status information of the status information 7058 overlaps with (e.g., is also displayed in) the status user interface 7032 (e.g., in FIG. 7K). For example, the status user interface 7032 in FIG. 7K includes the time, the network connectivity status for one or more different types of wireless connectivity (e.g., WiFi, Bluetooth, and/or cellular connectivity), and the current battery status. The status information 7058 in FIG. 7L also includes the time, the network connectivity status, and the current battery status. In some embodiments, the status information 7058 includes at least some status information that is not included in the status user interface 7032 (e.g., and optionally, the status user interface 7032 includes some status information that is not included in the status information 7058). In some embodiments, the status user interface 7032 includes a subset of status information that is included in the status information 7058.

In some embodiments, the system function menu 7043 includes a volume indicator 7054 (e.g., which optionally allows the user 7002 to adjust a current volume level for the computer system 101). The system function menu 7043 also includes a close affordance 7056 (e.g., which, when activated, causes the computer system 101 to cease to display the system function menu 7043).

In some embodiments, the indication 7074 of the system function menu 7043 and/or the system function menu 7043 is also accessible when the computer system 101 determines that data is stored for the hands of the current user (e.g., the computer system 101 determines that data is stored for the hand 7020 and/or the hand 7022 of the user 7002; and/or the computer system 101 determines that the hand 7020 and/or the hand 7022 are enrolled for the computer system 101). In some embodiments, if data is stored for the hand 7020 and/or the hand 7022, the user 7002 enables and/or configures (e.g., manually enables and/or manually configures) the computer system to allow access to the system function menu 7043. In some embodiments, if the computer system 101 determines that data is stored for the hands of the current user, the computer system 101 disables access to the system function menu 7043 via the indication 7074 of the system function menu 7043, and/or does not display the indication 7074 of the system function menu, by default. The user 7002 can override this default by manually enabling access to the system function menu 7043 (e.g., and/or enabling display of the indication 7047 of the system function menu 7043), for example, via a settings user interface of the computer system 101.

FIG. 7K follows from FIG. 7H. While the status user interface 7032 is displayed (e.g., as shown in FIG. 7H), the computer system 101 detects an air pinch gesture performed by the hand 7022 of the user 7002. The attention 7010 of the user 7002 remains directed toward the hand 7022′.

In response to detecting the air pinch gesture performed by the hand 7022 in FIG. 7K, the computer system 101 displays a system function menu 7044 as shown in FIG. 7L. In some embodiments, the system function menu 7044 is the same as the system function menu 7043 (e.g., both the system function menu 7043 and the system function menu 7044 include the same set of affordances shown in FIG. 7J3, or the same set of affordances shown in FIG. 7L). In some embodiments, the system function menu 7044 is different than the system function menu 7043 (e.g., the system function menu 7044 includes at least one affordance that is not included in the system function menu 7043, and/or the system function menu includes at least one affordance that is not included in the system function menu 7044).

For example, the system function menu 7043 in FIG. 7J3 includes the affordance 7041, and does not include an affordance 7050 (e.g., for displaying a virtual display for a connected device (e.g., an external computer system such as a laptop or desktop)). In contrast, the system function menu 7044 in FIG. 7L includes the affordance 7050, but does not include the affordance 7041.

In some embodiments, the virtual display for the connected device mirrors one or more actual displays of the connected device (e.g., the virtual display includes a desktop or other user interface that mirrors a desktop or user interface that is normally accessed and/or interacted with via the connected device). In some embodiments, the user 7002 can interact with the virtual display via the computer system 101, and these interactions are reflected in a state of the connected device. For example, the virtual display is a desktop, and the user 7002 opens one or more application user interfaces via the virtual display (e.g., a virtual desktop). The computer system 101 transmits information corresponding to this user interface to the connected device, and the connected device opens the corresponding application user interface(s) for the connected device (e.g., such that if the user 7002 switched from using and/or interacting with the computer system 101, to interacting with the connected device, the connected device would automatically display one or more application user interfaces (e.g., corresponding to the one or more application user interface opened via the virtual display)).

In some embodiments, while the user interface 7028-b is displayed (e.g., and/or while the user interface and/or the user interface 7028-c are displayed), the computer system 101 enables access to the system function menu 7044 as described above, but user interface with the affordance 7046, the affordance 7048, the affordance 7050, the affordance 7052, and/or the volume indicator 7054 are not enabled for user interaction (e.g., cannot be activated or selected by the user 7002, even if the attention 7010 of the user 7002 is directed toward a respective affordance or volume indicator while the user 7002 performs a user input). In some embodiments, the affordance 7046, the affordance 7048, the affordance 7050, the affordance 7052, and/or the volume indicator 7054 are enabled for user interaction if (e.g., and/or after) the computer system 101 is not displaying (e.g., or ceases to display) the user interface 7028-a, the user interface 7028-b, or the user interface 7028-c)

FIG. 7M shows that, while the computer system 101 is displaying the system function menu 7044, the user 7002 can interact with (e.g., activate) the affordances in the system function menu 7044. In some embodiments, the computer system 101 performs a respective function in response to detecting that the attention of the user 7002 is directed toward a respective affordance of the system function menu 7044 and optionally additional input.

For example, the user 7002 can activate the affordance 7046 by directing the attention 7010 of the user 7002 (e.g., based on gaze or a proxy for gaze) to the affordance 7046 and performing a selection input (e.g., an air pinch gesture, as shown by the hand 7022′ in FIG. 7M). Similarly, the user 7002 can activate the affordance 7048 (e.g., by directing an attention 7011 of the user 7002 to the affordance 7048, and performing the selection input), the affordance 7050 (e.g., by directing an attention 7013 of the user 7002 to the affordance 7050, and performing the selection input), or the affordance 7052 (e.g., by directing an attention 7015 of the user 7002 (e.g., based on gaze or a proxy for gaze) to the affordance 7052, and performing the selection input).

FIG. 7N shows that, in response to detecting the selection input while the attention of the user 7002 is directed toward the affordance 7046, the computer system 101 performs a function corresponding to the affordance 7046. For example, the affordance 7046 is an affordance for accessing one or more settings or additional system functions of the computer system 101. The function corresponding to the affordance 7046 is displaying a system space 7060 (e.g., a settings user interface).

In some embodiments, the system space 7060 includes one or more affordances, such as sliders, buttons, dials, toggles, and/or other controls, for adjusting system settings and/or additional system functions (e.g., additional system functions that do not appear in system function menu 7044 of FIG. 7M) of the computer system 101. In some embodiments, the system space 7060 includes an affordance 7062 for transitioning the computer system 101 to an airplane mode, an affordance 7064 for enabling or disabling a cellular function of the computer system 101, an affordance 7066 for enabling or disabling wireless network connectivity of the computer system 101, and/or an affordance 7068 for enabling or disabling other connectivity functions (e.g., Bluetooth connectivity) of the computer system 101. In some embodiments, the system space 7060 includes a slider 7072 for adjusting a volume level for the computer system 101.

In some embodiments, the system space 7060 includes one or more affordances for accessing additional functions of the computer system 101, and the one or more affordances for accessing the additional functions are optionally user configurable (e.g., the user 7002 can add and/or remove affordances, for accessing the additional functions, from the system space 7060). For example, in FIG. 7N, the system space 7060 includes an affordance 7074 (e.g., for activating one or more modes of the computer system 101, which modify notification delivery settings), an affordance 7076 (e.g., for initiating a screen-sharing or similar functionality, with a connected device), an affordance 7078 (e.g., for accessing a timer, clock, and/or stopwatch function of the computer system 101), and an affordance 7080 (e.g., for accessing a calculator function of the computer system 101).

In some embodiments, one or more of the affordances of the system space 7060 correspond to settings and/or system functions that are also accessible and/or adjustable via means other than the system space 7060. For example, as described in further detail below with reference to FIGS. 8A-8N, the user 7002 can adjust the current volume level for the computer system 101 without needing to navigate to and/or display the system space 7060.

In contrast to FIG. 7K and FIG. 7M, FIGS. 70-7P show example scenarios where the computer system 101 does not perform functions in response to detecting an air pinch gesture performed by the user 7002. In the following descriptions (with reference to FIGS. 70 and 7P), the computer system 101 is described as not performing a function in response to detecting an air pinch gesture. This is meant to describe situations in which the air pinch gesture is meant to but fails to trigger performance of a system operation (e.g., rather than being meant to interact with a displayed user interface, user interface object, or other user interface element, as described below with reference to FIGS. 7X-7Z, where the computer system 101 may perform a function specific to a user interface, user interface object, or user interface element, in response to detecting an air pinch gesture).

In FIG. 7O, for example, the user 7002 performs an air pinch gesture while the status user interface 7032 is not displayed. In some embodiments, the status user interface 7032 is not displayed because criteria to display the status user interface are not met (e.g., as in example 7038 of FIG. 7J1, where the attention 7010 of the user 7002 is directed toward the hand 7022′ while the hand is in the “palm down” orientation, but a hand flip was not performed while the attention 7010 of the user was directed toward the hand 7022′, or in some embodiments prior to (e.g., or within a threshold amount of time since) the attention 7010 of the user 7002 being directed toward the hand 7022′. In some embodiments, the computer system 101 displays the status user interface 7032 only if the attention 7010 of the user 7002 is directed toward the hand 7022′ within a threshold time (e.g., 0.1 seconds, 0.2 seconds, 0.5 seconds, 1 second, 2 seconds, or 5 seconds) of the computer system 101 detecting the hand flip gesture. In some embodiments, the computer system 101 displays the status user interface 7032 if (e.g., optionally, only if) the attention 7010 of the user 7002 remains directed toward the hand 7022′ while the hand flip occurs. In some embodiments, the computer system 101 does not display the status user interface 7032 if the attention 7010 of the user 7002 is not directed toward the hand 7022′ within the threshold time.

FIG. 7O shows various examples where the computer system 101 does not perform a function (e.g., display the system space 7060, shown in FIG. 7N) in response to detecting the air pinch gesture performed by the hand 7022′ of the user 7002.

In one example, the attention 7010 of the user is directed toward the hand 7022′ while the user 7002 performs the air pinch gesture with the hand 7022′. If, however, the air pinch gesture is not performed within a threshold amount of time (e.g., 0.1 seconds, 0.2 seconds, 0.5 seconds, 1 second, 2 seconds, or 5 seconds) from the time at which a hand flip was detected, the computer system 101 does not perform a function in response to detecting the air pinch gesture (e.g., even though the attention 7010 of the user 7002 is directed toward the hand 7022′, and even if the status user interface 7032 is displayed at the time the air pinch gesture is detected). Stated differently, in this example, the air pinch gesture was not detected as following a hand flip (e.g., the air pinch gesture was not detected within a threshold amount of time of detecting a hand flip), so the computer system 101 does not perform a function in response to detecting the air pinch gesture.

In a second example, the attention 7010 of the user 7002 is not directed toward the hand 7022′ of the user 7002, and although the air pinch gesture was detected within a threshold amount of time since a hand flip was detected (e.g., in contrast to the first example), the attention 7010 of the user 7002 was not directed toward the hand 7022′ during the hand flip (e.g., or the attention 7010 of the user 7002 moves away from the hand 7022′ at some point during the hand flip). Since the attention 7010 of the user was not directed toward the hand 7022′ throughout the hand flip, the status user interface 7032 is not displayed. Since the status user interface 7032 is not displayed at the time the computer system 101 detects the air pinch gesture, the computer system 101 does not perform a function in response to detecting the air pinch gesture.

In a third example, the attention 7010 of the user is not directed toward the hand 7022′ of the user 7002, and although the air pinch gesture was detected within a threshold amount of time since a hand flip was detected, the attention 7010 of the user 7002 has moved away from the hand 7022′ after the hand flip (e.g., but before the air pinch gesture). In response to detecting that the attention 7010 of the user is not directed toward the hand 7022′, the computer system 101 ceases to display the status user interface 7032 (e.g., that was displayed after the hand flip, and while the attention 7010 of the user 7002 was directed toward the hand 7022′). Since the status user interface 7032 is no longer displayed at the time the computer system 101 detects the air pinch gesture, the computer system 101 does not perform a function in response to detecting the air pinch gesture.

FIG. 7P shows additional examples where the computer system 101 does not perform a function (e.g., a system function, such as displaying the system space 7060, as shown in FIG. 7N), in response to detecting an air pinch gesture performed by the user 7002. Example 7084 represents the first example described above with reference to FIG. 7O. Example 7088 represents the second and/or third examples described above with reference to FIG. 7O. Example 7086 is analogous to the example 7084, but with the hand 7022′ in the “palm up” orientation when the air pinch gesture is detected, as opposed to the “palm down” orientation shown in example 7084 (e.g., and stage 7154-6 in FIG. 7AO). Example 7090 is analogous to the example 7088, but again with the hand 7022 in the “palm up” orientation when performing the air pinch gesture (e.g., as opposed to the “palm down” orientation shown in example 7084 and in FIG. 7AO). In both example 7086 and example 7090, the system space 7060 is not displayed in response to detecting the air pinch gesture, because the hand 7022 is not in the required orientation, and thus the status user interface 7032 is not displayed, at the time the air pinch gesture is performed. Example 7090 also illustrates scenarios in which, even if the attention 7010 had been directed to the hand 7022′ such that the control 7030 were displayed, the control 7030 is no longer displayed because the attention 7010 in example 7090 has moved away from the hand 7022′, and thus the computer system 101 forgoes displaying the home menu user interface 7031 in response to detecting the air pinch gesture.

Example 7092 illustrates the second example described above with reference to FIG. 7O in more detail, and shows an air pinch gesture following a hand flip gesture. During the first two illustrated steps of the hand flip gesture, the attention 7010 of the user 7002 is directed toward the hand 7022′. In the third illustrated step of the hand flip gesture, however, the attention 7010 of the user 7002 moves away from the hand 7022′ (e.g., and so as previously described above, the computer system 101 would not display the status user interface 7032). In the fourth illustrated step (e.g., the air pinch gesture), because the status user interface 7032 is not displayed (e.g., because the attention 7010 of the user 7002 moved away from the hand 7022′ during the hand flip), the computer system 101 does not perform a function in response to detecting the air pinch gesture.

Example 7094 shows an air pinch gesture performed with the hand 7022′ in the “palm up” orientation, but while the user interface 7028-a is displayed. In contrast to FIG. 7K and FIG. 7L, where while the user interface 7028-b is displayed, the computer system 101 performs a function (e.g., display the system function menu 7044 in FIG. 7L) in response to detecting an air pinch gesture with the hand in the “palm down” configuration, in example 7094, while the user interface 7028-a is displayed, the computer system 101 does not perform a function in response to detecting an air pinch gesture with the hand in the “palm up” configuration. Stated another way, if the user 7002 were to perform an air pinch gesture while the user interface 7028-a is displayed, even if the air pinch gesture is performed while the user 7002 is directing their attention toward the palm of the hand 7022′ (e.g., and even if the control 7030 is displayed in response, in contrast to the examples described with reference to FIG. 7G in which the user 7002 directing their attention 7010 toward the palm of the hand 7022′ while the user interface 7028-a is displayed does not result in display of the control 7030), the computer system 101 does not perform a function (e.g., a system operation, such as displaying a home menu user interface 7031 as described with reference to FIG. 7AK, or other system operation).

FIGS. 7Q1-7BE show example user interfaces of the computer system 101, while the user interface 7028-a, the user interface 7028-b, and the user interface 7028-c are not displayed (e.g., after the computer system 101 ceases to display the user interface 7028-a, the user interface 7028-b, and/or the user interface 7028-c, during normal operation of the computer system 101 outside of the initial setup and/or configuration process).

FIG. 7Q1 is similar to FIG. 7G, but the user interface 7028-a is not displayed in FIG. 7Q1. In response to detecting that the attention 7010 of the user 7002 is directed toward the hand 7022′, while the hand 7022′ is in the “palm up” orientation, and that display criteria are met, the computer system 101 displays the control 7030. Various display criteria (e.g., or more specifically, control display criteria) are described below with reference to, for example, FIGS. 7X-7Z, 7AB-7AF, 7AJ, and 7AU-7AW.

In some embodiments, the control 7030 has a three-dimensional appearance (e.g., has a visible length, width, and height). In some embodiments, the control 7030 has an appearance that includes characteristics that mimic light, for example, by simulating reflection and/or refraction of light (e.g., from any simulated light sources, and/or based on simulated lighting to mirror detected physical light sources within range of sensors of the computer system 101). For example, the control 7030 may have glassy edges that refract and/or reflect simulated light. In some embodiments, the control 7030 is a simulated three-dimensional object having a non-zero height, non-zero width, and non-zero depth.

In some embodiments, the control 7030 is displayed at a position within a gap having a threshold size gₜₕ between the index finger and the thumb of the hand 7022′ from the viewport of the user 7002. The size of the gap is optionally the lateral distance from the middle joint of the index finger (or a different portion of the index finger) to the top of the thumb (or a different portion of the thumb). In some embodiments, gₜₕ is at least 0.5 cm, 1.0 cm, 1.5 cm, 2.0 cm, 2.5 cm, 3.0 cm, or other distances from the viewpoint of the user. The control 7030 is also offset by a threshold distance oₜₕ from a midline 7096 of the hand 7022′ (e.g., a midline of the palm of the hand 7022′, optionally intersecting a center of the palm 7025 of the hand 7022). In some embodiments, the control 7030 is displayed with a spatial relationship (e.g., a fixed spatial relationship) to the hand 7022′. If the hand 7022′ moves, the computer system 101 displays the control at a position (e.g., a new position and/or an updated position) that maintains the spatial relationship of the control 7030 to the hand 7022′ (e.g., including maintaining display of the control 7030 during movement of the hand 7022′, fading out the control 7030 at the start of the movement and fading in the control 7030 when movement terminates, and/or other display effects).

In some embodiments, the computer system 101 includes one or more audio output devices that are in communication with the computer system (e.g., one or more speakers that are integrated into the computer system 101 and/or one or more separate headphones, earbuds or other separate audio output devices that are connected to the computer system 101 with a wired or wireless connection), and the computer system 101 generates audio 7103-a (e.g., a music clip, one or more tones at one or more frequencies, and/or other types of audio), concurrently with displaying the control 7030 (e.g., to provide audio feedback that the control 7030 is displayed).

FIG. 7Q2 shows four example transitions from FIG. 7Q1, optionally after the control 7030 is displayed in the viewport of FIG. 7Q1 for a threshold amount of time (e.g., 50-500 ms after the control 7030 is displayed) without changes of more than a threshold distance (e.g., less than 1 mm) in the position of the control 7030 (e.g., the control 7030 is stationary for at least the threshold amount of time). A first scenario 7198-1 shows leftward and upward movement of the hand 7022′ from an original position demarcated with an outline 7176 (e.g., the position of the hand 7022′ illustrated in FIG. 7Q1) to a new position. A dotted circle 7178 denotes a location the control 7030 would be displayed in response to the movement of the hand 7022′ in order to maintain the same spatial relationship between the control 7030 and the hand 7022′ as in FIG. 7Q1, for the hand 7022′ at the new position.

To reduce inadvertent changes to the position of the control 7030 (e.g., due to noise or other measurement artifact, or when a movement of or position of the hand 7022 may not be accurately determined due to, for example, low light conditions or other factors), the computer system 101 maintains a zone 7186 around the control 7030 within which no changes in a position of the control 7030 is displayed (e.g., the control 7030 remains displayed at a center of the zone 7186). As a result, even though the hand 7022′ has moved by the amount represented by the arrow 7200, the computer system 101 does not change a display location of the control 7030. By maintaining display of the control 7030 (e.g., at the center of the zone 7186), the computer system 101 suppresses noise from changes in a position of the hand 7022′ (e.g., within the threshold distance) that may be due to detection artifacts caused by environmental factors (e.g., low light conditions, or due to other factors).

In some embodiments, movement of the hand 7022 is detected based on a movement of a portion of the hand (e.g., a knuckle joint, such as an index knuckle or a corresponding location thereof) as indicated by the location of the arrow 7200. The portion of the hand may be a portion of the hand that is sufficiently visible (e.g., most visible) to and/or recognizable by one or more sensors (e.g., one or more cameras, and/or other sensing devices) of the computer system 101. A size of the arrow 7200 indicates a magnitude of a change between the original position of the hand 7022′ (e.g., shown by outline 7176) and a current position of the hand 7022 (e.g., displayed as the hand 7022′), as measured from the portion of the hand 7022 of the user (e.g., a knuckle joint). An orientation of the arrow 7200 indicates a direction of movement of the hand 7022′. In some embodiments, the zone 7186 is a three-dimensional zone (e.g., a sphere having a planar/circular cross section as depicted in FIG. 7Q2, and/or other three-dimensional shapes) and accounts for movement of the hand 7022 along three dimensions (e.g., three orthogonal dimensions).

In some embodiments, the zone 7186 has size (e.g., 2, 5, 7, 10, 15 mm, or another size), and the threshold amount of movement (e.g., along one or more of three orthogonal directions) to trigger movement of the control 7030 may match the size of the zone 7186 (e.g., 2, 5, 7, 10, 15 mm, or another threshold amount of movement), if there is a one-to-one mapping between movement of the hand 7022′ and the derived amount of movement of the control 7030 within the zone 7186. In some embodiments, a different scaling factor may be implemented (e.g., the hand 7022′ having to move by a larger or smaller amount to effect a corresponding change in position of the dotted circle 7178).

In some embodiments, the threshold amount of movement to trigger movement of the control 7030 may depend on a rate or frequency of movement oscillation of the hand 7022′. For example, for fast movements in the hand 7022′ (e.g., due to the user 7002 having unsteady hands, or other reasons), the computer system 101 may set a larger threshold amount of movement before a display location of the control 7030 is updated.

A second scenario 7198-2 shows rightward movement of the hand 7022′ from the original position demarcated with the outline 7176 to a new position. A dotted circle 7180 denotes a location the control 7030 would be displayed in response to the rightward movement of the hand 7022′ in order to maintain the same spatial relationship between the control 7030 and the hand 7022′ as in FIG. 7Q1. Due to the dotted circle 7180 being within the zone 7186, the computer system 101 maintains display of the control 7030 at the center of the zone 7186, without adjusting the display of the control 7030 based on the movement of the hand 7022′ represented by the arrow 7200. A third scenario 7198-3 shows rightward and downward movement of the hand 7022′ from the original position demarcated with the outline 7176 to a new position. A dotted circle 7182 denotes a location the control 7030 would be displayed in response to the rightward and downward movement of the hand 7022′ in order to maintain the same spatial relationship between the control 7030 and the hand 7022′ as in FIG. 7Q1. Due to the dotted circle 7182 being within the zone 7186, the computer system 101 maintains display of the control 7030 at the center of the zone 7186, without adjusting the display location of the control 7030 based on the movement of the hand 7022′ represented by the arrow 7200.

A fourth scenario 7198-4 shows leftward movement of the hand 7022′ from the original position demarcated with the outline 7176 to a new position. A dotted circle 7184 denotes the original location of the control 7030 (e.g., the original location as displayed in the viewport of FIG. 7Q1). Due to the movement of the hand 7022′ as represented by the arrow 7200 meeting a movement threshold (e.g., which would result in the control 7030, if displayed so as to maintain the same spatial relationship between the control 7030 and the hand 7022′ as in FIG. 7Q1, being at least partially outside of the zone 7186), the computer system 101 updates the display location of the control 7030 to maintain the same spatial relationship between the control 7030 and the hand 7022′ as in FIG. 7Q1 at the new location of the hand 7022′ depicted in the fourth scenario 7198-4 (e.g., and repositions the zone 7186 relative to the new display location of the control 7030).

In some embodiments, the computer system 101 continuously updates the position of the control 7030 once the updated position of the control 7030 has moved outside of the original zone 7186 (e.g., after maintaining the control 7030 at the center of the original zone 7186, depicted in the first through third scenarios 7198-1 to 7198-3, prior to the updated position of control 7030 moving outside of the original zone 7186) until movement of the hand 7022 is terminated. In some embodiments, the computer system 101 fades out the control 7030 at the center of the original zone 7186 once the updated position of control 7030 has moved outside of the original zone 7186, and the computer system 101 fades in the control 7030 at an updated location when the movement of the hand 7022 is terminated (e.g., as described herein with reference to FIG. 7T).

Due to the movement of the control 7030 in response to the movement of the hand 7022′ (e.g., depicted by the arrow 7200) meeting a respective threshold (e.g., distance, speed, and/or acceleration thresholds), a size of the zone 7186 is reduced in the fourth scenario 7198-4, with respect to the zone 7186 depicted in the first through third scenarios 7198-1 to 7198-3. For example, the distance threshold of the hand 7022′ may be greater than 5 mm, 7 mm, 8 mm, 10 mm, or a different distance threshold. For example, the speed threshold of the hand 7022′ may be greater than 0.05 m/s, greater than 0.1 m/s, greater than 0.15 m/s, greater than 0.25 m/s or a different speed threshold. In some embodiments, a center of the zone 7186 where the control 7030 is displayed moves with the movement of the knuckle based on a scaling factor (e.g., a one-to-one scaling, or a scaling factor of a different magnitude).

Shrinking one or more dimensions of the zone 7186 allows the control 7030 to be more sensitive or responsive to directional changes of the hand 7022′, once movement of the hand 7022′ meets a respective threshold. Further, once the control 7030 has started moving from its original position, the user 7002 may be less sensitive to noise in a detected position of the hand 7022′, due to a larger movement amount or a speed of movement of the hand 7022′. In some embodiments, filtering is further applied (e.g., removing high frequency movements of the hand 7022, that is above 2 Hz, 4 Hz, 5 Hz, or another frequency) on top of the detected movement of the hand 7022 to smooth out the display of the hand 7022′.

In some embodiments, the reduction in the size of the zone 7186 includes a sequence of zones 7186 having shrinking radii (or another dimension), and is not a single jump from the radius depicted in the first scenario 7198-1 to the radius depicted in the fourth scenario 7198-4. In some embodiments, the zone 7186 expands (e.g., going from the zone 7186 depicted in the fourth scenario 7198-4 to the zone 7186 depicted in the third scenario 7198-3) when a movement of the hand 7022′ has been below a threshold speed for a threshold period of time, and/or the hand 7022′ stops moving (e.g., less than 0.1 m/s of movement for 500 ms, less than 0.075 m/s of movement for 200 ms, or less than a different speed threshold and/or a time threshold).

In some embodiments, the dynamic change in the size of the zone 7186 and the filtering of higher frequency (e.g., 4 Hz or greater) oscillations in the detected position or movement of the hand 7022 are enabled by default, not only when the computer system 101 is in a low light environment. As a result, the control 7030 may be locked in place until the hand 7022 of the user 7002 meets a movement, speed, and/or acceleration threshold, and/or the control 7030 may be locked in place when the computer system 101 determines that there is a high level of noise in the physical environment 7000.

In some embodiments, the control 7030 is placed between a tip of an index finger of a thumb of the hand 7022′ (e.g., as described with reference to FIG. 7Q1), and the placement of the control 7030 is further based on a location of a knuckle of the hand 7022′ (e.g., for less than a threshold amount of movement of the hand 7022′ as in FIGS. 7Q1-7Q2, and/or for more than the threshold amount of movement of the hand 7022′ as in FIGS. 7R1-7R2). Further, as described with reference to FIGS. 7V-7U, the control 7030 and the status user interface have different sizes. As a result, the computer system 101 displays the control 7030 and the status user interface 7032 at different default positions with respect to the hand 7022′. For example, the computer system 101 may compute a hand space orientation of the hand 7022′ based on three orthogonal axes located at the knuckle of the hand 7022′ (e.g., x, y, and z axes oriented at the knuckle) and place the control 7030 and the status user interface 7032 at respective offset locations (e.g., based on an offset distance and/or an offset direction) relative to the index knuckle.

In some embodiments, the control 7030 and/or the status user interface 7032 are placed with an offset along a direction from the knuckle (e.g., index knuckle) based on a location of the wrist of the hand 7022′ (e.g., the wrist and the index knuckle defines a spatial vector, and the offset position of the control 7030 and/or the status user interface 7032 is determined relative to the spatial vector).

In some embodiments, the control 7030 is placed at a first offset distance from the knuckle, and the status user interface 7032 is placed at a second offset distance, different from the first offset distance, from the knuckle. As described with reference to FIG. 7AO, the computer system 101 replaces a display of the control 7030 with a display of the status user interface 7032 based on an orientation of the hand 7022′. In some embodiments, as the hand 7022′ changes an orientation (e.g., from “palm up” to “palm down”, or “flips”), the displayed user interface (e.g., the control 7030 or the status user interface 7032) is moved through a smooth set of positions, via interpolation (e.g., linear interpolation) between the “palm up” position and the “palm down” position.

In some embodiments, the threshold amount of movement required to move the control 7030 outside of its original zone 7186 is measured relative to an environment-locked point (e.g., a center of a circle or sphere, or another plane or volume within the physical environment 7000, selected when the hand 7022′ remains stationary beyond a threshold period of time).

In some embodiments, the offset is further scaled relative to a length of a finger (e.g., the index finger, a sum of the length of the three phalanges from the knuckle joint (e.g., knuckle to proximal joint, proximal joint to distal joint, and/or a different digit) of the hand 7022′ such that users having longer fingers will have the control 7030 and/or the status user interface 7032 be displayed with more offset from the hand 7022′ (e.g., knuckle, a fingertip, or a different part of the hand 7022′), and may result in the placement of the control 7030 and/or the status user interface 7032 at a more suitable (e.g., natural) position across the population size.

As described herein, an air pinch gesture involves the hand 7022 performing a sequence of movement of one or more fingers of the hand 7022. In some embodiments, a knuckle of a finger (e.g., the index finger) of the hand 7022 moves away from a contact point between the thumb and the finger during a pinch down phase of the air pinch gesture (e.g., while the control 7030 is displayed in the viewport in order to invoke the home menu user interface 7031, as described with reference to FIGS. 7AK). As a result, a position of the control 7030 may change in a different manner (e.g., opposite, and/or the control 7030 is displayed as popping up or moving towards the viewpoint of the user 7002 instead of being pressed down as a result of the down pinch phase in the air pinch gesture) than would be expected from the performance of the air pinch gesture, if the movement of the hand 7022 meets the threshold (e.g., distance, speed, acceleration, and/or other criteria) described above. In some embodiments, the computer system 101 detects and/or tracks the three-dimensional movement of the index knuckle (e.g., along three-orthogonal axes) and cancels the unintended movement of the knuckle to at least partially reverse a change in the position of the control 7030 (e.g., optionally suppressing any movement of the control 7030) during the pinch down phase of the air pinch gesture.

In some embodiments, once the air pinch gesture is performed (e.g., while contact between the thumb and the index finger is maintained) or after an incomplete air pinch gesture has ended (e.g., without contact having been made between the thumb and the index finger), in response to detecting movement of the hand 7022 of the user that meets the threshold (e.g., distance, speed, acceleration, and/or other criteria) as described above, computer system 101 updates a display location of the control 7030, by moving the control 7030 that is positioned at a center of the zone 7186, optionally with the zone 7186 having a reduced size (e.g., analogous to the fourth scenario 7198-4) based on the movement of the hand 7022′.

In some embodiments, while the control 7030 is displayed in the viewport, in response to detecting a release of the completed air pinch gesture, the computer system 101 ceases display of the control 7030 and displays the home menu user interface 7031 at a position in the three-dimensional environment that is not locked to a position of the hand 7022′, as described with reference to FIGS. 7AK and FIGS. 9A-9P (or analogously FIG. 7AL with respect to a press and release of a button on a controller). In some embodiments, while the control 7030 is displayed in the viewport, in response to detecting the air pinch gesture or button press being held for a threshold period of time, the computer system 101 ceases display of the control 7030 and displays a volume indicator 8004 that is environment-locked (e.g., not hand locked, before the volume level of the computer system 100 is adjusted down to a minimum value, and/or adjusted up to a maximum value) in the viewport as described with reference to FIGS. 8G-8I.

FIG. 7Q3 shows hand 7022′ holding a handheld controller 7111′ (e.g., a representation of a physical controller 7111 held in hand 7022 in the physical environment 7000). In FIG. 7Q3, because the attention 7010 of the user 7002 is directed toward the hand 7022′ while the hand 7022 is in the “palm up” orientation (e.g., with the palm 7025′ of the hand 7022′ facing the viewpoint of the user) and the display criteria are met, the control 7030 is displayed. The controller 7111 includes one or more input elements, such as the examples illustrated in FIG. 7Q3 as button 7117, button 7115, and button 7113 (e.g., representations of physical buttons on the controller 7111), for providing inputs to computer system 101 (e.g., selection inputs, commands, navigation inputs, inputs to applications, and/or other inputs).

FIG. 7Q3 illustrates that the control 7030 is displayed at a different location relative to (e.g., with a different spatial relationship to) the hand 7022′ while the hand 7022 is holding the controller 7111 than while the hand 7022 is not holding the controller 7111. For example, the location at which the control 7030 is displayed in FIG. 7Q3, relative to the hand 7022′ holding the controller 7111′, is different from the location, indicated by the dashed outline in FIG. 7Q3, at which the control 7030 is displayed relative to the hand 7022′ when the hand 7022′ is not holding the controller 7111′ as in FIG. 7Q1 (e.g., the control 7030 in FIG. 7Q3 is offset by a different threshold distance pₜₕ, rather than oₜₕ as in FIG. 7Q1, from a midline 7096 of the hand 7022′). More generally, in some embodiments the control 7030 is displayed at a first location relative to (e.g., with a first spatial relationship to) hand 7022′ if hand 7022 is not holding or manipulating a controller, whereas control 7030 is displayed at a second location relative to (e.g., with a second spatial relationship to) hand 7022′ if hand 7022 is holding a controller. In some embodiments, the behavior of the control 7030 in response to the movement of the hand 7022 described herein with reference to FIG. 7Q2 apply analogously to the hand 7022 while holding a controller as in FIG. 7Q3. In some embodiments, the size of the zone 7186 within which no changes in the position of the control 7030 is displayed is different (e.g., larger or smaller) when the hand 7022 is holding a controller than when the hand 7022 is not holding a controller (e.g., to account for differences in accuracy of determining the movement of or position of the hand 7022 when holding a controller than when not holding a controller).

FIG. 7Q4 shows movement of the hand 7022′ holding the controller 7111′ from the prior location of the hand 7022′ with the controller 7111′ as shown in FIG. 7Q3 (e.g., shown as dashed outlines in FIG. 7Q4) to a new location as shown in FIG. 7Q4. While the hand 7022′ is at the new hand location and holding the controller 7111′ at the new controller location as shown in FIG. 7Q4, the control 7030 is displayed at a new location that is different from the location, indicated by the dashed control outline in FIG. 7Q4, at which the control 7030 was displayed relative to the hand 7022′ in FIG. 7Q3. In some embodiments, while the hand 7022′ and the controller 7111′ are being moved relative to the three-dimensional environment, the computer system moves the control 7030 (e.g., through a plurality of intermediate locations) based on the direction and magnitude of the movement of the controller 7111. In some embodiments, the location of the control 7030 is based on (e.g., maintains a consistent spatial relationship with or is otherwise determined relative to) the location of a respective portion of the controller 7111, such as a button, joystick, sensor, housing, or other component or portion.

FIG. 7R1 shows movement of the hand 7022′ from an old position (e.g., the position of the hand 7022′ in FIG. 7Q1, shown as an outline 7098 in FIG. 7R1) to a new position (e.g., the position shown in FIG. 7R1), with a velocity v_{A}. The control 7030 also moves by a proportional amount (e.g., to maintain the same spatial relationship between the control 7030 and the hand 7022′ as in FIG. 7Q1). In some embodiments, while the hand 7022′ is moving with a velocity (e.g., the velocity v_{A}) that is below a threshold velocity vₜₕ₁ (e.g., as shown via the hand speed meter 7102 in FIG. 7R1, the velocity v_{A} is below the threshold velocity vₜₕ₁), the control 7030 is displayed with the same appearance (e.g., the same appearance as the control 7030 in FIG. 7Q1, when the hand 7022′ is not moving). In some embodiments, the threshold velocity vₜₕ₁ threshold is less than 15 cm/s, less than 10 cm/s, less than 8 cm/s or other speeds. As described herein, the appearance of the control 7030 in FIG. 7Q1 and FIG. 7R1 is sometimes referred to as a “normal” or “default” appearance of the control 7030. In some embodiments, the attention 7010 may not be required to stay on the hand 7022′ during movement of the hand 7022′ for the computer system 101 to maintain display of control 7030 (e.g., along the trajectory from the old position to the new position) during movement of the hand 7022′. For example, such an approach may reduce a likelihood of the user 7002 experiencing motion sickness by not requiring the user 7002 to sustain the attention 7010 directed to the moving hand 7022′.

FIG. 7R2 shows four example transitions from FIG. 7R1 after the control 7030 displayed in the viewport of FIG. 7Q1 begins moving. As explained with respect to the fourth scenario 7198-4, the zone 7186 reduces in size (e.g., from 10 mm to 4 mm, such as from 7 mm to 2 mm, or between different size values) in all four example transitions (e.g., corresponding to first scenario 7202-1, second scenario 7202-2, third scenario 7202-3, and fourth scenario 7202-4) due to the hand 7022′ not being stationary (e.g., optionally having met a speed threshold described with reference to FIG. 7Q2). The first scenario 7202-1 shows leftward and upward movement of the hand 7022′ from an original position demarcated with an outline 7188 (e.g., the position of the hand 7022′ illustrated in FIG. 7R1) to a new position. A dotted circle 7190 denotes a location the control 7030 would be displayed in response to the movement of the hand 7022′ in order to maintain the same spatial relationship between the control 7030 and the hand 7022′ as in FIG. 7Q1, while the hand 7022′ is displayed at the new position. Due to the dotted circle 7190 being within the zone 7186 around the control 7030, even though the hand 7022′ has moved by the amount represented by the arrow 7200, the computer system 101 does not change a display location of the control 7030.

The second scenario 7202-2 shows rightward movement of the hand 7022′ from the original position demarcated with the outline 7188 to a new position. A dotted circle 7192 denotes a location the control 7030 would be displayed in response to the rightward movement of the hand 7022′ in order to maintain the same spatial relationship between the control 7030 and the hand 7022′ as in FIG. 7Q1. Due to the dotted circle 7192 being within the zone 7186, the computer system 101 maintains display of the control 7030 at the center of the zone 7186, without adjusting the display of the control 7030 based on the movement of the hand 7022′ represented by the arrow 7200. The third scenario 7202-3 shows rightward and downward movement of the hand 7022′ from the original position demarcated with the outline 7188 to a new position. A dotted circle 7194 denotes a location the control 7030 would be displayed in response to the rightward and downward movement of the hand 7022′ in order to maintain the same spatial relationship between the control 7030 and the hand 7022′ as in FIG. 7Q1. Due to the dotted circle 7194 being within the zone 7186, the computer system 101 maintains display of the control 7030 at the center of the zone 7186, without adjusting the display of the control 7030 based on the movement of the hand 7022′ represented by the arrow 7200. The fourth scenario 7202-4 shows leftward movement of the hand 7022′ from the original position demarcated with the outline 7188 to a new position. A dotted circle 7196 denotes the original location of the control 7030 (e.g., the location as displayed in the viewport of FIG. 7R1). Due to the movement of the hand 7022′ represented by the arrow 7200 meeting a movement threshold, the computer system 101 updates the display of the control 7030 to maintain the same spatial relationship between the control 7030 and the hand 7022′ as in FIG. 7Q1 while the hand 7022′ is positioned at the new location depicted in the fourth scenario 7202-4.

FIG. 7S shows movement of the hand 7022′ with a velocity v_{B}, which is greater than the velocity v_{A} shown in FIG. 7R1. When the velocity of the hand 7022′ (e.g., the velocity v_{B}) is above the threshold velocity vₜₕ₁, but below a threshold velocity vₜₕ₂ (e.g., as shown in the hand speed meter 7102, the velocity v_{B} is between the threshold velocity vₜₕ₁ and the threshold velocity vₜₕ₂), the computer system 101 displays the control 7030 with an appearance that has a reduced prominence (e.g., is visually deemphasized) relative to the default appearance of the control 7030 (e.g., as shown in FIG. 7Q1 and FIG. 7R1, making the control 7030 more translucent (e.g., reducing an opacity), fading out, increasing a degree of blurring, reducing a brightness, reducing a saturation, reducing an intensity, reducing a contrast, and/or other deemphasis). For example, the computer system 101 displays the control 7030 with a dimmed or faded appearance (e.g., as shown in FIG. 7S), with a smaller size, with a blurrier appearance, and/or with a different color, relative to the default appearance of the control 7030. In some embodiments, the threshold velocity vₜₕ₂ threshold is less than 25 cm/s, less than 20 cm/s, less than 15 cm/s or other speeds.

FIG. 7T shows movement of the hand 7022′ with a velocity v_{C}, which is greater than the velocity v_{A} and the velocity v_{B}. When the velocity of the hand 7022′ (e.g., the velocity v_{C}) is above the threshold velocity vₜₕ₂, (e.g., as shown in the hand speed meter 7102, the velocity v_{C} is above the threshold velocity vₜₕ₂), the computer system 101 ceases to display the control 7030. For example, if the user 7002 moves the hand 7022 over a large distance relatively quickly (e.g., moving the hand 7022 down to the user's lap), the control 7030 may either gradually fade away and/or cease to be displayed depending on the velocity of the hand 7022′. In some embodiments, after the computer system 101 ceases to display the control 7030 due to the velocity v_{C} of the hand 7022′ being above the threshold velocity vₜₕ₂, in response to detecting that the velocity of the hand 7022′ has dropped below the threshold velocity vₜₕ₂, the computer system 101 redisplays the control 7030 (e.g., as shown in FIG. 7S, if the velocity is below the threshold velocity vₜₕ₂ but above the threshold velocity vₜₕ₁, and/or as shown in FIG. 7R1, if the velocity is below the threshold velocity vₜₕ₁). Thus, in some embodiments, the user 7002 is enabled to reversibly transition between FIGS. 7R1-7T, in that, starting from the viewport shown in FIG. 7T in which the control 7030 is not displayed (e.g., due to the velocity of the hand 7022′ being above the threshold velocity vₜₕ₂), the user 7002 can reduce a movement speed of the hand 7022′ so that the computer system 101 displays (e.g., redisplays) the control 7030 (as shown in FIGS. 7R1 and/or 7S). Alternatively, in the transition from FIG. 7S to FIG. 7T, the computer system 101 updates a display location of the control 7030 prior to ceasing display of the control 7030.

In some embodiments, the velocities and velocity thresholds described above are velocities of the hand 7022′ (e.g., following the velocities of the hand 7022 in the physical environment 7000) measured relative to the computer system 101 (e.g., such that the computer system 101 maintains display of the control 7030 if both the hand 7022, and accordingly the hand 7022′, and the computer system 101 are moving concurrently, with substantially the same velocity, such as if the user 7002 is walking, and/or turning or rotating the entire body of the user 7002).

In some embodiments, the above descriptions (e.g., with reference to velocities and threshold velocities) are applied instead to acceleration (e.g., of the hand 7022 in the physical environment 7000, and accordingly of the hand 7022′ in the three-dimensional environment 7000′) and acceleration thresholds (e.g., over a preset time window). For example, the control 7030 is displayed with the appearance that has a reduced prominence relative to the default appearance of the control 7030, when the computer system 101 detects acceleration of the hand 7022′ above a first acceleration threshold; and the computer system 101 ceases to display the control 7030 when the computer system 101 detects acceleration of the hand 7022′ above a second acceleration threshold (e.g., that is greater than the first acceleration threshold). In some embodiments, the acceleration of the hand is a linear acceleration (e.g., angular acceleration is not used to determine whether to change the appearance of the control 7030 and/or cease display of the control 7030). This allows the computer system 101 to maintain display of the control 7030 when the user 7002 is walking or turning or rotating the entire body of the user 7002 at a substantially consistent speed.

In some embodiments, the changes in appearance of the control 7030 described above with reference to FIGS. 7Q1-7T are based on a movement distance (e.g., of the hand 7022 in the physical environment 7000, and accordingly of the hand 7022′ in the three-dimensional environment 7000′) and movement thresholds. For example, the control 7030 is displayed with the appearance that has a reduced prominence relative to the default appearance of the control 7030, when the computer system 101 detects that the hand 7022′ has moved beyond a first distance threshold; and the computer system 101 ceases to display the control 7030 when the computer system 101 detects that the hand 7022′ has moved beyond a second distance threshold (e.g., that is greater than the first distance threshold). In some embodiments, the distance is measured as an absolute value (e.g., independent of direction of hand movement). In some embodiments, the distance is measured as displacement from an initial location, on a per-direction basis (e.g., movement of the hand 7022′ in a first direction increases progress of the movement of the hand 7022′ towards meeting or exceeding the first distance threshold (e.g., in the first direction), whereas movement of the hand 7022′ in a second direction that is opposite the first direction decreases progress of the movement of the hand 7022′ towards meeting or exceeding the first distance threshold (e.g., and/or causes the movement of the hand 7022′ to no longer exceed the first distance threshold, if the initial movement of the hand 7022′ already exceeded the first distance threshold in the first direction). In some embodiments, the computer system 101 ceases to display the control 7030 when the computer system 101 detects that the hand 7022′ has moved beyond a respective distance threshold in one direction (e.g., left and/or right, with respect to the viewport illustrated in FIG. 7Q1, but not in depth toward or away from a viewpoint of the user 7002).

In some embodiments, the changes in appearance of the control 7030 described above with reference to FIGS. 7Q1-7T are also applicable to the status user interface 7032 (e.g., described above with reference to FIG. 7H and FIG. 7K) while displayed (e.g., the status user interface 7032 exhibits analogous behavior, when displayed while the attention 7010 of the user 7002 is directed toward the hand 7022′ and while the hand 7022′ is in the “palm down” orientation) and/or to the volume indicator 8004 (e.g., while the volume level is at a limit).

While FIGS. 7R1-7T illustrate different display characteristics of the control 7030 once the control 7030 is displayed in the viewport, the speed of the hand 7022′ is also taken into account in determining whether a user input that corresponds to a request for displaying the control 7030 (e.g., directing the attention 7010 to hand 7022′ while the hand 7022′ is in a “palm up” configuration) meets display criteria. For example, instead of only taking into account an instantaneous velocity of the hand 7022′ at the time the attention 7010 is directed toward the hand 7022′, the computer system 101 determines if the speed of the hand 7022′ (e.g., an average hand movement speed, or maximum hand movement speed) is below a speed threshold in a time period (e.g., 50-2000 milliseconds) preceding the detection of the attention 7010 of the user being directed toward the hand 7022′. The speed threshold is optionally less than 15 cm/s, 10 cm/s, 8 cm/s or other speeds. For example, if the hand movement speed is below the speed threshold during the requisite time period preceding the request to display the control 7030, the control 7030 is displayed in response to the attention 7010 being directed toward the hand 7022′. In some embodiments, if the hand movement speed is above the speed threshold or has not been below the speed threshold for at least the requisite duration, the control 7030 is not displayed. Taking into account the hand movement speed of the hand 7022′ in the display criteria may help to prevent accidental triggers of display of the control 7030 (e.g., the user 7002 may be moving the hand 7022′ to perform a different task, and the attention 7010 momentarily coincides with the hand 7022′).

FIG. 7U shows the hand 7020′ and the hand 7022′ of the user 7002 and a representation 7104′ of a portion of a keyboard 7104 (the representation 7104′ also sometimes referred herein as keyboard 7104′) being displayed in the viewport. In some embodiments, the keyboard 7104 is in communication with the computer system 101. Both palms of the hand 7020′ and the hand 7022′ are facing toward the viewpoint of the user 7002 (e.g., are in the “palm up” orientation) and neither of the hands (7020′ and 7022′) are interacting with the keyboard 7104′. FIG. 7U also illustrates the attention 7010 of the user 7002 being directed toward the hand 7022′ while the palm 7025′ of the hand 7022′ faces the viewpoint of the user 7002. Based on the palm 7025′ being oriented toward the viewpoint of the user 7002 when the attention 7010 of the user 7002 is detected as being directed toward the hand 7022′, and if display criteria are met (e.g., whether hand 7022 is in proximity to and/or interacting with a physical object in physical environment 7000, whether hand 7022′ is in proximity to and/or interacting with a selectable user interface object within the three-dimensional environment 7000′, and/or other criteria), computer system 101 displays the control 7030 corresponding to (e.g., with a spatial relationship to) the hand 7022′. Similarly, if the attention 7010 were directed toward the hand 7020′ while a palm of the hand 7020′ was in the “palm up” orientation, and the display criteria were met, the computer system 101 would display the control 7030 with a spatial relationship (e.g., a fixed spatial relationship, the same spatial relationship as between the control 7030 and the hand 7022′, a different spatial relationship from the spatial relationship between the control 7030 and the hand 7022′, or other spatial relationship) to the hand 7020′. In some embodiments, the computer system 101 generates audio 7103-a, concurrently with displaying the control 7030.

FIG. 7V illustrates an example transition from FIG. 7U. FIG. 7V shows the result of hand flip gestures (e.g., as described with reference to FIG. 7B (b) and FIG. 7AO) that change the orientations of the hand 7020′ and the hand 7022′ from the “palm up” orientation to the “palm down” orientation. Neither the hand 7020′ nor the hand 7022′ interacts with the keyboard 7104′ in FIG. 7V. FIG. 7V also illustrates the attention 7010 of the user 7002 being directed toward the hand 7022′ (e.g., the back of hand 7022′, the attention 7010 optionally staying on the hand 7022′ during the hand flip gesture) while the palm 7025′ of the hand 7022′ faces away from the viewpoint of the user 7002. Based on the attention 7010 of the user 7002 being directed (e.g., continuously) toward the hand 7022′ during the hand flip gesture, the computer system 101 transitions from displaying the control 7030 (e.g., as illustrated in FIG. 7U) to displaying the status user interface 7032 (e.g., ceases display of the control 7030 and instead displays the status user interface 7032). Optionally, the computer system 101 displays an animation of the control 7030 transitioning into the status user interface 7032 (e.g., by rotating the control 7030 as the hand 7022′ is rotated, and displaying the status user interface 7032 once the orientation of the hand 7022′ has changed sufficiently (e.g., stage 7154-4 in FIG. 7AO)). Similarly, if the control 7030 were displayed with a spatial relationship to the hand 7020′ and if the attention 7010 directed to the hand 7020′ were maintained during a hand flip gesture of the hand 7020′, the computer system 100 would similarly transition from displaying the control 7030 to displaying the status user interface 7032 (e.g., relative to hand 7020′ instead of hand 7022′). The computer system 101 may optionally generate audio (e.g., the same audio as or different audio from the audio generated when the control 7030 is displayed) along with displaying the status user interface 7032.

FIG. 7W illustrates the hand 7020′ and the hand 7022′ interacting with the keyboard 7104′ (e.g., FIG. 7W optionally illustrates an example transition from FIG. 7U or from FIG. 7V). FIG. 7W also illustrates the attention 7010 of the user 7002 being directed toward the hand 7022′ (e.g., the back of hand 7022′) while the palm 7025′ of the hand 7022′ faces away from the viewpoint of the user 7002. Due to the attention 7010 of the user 7002 being directed toward the hand 7022 that is not in the required configuration (e.g., has a “palm down” orientation), and because the hand 7022′ is interacting with a physical object (e.g., the keyboard 7104), the computer system 101 forgoes displaying the control 7030 (e.g., if FIG. 7W were a transition from FIG. 7U, the computer system 101 would cease to display the control 7030 of FIG. 7U, optionally without generating any audio output).

In some embodiments, the user 7002 is enabled to reversibly transition between FIG. 7U and FIG. 7W, in that, starting from the viewport shown in FIG. 7W in which the control 7030 is not displayed (e.g., due to the user 7002 interacting with the keyboard 7104 and the hand 7022 not being in the required configuration), the user 7002 can perform hand flip gestures that change the orientations of the hand 7020′ and the hand 7022′ from the “palm down” orientation to the “palm up” orientation (e.g., in addition to ceasing interactions with the keyboard 7104) while directing the attention 7010 of the user 7002 toward the hand 7022′ (or toward hand 7020′) so that the computer system 101 displays the control 7030 (as shown in FIG. 7U), optionally while computer system 101 outputs the audio 7103-a.

FIG. 7X illustrates the requirement that, in some embodiments, the hand 7022′ (e.g., the hand to which the user 7002 is directing their attention 7010) must be greater than a threshold distance from a selectable user interface element (e.g., that is associated with and/or within an application user interface, or that is a system user interface element such as a title bar, a move affordance, a resize affordance, a close affordance, navigation controls, system controls, and/or other affordances not specific to an application user interface) in order for the display criteria to be met. FIG. 7X illustrates a view of a three-dimensional environment that includes an application user interface 7106 corresponding to a user interface of a drawing software application that executes on the computer system 101. FIG. 7X also illustrates attention 7010 of the user 7002 being directed toward the hand 7022′ that is in the “palm up” orientation while the hand 7022′ is at a distance 7122 from a tool palette 7108 associated with (e.g., and optionally within) the application user interface 7106. Due to the hand 7022′ being within a threshold distance Dₜₕ of a selectable user interface element (e.g., the tool palette 7108, in the example of FIG. 7X) (e.g., the distance 7122 is less than or equal to the threshold distance Dₜₕ), even though the attention 7010 of the user 7002 is detected as being directed toward the hand 7022′, display criteria are not met, and the computer system 101 forgoes displaying control 7030 . . . . The threshold distance Dₜₕ may be 0.5 cm, 1.0 cm, 1.5 cm, 2.0 cm, 2.5 cm, 3.0 cm, 4 cm, 5 cm, 10 cm, 20 cm, or other distances, whether as perceived from the viewpoint of the user, or based on an absolute distance within the three-dimensional environment. Top view 7110 shows the threshold distance Dₜₕ relative to the distance 7122 between the hand 7022′ and the tool palette 7108 of the application user interface 7106.

FIGS. 7Y-7Z illustrate the requirement that, in some embodiments, a threshold amount of time must have elapsed since the hand 7022′ (e.g., the hand to which the user 7002 is directing their attention 7010) last interacted with a user interface element in order for the display criteria to be met. FIG. 7Y illustrates a view of the three-dimensional environment that includes the application user interface 7106 and an application user interface 7114 corresponding to a user interface of a software application that executes on the computer system 101 (e.g., a photo display application, a drawing application, a web browser, a messaging application, a maps application, or other software application). FIG. 7Y also illustrates the attention 7010 of the user 7002 being directed toward application user interface 7106 while the hand 7022′ performs an air pinch gesture in the “palm down” orientation to select a pen tool from the tool palette 7108. Computer system 101 optionally visually deemphasizes application user interface 7114 while the attention 7010 of the user 7002 is directed toward the application user interface 7106.

FIG. 7Z illustrates an example transition from FIG. 7Y, in which application content element 7116 is added to the application user interface 7106 (e.g., generated as a result of the user interaction with the application user interface 7106 depicted in FIG. 7Y). For example, the application content element 7116 may be added as a result of a selection input directed to the tool palette 7018 (e.g., to select the pen option), followed by movement input of the hand 7022′ to create the application content element 7116 (e.g., a hand drawn line) (e.g., via direct interaction with the hand 7022′ being within a threshold distance from the tool palette 7018 (e.g., to select the pen tool) and then the canvas of the application user interface 7106 (e.g., to draw the application content element 7116), or via indirect interaction with the hand performing one or more air gestures more than the threshold distance away as the attention 7010 of the user 7002 is directed to the tool palette 7018 and then the canvas of the application user interface 7106). FIG. 7Z also illustrates the attention 7010 of the user 7002 being directed toward the hand 7022′ while the palm 7025′ of the hand 7022′ faces a viewpoint of the user 7002. In the example of FIG. 7Z, whether display criteria are met depends on the time interval between when the hand 7022′ last interacted with the application user interface 7106 (e.g., adding the application content element 7116) and when the attention 7010 is detected as being directed to the hand 7022′ in the “palm up” orientation for triggering display of the control 7030 (e.g., instead of or in addition to other display criteria requirements described herein). Based on the palm 7025′ being oriented toward the viewpoint of the user 7002 when the attention 7010 of the user 7002 is detected as being directed toward the hand 7022′, and because the display criteria are met due to the amount of time having elapsed since the hand 7022′ last interacted with a user interface element (e.g., application user interface 7106) being greater than an interaction time threshold (e.g., 5 seconds, 4 seconds, 3 seconds, 2 seconds, 1 second, or a different time threshold), the control 7030 is displayed, optionally in conjunction with the computer system 101 generating output audio 7103-a indicating that the control 7030 is displayed. Top view 7118 shows that the distance 7112 between the hand 7022′ is greater than the distance threshold Dₜₕ, thus, satisfying the display criteria with respect to the threshold distance.

In contrast, in scenarios in which the time interval between the last user interaction with the application user interface 7106 and the attention 7010 being detected as being directed to the hand 7022′ is less than the interaction time threshold, the computer system 101 forgoes displaying control 7030. Imposing a time interval (e.g., a time delay that corresponds to the interaction time threshold) between the last user interaction with a user interface element and when the attention 7010 is directed to the hand 7022′ in the “palm up” orientation to trigger display of the control 7030 may help to minimize or reduce inadvertent triggering of the display of the control 7030 when the user 7002 may simply be directing attention to the hand 7022′ during an interaction with a user interface element of an application user interface.

FIG. 7AA illustrates timing diagrams for displaying the control 7030, optionally in conjunction with generating audio outputs, in accordance with some embodiments. In some embodiments, as depicted in FIG. 7AA (a), a display trigger for the control 7030 is received by one or more input devices of the computer system 101 (e.g., one or more sensors 190, one or more sensors in sensor assembly 1-356 (e.g., as illustrated in FIG. 1I), a sensor array or system 6-102 (e.g., as illustrated in FIG. 1H), or other input devices) at time 7120-1. For example, the one or more input devices detect that the attention 7010 is directed toward the hand 7022′ that is in a “palm up” orientation. For simplicity, the timing diagrams in FIG. 7AA depict minimal latency (e.g., no latency, or no detectable latency) between detecting the display trigger and displaying the control 7030. In response to detecting the display trigger at time 7120-1 and in accordance with a determination that the display criteria are met, computer system 101 displays the control 7030 in conjunction with generating audio output 7122-1. A width of an indication 7124-1 denotes a duration in which the control 7030 is displayed in the viewport.

At a time 7120-2, display of the control 7030 ceases (e.g., due to the hand 7022′ moving above a speed threshold (e.g., as illustrated in FIG. 7T), the hand 7022′ changing an orientation (e.g., as illustrated in FIG. 7AO), the user 7002 invoking the home menu user interface 7031 (e.g., as illustrated in FIGS. 7AK and FIGS. 7AL), the attention 7030 being directed away from the control 7030, and/or other factors). In some embodiments, the computer system 101 ceases display of the control 7030 without generating an audio output.

At time 7120-3, which is a time period ΔT_{A} after the time 7120-1, another display trigger for displaying the control 7030 is detected. In accordance with a determination that the display criteria are met, and that the time period ΔT_{A} is greater than an audio output time threshold Tₜₕ₁ (e.g., 0.5, 1, 2, 5, 10, 15, 25, 45, 60, 100, 200 seconds or another time threshold), the computer system 101 both displays the control 7030 (e.g., shown by indication 7124-2) and generates audio output 7122-2.

In some embodiments, as depicted in FIG. 7AA (b), at time 7120-4, a display trigger for displaying the control 7030 is detected. In response to detecting the display trigger and in accordance with a determination that the display criteria are met, computer system 101 displays the control 7030 (e.g., shown by indication 7124-3) and generates audio output 7122-3. The computer system 101 ceases displaying the control 7030 before the end of a time period ΔT_{B} after the time 7120-4. At time 7120-5, which is the time period ΔT_{B} after the time 7120-4, another display trigger for control 7030 is detected. In accordance with a determination that the display criteria are met but the time period ΔT_{B} is less than the audio output time threshold Tₜₕ₁, computer system 101 displays the control 7030 (e.g., shown by indication 7124-4) without generating an audio output. Similarly, at each of time 7120-6 (e.g., a time period ΔT_{C} after the time 7120-5) and time 7120-7 (e.g., a time period ΔT_{D} after the time 7120-6), another display trigger for the control 7030 is detected. In accordance with a determination that the display criteria are met but the time period ΔT_{C} and the time period ΔT_{D} are less than the audio output time threshold Tₜₕ₁, the computer system 101 displays the control 7030 at each of the time 7120-6 and the time 7120-7 (e.g., shown by indication 7124-5 and indication 7124-6, respectively) without generating corresponding audio outputs. At time 7120-8, which is a time period ΔT_{E} after the time 7120-7, another display trigger for control 7030 is detected. In accordance with a determination that the display criteria are met and the time period ΔT_{E} is greater than the audio output time threshold Tₜₕ₁, the computer system 101 both displays control 7030 (e.g., shown by indication 7124-7) and generates audio output 7122-4.

In some embodiments, as depicted in FIG. 7AA (c), at time 7120-9, the user 7002 interacts with an application user interface (e.g., FIG. 7Y) or a system user interface. At time 7120-10, which is a time period ΔT_{F} after the time 7120-9, a display trigger for the control 7030 is detected. Because the time period ΔT_{F} is less than an interaction time threshold Tₜₕ₂ (e.g., Tₜₕ₂ is different from Tₜₕ₁, Tₜₕ₂ is the same as Tₜₕ₁, and/or Tₜₕ₂ is 0.5, 1, 2, 5, 10 seconds or another time threshold), computer system 101 forgoes displaying the control 7030 (e.g., even if the display criteria are met). At 7120-11 (e.g., a time period ΔT_{G} after the time 7120-9), another display trigger for control 7030 is detected. In accordance with a determination that the display criteria are met and the time period ΔT_{G} is greater than the second time threshold Tₜₕ₂, the computer system 101 displays the control 7030 at the time 7120-10 (e.g., shown by indication 7124-8) and, if the time 7012-11 is at least the audio output time threshold Tₜₕ₁ from a most recent time that audio output was generated for display of control 7030, generates audio output 7122-5. At time 7120-12, which is a time period ΔT_{H} after the time 7120-11, another display trigger for the control 7030 is detected. In accordance with a determination that the display criteria are met but the time period ΔT_{H} is less than the audio output time threshold Tₜₕ₁, the computer system 101 displays control 7030 (shown by indication 7124-9), but does not generate an audio output.

FIGS. 7AB-7AC illustrate the requirement that, in some embodiments, the hand 7022 (e.g., corresponding to the hand 7022′ to which the user 7002 is directing their attention 7010) must be free from interacting with a physical object in order for the display criteria to be met. FIG. 7AB and FIG. 7AC both illustrate the hand 7022 having the same pose, but the hand 7022 in FIG. 7AB is interacting with (e.g., holding, or manipulating) a physical object (e.g., a cell phone, a remote control, or another device) in the physical environment 7000, as indicated by hand 7022′ being shown with a representation 7128 of the physical object, when the attention 7010 is directed toward the hand 7022′. Even though the attention 7010 is directed toward the same portion of the hand 7022′ in the “palm up” orientation, computer system 101 does not display the control 7030 in FIG. 7AB due to the interaction of the hand 7022 with the physical object (e.g., such that the display criteria are not met). In contrast, in FIG. 7AC, because the hand 7022 is not interacting with any physical object (e.g., and optionally has not interacted with any physical object for at least a threshold period of time (e.g., 0.5 seconds, 1.0 second, 1.5 seconds, 2.0 seconds, 2.5 seconds, or other lengths of time) prior to detecting the attention 7010 being directed to the hand 7022′), and based on the attention 7010 being detected as being directed toward the same portion of the hand 7022′ after the threshold period of time has elapsed, the computer system 101 displays the control 7030 in FIG. 7AC, optionally in conjunction with generating an audio output indicating the display of the control 7030.

In some embodiments, the control 7030 is displayed even if the hand 7022 is interacting with a physical object (e.g., as described herein with reference to FIGS. 7Q). In some embodiments, the display criteria are met, and thus the control 7030 is displayed, if the hand 7022 is interacting with a particular type of physical object or one of a plurality of particular types of physical object, such as a controller (e.g., recognized by the computer system 101 as such a particular type of physical object based on image detection, device pairing, wired or wireless communication, and/or other mechanism). In some embodiments, the control 7030 is not displayed if the physical object that hand 7022 is interacting with is not of the particular type (e.g., not a controller), even if the display criteria are otherwise met. In some embodiments, other user interface transitions described herein that follow from display of the control 7030, including display of the status user interface 7032 or volume indicator 8004 (e.g., a volume level adjustment user interface), are likewise performed while the hand 7022 is interacting with a controller or more generally a physical object of a particular type.

In some embodiments where the control 7030 is displayed even if the hand 7022 is interacting with a respective physical object, other interactions described herein as following from the display of control 7030 (e.g., display of a home menu user interface 7031, status user interface 7032, system function menu 7044, or volume indicator 8004) are likewise available while the hand 7022 is interacting with the physical object.

FIGS. 7AD-7AE illustrate the requirement that, in some embodiments, the hand 7022 must be greater than a threshold distance from a head of the user 7002 and/or one or more portions of the computer system 101 in order for the display criteria to be met. FIG. 7AD and FIG. 7AE illustrate the hand 7022 having the same pose but positioned at different distances from the head of the user 7002 and/or one or more portions of the computer system 101. In FIG. 7AD, top view 7130 shows the hand 7022 being positioned outside a region 7132 centered at the head of the user 7002. For example, the region 7132 may be a circle of radius dₜₕ₁ centered at the head of the user 7002. While the hand 7022 is more than a distance dₜₕ₁ away from the head of the user 7002 (e.g., and from one or more portions of the computer system 101), as shown in FIG. 7AD, and based on detecting that the attention 7010 is directed toward the hand 7022′ that is in the “palm up” orientation, as in FIG. 7AD, the computer system 101 displays control 7030, optionally also generating an audio output indicating the display of the control 7030. In some embodiments, dₜₕ₁ is between 2-35 cm from the head of the user 7002 or from one or more portions of the computer system 101 (e.g., locations of one or more physical controls of the computer system 101), such as 2 cm, 5 cm, 10 cm, 15 cm, 20 cm, 25 cm, 30 cm, 35 cm, or other distances. In contrast, in FIG. 7AE, top view 7134 shows that the hand 7022 is within the region 7132 (e.g., the user 7002 may be attempting to access the one or more physical controls on the computer system 101). While the hand 7022 is less than the distance of dₜₕ₁ from the head of the user 7002, as is shown in FIG. 7AE, even though the attention 7010 is detected as being directed to the hand 7022′ that is in the “palm up” orientation, the computer system 101 forgoes displaying control 7030 (e.g., the display criteria are not met). In some embodiments, requiring the hand 7022 to be at least a threshold distance away from the head of the user 7002 prevents accidental triggering of the display of the control 7030 when the user interacts with physical buttons or input devices on the home computer system 101, and/or if the user touches portions of the user's head (e.g., covering the mouth in a palm-up orientation when the user sneezes).

FIG. 7AF illustrates the requirement that, in some embodiments, one or more fingers must not be bent at one or more joints in order for the display criteria to be met. FIG. 7AF illustrates the hand 7022 having fingers that are curled (e.g., forming a fist, holding onto an item, or other function), such that the palm 7025′ of the hand 7022′ is not open, although the palm 7025′ of the hand 7022′ faces toward the viewpoint of the user 7002. The hand 7022 is optionally considered curled if one or more fingers have one or more joints that are bent (e.g., a respective phalanx of a respective finger makes an angle of more than 30°, 45°, 55°, or another magnitude angle from an axis collinear with an adjacent phalanx), as illustrated in side view 7136 of FIG. 7AG. As shown in FIG. 7AF, because the hand 7022′ has one or more fingers that are curled such that the palm 7025′ of the hand 7022′ is not open, and even though the attention 7010 is detected as being directed toward the hand 7022′ that is in the “palm up” orientation, the computer system 101 forgoes displaying the control 7030 (e.g., the display criteria are not met). FIG. 7AH shows side view 7138 illustrating a side profile of the hand 7022 that has an open palm and that does not have curled fingers that are bent at one or more joints (e.g., a respective phalanx of a respective finger makes an angle of less than 30°, 45°, 55°, or another magnitude angle from an axis collinear with an adjacent phalanx), and the computer system 101 displays the control 7030 in response to detecting that the attention 7010 is directed to the hand 7022′ in a “palm up” orientation (e.g., with the palm 7025′ facing toward the viewpoint of the user 7002). For example, the user may be less likely to be invoking the display of the control 7030 when the user's hand 7022 is forming a first shape, or is about to pick up an item by curling the user's fingers.

FIGS. 7AI-7AJ illustrate the requirement that, in some embodiments, an angle of the hand 7022 must satisfy an angular threshold in order for the display criteria to be met. FIG. 7AI shows top views of the hand 7022 as the hand 7022 is rotated around an axis 7140, and FIG. 7AJ illustrates the hand 7022′ as visible in a viewport, in accordance with the hand 7022 being rotated around the axis 7140 such that a side profile of the hand 7022′ is visible from the viewpoint of the user 7002. The axis 7140 is substantially collinear with the right forearm of the user 7002. When the hand 7022′ has a hand angle that does not meet the display criteria (e.g., is rotated such that a lateral gap between the index finger and the thumb is no longer visible or does not meet the threshold gap size of gₜₕ from the viewpoint of the user 7002, as shown in FIG. 7AJ (e.g., and also illustrated by example 7042 in FIG. 7J1), or the hand 7022 has rotated (e.g., even further) into the “palm down” orientation (e.g., example 7038 in FIG. 7J1)), then even though the attention 7010 is detected as being directed toward the hand 7022′, the computer system 101 forgoes displaying the control 7030, as shown in FIG. 7AJ.

In FIG. 7AI, representations 7141-1, 7141-2, 7141-3 and 7141-4 show different degrees of rotation of the hand 7022 about the axis 7140, from a “palm up” orientation (e.g., representation 7141-1) to an orientation in which thumb 7142 is nearly in front of (e.g., but not obscuring) pinky 7144 from the viewpoint of the user 7002 (e.g., representation 7141-4). In some embodiments, the control 7030 would be displayed if the attention 7010 were detected as being directed to the hand 7022′ corresponding to each of representations 7141-1, 7141-2, 7141-3 and 7141-4. Representation 7141-5 corresponds to the top view of the hand 7022 corresponding to the hand 7022′ illustrated in FIG. 7AJ. The computer system 101 does not display the control 7030 even when the attention 7010 is detected as being directed to the hand 7022′ in FIG. 7AJ due to the hand angle of the hand 7022′ not meeting the display criteria.

FIG. 7AK1 shows that, while the control 7030 is displayed, the computer system detects an air pinch gesture performed by the hand 7022′ of the user 7002 (e.g., while the attention 7010 of the user 7002 is directed toward the hand 7022′, such that the control 7030 is displayed at the time that the air pinch gesture is detected). In some embodiments, in response to detecting the air pinch gesture (e.g., while the control 7030 is displayed), the computer system generates audio output 7103-b. In some embodiments, the audio output is generated as soon as the computer system 101 detects contact of two (e.g., or more) fingers of the hand 7022′ during the air pinch gesture. In some embodiments, the audio output 7103-b is generated after the computer system 101 detects the un-pinch portion (e.g., termination) of the air pinch gesture (e.g., after the computer system 101 determines that the user 7002 is performing an air pinch (e.g., and un-pinch) gesture and not a pinch and hold gesture). The audio output 7103-a may be different from or the same as audio output 7103-b.

FIG. 7AK2 shows that (e.g., while the user interface 7028-a, the user interface 7028-b, and the user interface 7028-c are not displayed), in response to detecting the air pinch gesture in FIG. 7AK1, the computer system 101 displays a home menu user interface 7031 (e.g., in contrast to the example 7094 of FIG. 7P, where the air pinch gesture is detected while the user interface 7028-a is displayed, and the home menu user interface 7031 is not displayed in response). FIG. 7AK2 shows the home menu user interface 7031 displaying a collection of application icons from which the user 7002 can launch a respective application user interface corresponding to a respective application icon. Selection emphasis is displayed over tab 7148-1 in a tab bar 7146, indicating that the home menu user interface 7031 is currently displaying the collection of application icons. The home menu user interface 7031 also includes a tab 7033-2. When the tab 7033-2 is selected (e.g., by an air pinch gesture, with or without gaze or a proxy for gaze, or by a different selection input), home menu user interface 7031 transitions from displaying the collection of application icons to displaying a collection of representations of respective persons (or, optionally, contacts) with whom the user 7002 may initiate communication or continue a communication session (e.g., communication such as video conferencing, audio call, email, and/or text messages). The user 7002 may scroll (e.g., by pinching and dragging on an edge of the collection of contacts), into the viewport of the user 7002, one or more additional pages of contacts or persons with whom the user 7002 may communicate. The user 7002 may similarly scroll (e.g., by pinching and dragging on an edge of the collection of application icons), into the viewport of the user 7002, one or more additional pages of application icons (e.g., when the home menu user interface 7031 is displaying the collection of application icons).

The home menu user interface 7031 also includes a tab 7033-3. When the tab 7033-3 is selected (e.g., by an air pinch gesture, with or without gaze, or a proxy for gaze, or by a different selection input), home menu user interface 7031 transitions from displaying the collection of application icons (or contacts) to displaying one or more selectable virtual environments (e.g., a beach scenery virtual environment, a mountain scenery virtual environment, an ocean scenery virtual environment, or other virtual environment). The user 7002 may scroll additional selectable virtual environments into the field of view of the user 7002 (e.g., by a pinch and drag input on an edge of the collection of selectable virtual environment). In some embodiments, when the user 7002 selects one of the virtual environments, the viewport is replaced by scenery from that selectable virtual environment, and application user interfaces are displayed within that virtual environment.

FIG. 7AL1 is analogous to FIG. 7AK1 in that FIG. 7AL1 similarly illustrates the computer system detecting an input performed by hand 7022 while the control 7030 is displayed (e.g., while the attention 7010 of the user 7002 is directed toward the hand 7022′, such that the control 7030 is displayed at the time that the input is detected), except that in FIG. 7AL1, the detected input includes a press of button 7117 of controller 7111, instead of an air pinch gesture as in FIG. 7AK1. Consequently, FIG. 7AL2 is analogous to FIG. 7AK2 in that FIG. 7AL2 similarly illustrates the computer system displaying the home menu user interface 7031 in response to the input of FIG. 7AL1 being detected while the control 7030 is displayed (e.g., except that FIG. 7AL2 shows the hand 7022′ holding the controller 7111′, instead of just the hand 7022′ as in FIG. 7AK2).

In some embodiments, inputs are provided via controller 7111 that are analogous to the air gestures described herein (e.g., performed by hand 7022) and that result in analogous user interface behaviors. For example, in some embodiments a pinch gesture performed by hand 7022 is analogous to a button press via controller 7111, a double pinch gesture performed by hand 7022 is analogous to a double press of a button via controller 7111, and/or a long pinch gesture performed by hand 7022 is analogous to a button press and hold via controller 7111. In some embodiments, user interface behaviors that are based on movement of hand 7022 occur whether the user 7002 is holding a controller or not (e.g., pinch and drag inputs are analogous to movement of hand 7022 while pressing a button of controller 7111).

FIGS. 7AL3-7AL6 illustrate example ranges of hand poses for which a respective system user interface, such as the control 7030 or the status user interface 7032, is displayed, optionally varying based on whether the hand is holding a controller or not. In some embodiments, determining whether the hand 7022 is within a respective range of hand poses corresponds to determining whether the angle of the hand 7022 satisfies an angular threshold in order for the display criteria (e.g., for displaying a particular system user interface) to be met, as described herein with reference to FIGS. 7AI-7AJ.

FIG. 7AL3 illustrates example hand poses for which the control 7030 is displayed or not displayed, while the hand 7022 is not holding a controller. In FIG. 7AL3, representations 7141-1 and 7141-3 through 7141-8 show top views of different degrees of rotation of the hand 7022 about the axis 7140 (e.g., as illustrated in FIG. 7AJ), which in some embodiments is substantially collinear with the right forearm of the user 7002, while hand 7022 is not holding a controller. Representation 7141-1 illustrates a “palm up” orientation, and representations 7141-3 through 7141-5 illustrate progressively increasing amounts of rotation of the hand 7022 (e.g., clockwise rotation, when viewed from above as shown in FIG. 7AL3) from the “palm up” orientation of representation 7141-1 such that the palm of the hand 7022 is increasingly turned toward the user's left (e.g., until the thumb 7142 is in front of, and substantially obscuring, pinky 7144 from the viewpoint of the user 7002). It is noted that representations 7141-1, 7141-3, 7141-4, and 7141-5 correspond respectively to the same numbered representations in FIG. 7AI. In the other direction, representations 7141-6 through 7141-8 represent progressively increasing amounts of rotation of the hand 7022 (e.g., counterclockwise rotation, when viewed from above as shown in FIG. 7AL3) from the “palm up” orientation of representation 7141-1 such that the palm of the hand 7022 is increasingly turned toward the user's right (e.g., until the thumb 7142 is behind pinky 7144, or substantially so, from the viewpoint of the user 7002).

FIG. 7AL3 illustrates that representations 7141-1, 7141-3, 7141-4, and 7141-6 correspond to hand angles (or more particularly hand orientations or hand poses) at which the control 7030 will be displayed (e.g., if other display criteria for control 7030 are met, such as the attention 7010 of the user 7002 being directed toward the hand 7022′) if hand 7022 is not holding a controller, whereas representations 7141-5, 7141-7, and 7141-8 correspond to hand angles at which the control 7030 will not be displayed if hand 7022 is not holding a controller.

FIG. 7AL4 illustrates example hand poses for which the control 7030 is displayed or not displayed, while the hand 7022 is holding a controller 7111. In FIG. 7AL4, representations 7143-1 through 7143-7 show top views of different degrees of rotation of the hand 7022 about the axis 7140 (e.g., as illustrated in FIG. 7AJ) while hand 7022 is holding the controller 7111. Representation 7143-1 illustrates a “palm up” orientation while holding the controller 7111, and representations 7143-2 through 7143-4 illustrate progressively increasing amounts of rotation of the hand 7022 (e.g., clockwise rotation, when viewed from above as shown in FIG. 7AL4) from the “palm up” orientation of representation 7143-1 such that the palm of the hand 7022 is increasingly turned toward the user's left (e.g., until the thumb 7142 is in front of, and substantially obscuring, pinky 7144 from the viewpoint of the user 7002) while the hand 7022 is holding the controller 7111. In the other direction, representations 7143-5 through 7143-7 represent progressively increasing amounts of rotation of the hand 7022 (e.g., counterclockwise rotation, when viewed from above as shown in FIG. 7AL4) from the “palm up” orientation of representation 7143-1 such that the palm of the hand 7022 is increasingly turned toward the user's right (e.g., until the thumb 7142 is behind pinky 7144, or substantially so, from the viewpoint of the user 7002) while the hand 7022 is holding the controller 7111. The representations 7143-1, 7143-2, 7143-3, 7143-4, 7143-5, 7143-6, and 7143-7 of FIG. 7AL4 with hand 7022 holding the controller are analogous to representations 7141-1, 7141-3, 7141-4, 7141-5, 7141-6, 7141-7, and 7141-8, respectively, of FIG. 7AL3 with hand 7022 not holding a controller.

FIG. 7AL4 illustrates that representations 7143-1 through 7143-6 correspond to hand angles (or more particularly hand orientations or hand poses) at which the control 7030 will be displayed (e.g., if other display criteria for control 7030 are met, such as the attention 7010 of the user 7002 being directed toward the hand 7022′) if hand 7022 is holding a controller, whereas representation 7143-7 corresponds to a hand angle at which the control 7030 will not be displayed if hand 7022 is holding a controller.

FIG. 7AL4 in contrast with FIG. 7AL3 thus illustrate that the range of hand angles for which the control 7030 is displayed if the hand 7022 is holding a controller (e.g., between the hand angle of representation 7143-4 and the hand angle of representation 7143-6 in FIG. 7AL4) is different from (e.g., includes different angles and/or is larger than or smaller than) the range of hand angles for which the control 7030 is displayed if the hand 7022 is not holding a controller (e.g., between the hand angle of representation 7141-4 and the hand angle of representation 7141-6 in FIG. 7AL3).

FIG. 7AL5 illustrates example hand poses for which the status user interface 7032 is displayed or not displayed, while the hand 7022 is not holding a controller. In FIG. 7AL5, representations 7141-5 and 7145-1 through 7145-6 show top views of different degrees of rotation of the hand 7022 about the axis 7140 (e.g., as illustrated in FIG. 7AJ) while hand 7022 is not holding a controller. Representation 7141-5 corresponds to the same numbered representation in FIG. 7AL3, with the palm of the hand 7022 facing toward the user's left. Representations 7145-1 through 7145-6 illustrate progressively increasing amounts of rotation of the hand 7022 (e.g., clockwise rotation, when viewed from above as shown in FIG. 7AL5) from the hand orientation of representation 7141-5. For example, representations 7145-1 through 7145-3 illustrate rotation of the hand 7022 such that the palm of the hand 7022 is increasingly turned away from the user's viewpoint, from facing toward the user's left to a “palm down” orientation, and representations 7145-4 through 7145-6 illustrate rotation of the hand 7022 from the “palm down” orientation of representation 7145-3 such that the palm of the hand 7022 is increasingly turned toward the user's right (e.g., until the thumb 7142 is behind pinky 7144, or substantially so, from the viewpoint of the user 7002).

FIG. 7AL5 illustrates that representation 7141-5 corresponds to a hand angle at which the status user interface 7032 is displayed (e.g., if other display criteria for the status user interface 7032 are met, such as the attention 7010 of the user 7002 being directed toward the hand 7022′ and a hand flip gesture having been detected, consistent with the description herein of FIG. 7AO) and at which the control 7030 is not displayed as in FIG. 7AL3, if hand 7022 is not holding a controller. In FIG. 7AL5, representations 7145-1 through 7145-4 also correspond to hand angles at which the status user interface 7032 will be displayed (e.g., will continue to be displayed during further rotation of the hand 7022 after the hand flip gesture is detected), if hand 7022 is not holding a controller. Representations 7141-5 and 7141-6 correspond to hand angles at which the status user interface 7032 in some embodiments will not be displayed if hand 7022 is not holding a controller.

FIG. 7AL6 illustrates example hand poses for which the status user interface 7032 is displayed or not displayed, while the hand 7022 is holding the controller 7111. In FIG. 7AL6, representations 7143-4 and 7145-1 through 7145-6 show top views of different degrees of rotation of the hand 7022 about the axis 7140 (e.g., as illustrated in FIG. 7AJ) while the hand 7022 is holding the controller 7111. Representation 7143-4 corresponds to the same numbered representation in FIG. 7AL4, with the palm of the hand 7022 facing toward the user's left. Representations 7147-1 through 7147-6 illustrate progressively increasing amounts of rotation of the hand 7022 (e.g., clockwise rotation, when viewed from above as shown in FIG. 7AL6) from the hand orientation of representation 7143-4. For example, representations 7147-1 through 7147-3 illustrate rotation of the hand 7022 holding the controller 7111 such that the palm of the hand 7022 is increasingly turned away from the user's viewpoint, from facing toward the user's left to a “palm down” orientation; and representations 7147-4 through 7147-6 illustrate rotation of the hand 7022 holding the controller 7111 from the “palm down” orientation of representation 7147-3 such that the palm of the hand 7022 is increasingly turned toward the user's right (e.g., until the thumb 7142 is behind pinky 7144, or substantially so, from the viewpoint of the user 7002). The representations 7147-1 through 7147-6 of FIG. 7AL6 with hand 7022 holding the controller 7111 are analogous to representations 7145-1 through 7145-6, respectively, of FIG. 7AL5 with hand 7022 not holding a controller.

FIG. 7AL6 illustrates that representation 7143-4 corresponds to a hand angle at which the status user interface 7032 is not displayed (e.g., even if other display criteria for the status user interface 7032 are met, such as the attention 7010 of the user 7002 being directed toward the hand 7022′) if hand 7022 is holding a controller 7111, consistent with the control 7030 being displayed instead for this hand angle, as in FIG. 7AL4 (e.g., a hand flip gesture has not yet been detected). Representation 7147-1 in FIG. 7AL6 corresponds to a first hand angle at which the status user interface 7032 is displayed. FIGS. 7AL4 and 7AL6 together illustrate that in some embodiments, if the hand 7022 is holding a controller 7111, a hand flip gesture is not detected until the hand angle has passed that of representation 7143-4 and reached that of representation 7147-1 (e.g., in contrast with FIGS. 7AL3 and 7AL5, which illustrate that a hand flip gesture will already have been detected when the hand angle reaches that of representation 7143-4 if the hand 7022 is not holding a controller). In FIG. 7AL6, representations 7147-2 through 7147-5 also correspond to hand angles at which the status user interface 7032 will be displayed (e.g., will continue to be displayed during further rotation of the hand 7022 after the hand flip gesture is detected) if hand 7022 is holding a controller 7111. Representation 7147-6 corresponds to a hand angle at which the status user interface 7032 in some embodiments will not be displayed (e.g., will cease to be displayed upon even further rotation of the hand 7022) while hand 7022 is holding a controller 7111.

FIG. 7AL6 in contrast with FIG. 7AL5 thus illustrate that the range of hand angles for which the status user interface 7032 is displayed if the hand 7022 is holding a controller (e.g., between the hand angle of representation 7147-1 and the hand angle of representation 7147-5 in FIG. 7AL6) is different from (e.g., includes different angles and/or is larger than or smaller than) the range of hand angles for which the status user interface 7032 is displayed if the hand 7022 is not holding a controller (e.g., between the hand angle of representation 7141-5 and the hand angle of representation 7145-4 in FIG. 7AL5).

FIG. 7AM illustrates an air pinch gesture by the hand 7022′ in a “palm down” configuration while the attention 7010 is directed to an application icon 7150 associated with the application user interface 7106.

FIG. 7AN illustrates an example transition from FIG. 7AM. FIG. 7AM illustrates that, in response to detecting the air pinch gesture while the attention 7010 of the user 7002 (e.g., based on gaze of the user 7002 or a proxy for gaze) is directed toward the application icon 7150 (e.g., as illustrated in FIG. 7AM), the computer system 101 displays application user interface 7106 depicted in FIG. 7AN that is associated with the application icon 7150.

FIG. 7AO shows a hand flip gesture (e.g., a hand flip as described above with reference to FIG. 7B), and a transition from displaying the control 7030 to displaying the status user interface 7032. In a first stage 7154-1 of a transition sequence 7152 of FIG. 7AO, the hand 7022′ is in the “palm up” orientation (e.g., has the same and/or substantially the same orientation as in FIG. 7Q1, and/or has a top view corresponding to representation 7141-1 in FIG. 7AI), and the control 7030 is displayed with an orientation that is centered with respect to (e.g., and/or facing, and/or aligned with) the viewpoint of the user 7002 (e.g., a plane of the front circular surface of the control 7030 is substantially orthogonal to a direction of the gaze, or a proxy for gaze, of the user 7002). In some embodiments, the computer system 101 generates audio 7103-a in conjunction with displaying the control 7030 (e.g., as shown in FIG. 7Q1).

As the hand flip gesture progresses from the first stage 7154-1 to a second stage 7154-2, the computer system 101 maintains display of the control 7030, but displays the control 7030 with a new orientation (e.g., an updated, adjusted, or modified orientation, relative to the orientation in the first stage 7154-1). In some embodiments, displaying the control 7030 with the new orientation includes rotating the control 7030 relative to a vertical axis (e.g., the axis that is substantially parallel to (e.g., within 5 degrees of, within 10 degrees of, or within another angular value) the fingers of the hand 7020 in FIG. 7AO). In some embodiments, displaying the control 7030 with the new orientation includes rotating the control 7030 around the same axis of rotation as the hand flip. In some embodiments, displaying the control 7030 with the new orientation includes rotating the control 7030 (e.g., about the vertical axis and/or the axis of rotation of the hand flip) by an amount that is proportional to an amount of rotation of the hand 7022 during the hand flip gesture (e.g., and optionally, the control 7030 is rotated by the same amount that the hand 7022 is rotated).

As the hand flip gesture continues to progress from the second stage 7154-2 to a third stage 7154-3, the computer system 101 continues to maintain display of the control 7030, and continues to rotate the control 7030 (e.g., about the vertical axis and/or the axis of rotation of the hand flip).

The third stage 7154-3 shows the hand 7022′ at a midpoint of the hand flip gesture or the transition sequence 7152 (e.g., or just before the midpoint of the hand flip gesture), based on the total amount of rotation of the hand 7022 during the hand flip gesture. The hand 7022′ has rotated by 90 degrees (e.g., or roughly 90 degrees, with a small buffer angle (e.g., to account for tolerance for inaccuracy in the sensors of the computer system 101 and/or instability in the movement of the user 7002)), such that palm 7025′ of the hand 7022′ is no longer visible (e.g., and/or minimally visible, again allowing for the small buffer angle) from the viewpoint of the user 7002. Similarly, the control 7030 is rotated by 90 degrees (e.g., or roughly 90 degrees). Described differently, the control 7030 is analogous to a coin (e.g., with a “front” circular surface, visible in the first portion of FIG. 7AO; a “back” circular surface on the opposite side of the “front” circular surface; and a thin “side” portion that connects the “front” and “back” circular surfaces). In the third stage 7154-3 of FIG. 7AO, the control 7030 has rotated such that only the thin “side” portion is visible (e.g., optionally, along with a minimal portion of the “front” or “back” circular surfaces).

As the hand flip gesture continues to progress from the third stage 7154-3 to a fourth stage 7154-4 of FIG. 7AO, the computer system 101 ceases to display the control 7030 and displays the status user interface 7032 (e.g., replaces display of the control 7030 with display of the status user interface 7032). In some embodiments, the status user interface 7032 is displayed with an orientation (e.g., that includes an amount of rotation) to simulate the status user interface 7032 being a backside of the control 7030 (e.g., the control 7030 is the “front” circular surface, and the status user interface 7032 is the “back” circular surface, in the coin analogy). Similarly, as the hand flip gesture continues to progress from the fourth stage 7154-4 to a fifth stage 7154-5, the computer system 101 maintains display of the status user interface 7032, and continues to rotate the status user interface 7032 (e.g., about the vertical axis and/or the axis of rotation of the hand flip gesture).

As the hand flip gesture continues to progress from the fifth stage 7154-5 to a sixth stage 7154-6 (e.g., final stage) of FIG. 7AO, the computer system 101 maintains display of the status user interface 7032 and rotates the status user interface 7032 (e.g., about the vertical axis and/or the axis of rotation of the hand flip). In the sixth stage 7154-6, the hand 7022′ is now in the “palm down” orientation, and the status user interface 7032 is substantially centered (e.g., and/or facing, and/or aligned with) with respect to the viewpoint of the user 7002 (e.g., a plane of the status user interface 7032 on which the summary of the information about the computer system 101 is presented is substantially orthogonal to the direction of the gaze, or a proxy for gaze, of the user 7002). In some embodiments, the computer system 101 generates audio 7103-e in conjunction with displaying the status user interface 7032 (e.g., at stage 7154-6 in conjunction with displaying the plane of the status user interface 7032 substantially orthogonal to the direction of the gaze, or a proxy for gaze, of the user 7002, or at an earlier stage of displaying (e.g., rotating) the status user interface 7032 such as stage 7154-4 or stage 7154-5). In some embodiments, the computer system 101 generates different audio (e.g., audio 7103-a instead of audio 7103-e) when transitioning from displaying the status user interface 7032 to displaying the control 7030 (e.g., when reversing the transition illustrated in FIG. 7AO from displaying the control 7030 to displaying the status user interface 7032). In some embodiments, the speed at which the animation illustrated in the transition sequence 7152 of FIG. 7AO is progressed (e.g., whether progressing in order from the first through sixth stages 7154-1 through 7154-6 or in the reverse from the sixth through first stages 7154-6 through 7154-1) (e.g., with or without accompanying audio output) is based on the rotational speed of the hand flip gesture. In some embodiments, one or more audio properties (e.g., volume, frequency, timbre, and/or other audio properties) of audio 7103-a and/or 7103-e change based on the rotational speed of the hand 7022 during the hand flip gesture (e.g., a first volume for faster hand rotation versus a different, second volume for slower hand rotation).

In some embodiments, the control 7030 is displayed at a position that is a first threshold distance oₜₕ from the midline 7096 of the palm 7025′ of the hand 7022′ (e.g., as described above with reference to FIG. 7Q1). In some embodiments, the status user interface 7032 is displayed at a position that is a second threshold distance from the midpoint of the palm 7025′ of the hand 7022′ (e.g., and/or a midpoint of a back of the hand 7022′, as the palm of the hand 7022′ is not visible in the “palm down” orientation). In some embodiments, the first threshold distance and the second threshold distance are the same (e.g., the control 7030 and the status user interface 7032 are displayed with substantially the same amount of offset from a midpoint of the palm/back of the hand 7022′). In some embodiments, the first threshold distance is different from the second threshold distance (e.g., the control 7030 has a different amount of offset as compared to the status user interface 7032). In some embodiments, as the hand flip gesture described in FIG. 7AO progresses, the computer system 101 transitions from displaying the status user interface 7032 at a position that is the first threshold distance from the midpoint of the palm/back of the hand 7022′, to a position that is the second threshold distance from the midpoint of the palm/back of the hand 7022′. In some embodiments, the transition progresses in accordance with the rotation of the hand 7022 during the hand flip gesture (e.g., in accordance with a magnitude of rotation of the hand 7022 during the hand flip gesture).

In some embodiments, the control 7030 is maintained (e.g., while the attention 7010 remains on the hand 7022′), even if the current orientation (e.g., and/or pose) of the hand does not meet the normal criteria for displaying the control 7030 (e.g., triggering display of the control 7030 in a viewport that does not yet display the control 7030). For example, the third stage 7154-3 of FIG. 7AO includes a hand orientation that is analogous to the hand orientation in example 7042 of FIG. 7J1, where the control 7030 is not displayed (e.g., even though the attention 7010 of the user 7002 is directed toward the hand 7022). In some embodiments, the computer system 101 maintains display of the control 7030 (e.g., regardless of hand orientation and/or pose) as long as the computer system 101 detects that a hand flip gesture is in progress (e.g., that rotational motion of the hand 7022 has been detected within a threshold period of time), and as long as the attention of the user 7002 remains directed toward the hand 7022.

In some embodiments, the transition from displaying the control 7030 to displaying the status user interface 7032 occurs analogously if the hand 7022′ is holding a controller 7111′ as described herein with reference to FIGS. 7Q (e.g., based on detecting a flip of the hand 7022 and/or based on detecting a flip of the controller 7111). In some embodiments, the positions at which the control 7030 is displayed relative to the hand 7022′ in stages 7154-1 through 7154-3 are different from (e.g., offset from) those shown in FIG. 7AO if the hand 7022′ is holding a controller 7111′, as described herein with reference to FIGS. 7Q. Similarly, in some embodiments, the positions at which the status user interface 7032 is displayed relative to the hand 7022′ in stages 7154-4 through 7154-6 are different from (e.g., offset from) those shown in FIG. 7AO if the hand 7022′ is holding a controller 7111′. For example, FIG. 7AP includes a dashed outline of controller 7111′ and a dashed status user interface outline 7023 illustrating that in some embodiments, if the hand 7022′ is holding the controller 7111′ while performing the hand flip gesture of 7AO, the status user interface 7032 will be displayed at a different location following the hand flip gesture than when the hand 7022′ is not holding a controller.

FIG. 7AP also shows that, while the status user interface 7032 is displayed (e.g., following the hand flip gesture of FIG. 7AO), the computer system 101 detects an air pinch gesture performed by the hand 7022′ of the user 7002. In FIG. 7AQ, in response to detecting the air pinch gesture (e.g., shown in FIG. 7AP) while the status user interface 7032 is displayed in the viewport, the computer system 101 displays the system function menu 7044 (e.g., replaces display of the status user interface 7032 with display of the system function menu 7044 after the status user interface 7032 ceases to be displayed). FIG. 7AP and FIG. 7AQ are analogous to FIG. 7K and FIG. 7L, respectively, except for the user interface 7028-b not being displayed (e.g., computer system 101 in FIGS. 7AP-7AQ is not performing initial setup and/or configuration). In some embodiments, a button press via controller 7111 (e.g., while the hand 7022 is holding the controller 7111) results in the same user interface transition from the status user interface 7032 to the system function menu 7044 as an air pinch gesture (e.g., while the hand 7022 is not holding a controller). In some embodiments, the system function menu 7044 is displayed at the same position (e.g., world-locked or head-locked) whether the input triggering display of the system function menu 7044 is an air pinch gesture or a controller button press. In some embodiments, the system function menu 7044 is displayed at different position if displayed in response to an air pinch gesture than if displayed in response to a controller button press (e.g., like the control 7030 as described with reference to FIGS. 7Q and/or the status user interface 7032 as described with reference to FIGS. 7AO-7AP).

FIGS. 7AR-7AT show an alternative sequence to FIG. 7AP and FIG. 7AQ, where instead of performing the air pinch gesture, the user 7002 begins to perform a hand flip from “palm down” to “palm up” (e.g., to “unflip” or reverse the change in hand orientation that triggered display of the status user interface 7032 in place of the control 7030, by rotating the hand 7022 in a direction opposite the direction shown in FIG. 7AO).

FIG. 7AS shows an intermediate state of the hand 7022′ during the hand flip, and also shows rotation of the status user interface 7032. FIG. 7AR and FIG. 7AS are analogous to the sixth stage 7154-6 of FIG. 7AO and the fifth stage 7154-5 of FIG. 7AO, respectively, but in reverse order (e.g., because the hand flip in FIG. 7AR and FIG. 7AS includes rotation of the hand 7022 in the opposite direction than in FIG. 7AO).

In some embodiments, if the user 7002 continues the hand flip gesture (e.g., rotates the hand 7022′ by a sufficient amount), the computer system 101 ceases to display the status user interface 7032 and displays (e.g., redisplays) the control 7030 (e.g., replaces display of the status user interface 7032 with display of the control 7030). Described differently, the user 7002 can reversibly change the orientation of the hand 7022 (e.g., “flip” and “unflip” the hand), as indicated by the bi-directional arrows in FIG. 7AO, which causes the computer system 101 to display the status user interface 7032 and/or the control 7030 with an appearance that includes an amount of rotation analogous to those described in FIG. 7AO (e.g., in forward or reverse order).

FIG. 7AT shows a final stage of the hand flip gesture sequence that started in FIG. 7AS which results in the computer system 101 displaying (e.g., redisplaying) the control 7030 (e.g., analogous to the first stage 7154-1 of FIG. 7AO, as a result of the orientation of the hand 7022′ traversing through the transition sequence in FIG. 7AO in reverse order). The computer system 101 also optionally generates output audio 7103-c (e.g., different from or the same as the output audio 7103-a and/or 7103-b) when the control 7030 is displayed. In some embodiments, the reverse transition from the status user interface 7032 to the control 7030 is also displayed in response to a hand flip from “palm down” to “palm up” while the hand 7022 is holding a controller 7111.

FIGS. 7AU-7BE illustrate various behaviors of the control 7030 when an immersive application is displayed in the viewport.

FIGS. 7AU-7AW illustrate that, for some immersive applications, a different sequence of user input is required for the display criteria to be met. FIG. 7AU shows an application user interface 7156 associated with an immersive application (e.g., App Z1) in the viewport into the three-dimensional environment. In some embodiments, an immersive application user interface is an application that is configured so that content from applications distinct from the immersive application user interface ceases to be displayed in the viewport when the immersive application is the active application user interface in the computer system 101. In some embodiments, computer system 101 permits an immersive application to render application content anywhere in the viewport into the three-dimensional environment even though the immersive application may not fill all of the viewport. Such an immersive application may differ from an application that renders application content only within boundaries (e.g., visible boundaries or non-demarcated boundaries) of an application user interface container (e.g., a windowed application user interface). The application user interface 7156 includes application content 7158 and 7160 that are optionally three-dimensional content elements. The hand 7022′ is illustrated in dotted lines in FIG. 7AU because the hand 7022′ may optionally not be displayed when a first type of immersive application is displayed in the viewport. For example, the first type of immersive application is permitted to suppress the display (e.g., or obscure (e.g., for optical passthrough)) of the hand 7022′. Thus, the display of the control 7030 may also be suppressed even though the display criteria described in FIGS. 7Q1-7AT are otherwise satisfied. Alternatively, the hand 7022′ may optionally be displayed (e.g., by the hand 7022′ breaking through the application user interface 7156) when a second type of immersive application is displayed in the viewport, different from the first type. As a result, the location of the hand 7022′ shown in dotted lines corresponds to where the hand 7022 is, even though the computer system 101 forgoes displaying the hand 7022′. In other words, the location of the hand 7022′ shown in dotted lines corresponds to where the video passthrough of hand 7022 would be displayed if the application user interface 7156 were a non-immersive application. Alternatively, the location of the hand 7022′ shown in dotted lines may correspond to a virtual graphic (e.g., an avatar's hand(s), or a non-anthropomorphic appendage (e.g., one or more tentacles)) that is overlaid on or displayed in place of the hand 7022′ and that is animated to move as the hand 7022 moves.

Alternatively or additionally, different application settings may be applicable in a respective immersive application such that a first application setting is in a first state (e.g., accessibility mode is activated) for the respective immersive application, the computer system 101 displays the hand 7022′. In contrast, if the first application setting is in a second state (e.g., accessibility mode is not activated) different from the first state, the computer system 101 forgoes displaying (e.g., or obscures) the hand 7022′. In some embodiments, if a second application setting is in a first state (e.g., display of the control 7030 is enabled), the computer system displays the control 7030 corresponding to the location of the hand 7022 in response to the user 7002 directing the attention 7010 to the location of the hand 7022 (e.g., whether or not the hand 7022′ is visible in accordance with application type and/or the first application setting), whereas if the second application setting is in a second state (e.g., display of the control 7030 is suppressed), the computer system does not display the control 7030 corresponding to the location of the hand 7022 even if the user 7002 is directing the attention 7010 to the location of the hand 7022 (e.g., whether or not the hand 7022′ is visible in accordance with application type and/or the first application setting). FIG. 7AU also illustrates the attention 7010 of the user 7002 being directed toward the hand 7022′ while the palm 7025′ of the hand 7022′ faces a viewpoint of the user 7002 (e.g., and/or the attention 7010 of the user 7002 being directed toward a location in the three-dimensional environment 7000′ that corresponds to a physical location of hand 7022 in the physical environment 7000 while the palm 7025 of the hand 7022 faces the viewpoint of the user 7002, for example if hand 7022′ is not displayed).

In scenarios where the hand 7022 is not displayed in the viewport (e.g., while the first type of immersive application is displayed in the viewport, and/or while the first application setting is in the second state), the attention 7010 of the user 7002 may still be directed to a region (e.g., indicated by the hand 7022′ in dotted lines) that corresponds to where the hand 7022 is (e.g., by the user 7002 moving their head towards a location of the hand 7022 (e.g., the user 7002 lowers the head of the user 7002 and directs the attention 7010 toward a general direction of the lap of the user 7002 when the hand 7022 is on the lap of the user 7002)). Various system operations can still be triggered without the control 7030 being displayed in the viewport, as described in FIG. 7BE. In some embodiments, in response to detecting that attention is directed to the region that corresponds to where hand 7022 is (e.g., while a representation of hand 7022 is not visible), computer system makes an indication of the location of the hand visible (e.g., by removing a portion of virtual content displayed at a location of hand 7022, by reducing an opacity of a portion of virtual content displayed at a location of hand 7022, and/or by displaying a virtual representation of a in the region that corresponds to where hand 7022 is). In some embodiments, making the indication of the location of the hand visible includes displaying a view of the hand 7022 (e.g., the hand 7022′) with a first appearance (e.g., and/or a first level of prominence). In some embodiments, the first appearance corresponds to a first level of immersion (e.g., a current level of immersion with which the first type of immersive application is displayed), and the user 7002 can adjust the level of immersion (e.g., from the first level of immersion to a second level of immersion), and in response, the computer system 101 displays (e.g., updates display of) the hand 7022′ with a second appearance (e.g., and/or with a second level of prominence) that is different from the first appearance. For example, if the user 7002 increases the current level of immersion, the hand 7022′ is displayed with a lower level of visual prominence (e.g., to remain consistent with the increased level of immersion), and if the user 7002 decreases the current level of immersion, the hand 7022′ is displayed with a higher level of visual prominence. Alternately, if the user 7002 increases the current level of immersion, the hand 7022′ is displayed with a higher level of visual prominence (e.g., to ensure visibility of the hand, while the first type of immersive application is displayed with the higher level of immersion), and if the user 7002 decreases the current level of immersion, the hand 7022′ is displayed with a lower level of visual prominence.

FIG. 7AU shows that, due to the application user interface 7156 being an immersive application that is the first type of immersive application and/or the first application setting being in the second state (e.g., such that the view of the hand 7022′ is suppressed, and consequently display of the control 7030 is suppressed), and/or the second application being in the second state (e.g., such that display of the control 7030 itself is suppressed), even though the attention 7010 of the user 7002 is detected as being directed toward (e.g., the location of) the hand 7022′ in a “palm up” orientation, and display criteria are otherwise met, the control 7030 is not displayed.

FIG. 7AV illustrates an example transition from FIG. 7AU. FIG. 7AV illustrates the attention 7010 of the user 7002 being directed toward a region 7162 around the hand 7022′ (e.g., or a location corresponding to the hand 7022) while the hand 7022 is in the “palm up” orientation in conjunction with the user 7002 performing an air pinch gesture (e.g., illustrated in the first two diagrams in FIG. 7B (a)).

FIG. 7AW illustrates an example transition from FIG. 7AV. FIG. 7AW illustrates the attention 7010 of the user 7002 being directed toward the hand 7022′ (e.g., or a location corresponding to the hand 7022) in conjunction with the user 7002 releasing the air pinch gesture (e.g., illustrated in the last two diagrams in FIG. 7B (a)) while the hand 7022′ is in the “palm up” orientation. Based on the user 7002 having performed the air pinch gesture while the attention 7010 is directed toward the hand 7022′ within the region 7162, and while the attention 7010 remains on the hand 7022′, the computer system 101 displays control 7030. In some embodiments, in response to detecting that attention is directed to the region that corresponds to where the hand 7022 is (e.g., while the representation 7022′ of the hand 7022 is not visible) and criteria for displaying the control 7030 has been met (e.g., because the palm 7025 of the hand 7022 is facing up), the computer system 101 makes an indication of the location of the hand 7022 visible (e.g., by removing a portion of virtual content displayed at a location of hand 7022, by reducing an opacity of a portion of virtual content displayed at a location of the hand 7022, and/or by displaying a virtual representation of a hand in the region that corresponds to where the hand 7022 is). In some embodiments, in response to detecting that attention 7010 of the user 7002 is directed to the region that corresponds to where the hand 7022 is (e.g., while the representation 7022′ of the hand 7022 is not visible) and criteria for displaying the control 7030 has not been met (e.g., because the palm 7025 of the hand 7022 is not facing up), the computer system 101 does not make an indication of the location of the hand 7022 visible even though the attention 7010 of the user 7002 is directed to the region that corresponds to where the hand 7022 is.

FIGS. 7AX-7AY illustrate an alternative sequence to that illustrated in FIGS. 7AV-7AW. FIG. 7AX illustrates the attention 7010 of the user 7002 being directed outside the region 7162 while the hand 7022′ is in the “palm up” orientation in conjunction with the user 7002 performing an air pinch gesture. FIG. 7AY illustrates an example transition from FIG. 7AX. FIG. 7AY illustrates the user 7002 releasing the air pinch gesture (e.g., as illustrated in FIG. 7AX) while the hand 7022′ is in the “palm up” orientation while the attention 7010 of the user 7002 is directed toward the hand 7022′. Based on the user 7002 having performed (e.g., initiated) the air pinch gesture while the attention 7010 of the user 7002 was directed outside the region 7162, even though the attention 7010 has shifted toward the hand 7022′ before or in conjunction with the release of the air pinch gesture, the computer system forgoes displaying control 7030 in response to detecting the release of the air pinch gesture.

FIG. 7AZ illustrates an example transition from FIG. 7AW. FIG. 7AZ illustrates the attention 7010 of the user 7002 being directed toward a region 7164 around the hand 7022′ (e.g., or a location corresponding to the hand 7022) while the hand 7022 is in the “palm up” orientation in conjunction with the user 7002 performing a second air pinch gesture (e.g., after the first air pinch gesture illustrate in FIG. 7AV). In some embodiments, the region 7164 is smaller than the region 7162. Having a smaller region 7164 than the region 7162 reduces the probability of an inadvertent activation or selection of the control 7030 by requiring the user 7002 to direct the attention 7010 to a more localized region.

FIG. 7BA illustrates an example transition from FIG. 7AZ. FIG. 7BA illustrates the user 7002 releasing the air pinch gesture while the hand 7022 is in the “palm up” orientation, and optionally in conjunction with the attention 7010 of the user 7002 being directed toward the hand 7022′ (e.g., in some embodiments the attention 7010 may be directed away from the region 7164 and/or the hand 7022′ once the hand 7022′ un-pinches). Based on the user 7002 having performed (e.g., initiated) the second air pinch gesture (e.g., an activation input for the control 7030, and/or a selection of the control 7030) while the attention 7010 is directed toward the hand 7022′ within the region 7164, and optionally while the attention 7010 remains on the hand 7022′, the computer system 101 displays home menu user interface 7031. In some embodiments, the computer system 101 generates output audio 7103-d when the control 7030 is selected (e.g., the audio 7103-d is distinct from each of audio 7103-a, 7103-b, and 7103-c). Optionally, the computer system 101 may visually deemphasize (e.g., by making application user interface 7156 more translucent (e.g., reduced an opacity), by fading out, increasing a degree of blurring, reducing a brightness, reducing a saturation, reducing intensity, reducing a contrast, reducing an immersion level associated with the application user interface 7156, and/or other visual deemphasis, including in some embodiments ceasing display of) the application user interface 7156 of the immersive application in conjunction with displaying the home menu user interface 7031.

FIGS. 7BB-7BC illustrate an alternative sequence to that illustrated in FIGS. 7AZ and 7BA. FIG. 7BB illustrates an example transition from FIG. 7AW and shows the attention 7010 of the user 7002 being directed outside the region 7164 while the hand is in the “palm up” orientation in conjunction with the user 7002 performing a second air pinch gesture. In some embodiments, when the attention 7010 of the user 7002 moves away from the hand 7022′ (e.g., outside both the region 7164 and the region 7162), the computer system 101 ceases display of the control 7030. When the attention 7010 of the user 7002 moves back within the region 7164 (e.g., optionally within a threshold time period), the computer system 101 displays (e.g., redisplays) the control 7030.

FIG. 7BC illustrates an example transition from FIG. 7BB. FIG. 7BC illustrates the attention 7010 of the user 7002 being redirected toward the hand 7022′ in conjunction with the user 7002 releasing the air pinch gesture (e.g., in FIG. 7BB) while the hand 7022′ is in the “palm up” orientation. Based on the user 7002 having performed (e.g., initiated) the second air pinch gesture while the attention 7010 of the user 7002 was directed outside the region 7164, even though the attention 7010 returned to the hand 7022′ (e.g., at a location within the region 7164) before or in conjunction with the release of the second air pinch gesture, the computer system 101 forgoes displaying the home menu user interface 7031 in response to detecting the release of the second air pinch gesture. In some embodiments, by requiring the attention 7010 of the user 7002 to be within the region 7164, the computer system 101 provides a way for the user to cancel (or, optionally, exit) an accidental triggering of the display of the control 7030 (e.g., by directing the attention 7010 away from the region 7164), after visual feedback is provided to the user 7002 by the display of the control 7030.

FIG. 7BD illustrates invoking the display of the control 7030 while an application user interface 7166 of an immersive application (e.g., App Z2) is displayed in the viewport. The immersive application may be a second type of immersive application that displays the hand 7022′ in the viewport while the application user interface 7166 is displayed (e.g., and/or has the first application setting in the first state). The hand 7022′ is visible in the viewport (e.g., by breaking through the application user interface 7166) while the application user interface 7166 of the immersive application is displayed in the viewport. Based on the hand 7022′ being in the “palm up” configuration when the attention 7010 of the user 7002 is detected as being directed toward the hand 7022′, the computer system 101 displays the control 7030 concurrently with displaying the application user interface 7166 (e.g., optionally in accordance with the second application setting being in the first state to enable display of the control 7030).

FIG. 7BE illustrates system operations that can be performed while an application user interface 7168 of an immersive application is displayed in the viewport (e.g., even without the control 7030 being displayed in the viewport). The immersive application (e.g., App Z3) illustrated in FIG. 7BE may be the first type of immersive application described with reference to FIG. 7AU or an immersive application that has the first application setting in the second state (e.g., such that the view of the hand 7022′ is suppressed, and consequently display of the control 7030 is suppressed), and/or the second application in the second state (e.g., such that display of the control 7030 itself is suppressed). As a result, the computer system 100 does not display the hand 7022′ nor the control 7030 in the viewport while the application user interface 7168 is displayed in the viewport.

In scenario 7170-1, hand 7022 performs a pinch and hold gesture while the application user interface 7168 of an immersive application (e.g., App Z3) is displayed in the viewport and the hand 7022′ is not displayed in the viewport. In response to detecting that the pinch and hold gesture (e.g., as described with reference to FIG. 7B (c)) in scenario 7170-1 is maintained for a threshold period of time while the attention 7010 of the user 7002 is directed to the location of the hand 7022, the scenario 7170-1 transitions to scenario 7170-2 in which the computer system 101 displays an indicator 8004 (e.g., a visual indicator that corresponds to a current value for the volume level that is being adjusted), optionally concurrently with displaying the application user interface 7168. In some embodiments, the application user interface 7168 is visually deemphasized while the indicator 8004 is displayed. In response to detecting that the pinch and hold gesture in scenario 7170-1 is not maintained for the threshold period of time (e.g., the hand 7022 instead performing an air pinch (e.g., and un-pinch) gesture as described with reference to FIG. 7B (a)) while the attention 7010 of the user 7002 is directed to the location of the hand 7022, the scenario 7170-1 transitions to scenario 7170-3 in which the computer system 101 displays the home menu user interface 7031.

Alternatively, in scenario 7170-4, hand 7022 is in a palm up orientation while the application user interface 7168 is displayed in the viewport. In response to detecting a change in orientation of the hand 7022 from the palm up orientation to the palm down orientation (e.g., as described with reference to FIG. 7B (b)) while the attention 7010 of the user 7002 is directed to the location of the hand 7022, the scenario 7170-4 transitions to scenario 7170-5, in which the status user interface 7032 is displayed in the viewport, optionally concurrently with the application user interface 7168. In some embodiments, the application user interface 7168 is visually deemphasized while the status user interface 7032 is displayed. In response to detecting the hand 7022 performing an air pinch gesture while the palm down orientation is maintained (e.g., as described with reference to FIG. 7B (d)) while the attention 7010 of the user 7002 is directed to the location of the hand 7022, the scenario 7170-5 transitions to scenario 7170-6, in which the computer system 101 replaces the display of the status user interface 7032 with the display of system function menu 7044.

In some embodiments, even when the hand 7022′ is not displayed in the viewport while an immersive application is being displayed, the user 7002 performs one or more system operations without directing the attention 7010 to a location in the viewport that corresponds to the position of the hand 7022 in the physical environment 7000. For example, in response to detecting a palm-up pinch gesture (e.g., optionally maintained for at least a threshold period of time as a palm-up pinch and hold gesture) while an immersive application is displayed in the viewport, optionally without the attention 7010 being directed to any specific location in the three-dimensional environment 7000′, the computer system 101 displays an application switching user interface that allows the user 7002 to switch between different applications that are currently open (e.g., running in the foreground, or running in the background) on the computer system 101.

In some embodiments, in addition to or instead of displaying the system user interfaces illustrated in FIG. 7BE (e.g., the status user interface 7032, the home menu user interface 7031, the system function menu 7044, and/or the indicator 8004) the gestures described in FIGS. 7B-7BE may be used to display other system user interfaces, such as a multitasking user interface that displays one or more representations of applications that were recently open on computer system 101 (e.g., application user interfaces that are within the viewport, application user interfaces that are outside the viewport, and/or minimized or hidden applications that are open or were recently open on computer system 101) and/or the application switching user interface.

Additional descriptions regarding FIGS. 7B-7BE are provided below in reference to method 10000 described with respect to FIGS. 10A-10K, method 11000 described with respect to FIGS. 11A-11E, method 15000 described with respect to FIGS. 15A-15F, method 16000 described with respect to FIGS. 16A-16F, and method 18000 described with respect to FIG. 18.

FIGS. 8A-8T show example user interfaces for adjusting a volume level of the computer system 101. The user interfaces in FIGS. 8A-8T are used to illustrate the processes described below, including the processes in FIGS. 13A-13G and FIG. 18.

FIG. 8A is analogous to FIG. 7Q1, and shows that in response to detecting that the attention 7010 of the user 7002 is directed toward the hand 7022′, while the hand 7022′ is in the “palm up” orientation, the computer system 101 displays the control 7030. In FIG. 8B, while the control 7030 is displayed, the computer system 101 detects an air pinch gesture performed by the hand 7022′ of the user 7002. In FIG. 8C, in response to detecting the air pinch gesture (e.g., while the control 7030 is displayed) and optionally release of the air pinch gesture, the computer system 101 displays the home menu user interface 7031. In FIG. 8D, while displaying the home menu user interface 7031, the computer system 101 detects an air pinch gesture performed by the hand 7022′, while the attention 7010 of the user is directed toward an affordance 8024 (e.g., an application icon corresponding to a media application) of the home menu user interface 7031.

In FIG. 8E, in response to detecting the air pinch gesture (e.g., in FIG. 8D, while the attention 7010 of the user is directed toward the affordance 8024), the computer system 101 displays a user interface 8000. In some embodiments, the user interface 8000 is an application user interface (e.g., for the media application that corresponds to the affordance 8024).

In some embodiments, the user interface 8000 includes audio content, and the computer system 101 includes one or more audio output devices that are in communication with the computer system (e.g., one or more speakers that are integrated into the computer system 101 and/or one or more separate headphones, earbuds or other separate audio output devices that are connected to the computer system 101 with a wired or wireless connection). For example, in FIG. 8E, the user interface 8000 includes a video that is playing, and the video includes both a visual component and an audio component 8002 (e.g., which is sometimes used herein, when describing the audio component regardless of what volume level the audio component is output at or with). In some embodiments, the computer system 101 outputs the audio 8002-a with a first volume level (e.g., where the “8002” indicates the audio component that is being output, and the “-a” modifier indicates the volume level at which the audio component 8002 is output), where the first volume level corresponds to the current volume level (e.g., the current value for the volume level) of the computer system 101 shown in FIG. 8E. As used herein, “volume level” refers to the volume level and/or volume setting of the computer system 101, which modifies the audio output of playing audio (e.g., the audio component 8002), which can be adjusted and/or modified by the user 7002. The “volume level” (e.g., of and/or for the computer system 101) is independent of (e.g., can be adjusted and/or modified independently of) the “volume” of the playing audio, which is used herein to describe inherent changes in loudness and softness in the playing audio. For example, if the playing audio is music, the music will typically naturally have louder portions and softer portions, which will always be louder and/or softer, relative to other portions of the music. The relationship between louder portions and softer portions of the music (e.g., the difference in volume between the louder portions and the softer portions) cannot be modified by the user 7002. Increasing or decreasing the “volume level” of the computer system 101 can increase or decrease the perceived loudness or softness of the music (e.g., due to increased audio output from one or more audio output devices, but does not affect the relationship between the louder portions and the softer portions (e.g., the difference in volume between the louder portions and the softer portions remains the same, because the louder portions and the softer portions are all modified by the “volume level” of the computer system 101 by the same amount).

In FIG. 8F, while the user interface 8000 is displayed (e.g., and while the visual and audio content of the video in the user interface 8000 continue to play), the computer system 101 detects that the attention 7010 of the user 7002 is directed toward the hand 7022′, and in response, the computer system 101 displays the control 7030.

In FIG. 8G, while displaying the control 7030 (e.g., and while the visual and audio content of the video in the user interface 8000 continues to play), the computer system detects an air pinch (e.g., an initial pinch or air pinch portion of a pinch and hold gesture, and/or initial contact between the thumb and pointer of the hand 7022′), performed by the hand 7022′ of the user 7002.

In some embodiments, in response to detecting the air pinch (e.g., the initial air pinch of the pinch and hold gesture), the computer system 101 displays the control 7030 with a different appearance (e.g., and/or changes the appearance of the control 7030). For example, in response to detecting the initial air pinch (e.g., of the pinch and hold gesture) in FIG. 8G, the computer system 101 changes a size, shape, color, and/or other visual characteristic of the control 7030 (e.g., to provide visual feedback that an initial air pinch has been detected, and/or that maintaining the air pinch will cause the computer system 101 to detect a pinch and hold gesture). In some embodiments, in response to detecting the initial air pinch, the computer system 101 outputs first audio (e.g., first audio feedback, and/or a first type of audio feedback).

In some embodiments, if the attention 7010 of the user 7002 is directed toward another interactive user interface object (e.g., a button, a control, an affordance, a slider, and/or a user interface) and not the hand 7022′, the computer system 101 performs an operation corresponding to the interactive user interface object in response to detecting the air pinch, and forgoes performing the operations shown and described below with reference to FIGS. 8H-8T. For example, in FIG. 8G, if the attention 7010 of the user 7002 is directed toward a video progress bar in the user interface 8000 when the air pinch gesture is detected, the computer system 101 performs a selection operation directed toward a slider of the video progress bar (e.g., and begins adjusting the playback of the video in accordance with movement of the slider along the video progress bar if the air pinch gesture is followed by hand movement, optionally while the air pinch gesture is maintained). The computer system 101 also ceases to display the control 7030 (e.g., because the attention 7010 of the user 7002 is not directed toward the hand 7022′ while the attention 7010 of the user 7002 is directed toward the video progress bar in the user interface 8000). In this example, the user 7002 cannot adjust a current value for the volume level of the computer system 101, as described below with reference to FIGS. 8H-8T, without first directing (e.g., redirecting) the attention 7010 of the user 7002 back to the hand 7022′ (e.g., performing the operations shown in FIG. 8F and FIG. 8G, again).

In FIG. 8H, the computer system 101 determines that the user 7002 is performing a pinch and hold gesture with the hand 7022. In some embodiments, the computer system 101 determines that the user 7002 is performing the pinch and hold gesture when the user 7002 maintains the initial pinch (e.g., maintains contact between two or more fingers of the hand 7022′, such as the thumb and pointer of the hand 7022′) detected in FIG. 8G for a threshold amount of time (e.g., 0.5 seconds, 1 second, 1.5 seconds, 2 seconds, 2.5 seconds, 5 seconds, or 10 seconds). In some embodiments, if the computer system 101 detects termination of the initial pinch before the threshold amount of time has elapsed, the computer system 101 determines that the user 7002 is performing an air pinch (and un-pinch) gesture (e.g., sometimes called a pinch and release gesture, or an air pinch and release gesture) (e.g., instead of a pinch and hold gesture). In some embodiments, in such circumstances, home menu user interface 7031 would be displayed in response to the air pinch gesture.

In response to detecting the pinch and hold gesture performed by the hand 7022′, the computer system 101 begins adjusting the volume level for the computer system 101. In some embodiments, the computer system 101 displays an indicator 8004 (e.g., a visual indicator that corresponds to a current value for the volume level that is being adjusted), in response to detecting the pinch and hold gesture performed by the hand 7022′. In some embodiments, the computer system 101 displays an animated transition of the control 7030 transforming into the indicator 8004 (e.g., an animated transition that includes fading out the control 7030 and fading in the indicator 8004; or an animated transition that includes changing a shape of the control 7030 (e.g., stretching and/or deforming the control 7030) as the control 7030 transforms into the indicator 8004). In some embodiments, in response to detecting the pinch and hold gesture (e.g., once the computer system 101 determines that the user 7002 is performing the pinch and hold gesture), the computer system 101 outputs second audio (e.g., second audio feedback, and/or a second type of audio feedback). In some embodiments, the first audio and the second audio are the same. In some embodiments, the first audio and the second audio are different.

In some embodiments, the indicator 8004 includes one or more visual components that indicate the current value for the volume level that is being adjusted. For example, the indicator 8004 includes: a solid black bar that indicates the current value (e.g., where a minimum value of 0% is on the far left of the indicator 8004, and a maximum value of 100% is on the far right of the indicator 8004); and a speaker icon with sound waves, where the number of sound waves corresponds to the current value for the volume level).

In some embodiments, once the computer system 101 detects the pinch and hold gesture (e.g., once the computer system 101 detects that the air pinch has been maintained for more than the threshold amount of time), the computer system 101 begins to adjust the current value for the volume level, regardless of where the attention 7010 of the user 7002 is directed. For example, in FIG. 8H, even though the attention 7010 of the user 7002 is directed toward the user interface 8000 (e.g., and not the hand 7022′), the computer system 101 continues to adjust the current value for the volume level. In some embodiments, the computer system 101 adjusts the current value for the volume level by an amount that is proportional to the amount of movement of the hand 7022′ (e.g., a larger and/or faster movement of the hand 7022′ results in a larger change in the current value for the volume level, while a smaller and/or slower movement of the hand 7022′ results in a smaller change in the current value for the volume level).

In FIG. 8I, while maintaining the pinch and hold gesture, and while the indicator 8004 is displayed, the user 7002 moves the hand 7022′ from a position 8007 (e.g., the position of the hand 7022′ in FIG. 8H) to a new position (e.g., the position shown in FIG. 8I), while the hand 7022′ is performing the pinch and hold gesture (e.g., while contact between at least two of the fingers of the hand 7022′ continues to be detected by the computer system 101). In response to detecting the movement of the hand 7022′, and while the hand 7022′ is performing the pinch and hold gesture, the computer system 101 adjusts (e.g., lowers) the current value for the volume level. At the current value for the volume level shown in FIG. 8I, the computer system 101 outputs audio 8002-b with a second volume level, which is lower than the first volume level described above with reference to FIG. 8E (e.g., as shown by the use of thinner, and fewer, lines representing the audio 8002-b, as compared to the audio 8002-a in FIG. 8E).

An outline 8006 shows the previous value for the volume level (e.g., the length/position of the solid black bar in FIG. 8H). The speaker icon is also displayed with only a single sound wave (e.g., as opposed to the two sound waves in FIG. 8H), which also reflects the adjustment (e.g., reduction) in volume level.

In FIG. 8J, the user 7002 continues to move the hand 7022′ from a position 8011 (e.g., the position of the hand 7022′ in FIG. 8I), to a new position (e.g., the position shown in FIG. 8J), while the hand 7022′ is performing the pinch and hold gesture (e.g., while the hand 7022′ maintains the pinch and hold gesture). In response to detecting the further movement of the hand 7022′ while the hand 7022′ is performing the pinch and hold gesture, the computer system 101 continues to adjust (e.g., lower) the current value for the volume level (e.g., in the same manner or direction as in FIG. 8I), down to a minimum value for the volume level. An outline 8012 shows the previous value for the volume level (e.g., the length/position of the solid black bar in FIG. 8I). The speaker icon is displayed without any sound waves (e.g., indicating that the current value for the volume level is the minimum value, which is optionally a 0 value or a value where no sound or audio is generated, as also indicated by the absence from FIG. 8J of the audio component 8002 of the video that is playing).

In some embodiments, in response to detecting that the current value for the volume level is (e.g., and/or has reached) the minimum value for the volume level, the computer system 101 outputs audio 8010 (e.g., to provide audio feedback to the user that the current volume level is now the minimum value, and that the current value for the volume level cannot be further lowered). In some embodiments, the computer system 101 outputs audio (e.g., which is, optionally, the same audio as the audio 8010) in response to detecting that the current value for the volume level is (e.g., and/or has reached) the maximum value for the volume level (e.g., if the hand 7022′ were moving in the opposite direction from that shown in FIG. 8I to FIG. 8J, and if the current value for the volume level were being increased).

In some embodiments, although the hand 7022′ is moving (e.g., to the left, relative to the view that is visible via the display generation component 7100a) in FIG. 8I and FIG. 8J, the indicator 8004 does not move (e.g., is displayed at the same location in FIG. 8H, FIG. 8I, and FIG. 8J). In some embodiments, the indicator 8004 does not move once displayed (e.g., regardless of movement of the hand). In some embodiments, the indicator 8004 does not move if the current value for the volume level is between the minimum and maximum value (e.g., between 0% and 100%) for the volume level.

FIG. 8K shows further movement of the hand 7022′, after the current value for the volume level has reached the minimum value. An outline 8016 shows the previous position of the hand 7022′ (e.g., the position of the hand 7022′ in FIG. 8J). Because the current value for the volume level had already reached the minimum value, and the computer system 101 detected further movement of the hand 7022′ (e.g., in the same direction as in FIG. 8I and FIG. 8J), the computer system 101 moves the indicator 8004 in accordance with movement of the hand 7022′. An outline 8014 shows the previous position of the indicator 8004 (e.g., the position of the indicator 8004 in FIG. 8J). More generally, in response to movement of the hand 7022′ that corresponds to a request to decrease the volume level below a lower limit (e.g., the minimum value), or increase the volume level above an upper limit (e.g., the maximum level), the computer system 101 moves the indicator 8004 in accordance with movement of the hand 7022′ (e.g., instead of changing the volume level, which is already at a limit).

In some embodiments, the indicator 8004 begins moving from its original location (e.g., the location shown in FIG. 8J), and moves by an amount that is proportional to the further movement of the hand 7022′ shown in FIG. 8K. In some embodiments, the indicator 8004 first “snaps to” to the hand 7022′ (e.g., is immediately displayed at a new position that maintains a same spatial relationship to the hand 7022′ in FIG. 8K, as the spatial relationship of the indicator 8004 to the hand 7022′ in FIG. 8H), then moves (e.g., continues moving) by an amount that is proportional to the further movement of the hand 7022′.

In some embodiments, the computer system 101 moves the indicator 8004 in accordance with movement of the hand 7022′ (e.g., regardless of the current value for the volume level). For example, in FIG. 8I and FIG. 8J, the computer system 101 would display the indicator 8004 moving toward the left of the display generation component 7100a (e.g., by an amount that is proportional to the amount of movement of the hand 7022′) (e.g., while also decreasing the volume level). In some embodiments, while the computer system 101 is moving the indicator 8004, the indicator 8004 exhibits analogous behavior to the control 7030, as described with reference to FIGS. 7R1-7T (e.g., behavior regarding a change in appearance, and/or when the control 7030/indicator 8004 ceases to be displayed). For example, if the hand 7022′ moves by more than a threshold distance, and/or if the hand 7022′ moves at a velocity that is greater than a threshold velocity, the computer system 101 moves the indicator 8004 in accordance with the movement of the hand 7022′, but displays the indicator 8004 with a different appearance (e.g., with a dimmed or faded appearance, with a smaller appearance, with a blurrier appearance, and/or with a different color, relative to a default appearance of the indicator 8004 (e.g., an appearance of the indicator 8004 in FIG. 8H)).

In FIG. 8L, the user 7002 moves the hand 7022′ in a direction that is opposite the direction of movement in FIGS. 8I-8K (e.g., to the right, in FIG. 8L, as opposed to the left as in FIGS. 8I-8K), and performs a hand flip that transitions the hand 7022′ from the “palm up” orientation to the “palm down” orientation, while maintaining the air pinch (e.g., maintaining contact between the pointer and the thumb of the hand 7022′). An outline 8018 shows the previous position of the hand 7022′ (e.g., the position of the hand 7022′ in FIG. 8K).

In response to detecting the movement of the hand 7022′ (e.g., to the right), the computer system 101 adjusts (e.g., increases) the current value for the volume level (e.g., as indicated by the presence of audio 8002-c, as compared to the absence of audio component 8002 in FIGS. 8J-8K). In some embodiments, the user 7002 can continue to adjust the current value for the volume level as long as the user 7002 maintains the air pinch with the hand 7022′ (e.g., optionally, regardless of the orientation of the hand 7022′).

At the current value for the volume level shown in FIG. 8L, the computer system 101 outputs audio 8002-c with a third volume level, which is higher than the first volume level described above with reference to FIG. 8E, and also higher than the second volume level described above with reference to FIG. 8I (e.g., as shown by the use of thicker, and more numerous, lines representing the audio 8002-c, as compared to the audio 8002-a in FIG. 8E and the audio 8002-b in FIG. 8I).

With respect to the indicator 8004, the solid black bar of the indicator 8004 increases (e.g., occupies more of the indicator 8004, as compared to FIG. 8H, FIG. 8I, and FIGS. 8J-8K), and the speaker icon includes more sound waves (e.g., four sound waves) as compared to FIG. 8H (e.g., showing two sound waves), FIG. 8I (e.g., showing one sound wave), and FIGS. 8J-8K (e.g., showing no sound waves).

In FIG. 8M, the computer system 101 detects movement of the hand 7022′ in a downward direction (e.g., relative to the display generation component 7100a) that is different than the direction of movement in FIGS. 8I-8L (e.g., a leftward direction in FIGS. 8I-8K, and a rightward direction in FIG. 8L). In response to detecting the movement of the hand 7022′ in the upward direction, the computer system 101 moves the indicator 8004 in accordance with the movement of the hand 7022′ (e.g., in a downward direction, by an amount that is proportional to the amount of movement of the hand 7022′ in the downward direction). An outline 8022 shows the previous position of the hand 7022′ (e.g., the position of the hand 7022′ in FIG. 8L), and an outline 8020 shows the previous position of the indicator 8004 (e.g., the position of the indicator 8004 in FIG. 8L). FIG. 8M also shows that the attention 7010 of the user 7002 returns to the hand 7022′ (e.g., away from the user interface 8000).

In some embodiments, the computer system 101 moves the indicator 8004 in accordance with the movement of the hand 7022′ along a vertical axis (e.g., upwards and/or downwards, along the vertical axis), regardless of the current value of the volume level (e.g., in FIG. 8M, the current value of the volume level is neither the minimum nor the maximum value), and optionally without changing the current value of the volume level.

In some embodiments, the computer system 101 detects movement of the hand 7022′ that includes both a horizontal component (e.g., leftward and/or rightward movement, as shown in FIGS. 8I-8L) and a vertical component (e.g., upward and/or downward movement, as shown in FIG. 8M). In response to detecting the movement of the hand 7022′, if the current value for the volume level is at the minimum or maximum value (e.g., or once the current value for the volume level is at the minimum or maximum value), the computer system 101 moves the indicator 8004 in accordance with both the vertical and horizontal movement of the hand 7022′. If the current value for the volume level is not at the minimum or maximum value, the computer system 101 moves the indicator 8004 in accordance with the vertical movement of the hand 7022′, but does not move the indicator 8004 in accordance with the horizontal movement of the hand 7022′ (e.g., the computer system 101 instead changes the volume level in accordance with the horizontal movement of the hand 7022′, until the minimum or maximum value is reached).

In some embodiments, if the current value for the volume level is not at the minimum or maximum value, and the hand 7022′ moves by a first amount in the vertical direction and by the first amount in the horizontal direction (e.g., the hand 7022′ moves by the same amount in both the vertical and horizontal direction), the computer system 101 moves the indicator 8004 in the vertical direction by a second amount that is proportional to the first amount, and the computer system 101 moves the indicator 8004 in the horizontal direction by a third amount that is less than the second amount (e.g., but is still proportional to the first amount).

FIGS. 8N-8P show examples where the user 7002 terminates the pinch and hold gesture by un-pinching, such that there is a break in contact between the fingers (e.g., the thumb and pointer) of the hand 7022′.

In FIG. 8N, the attention 7010 of the user 7002 is directed toward the hand 7022′ at the time that the computer system 101 detects the termination of the pinch and hold gesture (e.g., detects that the user 7002 un-pinches the hand 7022′). Since the hand 7022′ is in the “palm down” orientation when the termination of the pinch and hold gesture is detected, the computer system displays the status user interface 7032.

In FIG. 8O, the attention 7010 of the user 7002 is directed toward the hand 7022′ at the time that the computer system 101 detects the termination of the pinch and hold gesture (e.g., detects that the user 7002 un-pinches the hand 7022′). Since the hand 7022′ is in the “palm up” orientation when the termination of the pinch and hold gesture is detected (e.g., FIG. 8O illustrates an alternative transition that follows directly from FIG. 8K, without the user performing the hand flip shown in FIG. 8L), the computer system displays the control 7030.

In FIG. 8P, the attention 7010 of the user 7002 is not directed toward the hand 7022′ at the time that the computer system 101 detects the termination of the pinch and hold gesture (e.g., detects that the user 7002 un-pinches the hand 7022′). Since the attention 7010 of the user 7002 is not directed toward the hand 7022′ at the time that the computer system 101 detects the termination of the pinch and hold gesture, the computer system 101 ceases to display the indicator 8004 (e.g., and does not display the control 7030 or the status user interface 7032). While FIG. 8P shows the hand in the “palm up” orientation, the computer system 101 behaves similarly when the hand is in the “palm down” orientation (e.g., if the attention 7010 of the user 7002 is not directed toward the hand 7022′ at the time the termination of the pinch and hold gesture is detected, then the computer system 101 does not display the control 7030 or the status user interface 7032, regardless of the orientation and/or pose of the hand 7022′).

Whereas FIG. 8P illustrates an example transition from FIG. 8O, in which computer system 101 ceases display of the control 7030 in response to detecting that the attention 7010 is directed away from the hand 7022′ (e.g., toward the application user interface 8000), the reverse transition from FIG. 8P to FIG. 8O illustrates an example transition in which the computer system 101 displays (e.g., redisplays) the control 7030 in response to detecting that the attention 7010 moves (e.g., returns) to the hand 7022′ that is in the “palm up” configuration in FIG. 8O (e.g., from the application user interface 8000).

FIGS. 8Q-8S are analogous to FIGS. 8G-8I, except that in FIGS. 8Q-8S, the hand 7022 of the user 7002 is holding a controller 7111. Like FIG. 8G, FIG. 8Q illustrates that, while the attention 7010 of the user 7002 is directed toward the hand 7022′, causing the computer system to display the control 7030 relative to the controller 7111 as described herein with reference to FIG. 7Q3 (e.g., and while the visual and audio content of the video in the user interface 8000 continues to play), the computer system detects an input performed by the hand 7022 of the user 7002. In FIG. 8Q, however, the input detected by the computer system includes a press (e.g., an initial press) of a button 7117 of the controller 7111 (e.g., FIG. 8Q illustrates an example transition from an alternate version of FIG. 8F in which hand 7022′ is holding controller 7111, such as in FIG. 7AL1).

FIG. 8R is analogous to FIG. 8H, except that in FIG. 8R, the computer system 101 determines that hand 7022 is performing a press and hold of the button 7117 (e.g., maintaining the initial press of button 7117 shown in FIG. 8Q for a threshold amount of time, such as 0.5 seconds, 1 second, 1.5 seconds, 2 seconds, 2.5 seconds, 5 seconds, or 10 seconds) instead of an air pinch and hold gesture. FIG. 8R thus illustrates a transition from FIG. 8Q that is analogous to the transition from FIG. 8G to FIG. 8H, in that in response to detecting the button press and hold, the computer system 101 begins adjusting the volume level for the computer system 101 and optionally displays the indicator 8004 (e.g., even though the attention 7010 of the user 7002 is not directed toward the hand 7022′, as described herein with reference to FIG. 8H). FIG. 8R illustrates a contrast with FIG. 7AL2, in which the home menu user interface 7031 is displayed instead of the indicator 8004, in accordance with the input of FIG. 7AL1 being a press (e.g., a short press) of button 7117 (e.g., with the press of button 7117 being maintained for less than the threshold amount of time).

FIG. 8S illustrates a transition from FIG. 8R that is analogous to the transition from FIG. 8H to FIG. 8I. In particular, FIG. 8S shows that while maintaining the button press and hold (e.g., analogous to the pinch and hold gesture of FIG. 8I), and while the indicator 8004 is displayed, the user 7002 moves the hand 7022′ from a position 8026 (e.g., the position of the hand 7022′ in FIG. 8R) to a new position (e.g., the position shown in FIG. 8S), and in response the computer system 101 adjusts (e.g., lowers) the current value for the volume level, as indicated by the audio 8002-b in FIG. 8S, instead of the audio 8002-a in FIGS. 8Q-8R. In some embodiments, the computer system 101 changes the current value for the volume level based on the direction and/or magnitude of the movement of the controller 7111 analogously to the manner in which the computer system 101 changes the current value for the volume level based on the direction and/or magnitude of the movement of the hand 7022 as described herein with reference to FIGS. 8H-8M. Similarly, in some embodiments, the computer system 101 moves the indicator 8004 based on the direction and/or magnitude of the movement of the controller 7111 analogously to the manner in which the computer system 101 moves the indicator 8004 based on the direction and/or magnitude of the movement of the hand 7022 as described herein with reference to FIGS. 8H-8M.

FIG. 8T illustrates that the user 7002 has released the button 7117 of the controller 7111 and that, in response to detecting the release of the button press input, computer system 101 ends the volume level adjustment process and ceases to display the indicator 8004 (e.g., like in FIGS. 8O and 8P). In addition, because the attention 7010 of the user 7002 is not directed toward the hand 7022′, the computer system 101 does not display the control 7030, either (e.g., like in FIG. 8P).

In some embodiments, the indicator 8004 is displayed as long as the pinch and hold gesture, or button press and hold gesture in the case of a controller 7111, is maintained. For example, the indicator 8004 is displayed until the user 7002 un-pinches the fingers of the hand 7022′ (e.g., until the computer system 101 detects a break in contact between the fingers of the hand 7022′) or releases button 7117. In some embodiments, the computer system 101 ceases to display the indicator 8004 if the computer system 101 does not detect movement of the hand 7022′ for a threshold amount of time (e.g., 0.5 seconds, 1 second, 1.5 seconds, 2 seconds, 5 seconds, or 10 seconds), even if the computer system 101 detects that the pinch and hold gesture or button press is maintained. Optionally, the computer system 101 redisplays the indicator 8004 in response to detecting movement of the hand 7022′ (e.g., as long as the pinch and hold gesture or button press is maintained).

In some embodiments, the volume level can also be adjusted through alternative means (e.g., in addition to and/or in lieu of the methods described above), such as through a mechanical input mechanism (e.g., a button, a dial, a crown, or other input mechanism). In some embodiments, the volume level can be adjusted through the alternative means only if the computer system 101 is configured to allow volume level adjustment via the alternative means (e.g., a setting that enables volume level adjustment via the alternative means is enabled for the computer system 101).

For example, the computer system 101 includes a digital crown 703 (e.g., a physical input mechanism that can be rotated). In response to detecting rotation of the digital crown 703 in a first direction (e.g., a clockwise direction), the computer system 101 adjusts the volume level for the computer system 101 in a first manner (e.g., increases the volume level). In response to detecting rotation of the digital crown 703 in a second direction opposite the first direction (e.g., a counter-clockwise direction), the computer system 101 adjusts the volume level for the computer system 101 in a second manner (e.g., decreases the volume level). Optionally, a speed and/or magnitude of the rotation of the digital crown 703 controls by how much and/or how fast the value for the volume level is increased and/or decreased (e.g., faster and/or larger rotations increase and/or decrease the volume level by a larger amount and/or a larger rate of change, and slower and/or smaller rotations increase and/or decrease the volume level by a smaller amount and/or a smaller rate of change).

In some embodiments, the mechanical input mechanism(s) are enabled for changing a level of immersion for the computer system 101 (e.g., from a first level of immersion to a second level of immersion) (e.g., in addition to, or in lieu of, adjust the volume level). In some embodiments, the degree and/or rate at which the level of immersion is adjusted is based on the magnitude of movement of mechanical input mechanism(s) (e.g., in an analogous manner to the adjustment of the volume level described above).

In some embodiments, the level of immersion describes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion).

In some embodiments, the mechanical input mechanism(s) are only enabled for adjusting the volume level if audio is currently playing for the computer system 101 (e.g., and optionally, if audio is not currently playing, the mechanical input mechanism(s) are instead enabled for changing the level of immersion). In some embodiments, the computer system 101 selects a default choice between adjusting the volume level and changing the level of immersion, based on whether or not audio is playing for the computer system 101. For example, if audio is playing for the computer system 101, the computer system 101 selects adjusting the volume level as the default behavior in response to detecting movement of the mechanical input mechanism(s); and if audio is not playing for the computer system 101, the computer system 101 selects changing the level of immersion as the default behavior in response to detecting movement of the mechanical input mechanism(s). In some embodiments, if the computer system 101 is not configured to allow volume level adjustment via the alternative means, then the computer system 101 always selects changing the level of immersion as the default choice (e.g., irrespective of whether or not audio is playing for the computer system 101).

In some embodiments, the user 7002 can manually override the default choice selected by the computer system 101. For example, if audio is playing, the computer system 101 defaults to adjusting the volume level in response to detecting movement of the mechanical input mechanism(s), but the user 7002 can override this default choice (e.g., by performing a user input), which enables changing the level of immersion in response to detecting movement of the mechanical input mechanism(s) (e.g., even though audio is playing for the computer system 101).

Additional descriptions regarding FIGS. 8A-8T are provided below in reference to method 13000 described with respect to FIGS. 13A-13G and method 18000 described with respect to FIG. 18.

FIGS. 9A-9P illustrate examples of placing a home menu user interface based on characteristics of the user input used to invoke the home menu user interface and/or user posture when the home menu user interface is invoked. The user interfaces in FIGS. 9A-9P are used to illustrate the processes described below, including the processes in FIGS. 12A-12D.

FIG. 9A illustrates a view of a three-dimensional environment (e.g., corresponding at least partially to the physical environment 7000 in FIG. 7A) that is visible to the user 7002 via the display generation component 7100a of computer system 101. Side view 9020 shows that the head of the user 7002 is lowered relative to a horizon 9022, and top view 9028 shows that the head of the user 7002 is rotated slightly to the right of the user 7002, as represented by head direction 9024, as the user 7002 directs their attention 7010 to (e.g., by gazing at) a view 7022′ of the right hand 7022 (also called hand 7022′ for ease of reference). The horizon 9022 represents a horizontal reference plane in the three-dimensional environment that is at an eye level of the user 7002 (e.g., typically when the user 7002 is in an upright or standing position, and even though the gaze, or proxy for gaze, of the user 7002 and/or head may be pointed in a direction other than horizontally) and is sometimes also referred to as the horizon. The horizon 9022 is a fixed reference plane that does not change with changes in the head elevation of the user 7002 (e.g., head elevation pointing up, or head elevation pointing down) (e.g., without vertical or other translational movement of the head of the user 7002). As illustrated in side view 9020, the head of the user 7002 is lowered toward an arm 9026, resulting in a head direction 9024 (e.g., corresponding to the attention 7010) that is at a head angle θ with respect to the horizon 9022. Top view 9028 shows a torso vector 9030 of the user 7002 pointing from a torso 9027 of the user 7002 towards the physical wall 7006. The torso vector 9030 is optionally angularly rotated with respect to the head direction 9024 (e.g., the torso 9027 of the user 7002 is facing a different direction from the head direction 9024 of the user 7002). In some embodiments, the torso vector 9030 is perpendicular to a plane of the chest or the torso 9027 of the user 7002. Due to the posture of the user 7002 (e.g., head elevation pointing down), a large portion of the viewport into the three-dimensional environment includes the floor 7008′, in addition to the representation 7014′ of the physical object 7014 and the walls 7004′ and 7006′.

FIG. 9A illustrates the attention 7010 of user 7002 (e.g., gaze or an attention metric based on the gaze of the user, or a proxy for gaze) being directed toward the hand 7022′ while a palm 7025 (e.g., as illustrated in FIG. 7B) of the hand 7022 (e.g., represented by the view 7025′ of the palm in the viewport, also called palm 7025′ for ease of reference) faces a viewpoint of the user 7002. Based on the palm 7025′ of the hand 7022′ being oriented toward the viewpoint of the user 7002 when the attention 7010 of the user 7002 is detected as being directed toward the hand 7022′, the control 7030 is displayed. For example, the palm 7025 is detected as facing toward a viewpoint of the user 7002 in accordance with a determination that at least a threshold area or portion of the palm 7025 (e.g., at least 20%, at least 30%, at least 40%, at least 50%, more than 50%, more than 60%, more than 70%, more than 80%, or more than 90%) is detected by one or more input devices (e.g., in sensor system 6-102 (FIGS. 1H-1I)) as being visible from (e.g., facing toward) the viewpoint of the user 7002 and/or in accordance with a determination that the hand 7022′ is within a threshold range of hand poses (e.g., as described herein with reference to FIGS. 7AL3-7AL4).

FIG. 9B illustrates the user 7002 performing an air pinch gesture 9500-1 (e.g., including bringing two fingers into contact) while the control 7030 is displayed in the viewport and while the hand 7022 of the user 7002 is oriented with the palm 7025 of hand 7022 facing toward the viewpoint of the user 7002 (e.g., sometimes called a palm up air pinch gesture). Side view 9020 in FIG. 9B is analogous to side view 9020 in FIG. 9A. Similarly, top view 9028 in FIG. 9B is analogous to top view 9028 in FIG. 9A.

FIG. 9C illustrates an example transition from FIG. 9B. Based on the head elevation of the user 7002 being at a head angle θ relative to the horizon 9022 (e.g., θ is zero at horizon 9022) that is less than an angular threshold θₜₕ when the air pinch gesture 9500-1 by the hand 7022 is detected, an animation that presents the home menu user interface 7031 is displayed, optionally after the air pinch gesture 9500-1 is released (e.g., by breaking contact between two fingers). As used herein, the head angle θ is a signed angle that becomes more negative as the head of user 7002 is lowered with respect to the horizon 9022 (e.g., θ is zero at horizon 9022, negative when the head of the user 7002 is lowered below the horizon 9022, and positive when the head of the user 7002 is lifted above the horizon 9022). As used herein, the angular threshold θₜₕ is also a signed angle and may be, for example, 1, 2, 5, 10, 15, 25, 45, or 60 degrees below the horizon 9022 (e.g., −1, −2, −5, −10, −15, −25, −45, or −60 degrees). Thus, if the threshold angle θₜₕ is a negative angle, the head angle θ is less than the angular threshold θₜₕ if the head angle θ is more negative (e.g., a larger magnitude below the horizon 9022) than the threshold angle θₜₕ. The animation terminates with the display of the home menu user interface 7031 as described herein with reference to FIG. 9D. As illustrated in FIG. 9C, an animated portion 9040 of the home menu user interface 7031 is displayed within the viewport (e.g., at a lower left portion, or at another location within the viewport), at an intermediate location different from a display location of home menu user interface 7031 (e.g., after the animation terminates). Such an animation may provide visual feedback to the user 7002 that the air pinch gesture 9500-1 has successfully invoked home menu user interface 7031, and may guide the user 7002 to the display location of home menu user interface 7031. Optionally, the attention 7010 of the user 7002 no longer needs to be directed to the hand 7022′ once the air pinch gesture 9500-1 has invoked animated portion 9040. For example, the animated portion 9040 may include one or more of: content elements (e.g., application icons) of home menu user interface 7031 fading in and/or moving into place from edges of the viewport, content elements moving collectively from a portion of the viewport (as illustrated in FIG. 9C) to the display location along an animated trajectory, the content elements enlarging from respective initial sizes to respective final sizes of the content elements in the home menu user interface 7031, and/or other animation effects. Side view 9032 and top view 9034 illustrate the animated portion 9040 appearing within the viewport of the user 7002. In some embodiments, the animated portion 9040 is initially displayed with an orientation that is based on (e.g., perpendicular to) the head direction 9024 and transitions to being displayed with an orientation that is based on (e.g., perpendicular to) the torso vector 9030. For example, top view 9034 in FIG. 9C shows animated portion 9040 displayed at an angle relative to user 7002 that is between an angle based on (e.g., perpendicular to) the head direction 9024 and an angle based on (e.g., perpendicular to) the torso vector 9030, during the animation of the home menu user interface 7031 moving into place at the display location.

FIG. 9D illustrates an example transition from FIG. 9C. In some embodiments, the animation for presenting the home menu user interface 7031 concludes as the home menu user interface 7031 reaches the display location (e.g., by reaching a terminus of the animated trajectory of the animated portion 9040 of the home menu user interface 7031, by fading in at the display location, and/or by another animation effect) in the three-dimensional environment. The display location of the home menu user interface 7031 is determined by the direction of the torso vector 9030 when the home menu user interface 7031 was invoked (e.g., as illustrated in FIG. 9B). In addition, a plane of the home menu user interface 7031 (e.g., the plane in which application icons, contacts, and/or virtual environments are displayed) optionally maintains an angular relationship with the torso vector 9030 (e.g., perpendicular to, or within an angular range centered at 90°, or at a different angle). Optionally, the home menu user interface 7031 is displayed at a height such that the head direction 9024 meets a characteristic portion (e.g., the central portion, a top portion, and/or an edge portion) of the home menu user interface 7031 at an angle that is within an angular range of the horizon 9022 (e.g., −5°, −3°, 0°, 3°, 5°, or at another angle with respect to horizon 9022). FIG. 9D illustrates the attention 7010 of the user 7002 being optionally directed away from the hand 7022′ and toward the wall 7006′ (e.g., because the attention 7010 of the user 7002 need not remain directed toward hand 7022′ nor the animation of the home menu user interface 7031 in order for the animation to progress to display of the home menu user interface 7031 at the display location). Side view 9036 and top view 9038 show the home menu user interface 7031 at the display location in the three-dimensional environment. Due to the display location being determined based on the torso vector 9030 of the user 7002, and the head direction 9024 being lower and to the right relative to the torso vector 9030, only a portion of the home menu user interface 7031 is visible in the viewport of user 7002 illustrated in FIG. 9D (e.g., prior to the user 7002 changing a head elevation and/or head orientation).

FIG. 9E illustrates an example transition from FIG. 9D in response to the head rotation of the user 7002 (e.g., back to a neutral position) to result in the head direction 9024 being parallel (e.g., in three-dimensional space) to the torso vector 9030. Optionally, the head of the user 7002 is maintained at a neutral elevation, such that the head direction 9024 lies within or is substantially parallel to the horizon 9022. As described above, in some embodiments, the home menu user interface 7031 is displayed at a height such that the head direction 9024 meets (e.g., intersects with) a characteristic portion (e.g., a middle portion, a top edge, or another portion) of the home menu user interface 7031 at an angle relative to horizon 9022 in the three-dimensional environment that is within a threshold angular range, as illustrated in the side view 9044 of FIG. 9E. For example, side view 9044 shows that the head of the user 7002 is no longer pointed downward toward an arm 9026 as in FIGS. 9A-9D, and that the head direction 9024 of the user 7002 toward the characteristic portion of the home menu user interface 7031 (e.g., the center of home menu user interface 7031, in the example shown in FIG. 9E) makes a head angle θ of a few degrees (e.g., 3°, 5°, or another magnitude angle) below the horizon 9022 (e.g., −3°, −5°, or another angle). The head angle θ in the side view 9044 is enlarged for legibility (e.g., not necessarily drawn to scale).

FIGS. 9F-9H illustrate invoking a system user interface, such as the home menu user interface 7031, with an air pinch gesture 9500-2 while the control 7030 is displayed in the viewport. FIGS. 9F-9H are analogous to FIGS. 9A-9E, except that hand 7022 of user 7002 is positioned at a higher location in the physical environment 7000 compared to the location depicted in FIGS. 9A-9E (e.g., corresponding to a higher head elevation of the user 7002 in FIGS. 9F-9H compared to the example described in FIGS. 9A-9E).

FIG. 9F illustrates the attention 7010 of the user 7002 being directed toward the hand 7022′, which is positioned higher than the hand 7022′ in FIG. 9A, to invoke the display of the control 7030 at a corresponding higher position within the three-dimensional environment than the location of the control 7030 in FIG. 9A. Side view 9048 shows that the head of the user 7002 is elevated slightly above the horizon 9022, and that the head direction 9024 of the user 7002 makes a head angle θ with respect to the horizon 9022 that is larger than the threshold angle θₜₕ (e.g., less negative than the threshold angle θₜₕ, if the threshold angle θₜₕ is a negative angle). The head angle θ is similarly enlarged for legibility. Top view 9050 is analogous to top view 9028.

FIG. 9G illustrates the user 7002 performing an air pinch gesture 9500-2, which is a palm up air pinch gesture, while the control 7030 is displayed in the viewport. Side view 9052 shows the user 7002 maintaining the same head elevation as illustrated in side view 9048 (e.g., as illustrated in FIG. 9F) (e.g., the head of the user 7002 remains elevated slightly above the horizon 9022, and that the head direction 9024 of the user 7002 makes a head angle θ with respect to the horizon 9022 that is larger than the threshold angle θₜₕ). Top view 9054 is analogous to top view 9050 (e.g., as illustrated in FIG. 9F). In some embodiments, as illustrated in FIGS. 9F-9G, the display location of the home menu user interface 7031 is determined by the head angle θ when the home menu user interface 7031 is invoked (e.g., in accordance with detecting air pinch gesture 9500-2), even if the head of the user 7002 was positioned at a different head elevation and/or orientation prior to turning to the elevation and orientation shown in FIG. 9F followed by the user 7002 performing air pinch gesture 9500-2 as shown in FIG. 9G. For example, computer system 101 displays the home menu user interface 7031 at a height 9031-a when the head of the user 7002 is at a head height of 9029-a. Side view 9052 shows that the head angle θ with respect to the horizon 9022 is larger than angular threshold θₜₕ. As a result, the display location of the home menu user interface 7031 is based on the head orientation of user 7002, instead of the torso vector 9030 as illustrated in FIGS. 9A-9E.

FIG. 9H illustrates an example transition from FIG. 9G. Due to the head angle θ being greater than angular threshold θₜₕ when the home menu user interface 7031 is invoked, the display location of the home menu user interface 7031 is based on the head orientation of user 7002, and the home menu user interface 7031 (e.g., all of home menu user interface 7031) is displayed within the viewport of user 7002 (e.g., in contrast to FIG. 9D in which the home menu user interface 7031 is only partially visible in the viewport due to the home menu user interface 7031 being placed based on the torso vector 9030 instead of the head orientation of the user 7002), optionally without the animation illustrated in FIG. 9C, or with a different animation. Top view 9058 shows that the display location of the home menu user interface 7031 is angled relative to (e.g., not perpendicular to) the torso vector 9030. Side view 9056 shows the home menu user interface 7031 tilted by a first amount 9023 toward user 7002 (e.g., a plane of the home menu user interface 7031 is orthogonal to the head direction 9024). For example, the first amount of tilt 9023 is an angular tilt from a vertical axis. In some embodiments, depending on the head angle θ (e.g., for θ<5°, θ<10°, or another angular value), the home menu user interface 7031 is displayed perpendicular to the horizon 9022 (e.g., and facing the viewpoint of user 7002).

FIGS. 9I-9J illustrate invoking a system user interface, such as the home menu user interface 7031, with an air pinch gesture 9500-3 while the control 7030 is displayed in the viewport. FIGS. 9I-9J are analogous to FIGS. 9F-9H, except that the hand 7022 of user 7002 is positioned at an even higher location in the physical environment 7000 compared to the location depicted in FIGS. 9F-9H.

FIG. 9I illustrates the user 7002 performing the air pinch gesture 9500-3, which is a palm up air pinch gesture, while the attention 7010 of the user 7002 is directed toward hand 7022, which is positioned higher in the environment than the hand 7022′ in FIG. 9F, such that the control 7030 is displayed in FIG. 9I. For example, a ceiling 9001 occupies a large portion of the viewport depicted in FIG. 9I. Side view 9060 shows that the head of user 7002 is elevated significantly above the horizon 9022, and that head direction 9024 of user 7002 makes the head angle θ much larger (e.g., not necessarily drawn to scale) than the threshold angle θₜₕ. As a result, the display location of the home menu user interface 7031 is based on the head orientation of the user 7002, instead of the torso vector 9030.

FIG. 9J illustrates an example transition from FIG. 9I. Due to the head angle θ being greater than the angular threshold θₜₕ when the home menu user interface 7031 is invoked (e.g., via the air pinch gesture 9500-3), the display location of the home menu user interface 7031 is based on the head orientation of the user 7002, such that the home menu user interface 7031 is (e.g., fully) displayed within the viewport of the user 7002 (e.g., in contrast to FIG. 9D). For example, the computer system 101 displays the home menu user interface 7031 at a height 9031-b when the head of the user 7002 is at a head height of 9029-b (e.g., instead of displaying the home menu user interface 7031 at height 9031-a when the head height was 9029-a, as illustrated in FIG. 9H). Top view 9066 shows that the display location of the home menu user interface 7031 is angled relative to (e.g., not perpendicular to) the torso vector 9030. Side view 9064 shows the home menu user interface 7031 tilted by a second amount 9025 toward user 7002 (e.g., a plane of the home menu user interface 7031 is orthogonal to the head direction 9024) that is larger than the first amount of tilt 9023 illustrated in side view 9056 of FIG. 9H. The second amount 9025 may be an angular tilt from a vertical axis.

FIGS. 9K-9L illustrate an invocation (e.g., an automatic invocation) of a system user interface, such as the home menu user interface 7031, without the control 7030 being displayed in the viewport.

FIG. 9K illustrates a view of a three-dimensional environment that includes an application user interface 9100 corresponding to a user interface of a software application executing on the computer system 101 (e.g., a photo display application, a drawing application, a web browser, a messaging application, a maps application, or other software application). The application user interface 9100 is the only application user interface within the three-dimensional environment (e.g., no other application user interface is within the viewport illustrated in FIG. 9K, and no other application user interface is outside the viewport). FIG. 9K also illustrates the attention 7010 of the user 7002 being directed to a close affordance 9102 associated with the application user interface 9100 when an air pinch gesture 9506 by the hand 7022 is detected (e.g., the air pinch gesture 9506 is detected while the palm 7025 is facing away from the viewpoint of the user 7002, sometimes called a palm down air pinch gesture). The user 7002 is in an analogous posture (e.g., head elevation and torso orientation) in FIG. 9K as in FIG. 9B. Accordingly, side view 9068 of FIG. 9K is analogous to side view 9020 of FIG. 9A, in that the head of the user 7002 is lowered, and the head direction 9024 makes a head angle θ with respect to the horizon 9022 that is less than the angular threshold θₜₕ (e.g., more negative than the threshold angle θₜₕ, if the threshold angle θₜₕ is a negative angle). However, side view 9068 is different from side view 9020 of FIG. 9A in that side view 9068 indicates that application user interface 9100 is displayed in the viewport instead of control 7030. Top view 9070 of FIG. 9K is likewise similar to top view 9028 of FIG. 9A except that top view 9070 also shows the application user interface 9100 within the viewport of user 7002.

FIG. 9L illustrates an example transition from FIG. 9K. FIG. 9L illustrates that, in response to detecting the air pinch gesture 9506 while the attention 7010 of the user 7002 (e.g., gaze of the user 7002 or a proxy for gaze) is directed toward the close affordance 9102 (e.g., as illustrated in FIG. 7K), the computer system 101 ceases to display (e.g., closes) the application user interface 9100, which is the last open application user interface in the three-dimensional environment, and automatically displays home menu user interface 7031 at the display location depicted in FIG. 9L. Even though the head elevation of the user 7002 is at a head angle θ that is less than angular threshold θₜₕ when the air pinch gesture 9506 by hand 7022 is detected (e.g., even though the user 7002 is in an analogous posture (e.g., head elevation and torso orientation) in FIG. 9K as in FIG. 9B), the display location of the home menu user interface 7031 in FIG. 9L is determined based on the head orientation and/or the head elevation of the user 7002 (e.g., when the home menu user interface 7031 is invoked) instead of the torso vector 9030 as in FIGS. 9A-9E, because the home menu user interface 7031 in FIG. 9L is displayed (e.g., automatically invoked) as a result of closing the last application user interface 9100 open in the environment (e.g., optionally regardless of whether the head angle θ is less than the angular threshold θₜₕ) instead of being invoked through the control 7030 when the user's head elevation is at an angle θ that is less than the angular threshold θₜₕ. Side view 9072 of FIG. 9L is analogous to side view 9068 of FIG. 9K, except that side view 9072 shows that instead of the application user interface 9100, the home menu user interface 7031 is displayed, optionally at a position in the three-dimensional environment that is closer to the user 7002. Top view 9074 of FIG. 9L shows that the home menu user interface 7031 is perpendicular to the head direction 9024 (e.g., because home menu user interface 7031 is placed based on the head orientation and/or elevation) such that the display location of the home menu user interface 7031 is angled relative to (e.g., not perpendicular to) the torso vector 9030, in contrast to top view 9046 of FIG. 9E, where the home menu user interface 7031 is perpendicular to both the torso vector 9030 and the head direction 9024 (e.g., which extend in the same direction).

FIGS. 9M-9N illustrate an invocation of a system user interface, such as the home menu user interface 7031 via a user input on an input device of the computer system 101, without the control 7030 being displayed in the viewport.

FIG. 9M illustrates a view of the three-dimensional environment that optionally includes the application user interface 9100 corresponding to the user interface of a software application executing on computer system 101. In some embodiments, the processes described in FIGS. 9M-9N are independent of whether additional application user interfaces are present in the three-dimensional environment, and/or within the viewport specifically. FIG. 9M also illustrates a first user input 9550, such as a press input, on the digital crown 703. In some embodiments, the first user input 9550 is directed to a different input device (e.g., a button 701, a button 702, or another input device) than the digital crown 703 to invoke display of the home menu user interface 7031. In some embodiments, the digital crown 703 is a rotatable input mechanism that can be used to change a level of immersion within the three-dimensional environment (e.g., in response to rotation of the digital crown 703 rather than a press input on digital crown 703). The user 7002 is in an analogous posture (e.g., head elevation and/or torso orientation) in FIG. 9M as in FIGS. 9B and 9K, Accordingly, side view 9076 is analogous to side view 9068 of FIG. 9K (e.g., the head of the user 7002 is lowered, and the head direction 9024 makes a head angle θ with respect to the horizon 9022 that is less than the angular threshold θₜₕ) except for the hand 7022 of the user 7002 reaching up to the computer system 101 to press digital crown 703 as indicated by the position of arm 9026 in side view 9076. Top view 9078 is likewise similar to top view 9070 of FIG. 9K and shows the application user interface 9100 within the viewport of the user 7002.

FIG. 9N illustrates an example transition from FIG. 9M. FIG. 9N illustrates that, in response to detecting the first user input 9550 on the digital crown 703 (e.g., as illustrated in FIG. 7M), the computer system 101 displays home menu user interface 7031 at the display location depicted in FIG. 9N, while optionally maintaining display of the application user interface 9100. Even though the head elevation of the user 7002 is at a head angle θ that is less than the angular threshold θₜₕ when the first user input 9550 on the digital crown 703 is detected (e.g., even though the user 7002 is in an analogous posture in FIG. 9M as in FIG. 9B), the display location of the home menu user interface 7031 in FIG. 9N is based on the head orientation and/or the head elevation of the user 7002 (e.g., when the home menu user interface 7031 is invoked) instead of the torso vector 9030 as in FIGS. 9A-9E, because the home menu user interface 7031 in FIG. 9N is displayed in response to a press input to an input device such as digital crown 703 (e.g., optionally regardless of whether the head angle θ is less than angular threshold θₜₕ) instead of being invoked through the displayed control 7030 when the head elevation of the user 7002 is at a head angle θ that is less than the angular threshold θₜₕ. More generally, in some embodiments, the display location of the home menu user interface 7031 is based on the torso vector 9030 if the home menu user interface 7031 is invoked through the control 7030 (e.g., when the head elevation of the user 7002 is at a head angle θ that is less than the angular threshold θₜₕ), and based on the head orientation and head elevation (e.g., the viewpoint of the user 7002) if the home menu user interface 7031 is invoked another way other than using the control 7030. Side view 9080 of FIG. 9N is analogous to side view 9072 of FIG. 9L and side view 9076 of FIG. 9M, except that both the application user interface 9100 and the home menu user interface 7031 are displayed in front of the user 7002. The home menu user interface 7031 is also optionally displayed in front of the application user interface 9100. Top view 9082 of FIG. 9N shows both the application user interface 9100 and the home menu user interface 7031 within the viewport of the user 7002. The display location of the home menu user interface 7031 is perpendicular to the head direction 9024 (e.g., because home menu user interface 7031 is placed based on the head orientation and/or elevation) and angled relative to (e.g., not perpendicular to) torso vector 9030, in contrast to top view 9042 of FIG. 9E.

FIGS. 9O-9P illustrate an invocation of a system user interface, such as the home menu user interface 7031, via the control 7030 that is displayed in the viewport, but under circumstances in which reliable torso vector information is not available (e.g., in low light conditions, in a dark room, and/or due to other factors), in contrast to FIG. 9A-9E.

FIG. 9O illustrates an analogous view of the three-dimensional environment to that shown in FIG. 9B, except that the three-dimensional environment is darker (e.g., due to low light levels in the physical environment 7000). FIG. 9O illustrates the user 7002 performing a palm up air pinch gesture 9500-4 while the control 7030 is displayed in the viewport. The user 7002 is in an analogous posture (e.g., head elevation and/or torso orientation) in FIG. 9O as in FIG. 9B. Accordingly, top view 9086 of FIG. 9O is analogous to top view 9028 of FIG. 9B, and side view 9084 of FIG. 9O is analogous to side view 9020 of FIG. 9B.

FIG. 9P illustrates an example transition from FIG. 9O. Computer system 101, in accordance with a determination that information about the torso vector 9030 of the user 7002 cannot be determined with sufficient accuracy (e.g., due to low light conditions and/or other factors), forgoes displaying the home menu user interface 7031 based on the torso vector 9030 of the user 7002 even though the head angle θ is less than the angular threshold θₜₕ when the home menu user interface 7031 is invoked via the control 7030 in FIG. 9O (e.g., and even though the home menu user interface 7031 would otherwise be displayed based on the torso vector 9030 as described herein with reference to FIGS. 9A-9E). Instead, the display location of the home menu user interface 7031 is based on the head elevation and/or the head orientation of the user 7002, such that the home menu user interface 7031 is displayed (e.g., fully displayed) within the viewport of the user 7002, like in FIGS. 9L and 9P described herein. Top view 9090 of FIG. 9P is thus analogous to top view 9074 of FIG. 9L, with the display location of the home menu user interface 7031 being perpendicular to the head direction 9024 and angled relative to (e.g., not perpendicular to) the torso vector 9030. Side view 9088 of FIG. 9P is likewise analogous to side view 9072 of FIG. 9L.

Additional descriptions regarding FIGS. 9A-9P are provided below in reference to method 12000 described with respect to FIGS. 12A-12D.

FIGS. 14A-14L illustrate examples of switching between a wrist-based pointer and a head-based pointer, depending on whether certain criteria are met. The user interfaces in FIGS. 14A-14L are used to illustrate the processes described below, including the processes in FIGS. 17A-17D.

FIGS. 14A-14L include a top view 1408 that shows a head pointer 1402 (e.g., that indicates a direction and/or location toward which the head of the user 7002 is facing) and a wrist pointer 1404 (e.g., a ray that runs along the direction of the arm 9026 of the user 7002, and emerges from the wrist of the hand 7022 (e.g., the hand attached to the arm 9026)). FIGS. 14A-14L show both the head pointer 1402 and the wrist pointer 1404 in the top view 1408 for reference, with a dashed line (e.g., long dashes, as opposed to dots) indicating an enabled (e.g., and/or active) pointer and a dotted line (e.g., dots, as opposed to dashes) indicating a disabled (e.g., inactive) pointer. For example, in FIG. 14A, the head pointer 1402 is enabled and shown as a dashed line in the top view 1408, while the wrist pointer 1404 is disabled and shown as a dotted line in the top view 1408; conversely, in FIG. 14C, the head pointer 1402 is disabled and shown as a dotted line in the top view 1408, while the wrist pointer 1404 is enabled and shown as a dashed line in the top view 1408. In some embodiments, when (e.g., and/or while) the head and/or wrist pointer is disabled, the computer system 101 does not enable most user interaction via the disabled pointer (e.g., with some specific exceptions, as discussed in greater detail below with reference to FIG. 14F, 14I, and 14J), but the computer system 101 continues to track the location toward which the disabled pointer is directed (e.g., for use in determining whether and/or when the specific exceptions apply).

In FIGS. 14A-14B, the head pointer 1402 is enabled (e.g., and the wrist pointer 1404 is disabled). While the head pointer 1402 is enabled, the user 7002 can interact with the computer system 101 via the head pointer 1402 (e.g., the computer system 101 determines a location toward which the attention of the user 7002 is directed, based on the head pointer 1402). For ease of illustration, figures in which the head pointer 1402 is enabled show a reticle 1400 to indicate the location toward which the computer system 101 detects that the head of the user 7002 is facing. For ease of discussion, the reticle 1400 will sometimes be referred to as the attention 1400 of the user 7002 (e.g., a visual representation of where the attention of the user is directed). In some embodiments, the computer system 101 displays the reticle 1400 (e.g., as a cursor, to provide visual feedback and/or to improve the usability of the head-based system). In some embodiments, the reticle 1400 is not shown (e.g., is not shown to the user 7002, while using the computer system 101), and optionally other means (e.g., changes in visual appearance to user interface elements) are used to provide visual feedback in lieu of a displayed reticle 1400. In some embodiments, the head pointer 1402 is based on the direction the head of the user 7002 is facing (e.g., the head pointer 1402 is a ray that is substantially orthogonal to a face of the user 7002, as described herein with reference to the head direction in FIGS. 9A-9P). In some embodiments, the head pointer 1402 is based on a direction of a gaze of the user 7002.

In FIG. 14A, the computer system 101 displays an application user interface 7106 (e.g., the same application user interface 7106 as described above with reference to FIGS. 7X-7Z and/or 7AN). While displaying the application user interface 7106, the computer system 101 detects that the attention 1400 of the user 7002 is directed to an affordance 1406 of the application user interface 7106 (e.g., optionally, in combination with a user input such as an air pinch, air tap, or other air gesture performed by the hand 7022, as shown by the hand 7022 in the dashed box of FIG. 14A).

In FIG. 14B, in response to detecting that the attention 1400 of the user 7002 is directed to the affordance 1406, the computer system 101 performs an operation corresponding to the affordance 1406. For example, the affordance 1406 corresponds to a particular drawing tool (e.g., a pencil, marker, or brush tool of a drawing application). Based on movement of the attention 1400 of the user 7002, the computer system 101 traces out a drawing 1410 in the application 7106 (e.g., the user 7002 traces out the drawing 1410 using the head pointer 1402). In some embodiments, the computer system 101 draws the line 1410 (e.g., in accordance with movement of the attention 1400 of the user 7002) in response to detecting a user input (e.g., an air pinch, an air long pinch, or another continuous air gesture) performed by the hand 7022 (e.g., as indicated by the hand 7022 performing a pinch gesture in the dashed box of FIG. 14B).

FIGS. 14C-14D show an alternative to FIGS. 14A-14B, where the wrist pointer 1404 is enabled (e.g., instead of the head pointer 1402). In FIG. 14C, the user 7002 uses the wrist pointer 1404 to select the affordance 1406 (e.g., in combination with a user input, such as an air pinch, air tap, or other air gesture performed by the hand 7022, while the wrist pointer 1404 is directed toward the affordance 1406). In FIG. 14D, the user 7002 traces out a drawing 1411 (e.g., the computer system 101 continues to trace out the drawing 1411 as long as the hand 7022 maintains a user input, such as an air pinch, an air long pinch, or another continuous air gesture).

In FIG. 14E, while the wrist pointer 1404 is enabled, the head of the user 7002 moves. As shown in the side view 1412, the head of the user 7002 tilts downward and as shown in the top view 1408, the head of the user 7002 turns slightly to the right of the user 7002. The movement of the head of the user 7002 brings the hand 7022′ into view (e.g., the hand 7022′ is now visible via the display generation component 7100a). The head pointer 1402 (e.g., which is not currently enabled, but is shown in the top view 1408) is not directed toward the hand 7022′ (e.g., the hand 7022′ is off-center, relative to the display generation component 7100a), so the wrist pointer 1404 remains enabled.

In FIG. 14F, the head of the user 7002 moves again (e.g., and/or continues the movement shown in FIG. 14E). As shown in the top view 1408, the head of the user 7002 continues to turn to the right, such that the head pointer 1402 is directed toward the hand 7022′. In response to detecting that the head pointer 1402 is directed toward the hand 7022′ (e.g., while the hand 7022′ is in the “palm up” orientation), the computer system 101 displays the control 7030 (e.g., the same control 7030 as described above with reference to FIGS. 7A-7BE), and the computer system switches from the wrist pointer 1404 to the head pointer 1402 (e.g., the computer system 101 disables the wrist pointer 1404 and enables the head pointer 1402).

In FIG. 14G, while the control 7030 is displayed, the user 7002 performs an air pinch gesture with the hand 7022′ (e.g., while the head of the user 7002 remains in the same position and orientation as in FIG. 14F, such that the attention 1400 of the user 7002 continues to be directed toward the hand 7022′). While the wrist pointer 1404 is directed toward the user interface 7106, because the wrist pointer 1404 is disabled, the computer system 101 does not perform an operation corresponding to the user interface 7106 in response to detecting the air pinch gesture performed by the hand 7022′.

Instead, as shown in FIG. 14H, in response to detecting the air pinch gesture performed with the hand 7022′ (e.g., including detecting an end of the air pinch gesture), the computer system 101 performs an operation corresponding to the control 7030 and displays the home menu user interface 7031. In some embodiments, the home menu user interface 7031 is displayed at a location based on a head or torso location and/or orientation, consistent with the behavior of the home menu user interface 7031 described above with reference to FIGS. 9A-9P (e.g., in FIG. 14H, the home menu user interface 7031 is positioned based on the torso direction or the torso vector of the user 7002).

FIG. 14I is an alternative to FIG. 14F, and shows that the hand 7022′ is in the “palm down” orientation (e.g., FIG. 14I illustrates a transition from FIG. 14F in which the hand 7022′ has transitioned to the “palm down” orientation while the head pointer 1402 remains directed toward the hand 7022′ and/or the control 7030 is displayed, for example as described herein with reference to FIGS. 7G-7H and 7AO). In contrast to FIG. 14I, where the computer system 101 displays the control 7030, in FIG. 14I, the computer system 14I displays the status user interface 7032. While the status user interface 7032 is displayed, the user 7002 can perform an air pinch gesture to display the system function menu 7044 (e.g., as described above with reference to FIGS. 7K and 7L, with the head pointer 1402 determining where the attention 7010 of the user 7002 is directed) or in some embodiments the system function menu 7043.

FIG. 14J is an alternative to FIG. 14G, where instead of performing an air pinch gesture with the hand 7022′, the user 7002 performs a pinch and hold gesture with the hand 7022′ (e.g., or FIG. 14J illustrates a transition from FIG. 14G in accordance with the air pinch gesture initiated in FIG. 14G continuing to be maintained as a pinch and hold gesture). In response to detecting the pinch and hold gesture performed by the hand 7022′, the computer system 101 adjusts the volume level for the computer system 101 (e.g., or enables adjustment of the volume level in accordance with movement of the pinch and hold gesture), and displays the volume indicator 8004. In some embodiments, the computer system 101 adjusts the volume level as described above with reference to FIGS. 8A-8T.

FIG. 14K shows a transition from FIG. 14H. In FIG. 14K, because the head pointer 1402 is no longer directed toward the hand 7022′, the computer system switches from the head pointer 1402 to the wrist pointer 1404 (e.g., disables the head pointer 1402 and enables (e.g., reenables) the wrist pointer 1404), as shown by the head pointer 1402 using the dotted line and the wrist pointer 1404 using the dashed line. In FIG. 14K, the wrist pointer 1404 is directed toward the representation 7014′ of the physical object 7014, while the head pointer 1402 is directed toward the home menu user interface 7031. While the respective pointers remain directed toward their respective locations, if the user 7002 performs a user input (e.g., an air pinch, an air tap, or another air gesture), the computer system 101 does not perform operations corresponding to the home menu user interface 7031 (e.g., the user interface toward which the head pointer 1402 is directed, as the head pointer 1402 is disabled), and optionally performs an operation corresponding to the representation 7014′ of the physical object 7014 (e.g., the object toward which the wrist pointer 1402 is directed) if the representation 7014′ of the physical object 7014 is enabled for user interaction.

In FIG. 14L, the user 7002 moves the wrist pointer 1404 such that the wrist pointer 1404 is directed toward an affordance 1414 of the home menu user interface 7031. The head pointer 1402 is directed toward an affordance 1416 of the home menu user interface. While the respective pointers remain directed toward their respective locations, in response to detecting a user input (e.g., an air pinch, an air tap, or another air gesture), the computer system 101 activates the affordance 1414 (e.g., and launches an application or user interface corresponding to the affordance 1414), and the computer system 101 does not perform an operation corresponding to the affordance 1416 (e.g., because the head pointer 1402 is disabled).

Additional descriptions regarding FIGS. 14A-14L are provided below in reference to method 17000 described with respect to FIGS. 17A-17D.

FIGS. 10A-10K are flow diagrams of an exemplary method 10000 for invoking and interacting with a control based on attention being directed toward a location of a hand of a user, in accordance with some embodiments. In some embodiments, the method 10000 is performed at a computer system (e.g., computer system 101 in FIG. 1) that is in communication with one or more display generation components (e.g., a head-mounted display (HMD), a heads-up display, a display, a projector, a touchscreen, or other type of display) (e.g., display generation component 120 in FIGS. 1A, 3, and 4, or the display generation component 7100a in FIGS. 7A-7BE), one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c, the digital crown 703, and/or controller 7111 with buttons 7113, 7115, and/or 7117 in FIGS. 7A-7BE), and optionally one or more audio output devices (e.g., speakers 160 in FIG. 1A or electronic component 1-112 in FIGS. 1B-1C). In some embodiments, the method 10000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 10000 are, optionally, combined and/or the order of some operations is, optionally, changed.

While a view of an environment (e.g., a two-dimensional or three-dimensional environment that includes one or more virtual objects and/or one or more representations of physical objects) is visible via the one or more display generation components (e.g., using AR, VR, MR, virtual passthrough or optical passthrough), the computer system detects (10002), via the one or more input devices, that attention of a user (e.g., gaze or an attention metric based on a gaze, head direction, wrist direction, and/or other pointing manner of the user) is directed toward a location of a hand of the user (e.g., where the location of the hand in the view of the environment corresponds to a physical location of the hand in a physical environment that corresponds to the environment visible via the one or more display generation components, and the view of the environment optionally includes, at the location of the hand of the user, a view of the hand of the user that moves (e.g., in the environment) as the hand of the user moves (e.g., in physical space, in the corresponding physical environment), and in some embodiments one or more operations of methods 10000, 11000, 12000, 13000, 15000, 16000, 17000, and/or 18000 include or are based on the view of the hand being visible or displayed at the location of the hand). In some embodiments, the view of the hand of the user includes an optical passthrough view of the hand, a digital passthrough view of the hand (e.g., a realistic view or representation of the hand), or a representation of a hand that moves as the hand of the user moves such as an animated hand of an avatar that represents the user's hand. In some embodiments, the view of the hand of the user includes a virtual graphic that is overlaid on or displayed in place of the hand and that is animated to move as the hand moves (e.g., the virtual graphic tracks the movement of the hand and optionally includes portions, such as digits, that move as the fingers of the hand move).

In response to detecting (10004) that the attention of the user is directed toward the location of the hand: in accordance with a determination that the attention of the user (e.g., gaze or an attention metric based on a gaze, head direction, wrist direction, and/or other pointing manner of the user) is directed toward the location of the hand while first criteria are met, wherein the first criteria include a requirement that the hand is in a respective pose and oriented with a palm of the hand facing toward a viewpoint of the user (e.g., a first orientation of the hand) in order for the first criteria to be met (e.g., and the view of the hand is optionally in the respective pose and oriented with the palm of the view of the hand facing toward the viewpoint of the user), the computer system displays (10006), via the one or more display generation components, a control corresponding to (e.g., adjacent to, within a threshold distance of, or with a respective spatial relationship to) the location of the hand; and in accordance with a determination that the attention of the user (e.g., gaze or an attention metric based on a gaze, head direction, wrist direction, and/or other pointing manner of the user) is directed toward the location of the hand while the first criteria are not met, the computer system forgoes (10008) displaying the control (e.g., including forgoing displaying the control within the threshold distance of the location or view of the hand, and optionally forgoing displaying the control anywhere within the view of the environment visible via the one or more display generation components). In some embodiments, if the attention of the user is directed toward the location or view of the hand while the first criteria are not met, and the first criteria are subsequently met (e.g., the hand transitions to being in the respective pose and oriented with the palm of the hand facing toward the viewpoint of the user (e.g., the first orientation), and the view of the hand optionally appears or is displayed accordingly) while the attention of the user continues to be directed toward the location or view of the hand, the control is displayed. In some embodiments, the first criteria for displaying or not displaying the control corresponding to the location of the hand are evaluated separately for different hands. For example, if the user's left hand satisfies the first criteria for displaying the control (e.g., and the user's attention is directed toward the user's left hand), the control is displayed (e.g., corresponding to the user's left hand) even if the user's right hand does not meet the first criteria, whereas if the user's right hand satisfies the first criteria (e.g., and the user's attention is directed toward the user's right hand), the control is displayed (e.g., corresponding to the user's right hand) even if the user's left hand does not meet the first criteria. For example, in FIG. 7Q1, in response to detecting that the hand 7022′ is in the “palm up” configuration and that the attention 7010 of the user 7002 is directed toward the hand 7022′, the computer system 101 displays the control 7030. In contrast, in FIGS. 7I-7J3, the hand 7022′ and/or the attention 7010 do not satisfy display criteria, and the computer system 101 forgoes displaying the control 7030. Displaying a control corresponding to a location/view of a hand in response to a user directing attention toward the location/view of the hand, if criteria including whether the hand is palm up are met, reduces the number of inputs and amount of time needed to invoke the control and access a plurality of different system operations of the computer system without displaying additional controls.

In some embodiments, the requirement that the hand is in the respective pose includes (10010) a requirement that an orientation of the hand is within a first angular range with respect to the viewpoint of the user (e.g., the first angular range corresponds to the palm of the hand being oriented facing toward the viewpoint of the user; the hand is determined to be within the first angular range with respect to a viewpoint of the user when at least a threshold area or portion of the palm is detected by the one or more input devices as facing toward a viewpoint of the user). For example, in FIGS. 7AI-7AJ, when the hand angle of the hand 7022′ in the viewport of the user 7002 corresponds to the hand 7022 having any of the top view representations 7141-1, 7141-2, 7141-3, and 7141-4, in response to detecting that the attention 7010 of the user 7002 is directed toward the hand 7022′, the computer system 101 displays the control 7030. In contrast, in FIG. 7AJ, the hand angle of the hand 7022′ does not satisfy display criteria, and in response to detecting the attention 7010 being directed to the hand 7022′, the computer system 101 forgoes displaying the control 7030. Requiring that the user's hand be angled a particular way in order to enable displaying a control corresponding to a location/view of the hand in response to the user directing attention toward the location/view of the hand reduces the number of inputs and amount of time needed to invoke the control while reducing the chance of unintentionally triggering display of the control.

In some embodiments, the requirement that the hand is in the respective pose includes (10012) a requirement that the palm of the hand is open (e.g., with fingers extended or outstretched, rather than curled or making a fist). In some embodiments, the palm of the hand is open if the hand is not performing an air pinch gesture (e.g., using the thumb and index finger), and/or if one or more fingers of the hand (e.g., the thumb and index finger) are not curled. For example, in FIGS. 7AF-7AH, in accordance with a determination that the hand 7022 is not open (e.g., the fingers of the hand 7022 are curled by being bent at one or more joints), the computer system 101 forgoes displaying the control 7030. In contrast, in FIG. 7Q1, the palm 7025 of the hand 7022 is open, and in response to detecting the attention 7010 being directed to the hand 7022′ while the hand 7022′ is in the “palm up” configuration, the computer system 101 displays the control 7030. Requiring that the user's hand be open (e.g., with palm exposed and/or fingers extended) at least a threshold amount in order to enable displaying a control corresponding to a location/view of the hand in response to the user directing attention toward the location/view of the hand reduces the number of inputs and amount of time needed to invoke the control while reducing the chance of unintentionally triggering display of the control.

In some embodiments, the requirement that the palm of the hand is open includes (10014) a requirement that two fingers of the hand for performing an air pinch gesture (e.g., index finger and thumb) have a gap that satisfies a threshold distance (e.g., when viewed from a viewpoint of the user) in order for the first criteria to be met. For example, in FIG. 7Q1, there is a gap gₜₕ between the index finger and the thumb of the hand 7022′ from the viewpoint of the user, and in response to detecting that the attention 7030 is directed toward the hand 7022′ while the hand 7022′ is in the “palm up” configuration, the computer system 101 displays the control 7030. In some embodiments, the gap is at least a threshold distance such as 0.5 cm, 1.0 cm, 1.5 cm, 2.0 cm, 2.5 cm, 3.0 cm, or other distances from the viewpoint of the user. Requiring that the user's hand be configured with a sufficient gap between two or more fingers used to perform an air pinch gesture (e.g., prior to being poised to or actually performing an air pinch gesture) in order to enable displaying a control corresponding to a location/view of the hand in response to the user directing attention toward the location/view of the hand reduces the number of inputs and amount of time needed to invoke the control while reducing the chance of unintentionally triggering display of and/or interacting with the control.

In some embodiments, the requirement that the hand is in the respective pose includes (10016) a requirement that the hand is not holding an object (e.g., a phone, or a controller) in order for the first criteria to be met. In some embodiments, the first criteria are met 0.5 second, 1.0 second, 1.5 second, 2.0 second, 2.5 second, or other lengths of time after detecting the hand has ceased holding the object. For example, in Figure in 7AB, the hand 7022 is holding a physical object having a representation 7128 in the viewport. In response to detecting that the attention 7010 of the user is directed toward the hand 7022′, the computer system 101 forgoes displaying the control 7030. In contrast, in FIG. 7AC, the hand 7022 is in the same pose as the hand 7022 in FIG. 7AB but without holding the physical object. In FIG. 7AC, in response to detecting that the attention 7010 of the user is directed toward the hand 7022′, the computer system 101 displays the control 7030. Requiring that there be no objects held in the user's hand, optionally for at least a threshold amount of time since an object was most recently held in the user's hand, in order to enable displaying a control corresponding to a location/view of the hand (e.g., suppressing display of the control if an object is present) in response to the user directing attention toward the location/view of the hand causes the computer system to automatically reduce the chance of unintentionally triggering display of the control when the user is indicating intent to interact with the handheld object instead and/or reducing the chance of the handheld object interfering with visibility of and/or interaction with the control.

In some embodiments, the requirement that the hand is in the respective pose includes (10018) a requirement that the hand is more than a threshold distance away from a head of the user (e.g., between 2-35 cm from the head or from where a headset with one or more physical controls is located, such as 2 cm, 5 cm, 10 cm, 15 cm, 20 cm, 25 cm, 30 cm, or other distances) in order for the first criteria to be met. For example, in FIG. 7AD, the hand 7022 is more than a threshold distance dₜₕ₁ from the head of the user 7002. In response to detecting that the attention 7010 of the user is directed toward the hand 7022′, the computer system 101 displays the control 7030. In contrast, in FIG. 7AE, the hand 7022 is less than the threshold distance dₜₕ₁ from the head of the user 7002. In response to detecting that the attention 7010 of the user is directed toward the hand 7022′, the computer system 101 forgoes displaying the control 7030. Requiring that the user's hand be more than a threshold distance away from the user's head in order to enable displaying a control corresponding to a location/view of the hand in response to the user directing attention toward the location/view of the hand causes the computer system to automatically reduce the chance of unintentionally triggering display of the control when the user is indicating intent to interact with the computer system in a different manner.

In some embodiments, displaying the control corresponding to the location of the hand includes (10020) displaying a view of the hand at the location of the hand and displaying the control at a location between two fingers of the view of the hand and offset from a center of a palm of the view of the hand. For example, in FIG. 7Q1, the control 7030 is displayed between the index finger and the thumb of the hand 7022′ and is offset by oₜₕ from the midline 7096 of hand 7022′. Displaying the control with a particular spatial relationship to the location/view of the hand, such as between two fingers and offset from the hand or palm thereof, in response to the user directing attention toward the location/view of the hand causes the computer system to automatically place the control at a consistent and predictable location relative to where the user's attention is directed, to reduce the amount of time needed for the user to locate and interact with the control while maintaining visibility of the control and the location/view of the hand.

In some embodiments, the first criteria include (10022) a requirement that the hand has a movement speed that is less than a speed threshold in order for the first criteria to be met (e.g., when the hand is moving above the speed threshold, the control is not displayed, whereas when the hand is stationary or moving at a speed below the speed threshold, the control is displayed). In some embodiments, the speed threshold is less than 15 cm/s, less than 10 cm/s, less than 8 cm/s or other speeds. In some embodiments, the duration over which the hand movement speed is detected is between 50-2000 ms; for example, in the 50-2000 ms preceding the detection of the attention of the user being directed toward the location or view of the hand, if the hand movement speed (e.g., an average hand movement speed, or maximum hand movement speed) is below 8 cm/s, the control is displayed (e.g., in response to the attention of the user being directed toward the location or view of the hand) and/or display of the control is maintained (e.g., while the attention of the user continues to be directed toward the location or view of the hand). In some embodiments, if the hand movement speed is above the speed threshold or has not been below the speed threshold for at least the requisite duration, the control is not displayed (and/or if displayed, ceases to be displayed). For example, in FIG. 7T, the control 7030 ceases to be displayed when the velocity of the hand 7022 (e.g., and accordingly the hand 7022′) is above velocity threshold vₜₕ₂. Similarly, if the hand 7022 (e.g., and accordingly the hand 7022′) has a movement speed that is above a velocity threshold for a time interval preceding the detection of the attention 7010 being directed to the hand 7022′, the computer system 101 forgoes displaying the control 7030. Requiring that the user's hand be stationary or moving less than a threshold amount and/or with lower than a threshold speed in order to enable displaying a control corresponding to a location/view of the hand in response to the user directing attention toward the location/view of the hand causes the computer system to automatically suppress display of the control and reduce the chance of the user unintentionally triggering display of the control when the user is indicating intent to interact with the computer system in a different manner and in circumstances that would make it difficult to locate and interact with the control.

In some embodiments, the first criteria include (10024) a requirement that the location of the hand is greater than a threshold distance from a selectable user interface element (e.g., an application grabber, a displayed keyboard, ornaments, and/or an application user interface) and the location of the hand is not moving toward the selectable user interface element in order for the first criteria to be met. In some embodiments, the control is not displayed in accordance with a determination that the location or view of the hand is near (e.g., within the threshold distance from) a selectable user interface element or moving toward the selectable user interface element (e.g., even if the location or view of the hand is outside of the threshold distance from the selectable user interface element). For example, in FIG. 7X, the computer system 101 forgoes displaying the control 7030 because the hand 7022′ is less than a threshold distance Dₜₕ from the tool palette 7108 of the application user interface 7106. Requiring that a location/view of the hand be at least a threshold distance from a selectable user interface element and/or not moving toward the selectable user interface element in order to enable displaying a control corresponding to a view of the hand in response to the user directing attention toward the view of the hand causes the computer system to automatically reduce the chance of the user unintentionally triggering display of and/or interacting with the control when the user is likely attempting to interact with the selectable user interface element, as well as reduce the chance of the user unintentionally interacting with the selectable user interface element when the user is rather attempting to interact with the control.

In some embodiments, the first criteria include (10026) a requirement that the hand has not interacted with a user interface element (e.g., a direct interaction, or an indirect interaction, a selection, or movement air gesture, or a hover input) within a threshold time in order for the first criteria to be met. In some embodiments, the first criteria are met when a threshold length of time has elapsed since the hand interacted with the user interface element. In some embodiments, the threshold length of time is at least 0.7 second, 1 second, 1.5 second, 2 second, 2.5 second, 3 second, or another length of time. For example, in FIG. 7AA, the computer system 101 forgoes displaying the control 7030 at time 7120-10 because the time period ΔT_{F} is less than the interaction time threshold Tₜₕ₂ from the time 7120-9 when the user 7002 interacted with a user interface element (e.g., an application user interface element, such as the tool palette 7108 of the application user interface 7106). The computer system 101 displays the control 7030 (e.g., as shown by indication 7124-8) at time 7120-11 because the time period ΔT_{G} is greater than the interaction time threshold Tₜₕ₂ from the time 7120-9 when the user 7002 interacted with the user interface element. Requiring that at least a threshold amount of time have elapsed since a most recent interaction with a selectable user interface element in order to enable displaying a control corresponding to a location/view of the hand in response to the user directing attention toward the view of the hand causes the computer system to automatically reduce the chance of the user unintentionally triggering display of and/or interacting with the control until it is more clear that the user is finished interacting with the selectable user interface element.

In some embodiments, the first criteria include (10028) a requirement that the hand of the user is not interacting with the one or more input devices (e.g., a hardware input device such as a keyboard, trackpad, or controller) in order for the first criteria to be met. In some embodiments, the control is not displayed in accordance with a determination that the user is interacting with a physical object, such as a hardware input device. In some embodiments, the first criteria include a requirement that the hand of the user is not interacting with the one or more input devices that are in communication with the computer system (e.g., a hardware input device such as a keyboard, trackpad, or controller that is configured to provide and/or is currently providing input to the computer system) in order for the first criteria to be met (e.g., in some embodiments, the hand of the user interacting with other input devices that are not in communication with the computer system does not prevent the control from being displayed). For example, in FIGS. 7W and 7AB, in response to detecting that the hand of the user is interacting with an input device (e.g., the keyboard 7104 in FIG. 7W and a cell phone or remote control corresponding to the representation 7128 in FIG. 7AB), the computer system 101 forgoes displaying the control 7030. Requiring that the user or the user's hand not be interacting with a physical input device in order to enable displaying a control corresponding to a location/view of the hand in response to the user directing attention toward the location/view of the hand causes the computer system to automatically reduce the chance of unintentionally triggering display of and/or interacting with the control when the user is indicating intent to interact with the physical input device instead.

In some embodiments, while displaying the control corresponding to (e.g., adjacent to, within a threshold distance of, or with a respective spatial relationship to) the location of the hand, the computer system detects (10030), via the one or more input devices, movement of the location of the hand to a first position (e.g., movement of the location or view of the hand to a first position corresponding to a movement of the hand in the physical environment); and in response to detecting the movement of the location of the hand to the first position: in accordance with a determination that movement criteria are met, the computer displays, via the one or more display generation components, the control at an updated location corresponding to (e.g., adjacent to, within a threshold distance of, or with a respective spatial relationship to) the location of the hand being at the first position. In some embodiments, as described in more detail herein with reference to method 16000 the control moves with the hand when the hand moves more than a threshold amount of movement. In some embodiments, the control remains in place when the hand moves less than a threshold amount of movement. In some embodiments, the threshold amount of movement varies based on the speed of the movement of the hand. In some embodiments, the control moves with the hand when the hand moves with less than a threshold velocity. In some embodiments, the control is visually deemphasized or ceases to be displayed when the hand moves with greater than the threshold velocity. In some embodiments, the control is visually deemphasized while the hand moves with greater than a first threshold velocity, and ceases to be displayed while the hand moves with greater than a second threshold velocity that is above the first threshold velocity. For example, in FIGS. 7Q1 and 7R1, in response to detecting the movement of the hand 7022′ while attention 7010 remains directed toward the hand 7022′, the computer system 101 displays the control 7030 at an updated location corresponding to the location of the moved hand 7022′. Moving the control corresponding to the location/view of the hand in accordance with movement of the user's hand causes the computer system to automatically keep the control at a consistent and predictable location relative to the location/view of the hand, to reduce the amount of time needed for the user to locate and interact with the control.

In some embodiments, the control corresponding to the location of the hand is (10032) a simulated three-dimensional object (e.g., the control has a non-zero height, non-zero width, and non-zero depth, and optionally has a first set of visual characteristics including characteristics that mimic light, for example, glassy edges that refract and/or reflect simulated light). For example, in FIG. 7Q1, the control 7030 has a non-zero depth, a non-zero width, and a non-zero height, and also appears to have a glassy edge that refracts or reflects simulated light. Displaying the control corresponding to the location/view of the hand as a simulated three-dimensional object, such as with an appearance simulating a physical material and/or with simulated lighting effects, indicates a spatial relationship between the control, the location/view of the hand, and the environment in which the control is displayed, which provides feedback about a state of the computer system.

In some embodiments, the computer system detects (10034), via the one or more input devices, a first input (e.g., an air pinch gesture that includes bringing two or more fingers of a hand into contact with each other, an air long pinch gesture, an air tap gesture, or other input), and in response to detecting the first input: in accordance with a determination that second criteria are met (e.g., based on what type of input is detected, whether the first input is detected while the control is displayed, and/or other criteria), the computer system performs a system operation (e.g., while displaying the control corresponding to the location or view of the hand, or after the control has ceased to be displayed). For example, in FIGS. 7AK, FIGS. 7AL, FIG. 7AO, and FIGS. 8G-8H, in response to detecting an input performed by the hand 7022′ while the control 7030 is displayed in the viewport, the computer system 101 performs a system operation (e.g., displays the home menu user interface 7031 in FIGS. 7AK and FIGS. 7AL, displays the status user interface 7032 in FIG. 7AO, and displays the indicator 8004 in FIGS. 8G-8H). Performing a system operation in response to detecting a particular input, depending on the context and whether certain criteria are met, reduces the number of inputs and amount of time needed to perform the system operation and enables one or more different types of system operations to be conditionally performed in response to one or more different types of inputs without displaying additional controls.

In some embodiments, the second criteria include (10036) a requirement that the first input is detected while the control corresponding to the location of the hand is displayed in order for the second criteria to be met, and in accordance with a determination that the first input includes an air pinch gesture, the computer system performs the system operation includes displaying, via the one or more display generation components, a system user interface (e.g., an application launching user interface such as a home menu user interface, a notifications user interface, an application launching user interface, a multitasking user interface, a control user interface, and/or other operation system user interface). For example, in FIGS. 7AK and FIG. 7AL, in response to detecting an air pinch gesture performed by the hand 7022′ while the control 7030 is displayed in the viewport, the computer system 101 displays a system user interface (e.g., the home menu user interface 7031 in FIGS. 7AK and FIG. 7AL). Requiring that the input be detected while the control is displayed in order for the system operation to be performed, and displaying a system user interface if the detected input is or includes an air pinch gesture causes the computer system to automatically require that the user indicate intent to trigger performance of a system operation, based on currently invoking the control, and reduces the number of inputs and amount of time needed to display the system user interface while enabling different types of system operations to be performed without displaying additional controls.

In some embodiments, in response to detecting the first input: in accordance with a determination that the second criteria are not met (e.g., the air pinch gesture is detected while the control is not displayed), the computer system forgoes (10038) performing the system operation (e.g., forgoing displaying the system user interface, even if the first input includes an air pinch gesture (e.g., that is optionally less than a threshold duration)). For example, in FIGS. 70-7P, in response to detecting an air pinch gesture performed by the hand 7022′ while the control 7030 is not displayed in the viewport, the computer system 101 forgoes displaying any system user interfaces (e.g., the home menu user interface 7031). Requiring that the input be detected while the control is displayed in order for the system operation to be performed, such that the system operation is not performed if the input is detected while the control is not displayed, causes the computer system to automatically reduce the chance of unintentionally triggering performance of the system operation when the user does not intend to do so, based on not currently invoking the control.

In some embodiments, the system user interface comprises (10040) an application launching user interface (e.g., a home menu user interface, a multitasking user interface, or other interfaces from which an application can be launched from a list of two or more applications). For example, in FIGS. 7AK and FIG. 7AL, in response to detecting an air pinch gesture performed by the hand 7022′ while the control 7030 is displayed in the viewport, the computer system 101 displays the home menu user interface 7031, from which one or more applications can be launched (e.g., as in FIGS. 7AM-7AN). Displaying an application launching user interface if the detected input is or includes an air pinch gesture reduces the number of inputs and amount of time needed to display the application launching user interface and enables different types of system operations to be performed without displaying additional controls.

In some embodiments, in accordance with a determination that the first input includes an air long pinch gesture (e.g., a selection input, such as an air pinch gesture, performed by the hand of the user that is maintained for at least a threshold amount of time), the computer system performs (10042) the system operation includes displaying, via the one or more display generation components, a control for adjusting a respective volume level of the computer system (e.g., that includes a visual indication of a current volume level of the computer system; a visual indication of an available range for adjusting the respective volume level of the computer system; and/or an indication of a type and/or direction of movement that would cause the respective volume level of the computer system to be adjusted). In some embodiments, in accordance with a determination that the first input does not include an air long pinch gesture, the computer system forgoes displaying the visual indication of the respective volume level. In some embodiments, in accordance with a determination that the first input includes an air pinch that is not maintained for a threshold period of time, the computer system displays a system user interface (e.g., a home menu user interface, a multitasking user interface and/or a different operation system user interface). In some embodiments, the hand of the user is required to be detected in a particular orientation in order for the computer system to display the control for adjusting the respective volume level (also called herein a volume control). For example, the computer system displays the volume control if the hand has a first orientation with the palm of the hand facing toward the viewpoint of the user, and forgoes displaying the volume control if the hand has a second orientation with the palm of the hand facing away from the viewpoint of the user (e.g., or the computer system displays the volume control if the hand has the second orientation with the palm of the hand facing away from the viewpoint of the user, and forgoes displaying the volume control if the hand has the first orientation with the palm of the hand facing toward the viewpoint of the user). For example, in FIGS. 8G-8H, in response to detecting an air long pinch gesture performed by the hand 7022 while the control 7030 is displayed and while the attention 7010 is directed to the hand 7022′, the computer system 101 displays the indicator 8004 for adjusting a respective volume level of the computer system 101. Displaying a control for adjusting a respective volume level of the computer system if the detected input is or includes an air long pinch gesture reduces the number of inputs and amount of time needed to display the volume indication and enables different types of system operations to be performed without displaying additional controls.

In some embodiments, in accordance with a determination that the first input includes the air long pinch gesture followed by movement of the hand (e.g., lateral or other translational movement of the hand, optionally while the air long pinch gesture is maintained), the computer system performs (10044) the system operation includes changing (e.g., increasing or decreasing) the respective volume level (e.g., an audio output volume level and/or tactile output volume level, optionally for content from a respective application (e.g., application volume level) or for content systemwide (e.g., system volume level)) in accordance with the movement of the hand (e.g., the respective volume level is increased or decreased (e.g., by moving the hand toward a first direction or toward a second direction that is opposite the first direction) by an amount that is based on an amount (e.g., magnitude) of movement of the hand, where a larger amount of movement of the hand causes a larger amount of change in the respective volume level, and a smaller amount of movement of the hand causes a smaller amount of change in the respective volume level, and movement of the hand toward a first direction causes an increase in the respective volume level whereas movement of the hand toward a second direction different from (e.g., opposite) the first direction causes a decrease in the respective volume level). In some embodiments, in accordance with a determination that the first input does not include movement (e.g., lateral or other translational movement) of the hand, the computer system maintains the respective volume level at a same level. For example, in FIGS. 8H-8L, the user 7002 adjusts a respective volume level in accordance with movement of the hand 7022′ (e.g., corresponding to movement of the hand 7022). If the detected input triggers display of a volume indication or volume control and includes movement of the hand, changing the volume in accordance with the movement of the hand reduces the number of inputs and amount of time needed to adjust the volume of one or more outputs of the computer system and enables different types of system operations to be performed without displaying additional controls.

In some embodiments (e.g., in accordance with the determination that the first input includes the air long pinch gesture followed by movement of the hand), while detecting the movement of the hand, and while changing the respective volume level in accordance with the movement of the hand, the computer system detects (10046) that the attention of the user (e.g., gaze or an attention metric based on a gaze, head direction, wrist direction, and/or other pointing manner of the user) is directed away from the location of the hand of the user; and in response to detecting the movement of the hand while the attention of the user is directed away from (e.g., no longer directed toward) the location of the hand of the user (e.g., or in some embodiments without regard to whether the attention of the user is directed toward or away from the location or view of the hand of the user (e.g., as long as the air long pinch gesture is maintained)), the computer system continues to change the respective volume level in accordance with the movement of the hand (e.g., including in accordance with movement of the hand that occurs while the user's attention is directed away from the location or view of the hand). In some embodiments, in accordance with a determination that the attention of the user is directed away from (e.g., no longer directed toward) the location or view of the hand of the user and that no movement of the hand is detected, forgoing changing the respective volume level. For example, in FIGS. 8H-8L, the user 7002 adjusts a respective volume level in accordance with the movement of the hand 7022′ while the attention 7010 is directed away from the hand 7022′. Enabling continued adjustment of the volume in accordance with the movement of the hand during the detected input, even if the user's attention is not directed to the displayed volume indication or volume control or location/view of the hand, reduces the number of inputs and amount of time needed to perform certain types of system operations.

In some embodiments, the computer system detects (10048), via the one or more input devices, termination of the first input (e.g., a de-pinch, or a break in contact between the fingers of a hand that was performing the first input); and in response to detecting the termination of the first input, the computer system ceases to display the visual indication of the respective volume level (e.g., and ceasing to change the respective volume level in accordance with the movement of the hand). In some embodiments, in accordance with a determination that the air long pinch gesture of the first input is maintained, maintaining display of the visual indication of the respective volume level. For example, in FIGS. 8N-8P, the user 7002 terminates the pinch and hold gesture by un-pinching the hand 7022 while the indicator 8004 is displayed. In FIG. 8N, in response to detecting that the hand 7022 has un-pinched, the computer system 101 ceases to display the indicator 8004 (e.g., and optionally displays the status user interface 7032 in response to detecting that the attention 7010 of the user 7002 is directed toward the hand 7022′). If the detected input triggers display of a volume indication, ceasing to display the volume indication in response to detecting the end of the input reduces the number of displayed user interface elements by dismissing those that have become less relevant, and provides feedback about a state of the computer system.

In some embodiments, in accordance with a determination that the first input includes a change in orientation of the hand from a first orientation with the palm of the hand facing toward the viewpoint of the user to a second orientation (e.g., with the palm of the hand facing away from the viewpoint of the user) (e.g., while attention of the user is directed toward the location or view of the hand), the computer system performs (10050) the system operation includes displaying, via the one or more display generation components, a status user interface (e.g., that includes one or more status elements indicating status information (e.g., including system status information such as battery level, wireless communication status, a current time, a current date, and/or a current status of notification(s) associated with the computer system), as described herein with reference to method 11000). In some embodiments, in accordance with a determination that the first input does not include a change in orientation of the hand from the first orientation to the second orientation, the computer system forgoes displaying the status user interface (e.g., optionally while maintaining display of the control corresponding to the location or view of the hand). For example, in 7AO, in response to detecting a hand flip gesture of the hand 7022′ from the “palm up” configuration in the stage 7154-1 to the “palm down” configuration in the stage 7154-6, the computer system 101 displays the status user interface 7032. Displaying a status user interface if the detected input is or includes a change in orientation of the hand (e.g., based on the hand flipping over, such as from palm up to palm down or vice versa) reduces the number of inputs and amount of time needed to display the status user interface and enables different types of system operations to be performed without displaying additional controls.

In some embodiments, performing the system operation includes (10052) transitioning from displaying the control corresponding to the location of the hand to displaying the status user interface (e.g., described herein with reference to operation 10050). For example, in 7AO, in response to detecting the hand flip gesture of the hand 7022′ from the “palm up” configuration in the stage 7154-1 to the “palm down” configuration in the stage 7154-6, the computer system 101 transitions from displaying the control 7030 to displaying the status user interface 7032. Replacing display of the control corresponding to the location/view of the hand with the status user interface (e.g., via an animated transition or transformation from one to the other) reduces the number of displayed user interface elements by dismissing those that have become less relevant, and provides feedback about a state of the computer system.

In some embodiments, transitioning from displaying the control corresponding to the location of the hand to displaying the status user interface includes (10054) displaying a three-dimensional animated transformation of the control corresponding to the location of the hand turning over (e.g., by flipping or rotating about a vertical axis) to display the status user interface. For example, in 7AO, in response to detecting the hand flip gesture, the computer system 101 displays an animation of the control 7030 flipping over in which the control 7030 is transformed into the status user interface 7032. Displaying a three-dimensional animation of the control flipping over to display the status user interface (e.g., as the reverse side of the control) reduces the number of displayed user interface elements by dismissing those that have become less relevant, and provides feedback about a state of the computer system.

In some embodiments, a speed of the transitioning from displaying the control corresponding to the location of the hand to displaying the status user interface is (10056) based on a speed of the change in orientation of the hand from the first orientation to the second orientation (e.g., the transitioning is triggered by the change in orientation of the hand from the first orientation to the second orientation, an animation of a rotation of the control is optionally displayed concurrently with the transitioning, and/or a speed at which the animation is played is controlled by the speed at which the orientation of the hand is changed from the first orientation to the second orientation). For example, in 7AO, a speed of the animation of the turning of the control 7030 is based on the speed of change in orientation of the hand 7022′ from the “palm up” configuration (e.g., stage 7154-1) to the “palm down” configuration (e.g., stage 7154-6). Progressing the transition from displaying the control to displaying the status user interface with a speed that is based on a speed of the change in orientation of the user's hand (e.g., a speed with which the hand flips over) provides an indication as to how the computer system is responding to the user's hand movement, which provides feedback about a state of the computer system.

In some embodiments, while displaying the status user interface, the computer system detects (10058), via the one or more input devices, a selection input (e.g., an air pinch gesture that includes bringing two or more fingers of a hand into contact with each other, an air tap gesture, or other input); in response to detecting the selection input, the computer system displays, via the one or more display generation components, a control user interface that provides access to a plurality of controls corresponding to different functions (e.g., system functions) of the computer system. In some embodiments, as described in more detail herein with reference to method 11000, in response to detecting an air pinch input while the status user interface is displayed, a control user interface is displayed. For example, in FIGS. 7AP and 7AQ, in response to detecting the hand 7022′ performing an air pinch gesture while the status user interface 7032 is displayed, the computer system 101 displays system function menu 7044. Displaying a control user interface in response to a selection input detected while the status user interface is displayed reduces the number of inputs and amount of time needed to display the control user interface without displaying additional controls.

In some embodiments, the computer system outputs (10060), via one or more audio output devices that are in communication with the computer system (e.g., one or more speakers that are integrated into the computer system and/or one or more separate headphones, earbuds or other separate audio output devices that are connected to the computer system with a wired or wireless connection), first audio in conjunction with (e.g., concurrently with or while) transitioning from displaying the control corresponding to the location of the hand to displaying the status user interface. For example, in FIGS. 7AO, in response to the hand 7022′ flipping from the “palm up” configuration (e.g., at the stage 7154-1) to the “palm down” configuration (e.g., at the stage 7154-6), the computer system 101 generates audio 7103-e. Outputting audio along with the transition from displaying the control to displaying the status user interface provides feedback about a state of the computer system.

In some embodiments, while displaying the status user interface, the computer system detects (10062), via the one or more input devices, a change in orientation of the hand from the second orientation (e.g., with the palm of the hand facing away from the viewpoint of the user) (e.g., while attention of the user is directed toward the location or view of the hand) to the first orientation with the palm of the hand facing toward the viewpoint of the user; in response to detecting the change in orientation of the hand from the second orientation to the first orientation, the computer system transitions from displaying the status user interface to displaying the control corresponding to the location of the hand and the computer system outputs, via the one or more audio output devices, second audio that is different from the first audio. For example, in FIG. 7AO, if the hand 7022′ flips from the “palm up” configuration (e.g., at the first stage 7154-1) to the “palm down” configuration (e.g., at the sixth stage 7154-6), the computer system 101 generates audio 7103-e, whereas if the hand 7022′ flips from the “palm down” configuration (e.g., at the sixth stage 7154-6) to the “palm up” configuration (e.g., at the first stage 7154-1), the computer system 101 generates audio 7103-a, which is different from audio 7103-e. Outputting audio along with a transition from displaying the status user interface back to displaying the control that is different from the audio that was output when initially transitioning to displaying the status user interface provides different (e.g., non-visual) indications for different operations that are performed, which provides feedback about a state of the computer system.

In some embodiments, one or more audio properties (e.g., volume, frequency, timbre, and/or other audio properties) of the first audio (and/or the second audio) changes (10064) based on a speed at which the orientation of the hand is changed. For example, in FIG. 7AO, depending on a speed of the flipping of the hand from the “palm up” configuration (e.g., at the first stage 7154-1) to the “palm down” configuration (e.g., at the sixth stage 7154-6), the computer system 101 changes one or more audio properties, such as volume, frequency, timbre and/or other audio properties of audio 7103-a and/or audio 7103-e. For audio that is output along with the transition from displaying the control to displaying the status user interface, changing one or more audio properties of the audio output based on a speed of the change in orientation of the user's hand (e.g., a speed with which the hand flips over) provides feedback about a state of the computer system.

In some embodiments, the computer system detects (10066), via the one or more input devices, a second input (e.g., an air pinch gesture, an air long pinch gesture, an air tap gesture, or other input) that includes attention of the user directed toward the location of the hand (e.g., where in some embodiments different views of the hand that are dependent on what else is visible in the environment when the second input is detected, such as which application(s) are displayed, are displayed at the location of the hand), and in response to detecting the second input: in accordance with a determination that the attention of the user is directed toward the location of the hand while the first criteria are met and that an immersive application user interface is displayed in the environment with an application setting corresponding to the immersive application having a first state, the computer system displays, via the one or more display generation components, the control corresponding to the location of the hand; and in accordance with a determination that the attention of the user is directed toward the location of the hand while the first criteria are met and that the immersive application user interface is displayed in the environment with the application setting having a second state different from the first state, the computer system forgoes displaying the control corresponding to the location of the hand. In some embodiments, if, while the immersive application user interface is displayed in the environment, the attention of the user is not directed toward the location or view of the hand and/or the first criteria are not met, the computer system forgoes displaying the control without regard to the state of the application setting of the immersive application. For example, in FIG. 7AU, an application user interface 7156 of an immersive application App Z1 is displayed in the viewport. In response to detecting that the attention 7010 of the user 7002 is directed toward the hand 7022′, while the hand 7022 is in the palm up orientation, the computer system 101 forgoes displaying the control 7030, in accordance with an application type and/or one or more application settings of the immersive application App Z1. In contrast, in FIG. 7BD, an application user interface 7166 of an immersive application App Z2 is displayed in the viewport. In response to detecting that the attention 7010 of the user 7002 is directed toward the hand 7022′, while the hand 7022′ is in the palm up orientation, the computer system 101 displays the control 7030 while maintaining display of the application user interface 7166, in accordance with an application type and/or one or more application settings of the immersive application App Z2. For a control corresponding to a location/view of a hand that is conditionally displayed in response to a user directing attention toward the location/view of the hand if criteria including whether the hand is palm up are met, forgoing displaying the control if an immersive application user interface is displayed reduces the number of inputs and amount of time needed to invoke the control and access a plurality of different system operations of the computer system while reducing the chance of unintentionally triggering display of the control under certain circumstances.

In some embodiments, while forgoing displaying the control corresponding to the location of the hand (e.g., because the immersive application user interface is displayed and the application has the second state), the computer system detects (10068), via the one or more input devices, a third input (e.g., corresponding to a request to perform a system operation (e.g., analogous to the first input described herein)) (e.g., an air pinch gesture, an air long pinch gesture, an air tap gesture, and/or other input), and in response to detecting the third input: in accordance with a determination that performance criteria are met (e.g., analogous to the second criteria described herein with reference to the first input, such as an air pinch input being maintained for at least a threshold amount of time while the control is displayed, an air pinch input being detected within a threshold amount of time since a change in orientation of the hand is detected, or other criteria), the computer system performs a respective system operation (e.g., displaying a system user interface (e.g., an application launching user interface, a status user interface, or a control user interface) if the third input includes an air pinch gesture; displaying a visual indication of a respective volume level and optionally adjusting the respective volume level if the third input includes an air long pinch gesture and optionally movement thereof; and/or other system operation described herein); and in accordance with a determination that the performance criteria are not met, the computer system forgoes performing the respective system operation. For example, in FIG. 7BE, even though the control 7030 is not displayed in the viewports of scenarios 7170-1 and 7170-4, in accordance with a determination that the attention 7010 is directed to a location corresponding to the hand 7022 while the hand 7022 is in the required configuration, the computer system 101 performs system operations such as displaying the indicator 8004 (e.g., scenario 7170-2), the home menu user interface 7031 (e.g., scenario 7170-3), the status user interface (e.g., scenario 7170-5), and the system function menu 7044 (e.g., scenario 7170-6). Performing a system operation in response to detecting a particular input, even if a control corresponding to a location/view of a hand is not displayed due to an immersive application user interface being displayed, as long as other criteria for performing the system operation are met, reduces the number of inputs and amount of time needed to perform the system operation and enables one or more different types of system operations to be conditionally performed in response to one or more different types of inputs without displaying additional controls.

In some embodiments, the first criteria include (10070) a requirement that an immersive application user interface is not displayed in the environment (e.g., or does not have focus for user input) in order for the first criteria to be met. In some embodiments, an immersive application is an application that is enabled to place content of the immersive application anywhere in the environment or in regions of the environment not limited to one or more application windows (e.g., in contrast to a windowed application that is enabled to place its content only within one or more application windows for that application in the environment), an application whose content substantially fills a viewport into the environment, and/or an application whose content is the only application content displayed in the viewport, when the immersive application has focus for user inputs. In some embodiments, if the attention of the user is directed toward the location or view of the hand while an immersive application user interface is displayed (e.g., even if the hand is in the respective pose and oriented with the palm of the hand facing toward the viewpoint of the user (e.g., the first orientation)), the control is not displayed (e.g., unless display of the control in immersive applications is enabled, such as via an application setting or system setting). For example, no immersive application is displayed in the viewport in FIG. 7Q1. In response to detecting that the attention 7010 of the user 7002 is directed toward the hand 7022′ while the hand 7022 is in the palm up orientation, and display criteria are met, the computer system 101 displays the control 7030. In FIG. 7AU, an application user interface 7156 of an immersive application is displayed in the viewport, but in response to detecting that the attention 7010 of the user 7002 is directed toward the hand 7022′ while the hand 7022 is in the palm up orientation, the computer system 101 forgoes displaying the control 7030. Conditionally displaying a control corresponding to a location/view of a hand in response to a user directing attention toward the location/view of the hand based on whether an immersive application user interface is displayed or not reduces the number of inputs and amount of time needed to invoke the control and access a plurality of different system operations of the computer system while reducing the chance of unintentionally triggering display of the control under certain circumstances.

In some embodiments, while displaying the immersive application user interface and forgoing displaying the control (e.g., in accordance with the determination that the attention of the user was directed toward the location or view of the hand while the first criteria were not met), the computer system detects (10072), via the one or more input devices, a first selection gesture (e.g., an air pinch gesture, an air tap gesture, or an air swipe gesture performed using the hand) while the attention of the user (e.g., gaze or an attention metric based on a gaze, head direction, wrist direction, and/or other pointing manner of the user) is directed toward the location of the hand, and in response to detecting the first selection gesture while the attention of the user (e.g., gaze or an attention metric based on a gaze, head direction, wrist direction, and/or other pointing manner of the user) is directed toward the location of the hand, the computer system displays, via the one or more display generation components, the control corresponding to the location of the hand (e.g., within the environment, optionally within or overlaid on the immersive application user interface. In some embodiments, while an immersive application user interface is displayed, the user's attention directed toward the location or view of the hand plus a further selection input is required to cause display of the control. In contrast, while a non-immersive (e.g., windowed) application user interface is displayed, the further selection input is not required in order for the control to be displayed). While displaying the control corresponding to the location of the hand, the computer detects, via the one or more input devices, a second selection gesture (e.g., an air pinch gesture, an air tap gesture, or an air swipe gesture performed using the hand optionally while the attention of the user is directed toward the location or view of the hand (e.g., gaze or an attention metric based on a gaze, head direction, wrist direction, and/or other pointing manner of the user)); and in response to detecting the second selection gesture, the computer system activates the control corresponding to the location of the hand. In some embodiments, the first selection gesture causes the control to be displayed without activating the control. In some embodiments, a second selection gesture, which is optionally a same type of selection gesture as the first selection gesture, is further required to activate the control. For example, in FIGS. 7AU-7AW, the computer system 101, while displaying an application user interface 7156 of an immersive application, displays the control 7030 in response to detecting an air pinch gesture while the attention 7010 is directed toward a region 7162 corresponding to a location of the hand 7022 (e.g., after not initially displaying the control 7030 in response to the attention 7010 being directed toward the region 7162 without the air pinch gesture being performed). In FIGS. 7AZ-7BA, the computer system 101 activates the control 7030 in response to detecting a second pinch gesture while the control 7030 is displayed (e.g., and the attention 7010 is directed toward a region 7164 corresponding to the location of the hand 7022). While forgoing displaying a control corresponding to a location/view of a hand if an immersive application user interface is displayed, enabling displaying the control in response to a first selection input and then enabling activating the control in response to a second selection input causes the computer system to automatically require that the user indicate intent to trigger display of the control and intent to trigger performance of an associated activation operation such as a system operation, while reducing the chance of unintentionally triggering display of and/or interaction with the control.

In some embodiments, the first selection gesture is (10074) detected while the attention of the user is directed toward a first region corresponding to the location of the hand (e.g., a first spatial region in the environment that optionally includes one or more first portions of the view of the hand and/or one or more portions of the environment within a first threshold distance of the location or view of the hand. In some embodiments, displaying the control corresponding to the location or view of the hand in response to detecting the first selection gesture requires that (e.g., is performed in accordance with a determination that) the first selection gesture is detected while the attention of the user is directed toward the first region corresponding to the location or view of the hand (e.g., and not performed if the first selection gesture is detected while the attention of the user is not directed toward the first region). The second selection gesture is detected while the attention of the user is directed toward a second region corresponding to the location of the hand (e.g., a second spatial region in the environment that optionally includes one or more second portions of the view of the hand, optionally different from the one or more first portions of the view of the hand, and/or one or more portions of the environment within a different, second threshold distance of the location or view of the hand, and/or the control. In some embodiments, activating the control corresponding to the location or view of the hand in response to detecting the second selection gesture requires that (e.g., is performed in accordance with a determination that) the second selection gesture is detected while the attention of the user is directed toward the second region corresponding to the location or view of the hand (e.g., and not performed if the second selection gesture is detected while the attention of the user is not directed toward the second region). The first region is larger than the second region. For example, the region 7162 in FIG. 7AV is larger than the region 7164 in FIG. 7AZ. Allowing for a larger interaction region within which a user's attention must be directed in order for the control to be displayed, versus a smaller interaction region within which the user's attention must be directed in order for the control to be activated (e.g., using different size interaction regions for different interactions), causes the computer system to automatically require that the user indicate requisite intent to trigger display of the control versus to trigger performance of an associated activation operation such as a system operation (e.g., requiring different degrees of intent for different interactions), while reducing the chance of unintentionally triggering display of and/or interaction with the control.

In some embodiments, the computer system detects (10076), via the one or more input devices, a subsequent input; in response to detecting the subsequent input: in accordance with a determination that the subsequent input is detected while an immersive application user interface is not displayed in the environment and while displaying the control corresponding to the location of the hand (e.g., in response to detecting that the attention of the user is directed toward the location of the hand and that the first criteria are met in part because an immersive application user interface is not displayed in the environment), the computer system performs an operation associated with the control; and in accordance with a determination that the subsequent input is detected while an immersive application user interface is displayed in the environment (e.g., and while forgoing displaying the control in response to detecting that the attention of the user is directed toward the location of the hand, and that the first criteria are not met because an immersive application user interface is displayed in the environment), the computer system displays, via the one or more display generation components, the control corresponding to the location of the hand without performing an operation associated with the control. For example, in FIGS. 7AU-7AW, the computer system 101, while displaying an application user interface 7156 of an immersive application, displays the control 7030 in response to detecting an air pinch gesture (e.g., as illustrated in FIG. 7AV) while the attention 7010 is directed toward a region 7162 corresponding to the location of the hand 7022 (e.g., after not initially displaying the control 7030 in response to the attention 7010 being directed toward the region 7162 without the air pinch gesture being performed). In FIGS. 7AK and FIG. 7AL, no immersive application is displayed in the viewport, and in response to detecting an air pinch gesture while the attention 7010 is directed toward hand 7022 (e.g., and while the control 7030 is already displayed in response to detecting the attention 7010 directed toward hand 7022 even without the air pinch gesture being performed), the computer system 101 displays the home menu user interface 7031. If an immersive application user interface is displayed, requiring an additional input (e.g., a selection input) in combination with the user directing attention toward a location/view of the hand in order to invoke display of a control corresponding to the location/view of the hand, in contrast with displaying the control without requiring the additional input and performing an operation associated with the control in response to detected the additional input if an immersive application user interface is not displayed, reduces the chance of unintentionally triggering display of and/or interaction with the control under certain circumstances.

In some embodiments, while displaying the control corresponding to the location of the hand (e.g., and while the hand has the first orientation with the palm of the hand facing toward the viewpoint of the user), the computer system detects (10078), via the one or more input devices, that the attention of the user (e.g., gaze or an attention metric based on a gaze, head direction, wrist direction, and/or other pointing manner of the user) is not (e.g., is no longer or ceases to be) directed toward the location of the hand (e.g., detecting the user's attention moving away from the location of the hand or detecting that the user's attention is no longer directed toward the location of the hand); and in response to detecting that the attention of the user (e.g., gaze or an attention metric based on a gaze, head direction, wrist direction, and/or other pointing manner of the user) is not (e.g., is no longer or ceases to be) directed toward the location of the hand, the computer system ceases to display the control corresponding to the location of the hand. For example, in FIGS. 8O-8P, the control 7030 is displayed in the viewport while the attention 7010 is directed to hand 7022′. In response to detecting that the attention 7010 is directed away from the hand 7022′ towards the application user interface 8000, computer system 101 ceases display of the control 7030 (e.g., as also described with reference to example 7034 of FIG. 7J1, in which the attention 7010 of the user 7002 not being directed toward (e.g., moving away from) the hand 7022′ results in the control 7030 not being displayed). After a control corresponding to a location/view of a hand is displayed in response to a user directing attention toward the location/view of the hand, ceasing to display the control in response to the user's attention not being directed toward the location of the hand reduces the number of inputs and amount of time needed to dismiss the control and reduces the number of displayed user interface elements by dismissing those that have become less relevant.

In some embodiments, while the control corresponding to the location of the hand is not displayed (e.g., after ceasing to display the control corresponding to the location or view of the hand in response to detecting that the attention of the user has ceased to be directed toward the location or view of the hand), the computer system detects (10080), via the one or more input devices, that the attention of the user (e.g., gaze or an attention metric based on a gaze, head direction, wrist direction, and/or other pointing manner of the user) is directed (e.g., redirected) toward the location of the hand; and in response to detecting that the attention of the user is directed toward the location of the hand: in accordance with a determination that the first criteria are met, the computer system displays (e.g., redisplays), via the one or more display generation components, the control corresponding to the location of the hand; and in accordance with a determination that the first criteria are not met, the computer system forgoes displaying (e.g., redisplaying) the control corresponding to the location of the hand. For example, starting from FIG. 8P in which the control 7030 ceases to be displayed because the attention 7010 is directed instead to application user interface 8000, in response to detecting that the attention 7010 has moved (e.g., back) to the hand 7022′ that is in the “palm up” configuration, the computer system 101 redisplays the control 7030. After a control corresponding to a location/view of a hand has ceased to be displayed in response to a user directing attention away from the view of the hand, displaying the control in response to the user's attention being directed toward the location/view of the hand, if criteria including whether the hand is palm up are met, reduces the number of inputs and amount of time needed to invoke the control and access a plurality of different system operations of the computer system without displaying additional controls.

In some embodiments, in response to detecting that the attention of the user is directed toward the location of the hand: in accordance with the determination that the attention of the user is directed toward the location of the hand while the first criteria are met, the computer outputs (10082), via one or more audio output devices that are in communication with the computer system (e.g., one or more speakers that are integrated into the computer system and/or one or more separate headphones, earbuds or other separate audio output devices that are connected to the computer system with a wired or wireless connection), first audio (e.g., in conjunction with (e.g., concurrently with) displaying the control corresponding to the location or view of the hand) (e.g., audio that is indicative of display of the control). In some embodiments, in accordance with the determination that the attention of the user is directed toward the location or view of the hand while the first criteria are not met, the computer system forgoes outputting the first audio. While displaying the control corresponding to the location of the hand, the computer system detects a fourth input; in response to detecting the fourth input: in accordance with the determination that the fourth input meets third criteria (e.g., the third criteria require that the attention of the user is directed away from the location or view of the hand and/or that the hand is moved above a speed threshold while the control is displayed), the computer system ceases to display the control without outputting the first audio (e.g., nor any audio corresponding to ceasing to display the control). In some embodiments, in accordance with the determination that the fourth input does not meet the third criteria, the computer system maintains display of the control corresponding to the location or view of the hand without outputting the first audio. For example, in FIG. 7AA, the computer system 101 generates audio output 7122-1 at time 7120-1 in conjunction with the control 7030 being displayed, but the computer system 101 does not generate audio output at time 7120-2 in conjunction with the control 7030 ceasing to be displayed. Outputting audio along with displaying the control corresponding to the location/view of the hand and not outputting audio along with dismissing the control provides an appropriate amount of feedback about a state of the computer system when starting to perform an operation in response to a triggering input without overusing the audio output generators to provide redundant feedback when finishing the operation.

In some embodiments, after outputting the first audio: while the control corresponding to the location of the hand is not displayed, the computer detects (10084), via the one or more input devices, that the attention of the user (e.g., gaze or an attention metric based on a gaze, head direction, wrist direction, and/or other pointing manner of the user) is directed toward the location of the hand; and in response to detecting that the attention of the user (e.g., gaze or an attention metric based on a gaze, head direction, wrist direction, and/or other pointing manner of the user) is directed toward the location of the hand: in accordance with a determination that the attention of the user is directed toward the location of the hand while the first criteria are met and within a threshold amount of time since outputting the first audio, the computer system displays (e.g., redisplays), via the one or more display generation components, the control corresponding to the location of the hand without outputting the first audio (e.g., preventing the first audio from being played within a threshold amount of time since the first audio was last played; the threshold amount of time may be at least 2 seconds, 5 seconds, 10 seconds, or other lengths of time); and in accordance with a determination that the attention of the user is directed toward the location of the hand while the first criteria are met and at least a threshold time has elapsed since outputting the first audio, the computer system displays (e.g., redisplays), via the one or more display generation components, the control corresponding to the location of the hand and the computer system outputs, via the one or more audio output devices, the first audio (e.g., repeating the outputting of the first audio or another instance of the first audio). For example, in FIG. 7AA, even though display of the control 7030 was invoked, the computer system 101 does not output audio at times 7120-5, 7120-6, 7120-7, and 7120-12 in conjunction with displaying the control 7030 because the respective time periods ΔT_{B}, ΔT_{C}, ΔT_{D}, and ΔT_{H} are less than the audio output time threshold Tₜₕ₁. Forgoing outputting audio again if the control corresponding to the location/view of the hand is dismissed and then reinvoked within too short of a time period since a most recent instance of outputting audio along with displaying the control provides an appropriate amount of feedback about a state of the computer system without overusing the audio output generators.

In some embodiments, while displaying (e.g., or redisplaying) the control corresponding to the location of the hand, the computer system detects (10086), via the one or more input devices, a selection input directed toward the control (e.g., an air pinch gesture, an air tap gesture, or other input); and in response to detecting the selection input directed toward the control: the computer system outputs, via the one or more audio output devices, second audio (e.g., audio that is indicative of selection and/or activation of the displayed control, and that is optionally the same as or different from the first audio that is indicative of display of the control); and the computer system activates (e.g., and/or in some embodiments providing visual feedback indicating that the control has been activated or selected) the control corresponding to the location of the hand (e.g., and performing a system operation as described herein with respect to operations 10034-10064). For example, in FIGS. 7AK and FIGS. 7AL, in response to detecting the selection input (e.g., the air pinch gesture in FIG. 7AK1 or the button press in FIG. 7AL1) while the control 7030 is displayed, the computer system 101 generates audio 7103-b while selecting the control 7030. Outputting audio along with activating the control corresponding to the location/view of the hand provides feedback about a state of the computer system.

In some embodiments, while the view of the environment is visible via the one or more display generation components, in accordance with a determination that (e.g., and while) hand view criteria are met, the computer system displays (10088) a view of the hand of the user at the location of the hand of the user. In some embodiments, in accordance with a determination that (e.g., and while) the hand view criteria are not met, the computer system forgoes displaying a view of the hand of the user at the location of the hand of the user. For example, as described with reference to FIG. 7AU, in some embodiments, in response to detecting that attention is directed to the region that corresponds to where hand 7022 is (e.g., while a representation of hand 7022 is not visible), computer system 101 makes an indication of the location of the hand visible (e.g., by removing a portion of virtual content displayed at a location of hand 7022, by reducing an opacity of a portion of virtual content displayed at a location of hand 7022, and/or by displaying a virtual representation of a in the region that corresponds to where hand 7022 is). If a view of a hand is not displayed when hand view criteria are met, displaying the view of the hand indicates that the hand view criteria are met and optionally that interaction with a hand-based control or other user interface has been enabled, which provides feedback about a state of the computer system.

In some embodiments, the hand view criteria include (10090) a requirement that the attention of the user is directed toward the location of the hand of the user in order for the hand view criteria to be met. For example, as described with reference to FIG. 7AU, in some embodiments, in response to detecting that attention is directed to the region that corresponds to where hand 7022 is (e.g., while a representation of hand 7022 is not visible), computer system 101 makes an indication of the location of the hand visible (e.g., by removing a portion of virtual content displayed at a location of hand 7022, by reducing an opacity of a portion of virtual content displayed at a location of hand 7022, and/or by displaying a virtual representation of a in the region that corresponds to where hand 7022 is). If a view of a hand is not displayed, displaying the view of the hand in response to a user directing attention toward the location of the hand indicates that interaction with a hand-based control or other user interface has been enabled, which provides feedback about a state of the computer system.

In some embodiments, the hand view criteria include (10092) a requirement that the attention of the user is directed toward the location of the hand of the user while the first criteria are met in order for the hand view criteria to be met. In some embodiments, the hand view criteria do not include a requirement that the attention of the user is directed toward the location of the hand of the user while the first criteria are met in order for the hand view criteria to be met. For example, as described with reference to FIG. 7AU, in some embodiments, in response to detecting that attention is directed to the region that corresponds to where hand 7022 is (e.g., while a representation of hand 7022 is not visible) and optionally in accordance with detecting that hand 7022 is in a palm up orientation, computer system 101 makes an indication of the location of the hand visible (e.g., by removing a portion of virtual content displayed at a location of hand 7022, by reducing an opacity of a portion of virtual content displayed at a location of hand 7022, and/or by displaying a virtual representation of a in the region that corresponds to where hand 7022 is). If a view of a hand is not displayed, displaying the view of the hand in response to a user directing attention toward the location of the hand in addition to other criteria for displaying a hand-based control or other user interface indicates that interaction with the hand-based control or other user interface has been enabled, which provides feedback about a state of the computer system.

In some embodiments, displaying the view of the hand of the user includes (10094): in accordance with a determination that the view of the environment (e.g., a three-dimensional environment) includes a virtual environment (e.g., corresponding to the three-dimensional environment and/or the physical environment) having a first level of immersion, displaying the view of the hand with a first appearance; and in accordance with a determination that the view of the environment includes the virtual environment having a second level of immersion that is different from (e.g., higher or lower than) the first level of immersion, displaying the view of the hand with a second appearance, wherein the second appearance of the view of the hand has a different degree of visual prominence than a degree of visual prominence of the first appearance of the view of the hand. In some embodiments, the view of the hand is more prominent (e.g., relative to the virtual environment and/or as perceivable by the user) for a virtual environment with a higher level of immersion than for a virtual environment with a lower level of immersion. In some embodiments, the view of the hand is less prominent (e.g., relative to the virtual environment and/or as perceivable by the user) for a virtual environment with a higher level of immersion than for a virtual environment with a lower level of immersion. In some embodiments, a degree of visual prominence of the representation or view of a hand is increased by increasing a degree of passthrough (e.g., virtual passthrough or optical passthrough) applied to the representation of the hand (e.g., by removing or decreasing an opacity of virtual content that was being displayed in place of the representation of the hand). In some embodiments, a degree of visual prominence of the representation of a hand is increased by increasing a visual effect applied to the representation of the hand (e.g., increasing a brightness of a visual effect on or near the representation of the hand). For example, as described with reference to FIG. 7AU, in some embodiments, making the indication of the location of the hand visible includes displaying a view of the hand 7022 (e.g., the hand 7022′) with a first appearance (e.g., and/or a first level of prominence). In some embodiments, the first appearance corresponds to a first level of immersion (e.g., a current level of immersion with which the first type of immersive application is displayed), and the user 7002 can adjust the level of immersion (e.g., from the first level of immersion to a second level of immersion), and in response, the computer system 101 displays (e.g., updates display of) the hand 7022′ with a second appearance (e.g., and/or with a second level of prominence) that is different from the first appearance. For example, if the user 7002 increases the current level of immersion, the hand 7022′ is displayed with a lower level of visual prominence (e.g., to remain consistent with the increased level of immersion), and if the user 7002 decreases the current level of immersion, the hand 7022′ is displayed with a higher level of visual prominence. Alternately, if the user 7002 increases the current level of immersion, the hand 7022′ is displayed with a higher level of visual prominence (e.g., to ensure visibility of the hand, while the first type of immersive application is displayed with the higher level of immersion), and if the user 7002 decreases the current level of immersion, the hand 7022′ is displayed with a lower level of visual prominence. Displaying a view of a hand with different degrees of visual prominence for different levels of immersion of a virtual environment causes the computer system to automatically either preserve or enhance the immersive experience by displaying a less visually prominent hand in a more immersive environment even when hand-based controls and user interfaces are invoked, or make it easier for a user to interact with the hand-based controls and user interfaces during more immersive experiences that would otherwise suppress the view of the hand by displaying a more visually prominent view of the hand when invoked, and provides feedback about a state of the computer system.

In some embodiments, while the view of the environment includes the virtual environment having a respective level of immersion (e.g., the first level of immersion or the second level of immersion) and a respective appearance of the view of the hand, the computer system detects (10096) an input corresponding to a request to change the level of immersion of the virtual environment. In response to detecting the input corresponding to a request to change the level of immersion of the virtual environment, the computer system displays the view of the environment with the virtual environment having a third level of immersion that is different from the respective level of immersion, and the computer system displays the view of the hand with a third appearance that is different from the respective appearance. In some embodiments, the third appearance has a different degree of visual prominence than a degree of visual prominence of the respective appearance. In some embodiments, the appearance of the view of the hand is changed in accordance with the change in level of immersion of the virtual environment (e.g., the appearance of the view of the hand is changed and/or the prominence of the view of the hand is increased or decreased by an amount that is based on an amount (e.g., magnitude) of change in the level of immersion, where a larger amount of change in level of immersion causes a larger amount of change in the appearance and/or prominence of the view of the hand, and a smaller amount of change in level of immersion causes a smaller amount of change in the level of immersion, and a change in the level of immersion in a first direction (e.g., increase or decrease) causes an increase in the prominence of the view of the hand whereas a change in the level of immersion in a second direction different from (e.g., opposite) the first direction causes a decrease in the prominence of the view of the hand). For example, as described with reference to FIG. 7AU, in some embodiments, making the indication of the location of the hand visible includes displaying a view of the hand 7022 (e.g., the hand 7022′) with a first appearance (e.g., and/or a first level of prominence). In some embodiments, the first appearance corresponds to a first level of immersion (e.g., a current level of immersion with which the first type of immersive application is displayed), and the user 7002 can adjust the level of immersion (e.g., from the first level of immersion to a second level of immersion), and in response, the computer system 101 displays (e.g., updates display of) the hand 7022′ with a second appearance (e.g., and/or with a second level of prominence) that is different from the first appearance. For example, if the user 7002 increases the current level of immersion, the hand 7022′ is displayed with a lower level of visual prominence (e.g., to remain consistent with the increased level of immersion), and if the user 7002 decreases the current level of immersion, the hand 7022′ is displayed with a higher level of visual prominence. Alternately, if the user 7002 increases the current level of immersion, the hand 7022′ is displayed with a higher level of visual prominence (e.g., to ensure visibility of the hand, while the first type of immersive application is displayed with the higher level of immersion), and if the user 7002 decreases the current level of immersion, the hand 7022′ is displayed with a lower level of visual prominence. Changing the appearance of a view of a hand as the level of immersion of a virtual environment changes, so that the view of the hand is displayed with different degrees of visual prominence for different levels of immersion causes, the computer system to automatically either preserve or enhance the immersive experience by displaying a less visually prominent hand in a more immersive environment even when hand-based controls and user interfaces are invoked, or make it easier for a user to interact with the hand-based controls and user interfaces during more immersive experiences that would otherwise suppress the view of the hand by displaying a more visually prominent view of the hand when invoked, and provides feedback about a state of the computer system.

In some embodiments, aspects/operations of methods 11000, 12000, 13000, 15000, 16000, 17000, and 18000 may be interchanged, substituted, and/or added between these methods. For example, a hand flip to display the status user interface described in the method 11000 may be performed after the control that is displayed and/or interacted with in the method 10000 is displayed, the user can access the volume level adjustment function described in the method 13000 after the control that is displayed and/or interacted with in the method 10000 is displayed, and/or the control that is displayed and/or interacted with in the method 10000 is displayed based on a respective portion of the user's body as described in the method 12000. For brevity, these details are not repeated here.

FIGS. 11A-11E are flow diagrams of an exemplary method 11000 for displaying a status user interface and/or accessing system functions of the computer system, in accordance with some embodiments. In some embodiments, the method 11000 is performed at a computer system (e.g., computer system 101 in FIG. 1) that is in communication with one or more display generation components (e.g., a head-mounted display (HMD), a heads-up display, a display, a projector, a touchscreen, or other type of display) (e.g., display generation component 120 in FIGS. 1A, 3, and 4, or the display generation component 7100a in FIGS. 7A-7BE) and one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c, the digital crown 703, and/or controller 7111 with buttons 7113, 7115, and/or 7117 in FIGS. 7A-7BE and 8A-8T). In some embodiments, the method 11000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 11000 are, optionally, combined and/or the order of some operations is, optionally, changed.

While a view of an environment (e.g., a two-dimensional or three-dimensional environment that includes one or more virtual objects and/or one or more representations of physical objects) is visible via the one or more display generation components (e.g., using AR, VR, MR, virtual passthrough, or optical passthrough), the computer system detects (11002), via the one or more input devices, a selection input (e.g., an air pinch gesture, an air tap gesture, or an air swipe gesture) performed by a hand of a user (e.g., the air pinch gesture performed by the hand 7022′ in FIG. 7AP). The hand of the user can have (11004) a plurality of orientations including a first orientation with a palm of the hand facing toward the viewpoint of the user (e.g., a “palm up” orientation of the hand 7022′ in in FIG. 7G and stage 7154-1 in FIG. 7AO) and a second orientation with the palm of the hand facing away from the viewpoint of the user (e.g., a “palm down” orientation of the hand 7022′ in FIG. 7H and stage 7154-6 in FIG. 7AO). The selection input is performed (11006) while the hand is in the second orientation with the palm of the hand facing away from a viewpoint of the user (e.g., the hand 7022′ is in the “palm down” orientation in FIG. 7AP). In response to detecting (11008) the selection input (e.g., an air pinch gesture, an air tap gesture, or an air swipe gesture) performed by the hand while the hand is in the second orientation with the palm of the hand facing away from the viewpoint of the user, in accordance with a determination that the selection input (e.g., an air pinch gesture, an air tap gesture, or an air swipe gesture) was detected after detecting, via the one or more input devices, a change in orientation of the hand from the first orientation with the palm facing toward the viewpoint of the user to the second orientation with the palm facing away from the viewpoint of the user and that the change in orientation of the hand from the first orientation to the second orientation was detected while attention of the user (e.g., gaze or an attention metric based on a gaze, head direction, wrist direction, and/or other pointing manner of the user) was directed toward a location of the hand (e.g., by being directed toward a location in the environment that is within a respective threshold distance of the hand), the computer system displays (11010), via the one or more display generation components, a control user interface that provides access to a plurality of controls corresponding to different functions (e.g., system functions) of the computer system. For example, in FIG. 7AQ, in response to detecting the selection input (e.g., the air pinch input in FIG. 7AP), the computer system 101 displays the system function menu 7044 (e.g., because the air pinch gesture in FIG. 7AP was detected after detecting a hand flip gesture in FIG. 7AO). Requiring detecting a change in orientation of the user's hand (e.g., from a “palm up” orientation to a “palm down” orientation, or vice versa) prior to detecting a selection input in order for a control user interface that provides access to different functions of the computer system to be displayed in response to the selection input, causes the computer system to automatically require that the user indicate intent to trigger display of the control user interface, based on changing the hand orientation, without displaying additional controls.

In some embodiments, in accordance with a determination that the selection input was not detected after detecting, via the one or more input devices, a change in orientation of the hand from the first orientation with the palm facing toward the viewpoint of the user (e.g., the selection input was detected without first detecting a change in orientation of the hand from the first orientation with the palm facing toward the viewpoint of the user to the second orientation with the palm facing away from the viewpoint of the user), or that the change in orientation of the hand from the first orientation to the second orientation was not detected while attention of the user was directed toward the location of the hand, the computer system forgoes (11012) displaying the control user interface that provides access to the plurality of controls corresponding to different functions of the computer system. For example, in the first example of FIG. 7O and the example 7084 of FIG. 7P, the computer system 101 detects an air pinch gesture performed by the hand 7022′, but the computer system 101 did not detect a change in orientation of the hand (e.g., from a “palm up” orientation to a “palm down” orientation) before detecting the air pinch gesture, so the computer system 101 does not display the system function menu 7044. In contrast, in FIG. 7L, the computer system 101 displays the system function menu 7044 in response to detecting the air pinch gesture in FIG. 7K, because the air pinch gesture in FIG. 7K was detected after detecting a change in orientation of the hand 7022′ (e.g., from the “palm up” orientation in FIG. 7G to the “palm down” orientation in FIG. 7H) (e.g., analogously to FIGS. 7AO-7AQ). Forgoing displaying the control user interface if the required change in orientation of the user's hand was not detected prior to detecting the selection input causes the computer system to automatically reduce the chance of unintentionally triggering display of the control user interface when the user has not indicated intent to do so.

In some embodiments, prior to detecting the selection input performed by the hand of the user (e.g., and in accordance with a determination that the hand of the user is in the first orientation), the computer system displays (11014), via the one or more display generation components, a control (e.g., a control corresponding to the first orientation of the hand, optionally displayed while the hand of the user is (e.g., and/or remains in) the first orientation). In some embodiments, the computer system displays the control in response to detecting that the attention of the user is directed toward the location of the hand (e.g., and optionally, displays and/or maintains display of the control while detecting that the attention of the user is directed toward the location of the hand). In some embodiments, the computer system does not display the control if (e.g., and/or when) the attention of the user is not directed toward the location of the hand (e.g., regardless of whether the hand is in the first orientation or not). For example, in FIG. 7AO, prior to a hand flip performed by the hand 7022′, the computer system 101 displays the control 7030 in stage 7154-1 (e.g., and after detecting the hand flip, the computer system 101 displays the status user interface 7032 in stage 7154-6). Displaying a control (e.g., that corresponds to a view and/or orientation of a hand (e.g., in response to the user directing attention toward the location/view of the hand)) prior to the change in orientation of the user's hand indicates that one or more operations are available to be performed in response to detecting subsequent input, which provides feedback about a state of the computer system.

In some embodiments, prior to detecting the selection input, the computer system detects (11016), via the one or more input devices, a first gesture (e.g., an air pinch gesture or another air gesture). In some embodiments, the first gesture is analogous to the selection input (e.g., is the same type of input, or involves the same gesture(s), movement, pose, and/or orientation(s) as the selection input). In response to detecting the first gesture, in accordance with a determination that the hand of the user was in the first orientation when the first gesture was detected, the computer system displays, via the one or more display generation components, a system user interface. In some embodiments, the system user interface includes a plurality of application affordances. In some embodiments, the system user interface is a home screen or home menu user interface. In some embodiments, in response to detecting a user input activating a respective application affordance of the plurality of application affordances, the computer system displays an application user interface corresponding to the respective application (e.g., the respective application affordance is an application launch affordance and/or an application icon for launching, opening, and/or otherwise causing display of a respective application user interface). For example, in FIGS. 7AK and FIG. 7AL, while the hand 7022′ is in a “palm up” orientation (e.g., prior to detecting a hand flip, such as the hand flip in FIG. 7AO), the computer system 101 displays the home menu user interface 7031 in response to detecting an air pinch gesture or button press performed by the hand 7022′ (e.g., as shown in FIG. 7AK1 and FIG. 7AL1, respectively) while the control 7030 is displayed (e.g., and while the attention 7010 of the user 7002 is directed toward the hand 7022′). Displaying a system user interface, such as an application launching user interface (e.g., a home menu user interface), in response to detecting a gesture prior to the change in orientation of the user's hand (e.g., optionally while the control corresponding to the location/view of the hand is displayed) reduces the number of inputs and amount of time needed to perform different operations of the computer system without displaying additional controls.

In some embodiments, prior to detecting the selection input (e.g., an air pinch gesture, an air tap gesture, or an air swipe gesture) performed by the hand while the hand is in the second orientation, and while attention (e.g., gaze or an attention metric based on a gaze, head direction, wrist direction, and/or other pointing manner of the user) of the user is directed toward the location of the hand, the computer system detects (11018), via the one or more input devices, the change in orientation of the hand from the first orientation with the palm facing toward the viewpoint of the user to the second orientation with the palm facing away from the viewpoint of the user. In response to detecting the change in orientation of the hand from the first orientation to the second orientation (e.g., and in accordance with a determination that the change in orientation of the hand from the first orientation to the second orientation was detected while the attention of the user was directed toward the location of the hand, and in accordance with a determination that the attention of the user is maintained as directed toward the location of the hand), the computer system displays, via the one or more display generation components, a status user interface (e.g., the status user interface 7032 described above with reference to FIG. 7H) that includes one or more status elements, wherein a respective status element indicates a status of a respective function (e.g., system function or application function) of the computer system. In some embodiments, each status element in the status user interface indicates a current status of a different function of the computer system. In some embodiments, the status user interface ceases to be displayed in conjunction with displaying the control user interface (e.g., in response to detecting the selection input performed by the hand while the hand is in the second orientation with the palm of the hand facing away from the viewpoint of the user, and in accordance with the determination that the selection input was detected after detecting the change in orientation of the hand from the first orientation to the second orientation and that the change in orientation of the hand from the first orientation to the second orientation was detected while attention (e.g., gaze or an attention metric based on a gaze, head direction, wrist direction, and/or other pointing manner of the user) of the user was directed toward the location of the hand). For example, in FIG. 7AO, after detecting a hand flip by the hand 7022′ from a “palm up” orientation to a “palm down” orientation (e.g., and while the attention 7010 of the user 7002 remains directed toward the hand 7022′), the computer system 101 displays the status user interface 7032 which includes status elements indicating status information about one or more functions of the computer system 101, such as a battery level, a wireless communication status, a current time, a current date, and/or a current status of notification(s) associated with the computer system 101. Similarly, in FIG. 7H, the computer system 101 displays the status user interface 7032 after detecting a hand flip by the hand 7022′ (e.g., from FIG. 7G to FIG. 7H). Displaying a status user interface in response to detecting the change in orientation of the user's hand (e.g., while the user is directing attention toward the location/view of the hand), and prior to detecting the selection input, causes the computer system to automatically require that the user indicate intent to trigger display of the status user interface, based on changing the hand orientation, and reduces the number of inputs and amount of time needed to perform different operations of the computer system without displaying additional controls.

In some embodiments, while displaying the status user interface that includes the one or more status elements (e.g., and while attention of the user is and/or remains directed toward the location of the hand; and/or while the hand remains in the second orientation), the computer system detects (11020), via the one or more input devices, movement (e.g., including translational movement in a horizontal and/or vertical direction, relative to the plane of a respective display generation component of the one or more display generation components (e.g., translational movement includes movement in a direction (e.g., along an x-axis, and/or a y-axis) that optionally is substantially orthogonal to the direction of the user's gaze (e.g., a z-axis or depth axis)) of the hand (e.g., without changes in orientation and/or configuration of the hand). In response to detecting the movement of the hand, the computer system moves (e.g., changing a position of) the status user interface that includes the one or more status elements, in accordance with the movement of the hand. In some embodiments, prior to detecting the movement of the hand, the computer system displays the status user interface with a first spatial relationship to one or more portions of the hand (e.g., one or more fingers or fingertips of the hand, a palm of the hand, one or more joints or knuckles of the hand, and/or a wrist of the hand), and changing the position of the status user interface in accordance with the movement of the hand includes changing the position of the status user interface to maintain the first spatial relationship with the hand (e.g., with the one or more portions of the hand), during the movement of the hand. For example, in FIGS. 7Q1-7S, the computer system 101 moves the control 7030 in accordance with movement of the hand 7022′. As described with reference to FIGS. 7Q1-7S, the status user interface 7032 optionally exhibits analogous behavior (e.g., while displayed, would also move in accordance with movement of the hand 7022′). Moving the status user interface in accordance with movement of the user's hand causes the computer system to automatically keep the status user interface at a consistent and predictable location relative to the location/view of the hand, to reduce the amount of time needed for the user to locate and interact with the status user interface.

In some embodiments, while displaying the status user interface (e.g., and while the hand has the second orientation with the palm of the hand facing away from the viewpoint of the user), the computer system detects (11022), via the one or more input devices, that the attention of the user (e.g., gaze or an attention metric based on a gaze, head direction, wrist direction, and/or other pointing manner of the user) is not (e.g., is no longer or ceases to be) directed toward the location of the hand (e.g., detecting the user's attention moving away from the hand or detecting that the user's attention is no longer directed toward the location of the hand). In response to detecting that the attention of the user (e.g., gaze or an attention metric based on a gaze, head direction, wrist direction, and/or other pointing manner of the user) is not (e.g., is no longer or ceases to be) directed toward the location of the hand, the computer system ceases to display the status user interface (e.g., even if the hand is maintained in the second orientation). In some embodiments, the status user interface is displayed (e.g., redisplayed) in response to the user's attention being redirected toward the location of the hand, optionally subject to one or more additional criteria (e.g., requiring detecting the change in orientation of the hand from the first orientation to the second orientation again, and/or requiring that the user's attention is redirected toward the location of the hand within a threshold period of time). In some embodiments, the status user interface ceases to be displayed (e.g., and is in some embodiments replaced by the system control) in response to the hand changing in orientation from the second orientation back to the first orientation (e.g., even while the user's attention (e.g., gaze or an attention metric based on a gaze, head direction, wrist direction, and/or other pointing manner of the user) is maintained as directed toward the location of the hand). In some embodiments, the status user interface is redisplayed (e.g., replacing the system control) in response to the hand changing (e.g., returning) from the first orientation back to the second orientation (e.g., while the user's attention (e.g., gaze or an attention metric based on a gaze, head direction, wrist direction, and/or other pointing manner of the user) is directed toward the location of the hand). For example, as described above with reference to FIGS. 7H and 70, in some embodiments, in response to detecting that the attention 7010 of the user 7002 is not directed toward the hand 7022′ (e.g., because the attention 7010 has moved away from the hand 7022′ during display of the status user interface 7032), the computer system 101 ceases to display the status user interface 7032. Ceasing to display the status user interface in response to detecting that the user's attention is not (e.g., is no longer or ceases to be) directed toward the location/view of the hand, after a status user interface is displayed (e.g., in response to detecting the change in orientation of the user's hand and prior to detecting the selection input) based at least in part on the user directing attention toward the location/view of the hand, reduces the number of inputs and amount of time needed to dismiss the status user interface and reduces the number of displayed user interface elements by dismissing those that have become less relevant.

In some embodiments, after ceasing to display the status user interface, and while the hand is maintained in the second orientation with the palm of the hand facing away from the viewpoint of the user (e.g., without the status user interface being displayed and without detecting a subsequent change in orientation of the hand from another orientation, such as the first orientation, back to the second orientation), the computer system detects (11024), via the one or more input devices, that the attention of the user is directed toward (e.g., is redirected back toward after ceasing to be directed toward the location of the hand) the location of the hand. In response to detecting that the attention of the user is directed toward the location of the hand (e.g., after ceasing to be directed toward the location of the hand), the computer system forgoes displaying (e.g., redisplaying) the status user interface. In some embodiments, if, after ceasing to display the status user interface, the hand is transitioned again to the second orientation while the attention of the user is redirected toward the location of the hand, the status user interface is redisplayed (e.g., redirection of the user's attention alone, without a repeated instance of the change in orientation of the hand to the second orientation, does not trigger display of the status user interface). For example, as described above with reference to FIG. 7H, in some embodiments, after ceasing to display the status user interface 7032, the user 7002 must perform the initial steps of first directing the attention 7010 of the user 7002 to the hand 7022′ in the “palm up” orientation, and performing a hand flip, in order to display (e.g., redisplay) the status user interface 7032 (e.g., the status user interface 7032 cannot be redisplayed without first performing the initial steps of first directing the attention 7010 of the user 7002 to the hand 7022′ in the “palm up” orientation and performing a hand flip). Forgoing displaying (e.g., redisplaying) the status user interface in response to the user's attention being directed toward (e.g., redirected toward) the location/view of the hand (e.g., unless the change in orientation of the user's hand is detected again), after the status user interface has ceased to be displayed in response to a user directing attention away from the location/view of the hand, causes the computer system to automatically require that the user indicate intent to trigger display of the status user interface, based on changing the hand orientation, without displaying additional controls.

In some embodiments, after ceasing to display the status user interface (e.g., while the hand is maintained in the second orientation with the palm of the hand facing away from the viewpoint of the user), the computer system (11026), via the one or more input devices, that the attention of the user is directed toward (e.g., is redirected toward) the location of the hand. In response to detecting that the attention of the user is directed toward the location of the hand: in accordance with a determination that the attention of the user was directed toward the location of the hand within a threshold amount of time (e.g., 0.5 seconds, 1 second, 2 seconds, 5 seconds, or 10 seconds) after the attention of the user ceased to be directed toward the location of the hand, the computer system displays, via the one or more display generation components, the status user interface; and in accordance with a determination that the attention of the user was not directed toward the location of the hand within the threshold amount of time within the threshold amount of time since the attention of the user ceased to be directed toward the location of the hand, the computer system forgoes displaying the status user interface. For example, as described above with reference to FIG. 7H, in some embodiments, after ceasing to display the status user interface 7032, the computer system 101 redisplays the status user interface 7032 (e.g., without requiring the initial steps of first directing the attention 7010 of the user 7002 to the hand 7022′ in the “palm up” orientation and performing a hand flip), if the attention 7010 of the user 7002 returns to the hand 7022′ within a threshold amount of time (e.g., 0.1 seconds, 0.2 seconds, 0.5 seconds, 1 second, 2 seconds, or 5 seconds). After ceasing to display a status user interface (e.g., in response to detecting that a user's attention is not directed toward the location/view of the hand), displaying (e.g., redisplaying) the status user interface in response to detecting that the user's attention is directed toward (e.g., is redirected toward) the location/view of the hand within a threshold amount of time after the user's attention ceased to directed toward the location/view of the hand, and/or since the status user interface ceased to be displayed), reduces the number of inputs and amount of time needed to reinvoke the status user interface while the status user interface was only recently dismissed (e.g., possibly unintentionally) without displaying additional controls, while reducing the number of displayed user interface elements if the user has not requested to display the status user interface quickly enough (e.g., by redirecting attention toward the location/view of the hand within the threshold amount of time).

In some embodiments, prior to detecting the change in orientation of the hand from the first orientation to the second orientation (e.g., and while the hand is in the first orientation), the computer system displays (11028), via the one or more display generation components, a control (e.g., a control corresponding to the first orientation of the hand, optionally displayed while the hand of the user is (e.g., and/or remains in) the first orientation, such as the control 7030 described with reference to FIG. 7Q1) (e.g., in accordance with a determination that the attention of the user is directed toward the location of the hand), wherein the change in orientation of the hand from the first orientation to the second orientation is detected while the control is displayed. In response to detecting the change in orientation of the hand from the first orientation to the second orientation, the computer system replaces display of the control (e.g., the control 7030 described above with reference to FIG. 7Q1) with display of the status user interface (e.g., the status user interface 7032 described above with reference to FIG. 7H) (e.g., ceasing to display the control, in conjunction with and optionally concurrently with displaying the status user interface). In some embodiments, the computer system displays an animated transition of the control transforming into the status user interface. In some embodiments, the selection input is detected while the status user interface is displayed. For example, in FIG. 7AO, the computer system 101 replaces display of the control 7030 with display of the status user interface 7032 (e.g., as the hand 7022′ progresses through a hand flip gesture). For example, in FIG. 7AO, the computer system 101 transitions from displaying the control 7030 to displaying the status user interface 7032, as the hand 7022′ flips from a “palm up” orientation to a “palm down” orientation. Where a control corresponding to a location/view of a hand was displayed prior to the change in orientation of the user's hand (e.g., and in response to the user directing attention toward the location/view of the hand), replacing display of the control with the status user interface (e.g., via an animated transition or transformation from one to the other) in response to detecting the change in orientation of the user's hand reduces the number of displayed user interface elements by dismissing those that have become less relevant, and provides feedback about a state of the computer system.

In some embodiments, displaying the control includes (11030) displaying the control with a first relationship to the hand (e.g., spatial relationship to the hand, distance from a portion of the hand, and/or offset from a portion of the hand), and displaying the status user interface (e.g., as part of replacing display of the control with display of the status user interface) includes displaying the status user interface with a second relationship, different from the first relationship, to the hand (e.g., a different spatial relationship to the hand, a different distance from the portion of the hand, and/or a different offset from the portion of the hand). In some embodiments, the first relationship and/or the second relationship are selected based at least in part on a visual characteristic of the control and/or the status user interface, respectively. For example, if the status user interface is larger than (e.g., occupies more space than) the control, the second spatial relationship accommodates for the larger size of the status user interface relative to the control (e.g., the control is displayed a first distance or offset from a portion of the hand, and the status user interface is displayed a further distance or offset from the portion of the hand, to avoid occlusion conflicts with the hand or portions of the hand). In some embodiments, displaying the control with the first relationship to the hand includes displaying the control on a first side of the hand (e.g., a right hand of a user is displayed with a “palm up” orientation and the control is displayed on a right side of the hand, such that the control is closer to the thumb of the right hand than to the pinky of the right hand; and displaying the status user interface with the second relationship to the hand includes displaying the control on a second side (e.g., an opposite side) of the hand (e.g., the right hand of the user is displayed with a “palm down” orientation and the status user interface is displayed on a left side of the hand, such that status user interface is closer to the thumb of the right hand than to the pinky of the right hand). For example, as described above with reference to FIG. 7AO, in some embodiments, the status user interface 7032 is displayed at a position that is a second threshold distance from the midpoint of the palm 7025′ of the hand 7022′ (e.g., and/or a midpoint of a back of the hand 7022′, as the palm of the hand 7022′ is not visible in the “palm down” orientation). In some embodiments, the second threshold distance is the same as the first threshold distance (e.g., the distance at which the control 7030 is displayed from the midline of the palm 7025′). Displaying the control with a first spatial relationship to the location/view of the hand and the status user interface with a different, second spatial relationship to the location/view of the hand (e.g., with different offsets) causes the computer system to automatically place the different user interface elements at consistent and predictable locations relative to the location/view of the hand, to reduce the amount of time needed for the user to locate and interact with each user interface element, while accommodating changes in the orientation and/or configuration of the hand as well as accommodating differently sized and/or shaped user interface elements to improve visibility of the user interface elements and legibility of content displayed therein.

In some embodiments, displaying the status user interface with the second relationship to the hand (e.g., as part of replacing display of the control with display of the status user interface) includes (11032) transitioning (e.g., gradually transitioning) from displaying the status user interface with the first relationship to the hand, to displaying the status user interface with the second relationship to the hand (e.g., over a period of time, such as 0.1 seconds, 0.2 seconds, 0.5 seconds, 1 second, 2 seconds, or 5 seconds). For example, as described above with reference to FIG. 7AO, in some embodiments, as the hand flip gesture described in FIG. 7AO progresses, the computer system 101 transitions from displaying the status user interface 7032 at a position that is the first threshold distance from the midpoint of the palm/back of the hand 7022′ to displaying the status user interface 7032 at a position that is the second threshold distance from the midpoint of the palm/back of the hand 7022′. In replacing display of the control with the status user interface in response to detecting the change in orientation of the user's hand, transitioning from displaying the status user interface (e.g., or an intermediate user interface element that represents the status user interface during the transition) with the first spatial relationship to the location/view of the hand to displaying the status user interface with the second spatial relationship to the location/view of the hand causes the computer system to automatically move the status user interface to a consistent and predictable location/view relative to the location/view of the hand, to reduce the amount of time needed for the user to locate and interact with the status user interface, while accommodating changes in the orientation and/or configuration of the hand as well as accommodating differently sized and/or shaped user interface elements to improve visibility of the user interface elements and legibility of content displayed therein.

In some embodiments, the displayed transition (e.g., from displaying the status user interface with the first relationship to the hand, to displaying the status user interface with the second relationship to the hand) progresses (11034) gradually through a plurality of intermediate visual states in accordance with a change in orientation of the hand from the first orientation to the second orientation (e.g., during the detected change in orientation of the hand from the first orientation to the second orientation). In some embodiments, the transition from the first relationship to the second relationship progresses at a rate that corresponds to an amount (e.g., a magnitude) of change in orientation (e.g., an amount or magnitude of rotation and/or other movement) of the hand, as the hand changes from the first orientation to the second orientation. For example, as described above with reference to FIG. 7AO, in some embodiments, as the hand flip gesture described in FIG. 7AO progresses, the computer system 101 transitions from displaying the status user interface 7032 at a position that is the first threshold distance from the midpoint of the palm/back of the hand 7022′ to displaying the status user interface 7032 at a position that is the second threshold distance from the midpoint of the palm/back of the hand 7022′. In some embodiments, the transition progresses in accordance with the rotation of the hand 7022 during the hand flip gesture (e.g., in accordance with a magnitude of rotation of the hand 7022 during the hand flip gesture). Progressing the transition from displaying the control, through a plurality of intermediate visual states, to displaying the status user interface in accordance with progression of the change in orientation of the user's hand (e.g., based on a magnitude and/or speed of rotation of the hand) provides an indication as to how the computer system is responding to the user's hand movement, which provides feedback about a state of the computer system.

In some embodiments, the plurality of controls corresponding to different functions of the computer system includes (11036) a first control. While displaying the control user interface that provides access to the plurality of controls corresponding to different functions of the computer system (e.g., and that includes the first control), the computer system detects, via the one or more input devices, a user input (e.g., directed toward the first control of the plurality of controls). In response to detecting the user input, the computer system performs an operation corresponding to the first control. In some embodiments, the operation corresponding to the first control is an operation that includes displaying, via the one or more display generation components, a virtual display that incudes external content corresponding to another computer system that is in communication with the computer system. In some embodiments, the external content includes a user interface (e.g., a home screen, a desktop, and/or an application user interface) of the other computer system. In some embodiments, the other computer system transmits (e.g., and/or streams) content to the computer system, for display in the virtual display. In some embodiments, a state of the other computer system changes in response to one or more user inputs interacting with the virtual display (e.g., such that changes made via interaction with the virtual display of the computer system are reflected in the current state of the other computer system). For example, if the virtual display includes a desktop with application icons, and a user interacts with an application icon to launch an application (e.g., display an application user interface), the other computer system also launches the application on the other computer system (e.g., such that if the computer system and the other computer system cease to be in communication (e.g., are intentionally disconnected and/or lose connection with one another), the state of the other computer system reflects any user interactions detected via the virtual display (e.g., the user can seamlessly transition to using the other computer system, after interacting with the virtual display of the computer system). In some embodiments, one or more display generation components of the other computer system mirror the virtual display of the computer system (e.g., what is displayed via the virtual display of the computer system is the same as what is displayed via the one or more display generation components of the other computer system). In some embodiments, the one or more display generation components of the other computer system continue to mirror the virtual display of the computer system while the virtual display continues to be displayed (e.g., and in response to detecting any user inputs or other user interface via the virtual display; and/or in response to detecting one or more additional user interfaces are displayed in the virtual display; and/or in response to detecting one or more previously displayed user interface that were displayed in the virtual display cease to be displayed in the virtual display). For example, in FIG. 7L, the computer system 101 displays the system function menu 7044 that includes an affordance 7050 (e.g., for displaying a virtual display for a connected device (e.g., an external computer system such as a laptop or desktop)). Performing an operation corresponding to the first control in response to detecting the user input (e.g., that is directed to the first control) reduces the number of user inputs needed to perform the operation corresponding to the first control (e.g., the control user interface that includes the plurality of controls provides efficient access to respective operations for respective controls of the plurality of controls; and the user does not need to remember how to access each operation individually, and/or perform additional user inputs to navigate to an appropriate user interface to access a respective control).

In some embodiments, prior to detecting the selection input, and while the computer system is in a setup configuration state (e.g., an initial setup state for configuring the computer system before general use), the computer system displays (11038), via the one or more display generation components, a first user interface that includes instructions for performing the selection input. In some embodiments, the instructions for performing the selection input include: instructions for performing the selection input after changing the orientation of the hand from the first orientation with the palm facing toward the viewpoint of the user to the second orientation with the palm facing away from the viewpoint of the user; instructions for performing the selection input while the hand is in the second orientation with the palm of the hand facing away from the viewpoint of the user; and/or instructions for performing the selection input while the attention of the user is directed toward the location of the hand. For example, in FIGS. 7E-7H and 7K-7N, while the computer system 101 is in a setup configuration state, the computer system 101 displays the user interface 7028-a, the user interface 7028-b, or the user interface 7028-c. Displaying a first user interface that includes instructions for performing the selection input while the computer system is in a setup configuration state reduces the number of user inputs needed to efficiently interact with the computer system and reduces the amount of time needed to acclimate a user to interacting with the computer system (e.g., the user does not need to perform additional user inputs to display the first user interface (e.g., or other user manual and/or instruction user interfaces), or spend time looking for and/or separately accessing user manuals and/or instructions for the computer system.

In some embodiments, while the computer system is in the setup configuration state, the control user interface that provides access to the plurality of controls corresponding to different functions of the computer system is enabled (11040). In some embodiments, the computer system detects the selection input, while the computer system is in the setup configuration. In some embodiments, while the computer system is in the setup configuration state, the computer system displays the control user interface in response to detecting the selection input, or an analogous input that is analogous to the selection input, performed by the hand while the hand is in the second orientation with the palm of the hand facing away from the viewpoint of the user (e.g., and in accordance with a determination that the selection input (or, optionally, analogous input) was detected after detecting a change in orientation of the hand from the first orientation with the palm facing toward the viewpoint of the user to the second orientation with the palm facing away from the viewpoint of the user and that the change in orientation of the hand from the first orientation to the second orientation was detected while attention of the user was directed toward the location of the hand). For example, in FIG. 7K, while the user interface 7028-b is displayed, the computer system 101 detects an air pinch gesture performed by the hand 7022′ (e.g., while the attention 7010 of the user 7002 is directed toward the hand 7022′). In response to detecting the air pinch gesture (e.g., and while the user interface 7028-b is displayed), the computer system 101 displays the system function menu 7044 as in FIG. 7L. Providing access to the plurality of controls corresponding to different functions of the computer system, while the computer system is in the setup configuration state, reduces the number of user inputs needed to configure the computer system (e.g., the plurality of controls provide access to some hardware settings, such as audio volume level, and can be accessed while in the setup configuration state, without requiring the user first complete or exit the setup configuration state in order to access the plurality of controls).

In some embodiments, while the computer system is in the setup configuration state, a system user interface (e.g., that is different from the control user interface) is disabled (11042) (e.g., not enabled for display, and/or cannot be accessed, even if the required criteria are met and/or the required inputs, which normally trigger display of the system user interface (e.g., when the computer system is not in the setup configuration state), are performed). In some embodiments, while the computer system is in the setup configuration state, the computer system detects a second gesture (e.g., while the hand is in the first orientation, and optionally, while a control corresponding to the first orientation of the hand is displayed). In response to detecting the second gesture, the computer system forgoes displaying the system user interface. For example, in the example 7094 of FIG. 7P, because the user interface 7028-a is displayed, the computer system 101 does not display the home menu user interface 7031 in response to detecting an air pinch gesture performed by the hand 7022 while the attention 7010 of the user is directed to the hand 7022′. Disabling display of a system user interface while the computer system is in the setup configuration state reduces the risk of the user performing unintended operations (e.g., or prematurely performing operations which have not been fully configured) during a setup and/or configuration of the computer system (e.g., the user cannot accidentally or prematurely trigger display of the system user interface when trying to view and/or interact with instructions, tutorials, and/or settings while the computer system is in the setup configuration state, which would require the user to exit and/or navigate away from the system user interface to complete the setup and/or configuration of the computer system).

In some embodiments, while displaying the first user interface that includes instructions for performing the selection input (e.g., and/or while the computer system is in the initial setup and/or configuration state), the computer system detects (11044), via the one or more input devices, that the attention of the user is directed toward the location of the hand. In response to detecting that the attention of the user is directed toward the location of the hand: in accordance with a determination that the hand was in the first orientation when the attention of the user was directed toward the location of the hand, the computer system forgoes displaying a control (e.g., the control 7030 described above with respect to FIG. 7Q1); and in accordance with a determination that the hand was in the second orientation when the attention of the user was directed toward the location of the hand, the computer system forgoes displaying a status user interface (e.g., the status user interface 7032 described above with reference to FIG. 7H). In some embodiments, the computer system forgoes displaying the control, or the status user interface, as long as the computer system is in the initial setup and/or configuration state. In some embodiments, once the computer system is no longer in the initial setup and/or configuration state (e.g., after setup and/or configuration is complete), in response to detecting that the attention of the user is directed toward the location of the hand: in accordance with a determination that the hand was in the first orientation when the attention of the user was directed toward the location of the hand, the computer system displays the control; and in accordance with a determination that the hand was in the second orientation when the attention of the user was directed toward the location of the hand, the computer system displays the status user interface. For example, in FIG. 7G, the dotted outline of the control 7030 indicates that in some embodiments, the control 7030 is not displayed while (and/or before) the user interface 7028-a is displayed. Similarly, as described with reference to FIG. 7H, in some embodiments, the computer system 101 does not display the status user interface 7032 in response to detecting the hand flip (e.g., because the user interface 7028-b is displayed, and/or before the user interface 7028-b is displayed). In some embodiments, the computer system 101 does not display either the control 7030 or the status user interface 7032 when any of the user interface 7028-a, the user interface 7028-b, and/or the user interface 7028-c are displayed (e.g., while the computer system 101 is in the setup and/or configuration process). While and/or before displaying the first user interface with the instructions, forgoing displaying a control in response to detecting that the attention of the user is directed toward the location/view of the hand that is in the first orientation, and forgoing displaying the status user interface in response to detecting that the attention of the user is directed toward the location/view of the hand that is in the second orientation, prevents the UI from being cluttered while in the setup configuration state (e.g., displaying the control or status user interface may obscure and/or occlude instructions, tutorials, and/or settings that the user is trying to view and/or configure in the setup configuration state).

In some embodiments, prior to detecting the selection input, and while the computer system is in a setup configuration state (e.g., a state that is active when the computer system is used for the first time; a state that is active after a software update; and/or a state that is active when setting up and/or configuring a new user or user account for the computer system): in accordance with a determination that data corresponding to at least one hand of the user is enrolled (e.g., stored in memory or configured for use in providing input for air gestures via one or more hand tracking sensors of the computer system) for the computer system, the computer system displays (11046), via the one or more display generation components, a second user interface that includes instructions for performing the selection input (e.g., which, in some embodiments, is the same as the first user interface that includes instructions for performing the selection input); and in accordance with a determination that data corresponding to at least one hand of the user is not enrolled (e.g., stored in memory or configured for use in providing input for air gestures via one or more hand tracking sensors of the computer system) for the computer system, the computer system forgoes displaying the first user interface that includes instructions for performing the selection input. More detail regarding user interfaces displayed conditionally based on input element enrollment such as hand enrollment is provided herein with reference to method 15000. In some embodiments, a user undergoes an enrollment process when using (e.g., first using) the computer system (e.g., during an earlier setup step, while the computer system is in the setup configuration state, and/or during a previous use of the computer system). In some embodiments, as part of the enrollment process, the computer system scans one or more portions of the user (e.g., the user's face, the user's eyes, and/or the user's hands), and stores data (e.g., a size, shape, and/or skin tone) corresponding to the scanned portions of the user. In some embodiments, the computer system can uniquely and/or specifically identify the user and/or the scanned portions of the user (e.g., based on the stored data corresponding to the scanned portions of the user). For example, as described with reference to FIG. 7F, in some embodiments, the user interface 7028-a, the user interface 7028-b, and/or the user interface 7082-c are only displayed if the computer system 101 detects that data is stored for the hands of the current user (e.g., the computer system 101 detects that data is stored for the hand 7020 and the hand 7022 of the user 7002, while the user 7002, the hand 7020 and/or the hand 7022 of the user 7002 are enrolled for the computer system 101). Displaying a second user interface that includes instructions for performing the selection input when at least one hand of the user is enrolled, and forgoing displaying the first user interface that includes instructions for performing the selection input when at least one hand of the user is not enrolled, automatically displays contextually appropriate instructions without requiring additional user inputs (e.g., if the computer system cannot accurately determine a position, pose, and/or orientation of the user's hands, because none of the user's hands are enrolled, the computer system does not expend power to display instructions for performing inputs with the user's hands (e.g., that the computer system may and/or will not be able to accurately detect)).

In some embodiments, aspects/operations of methods 10000, 12000, 13000, 15000, 16000, 17000, and 18000 may be interchanged, substituted, and/or added between these methods. For example, the control that is displayed and/or interacted with in the method 10000 is displayed before a hand flip to display the status user interface described in the method 11000, and/or while displaying the status user interface of the method 11000, the user can access the volume level adjustment function described in the method 13000. For brevity, these details are not repeated here.

FIGS. 12A-12D are flow diagrams of an exemplary method 12000 for placing a home menu user interface based on characteristics of the user input used to invoke the home menu user interface and/or user posture when the home menu user interface is invoked, in accordance with some embodiments. In some embodiments, the method 12000 is performed at a computer system (e.g., computer system 101 in FIG. 1) that is in communication with one or more display generation components (e.g., a head-mounted display (HMD), a heads-up display, a display, a projector, a touchscreen, or other type of display) (e.g., display generation component 120 in FIGS. 1A, 3, and 4, or the display generation component 7100a in FIGS. 9A-9P), and one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, sensors 7101a-7101c and/or the digital crown 703 in FIGS. 9A-9P, or controller 7111 with buttons 7113, 7115, and/or 7117 in FIGS. 7A-7BE and 8A-8T). In some embodiments, the method 12000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 12000 are, optionally, combined and/or the order of some operations is, optionally, changed.

While a view of an environment (e.g., a two-dimensional or three-dimensional environment that includes one or more virtual objects and/or one or more representations of physical objects) is visible via the one or more display generation components (e.g., using AR, VR, MR, virtual passthrough, or optical passthrough), the computer system detects (12002), via the one or more input devices, an input (e.g., an air gesture, a touch input, a keyboard input, a button press, or other user input) corresponding to a request to display a system user interface (e.g., while a head of the user is facing in a different direction from a torso of the user).

In response to detecting (12004) the input corresponding to the request to display the system user interface: in accordance with a determination that the input corresponding to the request to display a system user interface is detected while respective criteria are met (e.g., based on elevation of the user's viewpoint, respective poses of one or more parts of the user's body such as the user's head, torso, and/or hand, which input device is used to provide the input, and/or other criteria), the computer system displays (12006) the system user interface in the environment at a first location that is based on a pose of a respective portion of (e.g., a front of) a torso of a user. In some embodiments, more generally, the system user interface is displayed at a first location that is based on a pose of a first part of the user's body that can change pose, such as to face different directions, without changing the viewpoint of the user (e.g., in FIGS. 9A-9E, the computer system 101 displays the home menu user interface 7031 based on the torso vector 9030 because criteria for displaying the home menu user interface 7031 based on the torso vector 9030 are met. In accordance with a determination that the input corresponding to the request to display a system user interface is detected while the respective criteria are not met, the computer system displays (12008) the system user interface in the environment at a second location that is based on a pose of a respective portion (e.g., a face) of a head of the user (e.g., determined based on a pose of a second part of the user's body, such as the user's head, where changes in the pose of the second part of the user's body, such as to face different directions, changes the viewpoint) (e.g., in FIGS. 9F-9P, the computer system 101 displays the home menu user interface 7031 based on the head direction 9024 because criteria for displaying the home menu user interface 7031 based on the torso vector 9030 are not met). In some embodiments, detecting the input corresponding to the request to display the system user interface includes detecting activation of a control corresponding to a location or view of a hand of the user, which in some embodiments is invoked and/or activated as described herein with reference to method 10000. Displaying a system user interface based on a pose of a respective portion of a torso of a user in response to a user request if respective criteria are met reduces the number of inputs and amount of time needed to position the system user interface at a more ergonomic position than a position that is based on a pose of a respective portion of a head of the user without displaying additional controls.

In some embodiments, the system user interface includes (12010) a home menu user interface. For example, in FIGS. 9E, 9H, 9J, 9L, 9N and 9P, the computer system 101 displays the home menu user interface 7031 based on either the torso vector 9030 or the head direction 9024 of the user 7002. Displaying a home menu user interface based on the pose of the respective portion of a torso or a head of the user in response to a user request reduces the number of inputs and amount of time needed to position the home menu user interface at an ergonomic position that allows the user to navigate between and access different collections of applications, contacts, and virtual environments without displaying additional controls.

In some embodiments, the respective criteria include (12012) a requirement that the input corresponding to the request to display a system user interface is performed while the respective portion of the head of the user has an elevation that is below a threshold elevation relative to a reference plane in the environment in order for the respective criteria to be met. In some embodiments, the threshold elevation is a respective elevation (e.g., 1, 2, 5, 10, 15, 25, 45, or 60 degrees) below or above a horizontal plane (e.g., horizon) extending from the viewpoint of the user. In some embodiments, the threshold elevation is that of the reference plane (e.g., 0 degrees relative to the reference plane). For example, if the user's head or respective portion thereof has an elevation that is below the threshold elevation (e.g., 1, 2, 5, 10, 15, 25, 45, or 60 degrees below or above) relative to the reference plane (e.g., horizon), the system user interface is displayed at a location in the environment that is determined based on the pose or direction of the user's torso, whereas if the user's head or respective portion thereof has an elevation that is above the threshold elevation, the system user interface is displayed at a location in the environment that is determined based on the user's viewpoint (e.g., based on the pose or direction of the user's head). For example, in FIGS. 9A-9E, the head direction 9024 indicates that the head of the user 7002 has an elevation that is less than the angular threshold Vth, so as a result, the computer system 101 displays the home menu user interface 7031 based on the torso vector 9030. Displaying the system user interface based on the pose of the respective portion of the torso of the user in response to the user request if criteria based on elevation of the user's viewpoint being below a threshold angle are met allows the computer system to display the system user interface based on the pose of the respective portion of the head of the user when ergonomic gains may be less than the efficiency gained from displaying the system user interface within the user's viewport (e.g., without the user having to change the elevation of the user's viewpoint to view the system user interface), and to display the system user interface based on the pose of the respective portion of the torso of the user when ergonomic gains are higher, without displaying additional controls.

In some embodiments, the respective criteria include (12014) a requirement that the input corresponding to the request to display the system user interface is performed while attention of the user is directed toward a location of a hand of the user in order for the respective criteria to be met (e.g., while a control corresponding to the location or view of the hand of the user is displayed, where detecting the input corresponding to the request to display the system user interface includes detecting activation of the control, as described herein with reference to method 10000). For example, in FIGS. 9K-9N, even though the head direction 9024 of the user 7002 otherwise meets criteria for displaying the home menu user interface 7031 based on the torso vector 9030 (e.g., as illustrated in FIGS. 9A-9E), the computer system 101 displays the home menu user interface 7031 based on the head direction 9024 because the home menu user interface 7031 was not invoked via an air pinch gesture while the control 7030 is displayed. Displaying the system user interface based on the pose of the respective portion of the torso of the user in response to the user request if criteria based on the user directing attention and activating a control displayed corresponding to a location of a hand are met reduces the number of inputs and amount of time needed to position the system user interface at a more ergonomic position (e.g., more ergonomic than a position based on a head elevation held only temporarily to direct attention to the location of the user's hand) without displaying additional controls.

In some embodiments, determining that the respective criteria are not met includes (12016) determining that the input corresponding to the request to display the system user interface includes a press input detected via the one or more input devices of the computer system (e.g., a digital crown, an input button, a button on a controller, and/or other input device). For example, in FIGS. 9M-9N, the computer system 101 displays the home menu user interface 7031 based on the head direction 9024 instead of the torso vector 9030, because the home menu user interface 7031 was invoked via a user input 9550 directed to the digital crown 703, even though the head direction 9024 otherwise meets criteria for displaying the home menu user interface 7031 based on the torso vector 9030 (e.g., as in FIGS. 9A-9E). Displaying the system user interface based on a pose of the respective portion of the head of the user in response to the user request being a press input reduces the number of inputs and amount of time needed to fully display the system user interface within the user's viewport (e.g., which is less likely to be based on a temporarily held head elevation) (e.g., without the user having to change the elevation of the user's viewpoint to view the system user interface), and without displaying additional controls.

In some embodiments, determining that the respective criteria are not met includes (12018) determining that the input corresponding to the request to display the system user interface includes an input corresponding to a request to close a last application user interface of one or more user interfaces of one or more applications in the environment (e.g., no other application user interface is open in the environment after the last of the one or more user interfaces of the one or more applications is closed). For example, in FIGS. 9K-9L, the computer system 101 displays the home menu user interface 7031 based on the head direction 9024 instead of the torso vector 9030, because the home menu user interface 7031 was automatically invoked as a result of a last application user interface 9100 in the three-dimensional environment being closed, even though the head direction 9024 otherwise meets criteria for displaying the home menu user interface 7031 based on the torso vector 9030 (e.g., as in FIGS. 9A-9E). Displaying the system user interface based on a pose of the respective portion of the head of the user in response to the user request being a request to close a last application user interface (thus not meeting the respective criteria) reduces the number of inputs and amount of time needed to fully display the system user interface within the user's viewport (e.g., which is less likely to be based on a temporarily held head elevation) (e.g., without the user having to change the elevation of the user's viewpoint to view the system user interface), and without displaying additional controls.

In some embodiments, displaying the system user interface in the environment at the second location that is based on the pose of the respective portion (e.g., a face) of the head of the user includes (12020): in accordance with a determination that the respective portion of the head of the user is at a first head height, the computer system displays the system user interface at a first height in the environment (e.g., the first height is proportional to the first head height, and/or the first height is dynamically linked to the first head height at the time the system user interface is invoked, where optionally the first height is fixed once the system user interface is invoked and does not change dynamically after invocation); and in accordance with a determination that the respective portion of the head of the user is at a second head height that is different from the first head height, the computer system displays the system user interface at a second height in the environment, wherein the second height is different from the first height (e.g., the second height is proportional to the second head height, and/or the second height is dynamically linked to the second head height at the time the system user interface is invoked, where optionally the second height is fixed once the system user interface is invoked and does not change dynamically after invocation). For example, in FIG. 9H, the user's head is at a first head height 9029-a, and the computer system 101 displays the home menu user interface 7031 at a first height 9031-a, whereas in FIG. 9J, the user's head is at a second head height 9029-b, higher than the first head height 9029-a, and the computer system 101 displays the home menu user interface 7031 at a second height 9031-b higher than the first height 9031-b. Displaying the system user interface at a height based on a head height of the user reduces fatigue, and automatically presents the system user interface at an ergonomically favorable position to the user, without requiring manual adjustments from the user, thus increasing operational efficiency of user-machine interactions.

In some embodiments, displaying the system user interface in the environment at the second location that is based on the pose of the respective portion (e.g., a face) of the head of the user includes (12022): in accordance with a determination that the respective portion of the head of the user is at a first elevation relative to a reference plane in the environment (e.g., a horizon, a floor, or a plane that is perpendicular to gravity) and satisfies first criteria (e.g., the first elevation is above the horizon, and/or the first elevation is greater than a threshold elevation (e.g., 1 degree, 2 degrees, 5 degrees, 10 degrees, or other elevation) above the horizon in order for the first criteria to be met), the computer system displays the system user interface such that a plane of the system user interface (e.g., a front, rear, or other surface of the system user interface, a plane in which system user interface elements are displayed (e.g., application icons in the home menu user interface, tabs for switching to displaying contacts or selecting a virtual environment in the home menu user interface, or representation of applications in a multitasking user interface), or other plane) is tilted a first amount relative to a viewpoint of the user, wherein the viewpoint of the user is associated with the respective portion of the head of the user being at the first elevation (e.g., the system user interface is tilted such that the plane of the system user interface is not perpendicular to the horizontal plane); and in accordance with a determination that the respective portion of the head of the user is at a second elevation relative to the reference plane in the environment that satisfies the first criteria, the computer system displays the system user interface such that the plane of the system user interface is tilted a second amount relative to the viewpoint of the user. The viewpoint of the user is associated with the respective portion of the head of the user being at the second elevation, the second elevation is different from the first elevation, and the second amount of tilt is different from the first amount of tilt. For example, in FIG. 9H, the user's head is at a first head elevation, and the computer system 101 displays the home menu user interface 7031 such that a plane of the home menu user interface 7031 tilts towards the viewpoint of the user 7002 by a first amount 9023. In FIG. 9J, the head of the user 7002 is at a second head elevation, higher than the first head elevation, and the computer system 101 displays the home menu user interface 7031 such that the plane of the home menu user interface 7031 tilts towards the viewpoint of the user 7002 by a second amount 9025. Tilting the plane of the system user interface toward a viewpoint of the user helps to automatically maintain the display of the system user interface at an ergonomically favorable orientation to the user, without requiring manual adjustments from the user, and reduces fatigue, thus increasing operational efficiency of user-machine interactions.

In some embodiments, the first criteria include (12024) a requirement that the respective portion of the head of the user has an elevation that is above a horizontal reference plane in the environment (e.g., a plane that is defined as a horizon, a plane that is parallel to a floor, and/or a plane that is perpendicular to gravity, where the horizontal reference plane is optionally set at a height of a viewpoint or head of the user) in order for the first criteria to be met. For example, in FIGS. 9H and 9J, the computer system 101 displays the home menu user interface 7031 such that a plane of the home menu user interface 7031 tilts towards the viewpoint of the user 7022 by different amounts for different head elevations when the head elevation of the user 7002 is above the horizon 9022. Displaying the system user interface such that a plane of the system user interface is tilted toward a viewpoint of the user for head elevations of the user that are above the horizontal reference plane in the environment helps to automatically maintain the display of the system user interface at an ergonomically favorable orientation to the user, without requiring manual adjustments from the user, and reduces fatigue, thus increasing operational efficiency of user-machine interactions.

In some embodiments, displaying the system user interface in the environment at the second location that is based on the pose of the respective portion (e.g., a face) of the head of the user includes (12026): in accordance with a determination that the respective portion of the head of the user is at an elevation relative to a reference plane in the environment (e.g., a plane that is defined as a horizon, a plane that is parallel to a floor, and/or a plane that is perpendicular to gravity, where the horizontal reference plane is optionally set at a height of a viewpoint or head of the user) that does not satisfy the first criteria (e.g., the elevation relative to the reference plane is below the horizon), the computer system displays the system user interface such that a plane of the system user interface is perpendicular to the reference plane in the environment (e.g., the system user interface is perpendicular to a horizon, or the system user interface is perpendicular to the floor). For example, in FIGS. 9E, 9L, 9N, and 9P, the computer system 101 displays the home menu user interface 7031 such that a plane of the system user interface is perpendicular to the reference plane in the environment when the head elevation of the user 7002 is below the horizon 9022. Displaying the system user interface such that a plane of the system user interface is perpendicular to the reference plane in the environment helps to automatically maintain the system user interface at an ergonomically favorable position to the user, without requiring manual adjustments from the user, and reduces fatigue, thus increasing operational efficiency of user-machine interactions.

In some embodiments, displaying the system user interface in the environment at the first location that is based on the pose of the respective portion of (e.g., a front of) the torso of the user includes displaying a first animation that includes (12028): displaying a first representation of the system user interface (e.g., a representation or preview of the system user interface) at a respective location that is within a viewport of the user at a time the input is detected; and after displaying the first representation of the system user interface at the respective location, the computer system ceases to display the first representation of the system user interface at the respective location, and displaying a second representation of the system user interface (e.g., where the second representation of the system user interface is the system user interface or a representation or preview of the system user interface that is the same as or different from the first representation of the system user interface) at the first location that is based on the pose of the respective portion of the torso of the user (e.g., without regard to whether the first location is within the viewport of the user at the time the input was detected). In some embodiments, the computer system displays the system user interface, or a representation of the system user interface, moving from the respective location that is within the viewport to the first location that is based on the pose of the respective portion of the torso of the user, optionally through a plurality of intermediate locations between the respective location and the first location, and ultimately displays the system user interface at the first location. For example, in FIGS. 9A-9E, the computer system 101 displays the home menu user interface 7031 based on the torso vector 9030, which includes the computer system 101 displaying an animation of the home menu user interface 7031 that includes the animated portion 9040 (e.g., as illustrated in FIG. 9C)) appearing in the viewport of the user. Displaying an animation that includes a representation of the system user interface at a respective location that is within a viewport of the user in response to the user request, if criteria based on elevation of the user's viewpoint are met, guides the user toward the display location of the system user interface that is in some circumstances outside or at least partially outside the viewport, reducing the amount of time needed for the user to locate the system user interface without displaying additional controls and providing feedback about a state of the computer system.

In some embodiments, displaying the system user interface in the environment at the second location that is based on the pose of the respective portion (e.g., a face) of the head of the user includes (12030) displaying the system user interface in the environment at the second location without displaying the first animation (e.g., the system user interface is displayed at the second location without any animation, or the system user interface is displayed at the second location using a different animation from the first animation (e.g., the system user interface fades in at the second location without first being displayed at another portion of the viewport of the user)). For example, in FIGS. 9F-9H, the computer system 101 displays the home menu user interface 7031 based on the head direction 9024 without displaying any animation, in contrast to the computer system 101 displaying the animated portion 9040 (e.g., as illustrated in FIG. 9C) as part of an animation for displaying the home menu user interface 7031 based on the torso vector 9030 of the user (e.g., as in FIGS. 9A-9E). Displaying the system user interface based on the pose of the respective portion of the head of the user in response to the user request without an animation that includes a representation of the system user interface at a respective location that is within the viewport of the user provides feedback to the user that the home menu user interface is displayed within the current viewport.

In some embodiments, the respective criteria include (12032) a requirement that information about the pose of the torso of the user is available (e.g., has been obtained within a threshold amount of time (e.g., recently enough such as within the last 0.1, 0.5, 1, 2, 3, 5, 10, 15, 30, 60 seconds, 2, 5, or 10 minutes) and can be used to determine the pose of the respective portion of the torso of the user within a threshold level of accuracy). In some embodiments, the information about the pose of the user's torso is needed in order to determine the first location at which to display the system user interface in the environment. In some embodiments, if the information about the pose of the user's torso is not available, the system user interface is displayed in the environment at the second location that is based on the pose of the respective portion of the user's head, whereas in some embodiments the system user interface is displayed in the environment at a respective location that is independent of the pose of the user's torso and optionally also independent of the pose of the user's head (e.g., a default location in the environment for displaying the system user interface when invoked that is independent of the user's pose and/or viewpoint relative to the environment). For example, in FIGS. 90-9P, the computer system 101 displays the home menu user interface 7031 based on the head direction 9024 instead of the torso vector 9030 because information about the pose of the torso of the user is not available, even though the head direction 9024 meets criteria for displaying the home menu user interface 7031 based on the torso vector 9030 (e.g., as in FIGS. 9A-9E). Displaying the system user interface based on the pose of the respective portion of the torso of the user in response to the user request if criteria based on availability of information about the pose of the torso of the user are met (e.g., and otherwise displaying the system user interface based on the pose of the respective portion of the user's head) reduces erroneous placement of the system user interface without displaying additional controls.

In some embodiments, aspects/operations of methods 10000, 11000, 13000, 15000, 16000, 17000, and 18000 may be interchanged, substituted, and/or added between these methods. For example, the control that is displayed and/or interacted with in the method 10000 are displayed before the home menu user interface is displayed as described in the method 12000, and/or the volume level adjustment described in the method 13000 may be performed before or after the home menu user interface is displayed as described in method 1200. For brevity, these details are not repeated here.

FIGS. 13A-13G are flow diagrams of an exemplary method 13000 for adjusting a volume level for a computer system, in accordance with some embodiments. In some embodiments, the method 13000 is performed at a computer system (e.g., computer system 101 in FIG. 1) that is in communication with one or more display generation components (e.g., a head-mounted display (HMD), a heads-up display, a display, a projector, a touchscreen, or other type of display) (e.g., display generation component 120 in FIGS. 1A, 3, and 4, or the display generation component 7100a in FIGS. 8A-8T), one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c, the digital crown 703, and/or controller 7111 with buttons 7113, 7115, and/or 7117 in FIGS. 8A-8T), and optionally one or more audio output devices (e.g., speakers 160 in FIG. 1A or electronic component 1-112 in FIGS. 1B-1C). In some embodiments, the method 13000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 13000 are, optionally, combined and/or the order of some operations is, optionally, changed.

While a view of an environment (e.g., a two-dimensional or three-dimensional environment that includes one or more virtual objects and/or one or more representations of physical objects) is visible via the one or more display generation components (e.g., using AR, VR, MR, virtual passthrough, or optical passthrough), the computer system detects (13002), via the one or more input devices, a first air gesture that meets respective criteria. The respective criteria include a requirement that the first air gesture includes a selection input (e.g., an air pinch gesture that includes bringing two or more fingers of a hand into contact with each other, an air long pinch gesture, or an air tap gesture) performed by a hand of a user and movement of the hand (e.g., while maintaining the selection input (e.g., maintaining the contact between the fingers of an air pinch gesture or air long pinch gesture, or maintaining the tap pose of an air tap gesture), prior to releasing the selection input) in order for the respective criteria to be met (e.g., the pinch and hold gesture performed by the hand 7022′ in FIGS. 8H-8I, which includes movement of the hand 7022′ in a leftward direction relative to the display generation component 7100a).

In response to detecting (13004) the first air gesture: in accordance with a determination that the first air gesture was detected while attention of the user (e.g., gaze or an attention metric based on a gaze, head direction, wrist direction, and/or other pointing manner of the user) was directed toward a location of the hand of the user (e.g., and optionally that the hand of the user has a respective orientation, such as a first orientation with the palm of the hand facing toward the viewpoint of the user or a second orientation with the palm of the hand facing away from the viewpoint of the user), the computer system changes (13006) (e.g., increases or decreases) a respective volume level (e.g., an audio output volume level and/or tactile output volume level, optionally for content from a respective application (e.g., application volume) or for content systemwide (e.g., system volume)) in accordance with the movement of the hand (e.g., the respective volume level is increased or decreased (e.g., by moving the hand toward a first direction or toward a second direction that is opposite the first direction) by an amount that is based on an amount (e.g., magnitude) of movement of the hand, where a larger amount of movement of the hand causes a larger amount of change in the respective volume level, and a smaller amount of movement of the hand causes a smaller amount of change in the respective volume level, and movement of the hand toward a first direction causes an increase in the respective volume level whereas movement of the hand toward a second direction different from (e.g., opposite) the first direction causes a decrease in the respective volume level) (e.g., in FIG. 8G, at the time the pinch and hold gesture is first detected, the attention 7010 of the user 7002 is directed to the hand 7022′, and in FIGS. 8H-8I, the computer system 101 changes the respective volume level in accordance with the movement of the hand 7022′ (e.g., irrespective of where the attention 7010 of the user 7002 is directed)). In some embodiments, the hand of the user is required to be detected in a particular orientation in order for the computer system to change the respective volume level in accordance with the movement of the hand, whereas if the hand of the user does not have the particular orientation, regardless of whether other criteria are met, the computer system forgoes changing the respective volume level in accordance with the movement of the hand.

In response to detecting (13004) the first air gesture: in accordance with a determination that the first air gesture was detected while attention of the user (e.g., gaze or an attention metric based on a gaze, head direction, wrist direction, and/or other pointing manner of the user) was not directed toward a location of the hand of the user (e.g., or optionally that the hand of the user does not have the respective orientation), the computer system forgoes (13008) changing the respective volume level in accordance with the movement of the hand (e.g., in the example 7088 and the example 7090, in FIG. 7P, the computer system 101 does not perform a function in response to detecting the air pinch gesture (e.g., or pinch and hold gesture) performed by the hand 7022′, because the attention 7010 of the user 7002 is not directed toward the hand 7022′). In some embodiments, in response to detecting a respective air gesture that does not meet the respective criteria, the respective volume level is not changed (e.g., even if the attention of the user is directed toward the location of the hand): for example, if the respective air gesture does not include a selection input prior to the movement of the hand, the respective volume level is not changed in accordance with the movement of the hand; in another example, if the respective air gesture includes a selection input without movement of the hand (e.g., optionally while the selection input is maintained), the respective volume level is not changed.

Changing a volume level of the computer system in response to detecting a selection input performed by a user's hand and in accordance with movement of the hand, conditioned on the selection input being performed while the user's attention is directed toward the location/view of the hand, reduces the number of inputs and amount of time needed to access the volume adjustment function while reducing the chance of unintentionally adjusting the volume if the user is not indicating intent to do so (e.g., due to not directing attention toward the hand).

In some embodiments, changing the respective volume level in accordance with the movement of the hand includes (13010) increasing the respective volume level in accordance with movement of the hand in a first direction (e.g., a leftward direction as shown in FIG. 8I, or a rightward direction as shown in FIG. 8L, relative to the display generation component 7100a (e.g., where leftward and rightward refer to movement along an x-axis, which is substantially orthogonal to a direction of the attention or gaze of the user 7002 (e.g., a z-axis or depth direction))); and decreasing the respective volume level in accordance with movement of the hand in a second direction that is different than the first direction. For example, in FIGS. 8I-8K, the computer system 101 decreases the respective volume level in accordance with movement of the hand 7022′ in a leftward direction (e.g., relative to the display generation component 7100a), and in FIG. 8L, the computer system 101 increases the respective volume level in accordance with movement of the hand 7022′ in a rightward direction (e.g., that is different, and opposite, the leftward direction). Increasing a volume level of the computer system in response to (e.g., and in accordance with) movement of the hand in a first direction and decreasing the volume level in response to (e.g., and in accordance with) movement of the hand in a different, second direction enables a user to adjust the volume level in an intuitive and ergonomic manner and reduces the number of inputs and amount of time needed to do so.

In some embodiments, while detecting the first air gesture, and while changing the respective volume level in accordance with the movement of the hand, the computer system detects (13012), via the one or more input devices, that the attention of the user is not (e.g., is no longer or has ceased to be) directed toward the location of the hand of the user. In response to detecting that the attention of the user is not (e.g., is no longer or has ceased to be) directed toward the location of the hand of the user, the computer system continues to change the respective volume level in accordance with the movement of the hand. In some embodiments (e.g., while changing the respective volume level), the computer system continues to change the respective volume level in accordance with the movement of the hand until the computer system detects termination of the air gesture (e.g., and the computer system ceases to change the respective volume level in accordance with the movement of the hand, in response to detecting termination of the first air gesture) and/or in some embodiments until the computer system detects a change in orientation of the hand (e.g., from a first orientation with the palm of the hand facing toward the viewpoint of the user to a second orientation with the palm of the hand facing away from the viewpoint of the user, or vice versa). In some embodiments, the computer system continues to change the respective volume level in accordance with the movement of the hand even if an orientation of the hand changes (e.g., from the first orientation with the palm of the hand facing toward the viewpoint of the user to the second orientation with the palm of the hand facing away from the viewpoint of the user, or vice versa). For example, in FIG. 8G, the attention 7010 of the user 7002 is directed toward the hand 7022′ as the user 7002 begins changing the respective volume level of the computer system 101 (e.g., performs the initial pinch of the pinch and hold gesture), and in FIG. 8H, while changing the respective volume level of the computer system 101, the attention 7010 of the user 7002 is not directed toward (e.g., no longer directed toward) the hand 7022′. After initiating changing the volume level of the computer system in accordance with movement of the user's hand, in response to a selection input performed while the user's attention is directed toward a location/view of the hand, continuing to change the volume level in accordance with movement of the user's hand whether or not the user's attention is directed toward (e.g., remains directed toward) the location/view of the hand (e.g., even while the user's attention is not directed and/or no longer directed to the location/view of the hand) enables the user to concurrently direct attention toward and interact with a different aspect or function of the computer system while still interacting with the volume level adjustment function.

In some embodiments, in response to detecting the first air gesture, and in accordance with the determination that the first air gesture was detected while the attention of the user was directed toward the location of the hand of the user, the computer system displays (13014), via the one or more display generation components, a visual indication of the respective volume level (e.g., a visual indication of the current value of the respective volume level, which is optionally updated in appearance as the respective volume level is changed (e.g., by changing a volume bar length, moving a slider thumb, increasing or decreasing a displayed value, and/or other visual representation)). In some embodiments, the computer system displays the visual indication of the respective volume level while (e.g., as long as the computer system is) changing the respective volume level. For example, in FIG. 8H, in response to detecting the pinch and hold gesture (e.g., that the initial pinch detected in FIG. 8G has been maintained for a threshold amount of time), the computer system 101 displays the indicator 8004 (e.g., a visual indication of the current value of the respective volume level). Displaying a volume level indication (e.g., while changing a volume level of the computer system, and optionally corresponding to the location/view of the user's hand) provides feedback about a state of the computer system.

In some embodiments, while detecting the first air gesture, and while changing the respective volume level in accordance with the movement of the hand, the computer system detects (13016), via the one or more input devices, that the attention of the user is not (e.g., is no longer or has ceased to be) directed toward the location of the hand of the user. In response to detecting that the attention of the user is not (e.g., is no longer or has ceased to be) directed toward the location of the hand of the user, the computer system maintains display of the visual indication of the respective volume level. In some embodiments (e.g., while changing the respective volume level), the computer system maintains display of the visual indication of the respective volume level until the computer system detects termination of the air gesture (e.g., and the computer system ceases to display the visual indication of the respective volume level, in response to detecting termination of the first air gesture). In some embodiments, the computer system displays the visual indication of the respective volume level while changing the respective volume level, and optionally continues changing the respective volume level in accordance with the movement of the hand (e.g., regardless of whether or not the attention of the user is, and/or remains, directed toward the location or view of the hand of the user). For example, in FIGS. 8H-8L, the indicator 8004 is displayed even though the attention 7010 of the user 7002 is not directed toward the hand 7022′. In FIG. 8M, the indicator 8004 is also displayed while the attention 7010 of the user 7002 is directed toward the hand 7022′. In both cases, the indicator 8004 is displayed while the user 7002 changes the respective volume level of the computer system 101 (e.g., irrespective of where the attention 7010 of the user 7002 is directed, while changing the respective volume level). Where a volume level indication of a current value for the volume level of the computer system is displayed in response to a selection input performed by a user's hand while the user's attention is directed toward a location/view of the hand, maintaining display of the volume level indication while changing the volume level of the computer system in accordance with the movement of the hand, whether or not the user's attention is directed toward (e.g., remains directed toward) the location/view of the hand (e.g., even while the user's attention is no longer directed toward the location/view of the hand), enables the user to concurrently direct attention toward and interact with a different aspect or function of the computer system while still interacting with the volume adjustment function.

In some embodiments, while displaying the visual indication of the respective volume level (e.g., and while detecting the first air gesture and/or, while changing the respective volume level in accordance with the movement of the hand), the computer system detects (13018), via the one or more input devices, a change in orientation of the hand from a first respective orientation to a second respective orientation (e.g., from the first orientation described herein with the palm facing toward the viewpoint of the user to the second orientation described herein with the palm facing away from the viewpoint of the user, or vice versa). In response to detecting the change in orientation of the hand from the first orientation to the second orientation, the computer system maintains display of the visual indication of the respective volume level. For example, in FIG. 8L, the hand 7022′ changes from a “palm up” orientation to a “palm down” orientation, and the computer system 101 maintains display of the indicator 8004 (e.g., and similarly would do so if the hand 7022′ changed from a “palm down” orientation to a “palm up” orientation). Maintaining display of a visual indication of a respective volume level during adjustment of the volume level in accordance with movement of the user's hand, even as the user's hand changes orientation (e.g., rotates) while moving, reduces the chance of unintentionally dismissing the volume indication while the user is still interacting with the volume adjustment function.

In some embodiments, the computer system detects (13020), via the one or more input devices, termination of the first air gesture (e.g., an un-pinch, or a break in contact between the fingers of a hand that was performing the first air gesture). In response to detecting the termination of the first air gesture, the computer system ceases to display the visual indication of the respective volume level (e.g., and ceasing to change the respective volume level in accordance with the movement of the hand). For example, in FIGS. 8N-8P, in response to detecting termination of the pinch and hold gesture by the hand 7022′, the computer system 101 ceases to display the indicator 8004 (e.g., regardless of whether the attention 7010 of the user 7002 is directed to the hand 7022′ in a “palm down” orientation as in FIG. 8N, directed to the hand 7022′ in a “palm up” orientation as in FIG. 8O, or not directed to the hand 7022′ as in FIG. 8P). Ceasing to display the visual indication of the respective volume level in response to the end of the input that initiated interaction with the volume level adjustment function and that controlled the changes in volume level (e.g., based on the movement of the user's hand during the input) provides feedback about a state of the computer system when the user has indicated intent to stop interacting with the volume adjustment function.

In some embodiments, in response to detecting (13022) the termination of the first air gesture: in accordance with a determination that the termination of the first air gesture was detected while the attention of the user was directed toward the location of the hand of the user, the computer system displays a control corresponding to the location of the hand; and in accordance with a determination that the termination of the first air gesture was detected while the attention of the user was not directed toward the location of the hand of the user, the computer system forgoes displaying the control corresponding to the location of the hand. For example, in FIG. 8O, the attention 7010 of the user 7002 is directed to the hand 7022′ (e.g., and the hand 7022′ is in a “palm up” orientation) when the computer system 101 detects termination of the pinch and hold gesture performed by the hand 7022′, and in response, the computer system 101 ceases to display the indicator 8004 and displays the control 7030 (e.g., replaces display of the indicator 8004 with display of the control 7030). In contrast, in FIG. 8P, the attention 7010 of the user 7002 is not directed to the hand 7022′ when the computer system 101 detects termination of the pinch and hold gesture performed by the hand 7022′, and in response, the computer system 101 does not display the control 7030 (e.g., or the status user interface 7032). Upon ceasing to display the visual indication of the respective volume level, displaying a control corresponding toward a location/view of the user's hand if the user's attention was directed toward the location/view of the hand (e.g., when the visual indication of the volume level is ceases to be displayed) reduces the number of inputs and amount of time needed to invoke the control and access a plurality of different system operations of the computer system without displaying additional controls.

In some embodiments, in response to detecting (13024) the termination of the first air gesture: in accordance with a determination that the termination of the first air gesture was detected while the attention of the user was directed toward a first portion (e.g., a front and/or palm, or a first orientation) of the location of the hand of the user, the computer system displays, via the one or more display generation components, a control (e.g., the control 7030 described above with reference to FIG. 7Q1) corresponding to the location of the hand; and in accordance with a determination that the termination of the first air gesture was detected while the attention of the user was directed toward a second portion (e.g., a back of the hand, or a second orientation different from the first orientation), different from the first portion, of the location of the hand of the user, the computer system displays, via the one or more display generation components, a status user interface (e.g., the status user interface 7032 described above with reference to FIG. 7H). For example, in FIG. 8O, the attention 7010 of the user 7002 is directed to the hand 7022′ while the hand 7022′ is in a “palm up” orientation when the computer system 101 detects termination of the pinch and hold gesture performed by the hand 7022′, and in response, the computer system 101 ceases to display the indicator 8004 and displays the control 7030 (e.g., replaces display of the indicator 8004 with display of the control 7030). In contrast, in FIG. 8N, the attention 7010 of the user 7002 is directed to the hand 7022′ while the hand 7022′ is in a “palm down” orientation when the computer system 101 detects termination of the pinch and hold gesture performed by the hand 7022′, and in response, the computer system 101 ceases to display the indicator 8004 and displays the status user interface 7032 (e.g., replaces display of the indicator 8004 with displays of the status user interface 7032). If the user's attention was directed toward a location/view of the user's hand upon ceasing to display the visual indication of the respective volume level, displaying a control corresponding to the location/view of the hand if the hand is in a “palm up” orientation, versus displaying a status user interface (e.g., optionally corresponding to the location of the user's hand) if the hand is in a “palm down” orientation reduces the number of inputs and amount of time needed to invoke the control and access a plurality of different system operations of the computer system or view status information about the computer system in the status user interface without displaying additional controls.

In some embodiments, moving (e.g., changing a location of) the visual indication of the respective volume level (e.g., the computer system moves (13026) the visual indication of the respective volume level in the view of the environment, relative to the environment) in accordance with movement of the hand (e.g., relative to the environment, during and/or while detecting the first air gesture). In some embodiments, the visual indication is moved in the same direction(s) as the movement of the hand (e.g., if the hand is moved in a leftward and upward direction in the view visible via the display generation component, the visual indication is likewise moved in the same leftward and upward directions), and optionally, the visual indication is moved by an amount that is proportional to the amount of movement of the hand (e.g., the visual indication moves by the same amount as the hand, with respect to both the leftward and the upward direction). For example, in FIG. 8K, the indicator 8004 moves (e.g., in a horizontal direction, relative to the display generation component 7100a) in accordance with movement (e.g., horizontal movement) of the hand 7022′. Moving the visual indication of the respective volume level in accordance with movement of the user's hand causes the computer system to automatically keep the visual indication of the respective volume level at a consistent and predictable location relative to the location/view of the hand, to reduce the amount of time needed for the user to locate and optionally interact with the volume indication and view feedback about a state of the computer system.

In some embodiments, displaying the visual indication of the respective volume level, in response to detecting the first air gesture, includes (13028) displaying the visual indication of the respective volume level with a first appearance. While detecting the first air gesture, the computer system detects, via the one or more input devices, that the movement of the hand includes more than a threshold amount of movement. In response to detecting that the movement of the hand includes more than the threshold amount of movement, the computer system displays, via the one or more display generation components, the visual indication of the respective volume level with a second appearance that is different from the first appearance. In some embodiments, displaying the visual indication of the respective volume level with the second appearance includes updating display of the visual indication of the respective volume level from the first appearance to (e.g., having) the second appearance. In some embodiments, the computer system displays the visual indication of the respective volume level with the second appearance while detecting the movement of the hand (e.g., as long as the computer system detects the movement of the hand). In some embodiments, in response to detecting that the movement of the hand includes more than the threshold amount of movement and/or moves with more than a threshold speed, the computer system visually deemphasizes (e.g., dims, blurs, fades, decreases opacity of, and/or other types of visual deemphasis) the visual indication of the respective volume level and/or ceases to display the visual indication of the respective volume level (e.g., optionally redisplaying the visually indication of the respective volume level with the first appearance in response to detecting that the movement of the hand no longer includes more than the threshold amount of movement and/or no longer moves with more than the threshold speed). In some embodiments, the control that corresponds to the location or view of the hand (e.g., displayed in response to detecting that the attention of the user is directed toward the location or view of the hand if the attention of the user is directed toward the location or view of the hand while the first criteria are met) exhibits analogous behavior to the visual indication of the respective volume level as a result of movement of the hand. For example, in FIG. 7S, the computer system 101 displays the control 7030 with a second appearance (e.g., a dimmed or faded appearance) in response to detecting that the hand 7022 is moving above a threshold velocity Vth (e.g., the hand 7022′ moves by more than a threshold amount of movement). As described with reference to FIG. 8K, in some embodiments, if the hand 7022′ moves by more than a threshold distance, and/or if the hand 7022′ moves at a velocity that is greater than a threshold velocity, the computer system 101 moves the indicator 8004 in accordance with the movement of the hand 7022′, but displays the indicator 8004 with a different appearance (e.g., with a dimmed or faded appearance, with a smaller appearance, with a blurrier appearance, and/or with a different color, relative to a default appearance of the indicator 8004 (e.g., an appearance of the indicator 8004 in FIG. 8H)) (e.g., analogously to the control 7030). While moving the visual indication of the respective volume level in accordance with movement of the user's hand, visually deemphasizing the visual indication of the respective volume level if the movement of the user's hand exceeds a threshold magnitude and/or speed of movement improves user physiological comfort by reducing the chance that the visual response in the environment may not be matched with the physical motion of the user. Improving user comfort is a significant consideration when creating an MR experience because reduced comfort can cause a user to leave the MR experience and then re-enter the MR experience or enable and disable features, which increases power usage and decreases battery life (e.g., for a battery powered device); in contrast, when a user is physiologically comfortable they are able to quickly and efficiently interact with the device to perform the necessary or desired operations, thereby reducing power usage and increasing battery life (e.g., for a battery powered device).

In some embodiments, moving the visual indication of the respective volume level in accordance with the movement of the hand includes (13030) moving the visual indication of the respective volume level while (e.g., detecting the first air gesture and while) changing the respective volume level in accordance with the movement of the hand. In some embodiments, at least some movement of the visual indication of the respective volume level occurs concurrently with changing the respective volume level in accordance with the movement of the hand. For example, as described above with reference to FIG. 8K, in some embodiments, the computer system 101 moves the indicator 8004 in accordance with movement of the hand 7022′ (e.g., regardless of the current value for the volume level). For example, in FIG. 8I and FIG. 8J, the computer system 101 would display the indicator 8004 moving toward the left of the display generation component 7100a (e.g., by an amount that is proportional to the amount of movement of the hand 7022′) (e.g., while also decreasing the volume level). Moving the visual indication of the respective volume level in accordance with movement of the user's hand while also changing the volume level in accordance with the movement of the user's hand causes the computer system to automatically keep the visual indication of the respective volume level at a consistent and predictable location relative to the location/view of the hand, to reduce the amount of time needed for the user to locate the volume indication and view feedback about a state of the computer system.

In some embodiments, moving the visual indication of the respective volume level in accordance with movement of the hand includes (13032): in accordance with a determination that the movement of the hand includes movement along a first axis, moving the visual indication of the respective volume level along the first axis, independent of a current value of the respective volume level (e.g., without changing the current value of the respective volume level based on the movement along the first axis); and in accordance with a determination that the movement of the hand includes movement along a second axis that is different than the first axis, moving the visual indication of the respective volume level along the second axis based on the current value of the respective volume level. In some embodiments, the second axis is an axis along which the respective volume level is changed (e.g., an increase or decrease in the respective volume level is indicated by a change in appearance, such as length, along the second axis), and the first axis is an axis that is perpendicular to the second axis (e.g., the second axis is a horizontal axis and the first axis is a vertical axis, or vice versa). For example, the first axis is a vertical axis (e.g., corresponding to an up and down direction on the display generation component) and the second axis is a horizontal axis (e.g., corresponding to a left and right direction on the display generation component), A third axis that is orthogonal to both the first axis and the second axis runs in the direction of the user's gaze (e.g., the third axis corresponds to an inward and outward direction on the display generation component). In some embodiments, the visual indication of the respective volume level is conditionally moved based on whether the respective volume level has a particular level. For example, if the current value of the respective volume level is at a maximum level, further movement of the hand in a first direction that would otherwise increase the current value of the respective volume level would instead result in movement of the visual indication of the respective volume level in the first direction; similarly, if the current value of the respective volume level is at a minimum level, further movement of the hand in a second direction that would otherwise decrease the current value of the respective volume level would instead result in movement of the visual indication of the respective volume level in the second direction. If the current value of the respective volume level is at neither the maximum nor minimum level, movement of the hand in the first or second direction would correspondingly increase or decrease, respectively, the current value of the respective volume level (e.g., until the maximum or minimum level is reached, at which point the visual indication of the respective volume level would in some embodiments be moved instead). For example, in FIG. 8M, the indicator 8004 is moved in a vertical direction (e.g., relative to the display generation component 7100a) in accordance with the vertical movement of the hand 7022′, even though the current value for the respective volume level is between the minimum value and the maximum value. In contrast, in FIG. 8I, the indicator 8004 is not moved in a horizontal direction in accordance with horizontal movement of the hand 7022′, because the current value for the respective volume level is between the minimum value and the maximum value. Moving the visual indication of the respective volume along a first axis independent of a current value of the respective volume level, and moving the visual indication of the respective volume level along a second axis based on a current value of the respective volume level, ensures that user interface objects are displayed clearly within the viewport of the user (e.g., the visual indication of the respective volume moves independent of the current value of the volume level, along the first axis (e.g., a vertical axis), to prevent the visual indication of the respective volume from obscuring or occluding the hand during motion along the first axis; but the visual indication of the respective volume moves based on the current value of the respective volume level along the second axis (e.g., a horizontal axis, and/or an axis along which the hand moves to change the respective volume level), as the visual indication of the respective volume is unlikely to obscure and/or occlude the hand during motion along the second axis.

In some embodiments, moving the visual indication of the respective volume level along the second axis, based on the current value of the respective volume level, includes (13034): in accordance with a determination that the current value of the respective volume level is between a first (e.g., minimum) value and a second (e.g., maximum) value for the respective volume level (e.g., the movement of the hand corresponds to a request to change the current value of the respective volume level between the first value and the second value without reaching the first value or the second value), forgoing moving (e.g., and/or suppressing movement of) the visual indication of the respective volume level along the second axis (e.g., and instead changing the current value of the respective volume level in accordance with the movement of the hand); and in accordance with a determination that the current value of the respective volume level is at the first value or the second value for the respective volume level (e.g., and the movement of the hand corresponds to a request to change the current value of the respective volume level to a value that is beyond the range of values between by the first value and the second value), moving the visual indication of the respective volume level along the second axis (e.g., optionally without changing the current value of the respective volume level in accordance with the movement of the hand). In some embodiments, in accordance with a determination that the current value of the respective volume level is between a minimum and a maximum value for the respective volume level, the computer system moves the visual indication of the respective volume level along the second axis by a first amount; and in accordance with a determination that the current value of the respective volume level is at the minimum or the maximum value for the respective volume level, the computer system moves the visual indication of the respective volume level along the second axis by a second amount that is different than the first amount. In some embodiments, the first amount and/or the second amount are based on (e.g., proportional to, and in the same direction as) an amount of movement of the hand in the second direction. In some embodiments, the second amount is greater than the first amount (e.g., the second amount is equal to the amount of movement of the hand (e.g., the second amount and the amount of the movement of the hand are scaled 1:1)), and the first amount is less than (e.g., and/or is a fraction of) the amount of movement of the hand (e.g., the first amount and the amount of the movement of the hand are scaled n:1, where n is a value that is less than 1). For example, in FIG. 8M, the indicator 8004 is moved in a vertical direction (e.g., relative to the display generation component 7100a) in accordance with the vertical movement of the hand 7022′, even though the current value for the respective volume level is between the minimum value and the maximum value. In contrast, in FIG. 8I, the indicator 8004 is not moved in a horizontal direction in accordance with horizontal movement of the hand 7022′, because the current value for the respective volume level is between the minimum value and the maximum value. In FIG. 8K, however, once the current value for the respective volume level is at the minimum value, the computer system 101 moves the indicator 8004 in the horizontal direction in accordance with horizontal movement of the hand 7022′ (e.g., further horizontal movement in the same direction that caused the respective volume level to decrease to the minimum value). Moving the visual indication of the respective volume level along a second axis based on a current value of the respective volume level, including forgoing moving the visual indication of the respective volume level when the current value of the respective volume level is between a first and second value, and moving the visual indication of the respective volume level when the current value of the respective volume is at the first or second value, provides improved visual feedback to the user (e.g., movement of the visual indication of the respective volume level indicates that the current value for the volume level has already reached the first or second value.

In some embodiments, prior to detecting the first air gesture (e.g., and while the attention of the user is directed toward the location or view of the hand), the computer system displays (13036), via the one or more display generation components, a control (e.g., the control 7030 described above with reference to FIG. 7Q1, and/or a control corresponding to the location or view of the hand). In response to detecting the first air gesture, replacing display of the control with display of the visual indication of the respective volume level. For example, in FIG. 8G, prior to detecting the pinch and hold gesture performed by the hand 7022′, the computer system displays the control 7030. In FIG. 8H, in response to detecting the pinch and hold gesture performed by the hand 7022′, the computer system replaces display of the control 7030 with display of the indicator 8004. Displaying a control corresponding to a location/view of a hand (e.g., in response to the user directing attention toward the location/view of the hand) prior to invoking a volume level adjustment function of the computer system indicates that one or more operations are available to be performed in response to detecting subsequent input, which provides feedback about a state of the computer system.

In some embodiments, replacing display of the control with display of the visual indication of the respective volume level includes (13038) displaying an animation of the control transforming into the visual indication of the respective volume level (e.g., an animation or sequence as described with reference to FIG. 8H). For example, as described above with reference to FIG. 8H, in some embodiments, the computer system 101 displays an animated transition of the control 7030 transforming into the indicator 8004 (e.g., an animated transition that includes fading out the control 7030 and fading in the indicator 8004; or an animated transition that includes changing a shape of the control 7030 (e.g., stretching and/or deforming the control 7030) as the control 7030 transforms into the indicator 8004). Where a control corresponding to a location/view of a hand was displayed prior to invoking the volume level adjustment function of the computer system, replacing display of the control with a visual indication of the respective volume level (e.g., via an animated transition or transformation from one to the other) in response to detecting an input invoking the volume level adjustment function of the computer system reduces the number of displayed user interface elements by dismissing those that have become less relevant, and provides feedback about a state of the computer system.

In some embodiments, the computer system detects (13040), via the one or more input devices, a second air gesture. In response to detecting the second air gesture, in accordance with a determination that the second air gesture at least partially meets (or, optionally, fully meets) the respective criteria (and optionally that the second air gesture was detected while the attention of the user was directed toward the location or view of the hand) (e.g., the respective criteria are met when the second air gesture includes contact of at least two fingers of a hand for a threshold amount of time, and the second air gesture partially meets the respective criteria when the computer system detects the initial contact of at least two fingers of the hand (e.g., before the at least two fingers of the hand have been in contact for the threshold amount of time)), the computer system displays, via the one or more display generation components, an indication (e.g., a hint or other visual sign) that the control will be replaced by the visual indication of the respective volume level (e.g., if the second air gesture continues to be detected and fully meets the respective criteria). In some embodiments, the second air gesture corresponds to a first portion (e.g., an initial portion) of the first air gesture (e.g., a first portion of the selection input, such as an air pinch gesture that has not yet met the threshold duration for an air long pinch gesture). In some embodiments, changing the respective volume level is performed in accordance with determining that a second portion (e.g., a subsequent portion) of the first air gesture meets the respective criteria (or that the first portion and second portion of the first air gesture in combination meet the respective criteria). In response to detecting the second air gesture, in accordance with a determination that the second air gesture does not at least partially meet (or, optionally, does not fully meet) the respective criteria (or optionally that the second air gesture was not detected while the attention of the user is directed toward the location or view of the hand), the computer system forgoes displaying the indication that the control will be replaced by the visual indication of the respective volume level (e.g., and, because the second air gesture does not meet the respective criteria, forgoing changing the respective volume level in accordance with the movement of the hand, without regard to whether the second air gesture was detected while attention of the user is directed toward the location or view of the hand). In some embodiments, the indication that the control will be replaced by the visual indication of the respective volume level is a change in shape, color, size, and/or appearance of the control. For example, as described above with reference to FIG. 8G, in some embodiments, in response to detecting the initial pinch (of the pinch and hold gesture) in FIG. 8G, the computer system 101 changes a size, shape, color, and/or other visual characteristic of the control 7030 (e.g., to provide visual feedback that an initial pinch has been detected, and/or that maintaining the air pinch will cause the computer system 101 to detect a pinch and hold gesture), and optionally outputs first audio (e.g., first audio feedback and/or a first type of audio feedback). While displaying the control corresponding to the location/view of the hand and detecting an input corresponding to the control, displaying an indication as to whether the input is meeting criteria for invoking the volume level adjustment function of the computer system provides feedback about a state of the computer system and gives the user a chance to cancel an impending operation.

In some embodiments, while displaying the control, the computer system detects (13042), via the one or more input devices, a first user input that activates the control. In response to detecting the first user input that activates the control, the computer system outputs, via one or more audio output devices that are in communication with the computer system (e.g., one or more speakers that are integrated into the computer system and/or one or more separate headphones, earbuds or other separate audio output devices that are connected to the computer system with a wired or wireless connection), first audio (e.g., that corresponds to activation of the first control). In some embodiments, in response to detecting the first user input that activates the control, the computer system performs an operation (e.g., opens a user interface, displays status information, and/or performs a function) corresponding to the control. For example, in response to detecting the air pinch gesture performed by the hand 7022′ in FIG. 7AK1 or the button press in FIG. 7AL1 (e.g., that activates the control 7030), the computer system 101 generates audio output 7103-b. Outputting audio in response to an input activating, or at least initially selecting, the control corresponding to the location/view of the hand (e.g., along with, in some circumstances, triggering display of the visual indication of the respective volume level) provides feedback about a state of the computer system.

In some embodiments, in response to detecting the first air gesture, and in accordance with the determination that the first air gesture was detected while the attention of the user was directed toward the location of the hand of the user (e.g., and in conjunction with or concurrently with displaying the visual indication of the respective volume level), the computer system outputs (13044), via the one or more audio output devices, first audio (e.g., a sound or other audio notification that is output when the visual indication of the respective volume level is displayed and/or is first displayed). For example, as described above with reference to FIG. 8H, in some embodiments, in response to detecting the pinch and hold gesture (e.g., once the computer system 101 determines that the user 7002 is performing the pinch and hold gesture), the computer system 101 outputs second audio (e.g., second audio feedback, and/or a second type of audio feedback). Outputting audio along with displaying the visual indication of the respective volume provides feedback about a state of the computer system.

In some embodiments, prior to detecting the first air gesture (e.g., and while the attention of the user is directed toward the location or view of the hand), the computer system displays (13046), via the one or more display generation components, a control (e.g., corresponding to the location or view of the hand). The first air gesture is detected while displaying the control. Outputting the first audio includes: in response to detecting a first portion of the first air gesture, wherein the first portion of the first air gesture does not meet the respective criteria, outputting, via the one or more audio output devices, second audio that corresponds to detecting the first portion of the first air gesture; and in response to detecting a second portion of the first air gesture, wherein the second portion of the first air gesture follows the first portion of the first air gesture, and wherein the second portion of the first air gesture meets the respective criteria (or the first portion and the second portion of the first air gesture in combination meet the respective criteria), outputting, via the one or more audio output devices, third audio that corresponds to detecting the second portion of the first air gesture and that is different than the second audio (e.g., concurrently with and/or while replacing display of the control with display of the visual indication of the respective volume level). In some embodiments, outputting the first audio includes outputting the second audio and outputting the third audio. For example, as described above with reference to FIG. 8H, in some embodiments, in response to detecting the pinch and hold gesture (e.g., once the computer system 101 determines that the user 7002 is performing the pinch and hold gesture), the computer system 101 outputs second audio (e.g., second audio feedback, and/or a second type of audio feedback). In some embodiments, the first audio and the second audio are different. Outputting audio corresponding to display of the visual indication of the respective volume by outputting initial audio indicating selection of the control corresponding to the location/view of the hand that is displayed prior to invoking the volume level adjustment function and outputting additional audio when the volume level adjustment function is invoked and the visual indication of the respective volume level is displayed provides an indication as to how the computer system is responding to the input, which provides feedback about a state of the computer system.

In some embodiments, the respective criteria include (13048) a requirement that the selection input is maintained for at least a threshold amount of time (optionally prior to the movement of the hand) in order for the respective criteria to be met. In some embodiments, a respective air gesture that includes a selection input that is not maintained for at least the threshold amount of time does not meet the respective criteria and does not result in adjusting the respective volume level (e.g., even if the respective air gesture includes subsequent movement of the hand and even if the user's attention is directed toward the location of the hand during at least an initial portion of the respective air gesture). For example, as described above with reference to FIG. 8G, in some embodiments, the computer system 101 determines that the user 7002 is performing the pinch and hold gesture when the user 7002 maintains the initial pinch (e.g., maintains contact between two or more fingers of the hand 7022′, such as the thumb and pointer of the hand 7022′) detected in FIG. 8G for a threshold amount of time (e.g., 0.5 seconds, 1 second, 1.5 seconds, 2 seconds, 2.5 seconds, 5 seconds, or 10 seconds). Requiring that an input be maintained for at least a threshold amount of time in order for the volume level adjustment function to be invoked causes the computer system to automatically require that the user indicate intent to adjust the volume level of the computer system, and reduces the number of inputs and amount of time needed to adjust the volume level while enabling different types of system operations to be performed without displaying additional controls.

In some embodiments, in accordance with a determination that the first air gesture was detected while attention of the user was directed toward a first user interface object (e.g., a control, an affordance, a button, a slider, a user interface, or a virtual object) (e.g., rather than toward the location or view of the hand of the user), the computer system performs (13050) a first operation corresponding to the first user interface object. For example, as described above with reference to FIG. 8G, in some embodiments, if the attention 7010 of the user 7002 is directed toward another interactive user interface object (e.g., a button, a control, an affordance, a slider, and/or a user interface) and not the hand 7022′, the computer system 101 performs an operation corresponding to the interactive user interface object in response to detecting the air pinch gesture. Performing an operation corresponding to a user interface object in response to detecting an air gesture while a user's attention is directed to the user interface object, and changing the respective volume level in response to detecting the air gesture while the attention of the user is directed toward the location of the hand of the user, reduces the number of inputs needed to switch between different functions of the computer system (e.g., the user does not need to perform additional user inputs to enable and/or disable different functions of the computer system, and can instead select between different available functions by directing the user's attention toward an appropriate location and/or user interface object).

In some embodiments, while changing the respective volume level in accordance with the movement of the hand, the computer system detects (13052), via the one or more input devices, that a current value of the respective volume level has reached a minimum or maximum value. In response to detecting that the current value of the respective volume level has reached the minimum or maximum value, the computer system outputs, via one or more audio output devices that are in communication with the computer system (e.g., one or more speakers that are integrated into the computer system and/or one or more separate headphones, earbuds or other separate audio output devices that are connected to the computer system with a wired or wireless connection), respective audio that indicates that the current value of the respective volume level has reached the minimum or maximum value. For example, in FIG. 8J, the computer system 101 outputs audio 8010 in response to detecting that the current value for the respective volume level is at a minimum value. In some embodiments, the computer system 10 outputs analogous audio (e.g., which is optionally the same as the audio 8010) in response to detecting that the current value for the respective volume level is at a maximum value. Outputting audio to indicate that the current value of the respective volume level of the computer system has been changed to a minimum or maximum value (e.g., has reached a volume level limit) provides feedback about a state of the computer system.

In some embodiments, while the view of the environment is visible via the one or more display generation components, the computer system detects (13054), via the one or more input devices, a first input that includes movement of a first input mechanism (e.g., pressing, activating, rotating, flipping, sliding, or otherwise manipulating a button, dial, switch, slider, or other input mechanism of the computer system). In response to detecting the first input that includes the movement of the first input mechanism: in accordance with a determination that a setting for the computer system (e.g., that enables volume level adjustment via the first input mechanism) is enabled, the computer system changes the respective volume level in accordance with the movement of the first input mechanism; and in accordance with a determination that the setting for the computer system is not enabled, the computer system forgoes changing the respective volume level in accordance with the movement of the first input mechanism. In some embodiments, a speed and/or a magnitude of the movement of the first input mechanism controls by how much and/or how fast the volume level changed (e.g., is increased and/or decreased). For example, faster and/or larger movements change the volume level by a larger amount and/or with a larger rate of change, and slower and/or smaller movements increase and/or decrease the volume level by a smaller amount and/or with a smaller rate of change). For example, as described above with reference to FIG. 8P, in some embodiments, mechanical input mechanism(s) are only enabled for adjusting the volume level if audio is currently playing for the computer system 101, but in some embodiments, the volume level can be adjusted through alternative means only if the computer system 101 is configured to allow volume level adjustment via the alternative means (e.g., a setting that enables volume level adjustment via the alternative means is enabled for the computer system 101). When a setting for a computer system is enabled, changing the respective volume level in response to detecting an input that includes movement of an input mechanism, and in accordance with the movement of the input mechanism, provides additional control options without cluttering the UI with additional displayed controls (e.g., additional displayed controls for increasing or decreasing the current value for the volume level), and reduces the number of inputs needed to change the respective volume level (e.g., the user can change the respective volume level without needing to first invoke display of the control or status information user interface; and/or the user can change the respective volume level even if the computer system is unable to detect the hands and/or attention of the user, such as when the user is a new user or guest user of the computer system, when the computer system is being used in poor lighting conditions, and/or to make the computer system more accessible to a wider variety of users by supporting different input mechanisms besides hand- and/or gaze-based inputs).

In some embodiments, the view of the environment (e.g., a three-dimensional environment) includes a virtual environment (e.g., corresponding to the three-dimensional and/or the physical environment) having a first level of immersion, and in accordance with the determination that the setting for the computer system is not enabled, the computer system changes (13056) a level of immersion for the computer system from a first level of immersion to a second level of immersion, in accordance with the movement of the first input mechanism (e.g., the movement of the first input mechanism controls level of immersion rather than volume level). In some embodiments, in accordance with a determination that the setting for the computer system is enabled, the computer system 101 changes the respective volume level in accordance with the movement of the first input mechanism, while maintaining the first level of immersion (e.g., without changing the level of immersion of the computer system from the first level of immersion to a different level of immersion). In some embodiments, the level of immersion describes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, if the setting is enabled, such that the volume level is changed in accordance with the movement of the first input mechanism, the computer system is configured to change the level of immersion in accordance with the movement of the first input mechanism (e.g., instead of the volume level) in response to a user input, such as user attention being directed toward and/or selection of a user interface element corresponding to the immersion level setting, optionally before or while moving the first input mechanism. For example, as described above with reference to FIG. 8P, in some embodiments, mechanical input mechanism(s) are only enabled for adjusting the volume level if audio is currently playing for the computer system 101, and if audio is not currently playing, the mechanical input mechanism(s) are instead enabled for changing the level of immersion. In some embodiments, if the computer system 101 is not configured to allow volume level adjustment via the alternative means, then the computer system 101 adjusts the level of immersion in response to detecting movement of the mechanical input mechanism(s) (e.g., irrespective of whether or not audio is playing for the computer system 101). In response to detecting movement of an input mechanism, changing the respective volume level when a setting for a computer system is enabled, and changing a level of immersion when the setting for the computer system is not enabled, provides additional control options without cluttering the UI with additional displayed controls (e.g., additional displayed controls for increasing or decreasing the current value for the volume level).

In some embodiments, aspects/operations of methods 10000, 11000, 12000, 15000, 16000, 17000, and 18000 may be interchanged, substituted, and/or added between these methods. For example, the control and/or status user interface that is displayed and/or interacted with in the method 10000 are displayed before and/or after the volume level adjustment described in the method 13000. For brevity, these details are not repeated here.

FIGS. 15A-15F are flow diagrams of an exemplary method 15000 for accessing a system function menu when data is not stored for one or more portions of the body of a user of the computer system, in accordance with some embodiments. In some embodiments, the method 15000 is performed at a computer system (e.g., computer system 101 in FIG. 1) that is in communication with one or more display generation components (e.g., a head-mounted display (HMD), a heads-up display, a display, a projector, a touchscreen, or other type of display) (e.g., display generation component 120 in FIGS. 1A, 3, and 4, or the display generation component 7100a in FIGS. 8A-8P), one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c, the digital crown 703, and/or controller 7111 with buttons 7113, 7115, and/or 7117 in FIGS. 7A-7BE).

While the computer system is (15002) in a configuration state enrolling one or more input elements (e.g., one or more eyes of a user, one or more hands of a user, one or more arms of a user, one or more legs of a user, a head of the user, and/or one or more controllers) (e.g., a state that is active when the computer system is used for the first time; a state that is active after a software update; a state that is active during a user-initiated recalibration process; and/or a state that is active when setting up and/or configuring a new user or user account for the computer system, such as the initial setup state shown in FIGS. 7C-7N), and in accordance with a determination that data corresponding to a first type of input element (e.g., one or more hands of the user, one or more wrists of the user, and/or other input element) is not enrolled (e.g., is not stored in memory or configured for use in providing input for air gestures via one or more sensors, such as hand tracking sensors, of the computer system) for the computer system, the computer system enables (15004) (e.g., the computer system enables display of) a first system user interface (e.g., in accordance with a determination that first criteria for displaying the first system user interface are met, such as the attention of the user being directed toward a respective region of a current viewport); and In some embodiments, the computer system also displays, via the one or more display generation components, the first system user interface in conjunction with enabling display of the first system user interface. In some embodiments, the first system user interface is a viewport-based control user interface that is displayed based on attention directed toward a particular portion of the viewport. For example, if the computer system 101 detects that data is not stored for the hands of the user 7002 (e.g., the hands of the user 7002 are not enrolled), the computer system 101 enables the indicator 7074 of the system function menu 7043, and enables the system function menu 7043, as shown in FIGS. 7J2-7J3. In accordance with a determination that data corresponding to the first type of input element is enrolled (e.g., is stored in memory or configured for use in providing input for air gestures via one or more sensors, such as hand tracking sensors, of the computer system) for the computer system, the computer system forgoes (15006) enabling (e.g., forgoing enabling display of) the first system user interface (e.g., and forgoing displaying the first system user interface while in the setup configuration state, even if criteria for displaying the first system user interface are met). For example, in FIGS. 7K-7N, the computer system 101 does not enable access to the indicator 7074 of the system function menu 7043 and the system function menu 7043 of FIGS. 7J2-7J3.

After enrolling the one or more input elements, while the computer system is not (15008) in the configuration state (e.g., after the computer system has completed setup configuration and/or is no longer in the setup configuration state), and in accordance with a determination that a first set of one or more criteria (e.g., criteria for displaying the first system user interface) are met (e.g., the attention of the user being directed toward a respective region of a current viewport such as attention based on gaze, head direction, or wrist direction) and that display of the first system user interface is enabled (e.g., because data corresponding to the first type of input element is not enrolled for the computer system), the computer system displays (15010) the first system user interface. For example, as described with reference to FIG. 7J3, in some embodiments, the user 7002 can continue to access the system function menu 7043 (e.g., in response to detecting that the attention 7010 of the user 7002 is directed toward the region 7072, as shown in FIG. 7J2), when (e.g., and/or after) the computer system 101 is no longer in the initial setup and/or configuration state. After enrolling the one or more input elements, while the computer system is not in the configuration state (e.g., after the computer system has completed setup configuration and/or is no longer in the setup configuration state), and in accordance with a determination that the first set of one or more criteria are met and that display of the first system user interface is not enabled (e.g., because data corresponding to the first type of input element is enrolled for the computer system), the computer system forgoes (15012) displaying the first system user interface (e.g., forgoing displaying the indicator 7074 of the system function menu 7043 and the system function menu 7043 of FIGS. 7J2-7J3 if not enabled). In some embodiments, if the criteria for displaying the first system user interface are not met, the computer system forgoes displaying the first system user interface (e.g., even if the first system user interface is enabled). Conditionally displaying a system user interface based on a particular type of input element not being enrolled for the computer system, such as a viewport-based user interface that is configured to be invoked using a different type of interaction (e.g., gaze or another attention metric instead of a user's hands), enables users who prefer not to or who are unable to use the particular type of input element to still use the computer system, which makes the computer system more accessible to a wider population.

In some embodiments, the first system user interface is (15014) a control user interface that provides access to a plurality of controls corresponding to different functions (e.g., system functions) of the computer system (e.g., as described herein with reference to methods 10000 and 11000). For example, in FIG. 7J3, the computer system displays the system function menu 7043 (e.g., a control user interface) which includes different affordances (e.g., a plurality of controls) for accessing different functions of the computer system (e.g., functionality for accessing: a home menu user interface, one or more additional system functions, one or more virtual experiences, one or more notifications, and/or a virtual display for a connected device). When a particular type of input element is not enrolled, enabling a user to access a control user interface using other types of interactions and/or input elements reduces the number of inputs and amount of time needed to display the control user interface and access different functions of the computer system and makes the computer system more accessible to a wider population.

In some embodiments, the computer system detects (15016), via the one or more input devices, that attention of a user is directed toward a respective region of a current viewport of the user (e.g., a predefined region of a particular display generation component). As used herein, attention of the user refers to gaze or a proxy for gaze, such as an attention metric based on a gaze, head direction, wrist direction, and/or other pointing manner of the user. the first set of one or more criteria include a requirement that the attention of the user is directed toward the respective region of the current viewport of the user in order for the first set of one or more criteria to be met. In some embodiments, the first system user interface is or includes a system function menu, or the first system user interface is or includes an indication of the system function menu. For example, in FIG. 7J1, the computer system 101 detects that the attention 7010 of the user 7002 is directed toward the region 7072. In FIG. 7J2, in response to detecting that the attention 7010 of the user 7002 is directed toward the region 7072, the computer system 101 displays the indication 7074 of the system function menu 7043. When a particular type of input element is not enrolled, enabling a user to access a system user interface using attention-based interaction instead of the particular type of input element makes the computer system more accessible to a wider population.

In some embodiments, while displaying the first system user interface, the computer system detects (15018), via the one or more input devices, a first user input that is performed while the attention of the user is directed toward the first system user interface. In some embodiments, detecting the first user input includes detecting a tap, air pinch, mouse click or other selection input. In some embodiments, detecting the first user input includes detecting that the attention of the user directed toward the first system user interface is maintained for at least a threshold amount of time (e.g., a dwell input). In response to detecting the first user input, the computer system displays, via the one or more display generation components, a control user interface (also called herein a system function menu, e.g., as described herein with reference to FIG. 7L and methods 10000 and 11000) that includes one or more controls for accessing functions of the computer system. For example, in FIG. 7J2, the computer system 101 also detects that the attention of the user is directed toward the indication 7074 of the system function menu 7043 (e.g., which is within the region 7072). In FIG. 7J3, in response to detecting that the attention 7010 of the user 7002 is directed toward the indication 7074 of the system function menu 7043, the computer system 101 displays the system function menu 7043. Enabling a user to access a control user interface when another system user interface is conditionally enabled due to a particular type of input element not being enrolled enables users who have not enrolled the particular type of input element to still use and control the computer system, which makes the computer system more accessible to a wider population.

In some embodiments, while the computer system is in the setup configuration state and after forgoing enabling display of the first system user interface in accordance with the determination that data corresponding to the first type of input element is enrolled for the computer system, the computer system detects (15020), via the one or more input devices, an input corresponding to a request to enable the first system user interface (e.g., a tap, air pinch, mouse click or other selection input directed toward a control in a settings user interface for enabling the first system user interface). In response to detecting the input corresponding to the request to enable the first system user interface, the computer system enables display of (e.g., and optionally displaying) the first system user interface (e.g., even though data corresponding to the first type of input element is enrolled for the computer system). In some embodiments, while the computer system is not (e.g., is no longer) in the setup configuration state, if display of the first system user interface has been enabled, the criteria for displaying the first system user interface being met invokes the first system user interface (e.g., even if data corresponding to the first type of input element is enrolled). For example, as described with reference to FIG. 7J3, in some embodiments, the indication 7074 of the system function menu 7043 and/or the system function menu 7043 is also accessible when the computer system 101 determines that data is stored for the hands of the current user (e.g., the computer system 101 determines that data is stored for the hand 7020 and/or the hand 7022 of the user 7002; and/or the computer system 101 determines that the hand 7020 and/or the hand 7022 are enrolled for the computer system 101). In some embodiments, if data is stored for the hand 7020 and/or the hand 7022, the user 7002 enables and/or configures (e.g., manually enables and/or manually configures) the computer system to allow access to the system function menu 7043. In some embodiments, if the computer system 101 determines that data is stored for the hands of the current user, the computer system 101 disables access to the system function menu 7043 via the indication 7074 of the system function menu 7043, and/or does not display the indication 7074 of the system function menu, by default. The user 7002 can override this default by manually enabling access to the system function menu 7043 (e.g., and/or enabling display of the indication 7047 of the system function menu 7043), for example, via a settings user interface of the computer system 101. Allowing users who have enrolled a particular type of input element to also enable a system user interface that is typically used by users who have not enrolled the particular type of input element provides users with additional control options that the users may find to be more ergonomic, which makes using the computer system easier and more efficient.

In some embodiments, the first system user interface (e.g., the viewport-based control user interface) provides (15022) access to a first plurality of controls corresponding to different functions of the computer system (e.g., the first system user interface is a respective control user interface that includes the first plurality of controls; or further interaction with the first system user interface is required to cause the computer system to present (e.g., display, describe with audio, and/or other manner of non-visual output of) the respective control user interface including the first plurality of controls, where optionally the first system user interface is an indication of the respective control user interface). After enrolling the one or more input elements, while the computer system is not in the configuration state, in accordance with a determination that a second set of one or more criteria are met (e.g., including a requirement that data corresponding to the first type of input element is enrolled; a requirement that the attention of the user is directed toward a location of a particular portion of the first type of input element; and/or a requirement that display of the first system user interface is not enabled), wherein the second set of one or more criteria is different from the first set of one or more criteria (e.g., and optionally in accordance with a determination that the first set of one or more criteria are not met), the computer system displays, via the one or more display generation components, a second system user interface (e.g., the hand-based control user interface) that provides access to a second plurality of controls corresponding to different functions of the computer system, wherein the second plurality of controls includes one or more of the first plurality of controls. In some embodiments, the second set of one or more criteria are criteria for displaying a hand-based control user interface that is displayed based on attention directed to a particular portion of a hand of the user. In some embodiments, the second system user interface includes one or more of the same controls corresponding to different functions of the computer system that were accessible via the first system user interface (e.g., the second system user interface is the control user interface of other methods described herein, including method 11000, which is optionally different from the respective control user interface to which the first system user interface provides access). In some embodiments, interaction with the second system user interface results in display of the second plurality of controls corresponding to different functions of the computer system (e.g., the second system user interface is the control or the status user interface described herein with reference to other methods described herein, including methods 10000 and 11000). For example, the system function menu 7044 in FIG. 7L (e.g., which is accessible via performing an air pinch gesture while the hand-based status user interface 7032 is displayed in FIG. 7K) includes the affordance 7046, the affordance 7048, and the affordance 7052, which are also included in the system function menu 7043 in FIG. 7J3 (e.g., which is accessible via the viewport-based indication 7074 in FIG. 7J2). Allowing users who have not enrolled a particular type of input element to access a same or similar control user interface to that which is typically available to users who have enrolled the particular type of input element enables users who have not enrolled the particular type of input element to still use and control the computer system, which makes the computer system more accessible to a wider population.

In some embodiments, the first plurality of controls and the second plurality of controls differ (15024) by at least one control. In some embodiments, the first system user interface includes (or provides access to) at least one control that is not included in (or accessible via) the second system user interface, and/or the second system user interface includes (or provides access to) at least one control that is not included in (or accessible via) the first system user interface. For example, the system function menu 7043 of FIG. 7J3 includes the affordance 7041, which is not included in the system function menu 7044 of FIG. 7L. The system function menu 7044 includes the affordance 7050, which is not included in the system function menu 7043. Providing at least some different controls to users who have not enrolled a particular type of input element than those which are typically available to users who have enrolled the particular type of input element allows the computer system to provide users who use other types of interactions and/or input elements with additional and/or more relevant control options, which reduces the amount of time and number of inputs needed to perform operations on the computer system and makes the computer system more accessible to a wider population.

In some embodiments, the first plurality of controls includes (15026) a first control; the first control, when activated, causes the computer system to display, via the one or more display generation components, a third system user interface; and the second plurality of controls does not include the first control. In some embodiments, the third system user interface includes a plurality of application affordances. In some embodiments, the third system user interface is a home screen or home menu user interface. In some embodiments, in response to detecting a user input activating a respective application affordance of the plurality of application affordances, the computer system displays an application user interface corresponding to the respective application (e.g., the respective application affordance is an application launch affordance and/or an application icon for launching, opening, and/or otherwise causing display of a respective application user interface). In some embodiments, the first control (e.g., a control that, when activated, causes the computer system to display the third system user interface) is included in both the first plurality of controls and the second plurality of controls, such that the first control is available (e.g., in both the viewport-based control user interface and the hand-based control user interface) regardless of whether the first type of input element is being used for interaction or not. For example, the system function menu 7043 in FIG. 7J3 includes the affordance 7041 (e.g., for accessing a home menu user interface), and the system function menu 7044 in FIG. 7L does not include the affordance 7041 (e.g., because the home menu user interface is otherwise accessible via the control 7030, rather than the system function menu 7044). Providing at least some different controls to users who have not enrolled a particular type of input element than those which are typically available to users who have enrolled the particular type of input element allows the computer system to provide users who use other types of interactions and/or input elements with additional and more relevant control options, which might otherwise not be easily accessed, which reduces the amount of time and number of inputs needed to perform operations on the computer system and makes the computer system more accessible to a wider population.

In some embodiments, the second plurality of controls includes (15028) a second control; the second control, when activated, causes the computer system to display, via the one or more display generation components, a virtual display that includes external content corresponding to another computer system that is in communication with the computer system; and the first plurality of controls does not include the second control. For example, the system function menu 7044 of FIG. 7L includes the affordance 7050 (e.g., for displaying a virtual display for a connected device or an external computer system, such as a laptop or desktop), which is not included in the system function menu 7043 of FIG. 7J3. Providing at least some different controls to users who have not enrolled a particular type of input element than those which are typically available to users who have enrolled the particular type of input element allows the computer system to forgo providing users who use other types of interactions and/or input elements with control options that are less relevant, which avoids unnecessarily displaying additional controls and makes the computer system more accessible to a wider population.

In some embodiments, in accordance with a determination that the first system user interface is enabled and the second system user interface is enabled (e.g., because the second system user interface is enabled in accordance with a determination that the first type of input element is enrolled, and because the first system user interface, although disabled by default during configuration if the first type of input element is enrolled, was enabled by the user overriding the default), the first plurality of controls (e.g., in or accessed through the first system user interface, such as the viewport-based control user interface) is (15030) the same as the second plurality of controls (e.g., in or accessed through the second system user interface, such as the hand-based control user interface). In some embodiments, the first system user interface includes the same controls as the second system user interface. In some embodiments, in accordance with a determination that the first system user interface is enabled and the second user interface is not enabled (e.g., because the first system user interface is enabled (e.g., by default during configuration) in accordance with a determination that the first type of input element is not enrolled, and because the second system user interface is not enabled due to the first type of input element not being enrolled), the first plurality of controls is different than the second plurality of controls (e.g., the first system user interface includes at least one control that is not included in the second system user interface, and/or the second system user interface includes at least one control that is not included in the first system user interface). For example, as described with reference to FIG. 7K, in some embodiments, the system function menu 7044 of FIG. 7L is the same as the system function menu 7043 of FIG. 7J3 (e.g., both the system function menu 7043 and the system function menu 7044 include the same set of affordances shown in FIG. 7J3, or the same set of affordances shown in FIG. 7L). For users who have enrolled a particular type of input element and also enabled a system user interface that is typically used by users who have not enrolled the particular type of input element, providing the same controls in the control user interface that is accessed using the particular type of input element as in the control user interface that is accessed using other types of interactions and/or input elements provides consistency across user interfaces that reduces the amount of time and number of inputs needed to perform operations on the computer system. In contrast, providing at least some different controls to users who have not enrolled the particular type of input element allows the computer system to provide users who use the other types of interactions and/or input elements with more relevant control options, which reduces the amount of time and number of inputs needed to perform operations on the computer system and makes the computer system more accessible to a wider population.

In some embodiments, the first type of input element is (15032) a biometric feature (e.g., one or more eyes, one or more hands, one or more arms, a head, a face, or a torso of the user). For example, in FIGS. 7J2-7J3, the biometric feature is one or more hands of the user 7002 (e.g., the hand 7022). Because the hands of the user 7002 are not enrolled, the computer system 101 enables the first system user interface (e.g., the indication 7074 of the system function menu 7043 and/or the system function menu 7043), which is accessible via a different type of input element (e.g., one or more eyes of the user 7002, or a gaze (or other proxy for gaze) of the user 7002, represented by the attention 7010 of the user 7002). Conditionally displaying a system user interface if a user has not enrolled a particular biometric feature enables users who prefer not to or who are unable to provide inputs using the biometric feature to still use the computer system, which makes the computer system more accessible to a wider population.

In some embodiments, the biometric feature is (15034) a hand of the user. For example, in FIGS. 7J2-7J3, the biometric feature is one or more hands of the user 7002 (e.g., the hand 7022). Because the hands of the user 7002 are not enrolled, the computer system 101 enables the first system user interface (e.g., the indication 7074 of the system function menu 7043 and/or the system function menu 7043), which is accessible via a different type of input element (e.g., one or more eyes of the user 7002, or a gaze (or other proxy for gaze) of the user 7002, represented by the attention 7010 of the user 7002). Conditionally displaying a system user interface if a user has not enrolled one or more hands enables users who prefer not to or who are unable to provide hand-based inputs to still use the computer system, which makes the computer system more accessible to a wider population.

In some embodiments, after enrolling the one or more input elements, while the computer system is not in the configuration state, and in accordance with a determination that a second set of one or more criteria are met (e.g., criteria for displaying the hand-based control user interface), the computer system displays (15036) a second system user interface with a respective spatial relationship to the biometric feature (e.g., regardless of movement and/or positioning of the biometric feature), wherein the second set of one or more criteria is different from the first set of one or more criteria, and the second system user interface is different from the first system user interface. In some embodiments, displaying the second system user interface with the respective spatial relationship to the biometric feature includes displaying the second system user interface near and/or in proximity to the biometric feature (e.g., close enough to be comfortably viewed concurrently with the biometric feature, and optionally with an offset to avoid occlusion or obscuring of the biometric feature). In some embodiments, the second system user interface is the control or the status user interface of methods 10000 and 11000. In some embodiments, the criteria for displaying the second system user interface are the criteria for displaying the control or the status user interface, as described herein with reference to methods 10000 and 11000. For example, in FIG. 7Q1, first criteria are met (e.g., the attention 7010 of the user 7002 is directed toward the hand 7022′ while the hand 7022′ is in the “palm up” orientation), and the computer system displays a system user interface (e.g., the control 7030) with a respective spatial relationship to the hand 7022′ (e.g., with a location and offset, as described in more detail herein with reference to FIG. 7Q1). Displaying a system user interface corresponding to a biometric feature that is a particular type of input element near the biometric feature reduces the amount of time and number of inputs needed to locate the system user interface and perform associated operations on the computer system using the particular type of input element.

In some embodiments, after enrolling the one or more input elements, while the computer system is not in the configuration state, and in accordance with a determination that a second set of one or more criteria are met (e.g., criteria for displaying the hand-based control user interface), wherein the second set of one or more criteria is different from the first set of one or more criteria and includes a requirement that a view of the biometric feature (e.g., a view of a hand) is visible (e.g., displayed or visible in passthrough) in a current viewport of the user in order for the second set of one or more criteria to be met, the computer system displays (15038) a second system user interface (e.g., corresponding to the view of the biometric feature) that is different from the first system user interface. In some embodiments, displaying the second system user interface with the respective spatial relationship to the biometric feature includes displaying the second system user interface near and/or in proximity to the biometric feature (e.g., close enough to be comfortably viewed concurrently with the biometric feature, and optionally with an offset to avoid occlusion or obscuring of the biometric feature). In some embodiments, the second system user interface is the control or the status user interface of methods 10000 and 11000, which in some embodiments is displayed based on whether a view of a hand of a user is visible or displayed in a current viewport of the user, as described herein with reference to methods 10000 and 11000. For example, in FIG. 7Q1, the hand 7022′ (e.g., a representation of the hand 7022 and/or a view of the hand 7022) is visible in the current viewpoint (e.g., visible via the display generation component 7100a), and the attention 7010 of the user 7002 is directed toward the hand 7022′, and in response, the computer system 101 displays the control 7030. Displaying a system user interface corresponding to a biometric feature that is a particular type of input element near the biometric feature based on the biometric feature being visible within a current viewport of the user reduces the amount of time and number of inputs needed to locate the system user interface and perform associated operations on the computer system using the particular type of input element.

In some embodiments, display of the first system user interface is enabled (e.g., because data corresponding to the first type of input element was not enrolled for the computer system while the computer system was in the setup configuration state). While a view of an environment (e.g., a two-dimensional or three-dimensional environment that includes one or more virtual objects and/or one or more representations of physical objects) is visible via the one or more display generation components (e.g., using AR, VR, MR, virtual passthrough or optical passthrough), the computer system detects (15040), via the one or more input devices, one or more user inputs (e.g., one or more taps, swipes, air pinches, air pinch and drags, mouse clicks, mouse drags, and or other inputs). In response to detecting the one or more user inputs: in accordance with a determination that the one or more user inputs meet the first set of one or more criteria (e.g., for invoking display of the first system user interface), the computer system displays, via the one or more display generation components, the first system user interface (e.g., the viewport-based control user interface); and in accordance with a determination that the one or more user inputs meet a second set of one or more criteria (e.g., for invoking display of a different system user interface than the first system user interface) different from the first set of one or more criteria, the computer system displays, via the one or more display generation components, a second system user interface (e.g., the hand-based control user interface) corresponding to the first type of input element. Examples of user inputs that meet criteria for displaying the hand-based control user interface are described with reference to method 11000. For example, as described with reference to FIG. 7L, in some embodiments, if the computer system 101 determines that data is stored for the hands of the current user, the computer system 101 disables access to the system function menu 7043 via the indication 7074 of the system function menu 7043, and/or does not display the indication 7074 of the system function menu, by default. The user 7002 can override this default by manually enabling access to the system function menu 7043 (e.g., and/or enabling display of the indication 7074 of the system function menu 7043), for example, via a settings user interface of the computer system 101 As described with reference to FIG. 7J3, in some embodiments, the system function menu 7044 (e.g., accessed via the hand 7022′ of the user 7002) is the same as the system function menu 7043 (e.g., accessed via the gaze of the user 7002), and in some embodiments, the system function menu 7044 is different than the system function menu 7043. Displaying a second system user interface corresponding to the first type of input element in accordance with a determination that the one or more user inputs meet a second set of one or more criteria, and displaying a first system user interface in accordance with a determination that the one or more user inputs meet a first set of one or more criteria, reduces the number of user inputs needed to access functions of the computer system (e.g., the user does not need to manually enable and/or disable user inputs meeting the first and/or second sets of one or more criteria) and automatically displays a contextually appropriate system user interface without requiring additional user inputs.

In some embodiments, while the computer system is in the configuration state enrolling one or more input elements, and in accordance with the determination that data corresponding to the first type of input element is enrolled (e.g., such that the computer system forgoes enabling the first system user interface, at least by default), the computer system displays (15042), via the one or more display generation components, instructions for interacting with the computer system via the first type of input element. For example, if the first type of input element is a hand of the user, the computer system displays instructions (e.g., as part of a tutorial) for performing one or more user inputs (e.g., hand gestures) with the hand (e.g., and optionally, includes a description of what functions are performed in response to detecting a respective gesture performed with the hand). For example, in FIG. 7E, the computer system 101 displays the user interface 7028-a, which include instructions for interacting with the computer system 101. FIG. 7F shows additional examples of different user interfaces with different instructions for different user interaction with the computer system 101. As described with reference to FIG. 7F, in some embodiments, the user interface 7028-a, the user interface 7028-b, and/or the user interface 7082-c are only displayed if the computer system 101 detects that data is stored for the hands of the current user (e.g., the computer system 101 detects that data is stored for the hand 7020 and/or the hand 7022 of the user 7002, while the user 7002 and/or the hand 7020 and/or the hand 7022 of the user 7002 are enrolled for the computer system 101). In some embodiments, if the computer system 101 detects that no data is stored for the hands of the current user (e.g., the current user's hands are not enrolled for the computer system 101), the computer system 101 does not display the user interface 7028-a, the user interface 7028-b, and/or the user interface 7082-c. Conditionally displaying instructions for interacting with the computer system using a particular type of input element that is enrolled, and not if the particular type of input element is not enrolled, helps limit the amount of displayed information to what is relevant for the types of interactions and/or input elements that the user has configured the computer system to use, which provides feedback about a state of the computer system.

In some embodiments, the configuration state is (15044) an initial setup state for the computer system (e.g., a state of the computer system when the user is using the computer system for the first time). For example, as described with reference to FIG. 7F, in some embodiments, the user interface 7028-a, the user interface 7028-b, and the user interface 7028-c are displayed during an initial setup state or configuration state for the computer system 101 (e.g., the computer system 101 is in the same initial setup state or configuration state in FIGS. 7E-7N as in FIGS. 7C-7D). Displaying instructions for interacting with the computer system using particular types of interactions and/or input elements during initial setup of the computer system informs users as to how to use the computer system (e.g., at the outset of using the computer system), which reduces the amount of time and number of inputs needed to perform operations on the computer system.

In some embodiments, the configuration state is (15046) a setup state following a software update (e.g., an operating system update) for the computer system (e.g., the computer system enters the configuration state following the software update and prior to allowing a user to use the computer system outside of the configuration state). For example, as described with reference to FIG. 7F, in some embodiments, the user interface 7028-a, the user interface 7028-b, and the user interface 7028-c are displayed during a configuration state that follows a software update. Displaying instructions for interacting with the computer system using particular types of interactions and/or input elements following a software update of the computer system informs users as to how to use the computer system (e.g., when the software update has changed features of the computer system, and/or as a reminder), which reduces the amount of time and number of inputs needed to perform operations on the computer system.

In some embodiments, while the computer system is in the configuration state enrolling one or more input elements, the computer system detects (15048), via the one or more input devices, that attention (e.g., based on gaze or a proxy for gaze) of the user is directed toward a location of the first type of input element (e.g., a location and/or view of a hand of the user, which optionally must be in a first orientation with a palm of the hand facing toward a viewpoint of the user). In response to detecting that the attention of the user is directed toward the location of the first type of input element: in accordance with a determination that the instructions for interacting with the computer system via the first type of input element are displayed (e.g., or have previously been displayed while in the configuration state), the computer system displays, via the one or more display generation components, a user interface (e.g., the second system user interface such as the hand-based control user interface) corresponding to the first type of input element (e.g., a control or a status user interface corresponding for example to a hand of the user, as described herein with reference to method 11000); and in accordance with a determination that the instructions for interacting with the computer system via the first type of input element are not displayed (e.g., or have not yet been displayed while in the configuration state), the computer system forgoes displaying the user interface corresponding to the first type of input element. For example, as described with reference to FIG. 7G, in some embodiments, the control 7030 is not displayed, even if the computer system 101 detects that the attention 7010 of the user 7002 is directed toward the hand 7022′ while the hand 7022′ is in the “palm up” orientation, before the computer system 101 displays (e.g., for a first time, during or following a setup or configuration state, or following a software update) the user interface 7028-a . . . . For example, as described with reference to FIG. 7H, in some embodiments, the status user interface 7032 is not displayed, even if the computer system 101 detects that the attention 7010 of the user 7002 is directed toward the hand 7022′ during a hand flip from the “palm up” orientation to the “palm down” orientation, before the computer system 101 displays (e.g., for a first time, during or following a setup or configuration state, or following a software update) the user interface 7028-b. Forgoing displaying the user interface corresponding to the first type of input element, in accordance with a determination that the instructions for interacting with the computer system via the first type of input element are not displayed or have not yet been displayed, reduces the risk of accidental and unintentional activation of functions of the computer system (e.g., via different types of user inputs which are not familiar and/or have not yet been explained to the user) and reduces the number of user inputs needed to configure the computer system (e.g., the user does not need to perform additional user inputs, some of which the user may be unfamiliar with, to return to and/or redisplay user interfaces directly related to configuration of the computer system in the configuration state, if the user navigates away from said user interfaces by accidentally triggering operations corresponding to the user interface corresponding to the first type of input element).

In some embodiments, while the computer system is in the configuration state enrolling one or more input elements, and while the attention of the user is directed toward a location of the first type of input element (e.g., a hand of the user, optionally while the hand of the user is in a first orientation with a palm of the hand facing toward a viewpoint of the user, and optionally while displaying the user interface corresponding to the first type of input element), the computer system detects (15050), via the one or more input devices, a second user input. In response to detecting the second user input, the computer system forgoes displaying a second system user interface (e.g., an application launching user interface such as a home menu user interface, a notifications user interface, an application launching user interface, a multitasking user interface, a control user interface, and/or other operation system user interface) that is different than the user interface corresponding to the first type of input element. In some embodiments, after the one or more input elements are enrolled, while the computer system is not in the configuration state, and while the attention of the user is directed toward a location of the first type of input element and while optionally displaying the user interface corresponding to the first type of input element (e.g., if a second set of one or more criteria are met including that data corresponding to the first type of input element is enrolled and/or that the attention of the user is directed toward a location of the first type of input element), the computer system detects an input and, in response, displays the second system user interface (e.g., the second system user interface can be invoked outside of the configuration state but not while in the configuration state). For example, as described with reference to the example 7094 of FIG. 7P, while (e.g., and because) the user interface 7028-a is displayed, the computer system 101 does not perform a function (e.g., a system operation, such as displaying a home menu user interface 7031) in response to detecting an air pinch gesture performed by the hand (e.g., even if the air pinch gesture is detected while the attention 7010 of the user 7002 is directed toward the hand 7022′, while the hand 7022′ is in the “palm up” orientation). Forgoing displaying the second system user interface while the computer system is in the configuration state reduces the risk of accidental and incorrect display of system user interfaces (e.g., of the control user interface) while the computer system is in the configuration state (e.g., and while the user is becoming familiar with different ways of interacting with the computer system) and reduces the number of user inputs needed to configure the computer system (e.g., the user does not need to perform additional user inputs to return to and/or redisplay user interfaces directly related to configuration of the computer system in the configuration state, if the user navigates away from said user interfaces by displaying the second system user interface).

In some embodiments, while the computer system is in the configuration state enrolling one or more input elements, and while the attention of the user is directed toward a location of the first type of input element (e.g., a hand of the user, optionally while the hand of the user is in a first orientation with the palm of the hand facing toward a viewpoint of the user, and optionally while displaying the user interface corresponding to the first type of input element, the computer system detects (15052), via the one or more input devices, a third user input (e.g., including detecting a change in orientation of the first type of input element, such as a change in orientation of the hand of the user from the first orientation with the palm of the hand facing toward the viewpoint of the user to a second orientation with the palm of the hand facing away from the viewpoint of the user). In response to detecting the third user input, the computer system displays, via the one or more display generation components, a control user interface that includes one or more controls for accessing functions of the computer system. The computer system detects an input (e.g., any of the types of inputs described herein such as a selection input like an air tap gesture or an air pinch gesture) directed to a respective control of the one or more controls in the control user interface. In response to detecting input directed to the respective control, the computer system forgoes performing a respective operation corresponding to the respective control. In some embodiments, after the one or more input elements are enrolled, while the computer system is not in the configuration state, the computer system detects an input directed to a respective control of the one or more controls in the control user interface (e.g., the second plurality of controls described herein with reference to the second system user interface that is optionally the hand-based control user interface) and, in response, performs a corresponding operation so as to provide access to a respective function of the computer system (e.g., the controls in the control user interface are functional outside of the configuration state but not while in the configuration state). For example, as described with reference to FIG. 7L, in some embodiments, while the user interface 7028-b is displayed (e.g., and/or while the user interface 7028-a and/or the user interface 7028-c are displayed), the computer system 101 enables access to the system function menu 7044 as described above, but the affordance 7046, the affordance 7048, the affordance 7050, the affordance 7052, and/or the volume indicator 7054 are not enabled for user interaction (e.g., and optionally, are enabled for user interaction (e.g., to trigger performance of a corresponding operation and/or display of a corresponding user interface) after the computer system 101 ceases to display the user interface 7028-a, the user interface 7028-b, or the user interface 7028-c, outside of the configuration state). Forgoing performing a respective operation corresponding to a respective control, in response to detecting a user input directed to the respective control while the computer system is in the configuration state, reduces the risk of accidental and incorrect activation of controls (e.g., of the control user interface) while the computer system is in the configuration state (e.g., and while the user is becoming familiar with different ways of interacting with the computer system) and reduces the number of user inputs needed to configure the computer system (e.g., the user does not need to perform additional user inputs to return to and/or redisplay user interfaces directly related to configuration of the computer system in the configuration state, if the user navigates away from said user interfaces by activating the respective control).

In some embodiments, while the computer system is in the configuration state enrolling one or more input elements, and while displaying the instructions for interacting with the computer system via the first type of input element and while the attention of the user is directed toward a location of the first type of input element, the computer system detects (15054), via the one or more input elements, a fourth user input that includes movement of the hand of the user (e.g., the sixth user input is a pinch and hold gesture, or another type of air gesture as described herein, performed while moving the hand of the user). In response to detecting the fourth user input, the computer system adjusts a respective volume level of the computer system in accordance with the movement of the hand of the user from a first value (e.g., a respective value that is a default volume level) to a second value that is different from the first value. In some embodiments, the hand of the user is required to be detected in a particular orientation in order for the computer system to adjust the respective volume level in accordance with the movement of the hand. For example, the computer system adjusts the respective volume level if the hand has a first orientation with the palm of the hand facing toward the viewpoint of the user, and forgoes adjusting the respective volume level if the hand has a second orientation with the palm of the hand facing away from the viewpoint of the user. In another example, the computer system adjusts the respective volume level if the hand has the second orientation with the palm of the hand facing away from the viewpoint of the user, and forgoes adjusting the respective volume level if the hand has the first orientation with the palm of the hand facing toward the viewpoint of the user. After adjusting the respective volume level of the computer system, the computer system detects a request to cease to display the instructions for interacting with the computer system via the first type of input element. In response to detecting the request to cease displaying the instructions for interacting with the computer system via the first type of input element, the computer system ceases to display the instructions for interacting with the computer system via the first type of input element and setting the respective volume level of the computer system to the first value (e.g., a predetermined, predefined, or default value, regardless of volume adjustment while the instructions for interacting with the computer system via the first type of input element were displayed). For example, as described with reference to FIG. 7H, in some embodiments, although the computer system 101 allows for adjustments to the volume level of the computer system 101 while the user interface 7028-a, the user interface 7028-b, and/or the user interface 7028-c are displayed, after ceasing to display the user interface 7028-a, the user interface 7028-b, and the user interface 7028-c (e.g., after the computer system 101 is no longer displaying instructions for performing gestures for interacting with the computer system 101; and/or after the computer system 101 is no longer in a setup or configuration state, in which the computer system 101 provides instructions for interacting with the computer system 101), the computer system 101 resets the current volume level of the computer system 101 to a default value (e.g., 50% volume). Setting the respective volume level of the computer system to the first value (e.g., a predetermined, predefined, or default volume) in response to detecting the request to cease displaying the instructions for interacting with the computer system via the first type of input element, reduces the risk of accidental and/or incorrect volume adjustment while a user is becoming familiar with different way of interacting with the computer system.

In some embodiments, while the computer system is in the configuration state enrolling one or more input elements, and while the attention of the user is directed toward a location of the first type of input element, the computer system detects (15056), via the one or more input elements, a fifth user input that includes movement of the hand of the user (e.g., the seventh user input is a pinch and hold gesture, or another type of air gesture as described herein, performed while moving the hand of the user). In response to detecting the fifth user input, the computer system adjusts a respective volume level of the computer system in accordance with the movement of the hand of the user from a first value to a second value that is different from the first value, and the computer system outputs, via one or more audio output devices that are in communication with the computer system. Outputting the audio includes: while the respective volume level has the first value, outputting the audio at the first value for the respective volume level; and while the respective volume level has the second value, outputting the audio at the second value for the respective volume level (e.g., the computer system outputs ambient sound or other aural feedback regarding the second value of the respective volume). In some embodiments, the audio is continuous audio (e.g., that is output at a volume that is updated dynamically as the respective volume is adjusted through one or more intermediate values between the first value and the second value). For example, as described with reference to FIG. 7H, in some embodiments, while the user 7002 is adjusting the volume level of the computer system 101 (e.g., while the computer system 101 continues to detect the pinch and hold gesture), the computer system 101 outputs audio (e.g., continuous or repeating audio, such as ambient sound, a continuous sound, or a repeating sound) that changes in volume level as the volume level of the computer system is adjusted in accordance with movement of the pinch and hold gesture. Outputting audio at a first volume while the volume level has a first value, and outputting volume at a second volume while the volume level has a second value, provide audio feedback to the user regarding the current volume level, as the user is adjusting the current volume level.

In some embodiments, aspects/operations of methods 10000, 11000, 12000, 13000, 16000, 17000, and 18000 may be interchanged, substituted, and/or added between these methods. For example, the system user interfaces, such as the control, status user interface, control user interface, and respective volume level indication and/or volume level adjustment user interface that are conditionally displayed in the method 15000 are the same as and/or have one or more similar features to those described in the methods 10000, 11000, 13000, 16000, 17000, and/or 18000. For brevity, these details are not repeated here.

FIGS. 16A-16F are flow diagrams of an exemplary method 16000 for displaying a control for a computer system during or after movement of the user's hand, in accordance with some embodiments. In some embodiments, the method 16000 is performed at a computer system (e.g., computer system 101 in FIG. 1) that is in communication with one or more display generation components (e.g., a head-mounted display (HMD), a heads-up display, a display, a projector, a touchscreen, or other type of display) (e.g., display generation component 120 in FIGS. 1A, 3, and 4, or the display generation component 7100a in FIGS. 8A-8P) and one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c, the digital crown 703, and/or controller 7111 with buttons 7113, 7115, and/or 7117 in FIGS. 7A-7BE and 8A-8T).

While a view of an environment (e.g., a two-dimensional or three-dimensional environment that includes one or more virtual objects and/or one or more representations of physical objects) is visible via the one or more display generation components (e.g., using AR, VR, MR, virtual passthrough or optical passthrough), the computer system displays (16002), via the one or more display generation components, a user interface element corresponding to a location of a respective portion of a body (e.g., a finger, hand, arm, or foot) of a user (e.g., a control, status user interface, respective volume level indication, or other system user interface corresponding to the location and optionally a view of the hand, as described herein with reference to methods 10000, 11000, 12000, 13000, 15000, 16000, 17000, and 18000).

The computer system detects (16004), via the one or more input devices, movement (e.g., geometric translation) of the respective portion of the body of the user (e.g., in a physical environment corresponding to the environment that is visible via the one or more display generation components) corresponding to movement from a first location in the environment to a second location in the environment. The second location is different from the first location; and in some embodiments, the detected movement of the hand is from a first physical location to a second physical location that is different from the first physical location, wherein the first physical location corresponds to the first location in the environment, and the second physical location corresponds to the second location in the environment.

In response to detecting (16006) the movement of the respective portion of the body of the user: in accordance with a determination that the movement of the respective portion of the body of the user meets first movement criteria, the computer system moves (16008) the first user interface element relative to the environment in accordance with one or more movement parameters (e.g., distance, velocity, acceleration, direction, and/or other parameter) of the movement of the respective portion of the body of the user (e.g., the user interface element is moved (e.g., translated and/or rotated) relative to the environment by an amount that is based on an amount (e.g., magnitude) of movement of the hand, where a larger amount of movement of the hand causes a larger amount of movement of the user interface element, and a smaller amount of movement of the hand causes a smaller amount of movement of the user interface element, and movement of the hand toward a first direction causes movement of the user interface element toward the first direction (or a third direction different from the first direction) whereas movement of the hand toward a second direction different from (e.g., opposite) the first direction causes movement of the user interface element toward the second direction (or a fourth direction different from the second direction and different from (e.g., opposite) the third direction).

In response to detecting (16006) the movement of the respective portion of the body of the user: in accordance with a determination that the movement of the respective portion of the body of the user meets second movement criteria that are different from the first movement criteria, the computer system ceases (16010) to display the user interface element corresponding to the location of the respective portion of the body of the user (e.g., during the movement of the respective portion of the body of the user).

For example, as described with reference to FIG. 7R1, the control 7030 moves to maintain the same spatial relationship between the control 7030 and the hand 7022′ when the velocity of the hand 7022′ moving from an old position shown as an outline 7098 in FIG. 7R1 to a new position (e.g., the position shown in FIG. 7R1) is below velocity threshold vₜₕ₁. In FIG. 7T, the control 7030 ceases to be displayed when the velocity of the hand 7022′ is above velocity threshold vₜₕ₂. Requiring that the user's hand be moving less than a threshold amount and/or with lower than a threshold speed in order to enable displaying a control corresponding to a location/view of the hand in response to the user directing attention toward the location/view of the hand causes the computer system to automatically suppress display of the control and reduce the chance of the user unintentionally triggering display of the control when the user is indicating intent to interact with the computer system in a different manner and in circumstances that would make it difficult to locate and interact with the control.

In some embodiments, in accordance with a determination that the movement of the respective portion of the body of the user meets third movement criteria, wherein the third movement criteria are different from the first movement criteria and the second movement criteria, the computer system maintains (16012) display of the user interface element without moving the first user interface element (e.g., maintaining display of the user interface element at an original position, wherein the original position is the position at which the user interface element was displayed prior to detecting the movement of the hand). In some embodiments, displaying the user interface element corresponding to the location of the respective portion of the body (e.g., and prior to detecting the movement of the hand) includes displaying the user interface element at an original location, and in accordance with a determination that the movement of the respective portion of the body of the user meets third movement criteria, wherein the third movement criteria are different from the first movement criteria and the second movement criteria, the computer system maintains display of the user interface element at the original location. For example, as described with reference to FIG. 7Q2, the control 7030 remains displayed at the same location when the movement of the hand 7022′ from an old position (e.g., shown as an outline 7176 in the first scenario 7198-1 of FIG. 7Q2) to a new position (e.g., the position shown in the first scenario 7198-1 of FIG. 7Q2) is below a movement threshold and/or a velocity threshold. Maintaining display of a control corresponding to a location/view of the hand without moving the control causes the computer system to automatically suppress noise when changes in a position of the hand of the user are too small and/or cannot be determined with sufficient accuracy, reducing unnecessary changes in the position of the control, and allowing the user to continue to interact with the control at a fixed location.

In some embodiments, the first movement criteria include (16014) a criterion that is met when the movement of the respective portion of the body of the user includes at least a first threshold amount of movement (e.g., 0.1 mm, 0.5 mm, 1 mm, 7 mm, 10 mm, 15 mm, 1 cm, or 5 cm). The second movement criteria include a criterion that is met when the movement of the respective portion of the body of the user includes at least the first threshold amount of movement (e.g., the first criteria and the second criteria include a common criterion, and the common criterion is met when the movement of the hand includes at least the first threshold amount of movement). The third movement criteria include a criterion that is met when the movement of the respective portion of the body of the user does not include the first threshold amount of movement (e.g., the third criteria include a criterion that is met when the movement of the hand is below the first threshold amount of movement). For example, the different movement criteria are described with reference to FIGS. 7Q2, 7R1, 7R2, and 7T. In FIG. 7R1 the control 7030 moves to maintain the same spatial relationship between the control 7030 and the hand 7022′, as the first movement criteria are met when the movement amount of the hand 7022′ is larger than a first threshold amount of movement (e.g., as illustrated in FIG. 7R1). In FIG. 7T, the control 7030 ceases to be displayed, as the second movement criteria are met when the change in the position of the hand 7022′ is larger than another threshold amount of movement that is larger than the first threshold amount of movement. In FIGS. 7Q2 and FIGS. 7R2, the control 7030 remains displayed at the same location, as the third movement criteria are met when the hand 7022′ moves from an old position (e.g., shown as an outline 7176 in first scenario 7198-1 of FIG. 7Q2, and as an outline 7188 in first scenario 7202-1 of FIG. 7R2) to a new position (e.g., the position shown in the first scenario 7198-1 of FIG. 7Q2 and the position shown in the first scenario 7202-1 of FIG. 7R2) is below a threshold amount of movement. Maintaining display of a control corresponding to a location/view of the hand without moving the control when the movement of the hand is below a threshold amount of movement (e.g., in contrast to updating the location of the control or ceasing display of the control when the movement of the hand is above the threshold amount of movement) causes the computer system to automatically suppress noise when changes in a position of the hand of the user are too small and/or cannot be determined with sufficient accuracy, reducing unnecessary changes in the position of the control, and allowing the user to continue to interact with the control. When the movement of the hand is above the threshold amount of movement, updating a display location of the control causes the computer system to automatically keep the control at a consistent and predictable location relative to the location/view of the hand, to reduce the amount of time needed for the user to locate and interact with the control, whereas ceasing display of the control automatically suppresses display of the control and reduces the chance of the user unintentionally triggering display of the control when the user is indicating intent to interact with the computer system in a different manner and in circumstances that would make it difficult to locate and interact with the control.

In some embodiments, while the movement of the respective portion of the body of the user includes movement at a first speed (e.g., or velocity), the first threshold amount of movement is (16016) a first threshold value; and while the movement of the respective portion of the body of the user includes movement at a second speed (e.g., or velocity) that is different from the first speed (e.g., or velocity), the first threshold amount of movement is a second threshold value that is different from the first threshold value. In some embodiments, when the respective portion of the body of the user (e.g., a hand of the user) is moving slowly, the threshold amount of movement is set to a large value (e.g., slow movement of the respective portion of the body of the user may include unintentional movement, so setting the threshold amount of movement to be a large value reduces the risk of jittering or other visual artifacts, that might occur as a result of trying to move the user interface element in accordance with small, unintentional movements). In some embodiments, when the respective portion of the body of the user is moving more quickly, the threshold amount of movement is set to a small value, or smaller value, relative to when the respective portion of the body of the user is moving slowly (e.g., fast movement of the hand is more likely to indicate intentional movement of the respective portion of the body of the user, so setting the threshold amount of movement to be a small value enables the computer system to move the user interface element in accordance with movement of the respective portion of the body of the user in a smoother and more responsive fashion). In some embodiments, the computer system does not move the user interface element until the computer system detects the first threshold amount of movement (e.g., 0.1 mm, 0.5 mm, 1 mm, 7 mm, 10 mm, 15 mm, 1 cm, or 5 cm), which defines a region (e.g., a spherical region, with a radius defined by the threshold amount of movement) around (e.g., centered on) the user interface element (e.g., and/or the respective portion of the body of the user), which is sometimes referred to herein as a “dead zone”). For example, as described with reference to FIGS. 7Q2 and 7R2, a zone 7186 around the control 7030 depicts the threshold amount of movement of the hand 7022′ required to change a display location of the control 7030. The zone 7186 in the first scenario 7202-1 (e.g., as illustrated in FIG. 7R2) is reduced in size with respect to the zone 7186 in the first scenario 7198-1 (e.g., as illustrated in FIG. 7Q2) due to the hand 7022′ in the first scenario 7202-1 of FIG. 7R2 moving at a higher speed than the hand 7022′ in first scenario 7198-1 of FIG. 7Q2. Changing a threshold value for the threshold amount of movement based on a speed of the hand causes the computer system to automatically display the control 7030 at a location that is more responsive to a change in direction of a hand that is moving at a sufficient speed, allowing the user to more easily locate and interact with the control.

In some embodiments, the second speed is (16018) greater than the first speed; and the second threshold value is less than the first threshold value. In some embodiments, after the movement of the respective portion of the body of the user exceeds the first threshold amount of movement at the first threshold value, the computer system decreases the first threshold amount of movement to the second threshold value for further (e.g., continued) movement of the respective portion of the body of the user. For example, as described with reference to FIG. 7Q2, a zone 7186 around the control 7030 depicts the threshold amount of movement of the hand 7022′ required to change a display location of the control 7030. The zone 7186 in the first scenario 7198-1 dynamically reduces in size with respect to the zone 7186 in the fourth scenario 7198-4 due to the hand 7022′ in the fourth scenario 7198-4 moving by an amount indicated by the arrow 7200 that is more than the threshold amount of movement. Changing a threshold value for the threshold amount of movement based on a speed or magnitude of movement of a hand causes the computer system to automatically display the control 7030 at a location that is more responsive to a change in direction of the hand that is moving at a sufficient speed or has moved through a sufficient distance, allowing the user to more easily locate and interact with the control.

In some embodiments, after detecting the movement of the respective portion of the body of the user, the computer detects (16020) a change in the movement of the respective portion of the body of the user (e.g., a continuation of the detected movement of the respective portion of the body of the user and/or stopping of the detected movement); and in response to detecting the change in the movement of the respective portion of the body of the user: in accordance with a determination that the change in the movement of the respective portion of the body of the user causes the movement of the respective portion of the body of the user to not meet the first threshold amount of movement, the computer system increases a respective value of the first threshold amount of movement. For example, in response to detecting that a speed of the movement of the hand increases to at least the second speed, the computer system automatically adjusts the first threshold amount of movement to be the second threshold value (e.g., and maintains the second threshold value as the first threshold amount of movement while the speed of the hand remains at least the second speed). If the speed of the movement of the hand drops below the second speed (e.g., and/or stops), the computer system automatically adjusts the first threshold amount to be the first threshold value (e.g., and maintains the first threshold value as the first threshold amount of movement while the speed of the hand remains below the second speed). For example, as described with reference to FIG. 7Q2, the zone 7186 expands (e.g., going from the zone 7186 depicted in the fourth scenario 7198-4 to the zone 7186 depicted in the third scenario 7198-3) when a movement of the hand 7022′ has been below a threshold speed for a threshold period of time, and/or the hand 7022′ stops moving (e.g., less than 0.1 m/s of movement for 500 ms, less than 0.075 m/s of movement for 200 ms, or less than a different speed threshold and/or a time threshold). Increasing a threshold value for the threshold amount of movement based on movement of the hand slowing or stopping causes the computer system to automatically suppress noise when changes in a position of the hand of the user are too small and/or cannot be determined with sufficient accuracy, reducing unnecessary changes in the position of the control, and allowing the user to continue to interact with the control.

In some embodiments, the first threshold amount of movement (e.g., and/or the second threshold amount of movement) is (16022) based on a rate of movement oscillation (e.g., based at least in part on movement of the hand in a first direction and a second direction that is opposite the first direction). For example, as described with reference to FIG. 7Q2, the threshold amount of movement to trigger movement of the control 7030 depends on a rate or frequency of movement oscillation of the hand 7022′. In response to detecting fast movements in the hand 7022′, the computer system 101 sets a larger threshold amount of movement before a display location of the control 7030 is updated. Setting a threshold value for the threshold amount of movement based on a rate of movement oscillation of the hand causes the computer system to automatically suppress noise when changes in a position of the hand of the user are too small and/or too frequent and/or cannot be determined with sufficient accuracy, reducing unnecessary changes in the position of the control, and allowing the user to continue to interact with the control.

In some embodiments, the first threshold amount of movement is (16024) measured in three dimensions (e.g., x, y, and z dimensions, or left/right, up/down, and backward/forward in depth). In some embodiments, the first threshold amount of movement defines the radius of a sphere, and movement of the hand beyond the defined sphere causes the computer system to move the user interface element in accordance with movement of the hand. For example, as described with reference to FIG. 7Q2, the zone 7186 is a three-dimensional zone (e.g., a sphere having a planar/circular cross section as depicted in FIG. 7Q2, and/or other three-dimensional shapes) and accounts for movement of the hand 7022 along three dimensions (e.g., three orthogonal dimensions). Accounting for movement measured in three dimensions causes the computer system to be more responsive in updating the display location of the control based on the movement in one or more of the three dimensions, allowing the user to continue to interact with the control independently of the specific direction of the movement of the hand.

In some embodiments, the first threshold distance is (16026) measured relative to a predefined location (e.g., a predefined location defined relative to the display generation component; or a predefined location defined relative to a portion of the body of the user). For example, as described with reference to FIG. 7Q2, the threshold amount of movement required to move the control 7030 outside of its original zone 7186 is measured relative to an environment-locked point (e.g., a center of a circle or sphere, or another plane or volume within the physical environment 7000, selected when the hand 7022′ remains stationary beyond a threshold period of time), such that even if the user's viewpoint and gaze were to change during the movement of the hand 7022′, the amount of movement of the hand 7022′ would only be measured with respect to the environment-locked point. Measuring the threshold amount of movement relative to a predefined location in three dimensions allows the computer system to be more responsive to movement changes in the hand without having to account for changes in the position of the hand due to movement of the viewpoint and/or gaze of the user.

In some embodiments, the first criteria include (16028) a criterion that is met when the movement of the respective portion of the body of the user includes movement of the respective portion of the body of the user at a velocity that is below a first velocity threshold; and the second movement criteria include a criterion that is met when the movement of the respective portion of the body of the user includes movement of the respective portion of the body of the user at a velocity that is above the first velocity threshold. For example, as described with respect to FIG. 7T, the control 7030 ceases to be displayed when the velocity of the hand 7022′ is above velocity threshold vₜₕ₂. Similarly, if the hand 7022′ has a movement speed that is above a velocity threshold for a time interval preceding the detection of the attention 7010 being directed to the hand 7022′, the computer system 101 forgoes displaying the control 7030. Requiring that the user's hand be moving less than a threshold speed in order to enable displaying a control corresponding to a location/view of the hand in response to the user directing attention toward the location/view of the hand causes the computer system to automatically suppress display of the control and reduce the chance of the user unintentionally triggering display of the control when the user is indicating intent to interact with the computer system in a different manner and in circumstances that would make it difficult to locate and interact with the control.

In some embodiments, while moving the first user interface element relative to the environment in accordance with the one or more movement parameters of the movement of the respective portion of the body of the user (e.g., while the movement of the respective portion of the body of the user meets the first movement criteria), the computer system detects (16030), via the one or more input devices, that the movement of the respective portion of the body of the user meets the second criteria (e.g., the movement of the respective portion of the body of the user initially does not meet the second movement criteria, but the computer system detects a change in the movement of the respective portion of the body of the user, such that the movement of the respective portion of the body of the user now meets the second movement criteria); and in response to detecting that the movement of the respective portion of the body of the user meets the second movement criteria, the computer system ceases to display the user interface element corresponding to the location of the respective portion of the body of the user. In some embodiments, the movement of the respective portion of the body of the user initially meets the first movement criteria without meeting second movement criteria (e.g., and the computer system moves the first user interface element relative to the environment). Subsequently, the movement of the respective portion of the body of the user meets the second movement criteria, and in response, the computer system ceases to display the user interface element. For example, as described with reference to a transition from FIGS. 7S to 7T, the computer system 101 updates a display location of the control 7030 (e.g., as illustrated in FIG. 7S) prior to ceasing display of the control 7030 (e.g., as illustrated in FIG. 7T). After moving the control in accordance with movement of the user's hand while the user's hand is moving less than a threshold amount and/or with lower than a threshold speed and optionally while the user is directing attention toward the location/view of the hand, which causes the computer system to automatically keep the control at a consistent and predictable location relative to the location/view of the hand, to reduce the amount of time needed for the user to locate and interact with the control, ceasing to display the control when the user's hand moves more than the threshold amount and/or with more than the threshold speed automatically suppresses display of the control and reduces the chance of the user unintentionally triggering display of the control when the user is indicating intent to interact with the computer system in a different manner and in circumstances that would make it difficult to locate and interact with the control.

In some embodiments, while moving the first user interface element relative to the environment in accordance with the one or more movement parameters of the movement of the respective portion of the body of the user (e.g., while the movement of the respective portion of the body of the user meets the first movement criteria), the computer system dynamically changes (16032) a first visual characteristic of the user interface element in accordance with a progress of the movement of the respective portion of the body of the user towards meeting the second movement criteria. For example, as described with reference to FIGS. 7S and 7T, the computer system 101 displays the control 7030 with an appearance that has a reduced prominence relative to the default appearance of the control 7030 when the velocity of the hand 7022′ is above the threshold velocity vₜₕ₁, but below a threshold velocity vₜₕ₂ (e.g., as illustrated in FIG. 7S), and ceases display of the control 7030 when the velocity of the hand 7022′ is above the threshold velocity vₜₕ₂ (e.g., as illustrated in FIG. 7T). Displaying the control at an updated location with reduced prominence prior to ceasing display of the control when the velocity of the hand is above a threshold speed causes the computer system to automatically provide visual feedback to the user, allowing the user to take corrective action if the user intends to interact with the computer system in a different manner, without displaying additional controls.

In some embodiments, after ceasing to display the user interface element corresponding to the location of the respective portion of the body of the user (e.g., in accordance with a determination that the movement of the respective portion of the body of the user meets the second movement criteria that are different from the first movement criteria), the computer system detects (16034), via the one or more input devices, that the movement of the respective portion of the body of the user does not meet (e.g., no longer meets) the second movement criteria; and in response to detecting that the movement of the respective portion of the body of the user does not meet (e.g., no longer meets) the second movement criteria, the computer system displays (e.g., redisplays), via the one or more display generation components, the user interface element (e.g., corresponding to the location of the respective portion of the body of the user). In some embodiments, in response to detecting that the movement of the respective portion of the body of the user no longer meets the second movement criteria, and that the movement of the respective portion of the body of the user meets the first movement criteria, the computer system displays (e.g., redisplays) the user interface element, and moves the displayed (e.g., redisplayed) user interface element in accordance with the one or more movement parameters the movement of the respective portion of the body of the user. For example, as described with reference to FIGS. 7R1-7T, starting from the viewport shown in FIG. 7T in which the control 7030 is not displayed (e.g., due to the velocity of the hand 7022′ being above the threshold velocity vₜₕ₂), the user 7002 can reduce a movement speed of the hand 7022′ so that the computer system 101 displays (e.g., redisplays) the control 7030 (as shown in FIGS. 7R1 and/or 7S). Redisplaying the control when the velocity of the hand drops below a threshold speed causes the computer system to automatically display the control and reduces the amount of time needed for the user to interact with the control.

In some embodiments, the second movement criteria include (16036) a criterion that is met when the movement of the respective portion of the body of the user includes movement in a first direction (e.g., at least a first threshold amount of movement in the first direction); and the second movement criteria are not met when the movement of the respective portion of the body of the user includes movement in (e.g., only movement in) a second direction that is different than the first direction. For example, in some embodiments, the second movement criteria require at least the first threshold amount of movement in an x-direction or y-direction, relative to the display generation component and/or view of the user (e.g., movement in a leftward and/or rightward direction relative to the view of the user). The second criteria are not met if the movement of the respective portion of the body of the user includes only movement in a z-direction (e.g., a depth direction, relative to the view of the user). For example, as described with reference to FIGS. 7Q1-7T, the computer system 101 ceases to display the control 7030 when the computer system 101 detects that the hand 7022′ has moved beyond a respective distance threshold in one direction (e.g., left and/or right, with respect to the viewport illustrated in FIG. 7Q1), but not another direction (e.g., in depth toward or away from a viewpoint of the user 7002). Ceasing display of the control when the movement of the hand exceeds a threshold for one or more directions but not one or more other directions causes the computer system to automatically account for differences in probability that the user is more likely to intend to interact with the control during or after movement along the other direction(s) and reduces the amount of time needed for the user to interact with the control.

In some embodiments, displaying the user interface element corresponding to the location of the respective portion of the body of the user includes (16038) displaying, via the one or more display generation components, the user interface element with a first spatial relationship to the respective portion of the body of the user (e.g., with the first spatial relationship to a respective part of the respective portion of the body of the user, such as a joint of a finger or hand). In some embodiments, while the user interface element is displayed, the computer system maintains the first spatial relationship to the respective portion of the body of the user (e.g., regardless of movement and/or positioning of the respective portion of the body of the user). For example, as described with reference to FIGS. 7Q2 and 7R2, the control 7030 is displayed at an offset from an index knuckle (at a location corresponding to or near the arrow 7200) of the hand 7022′ in FIG. 7Q2, and the control 7030 is displayed between the index finger and the thumb of the hand 7022′ and is offset by oₜₕ from the midline 7096 of hand 7022′ as described with reference to FIG. 7Q1. Displaying the control with a particular spatial relationship to the location/view of the hand, such as between two fingers and offset from the hand, particularly from an index knuckle of the hand, or palm of the hand, in response to the user directing attention toward the location/view of the hand causes the computer system to automatically place the control at a consistent and predictable location relative to where the user's attention is directed, to reduce the amount of time needed for the user to locate and interact with the control while maintaining visibility of the control and the location/view of the hand.

In some embodiments, the first spatial relationship includes (16040) an offset from the respective portion of the body of the user (e.g., a knuckle or a wrist) of the user in a respective direction from the respective portion of the body of the user (e.g., in the respective direction from the center of the respective portion of the body of the user). For example, as described with reference to FIGS. 7Q2 and 7R2, the control 7030 is placed with an offset along a direction from the index knuckle based on a location of the wrist of the hand 7022′ (e.g., the wrist and the index knuckle defines a spatial vector, and the offset position of the control 7030 is determined relative to the spatial vector). Displaying the control with a particular spatial relationship to the location/view of the hand, such as offset from a spatial vector between an index knuckle and the wrist, in response to the user directing attention toward the location/view of the hand causes the computer system to automatically place the control at a consistent and predictable location relative to where the user's attention is directed, to reduce the amount of time needed for the user to locate and interact with the control while maintaining visibility of the control and the location/view of the hand.

In some embodiments, the first spatial relationship includes (16042) an offset from the respective portion of the body of the user (e.g., a knuckle or a wrist of the user) by a first distance from the respective portion of the body of the user (e.g., by the first distance from a center of the respective portion of the body of the user). For example, as described with reference to FIGS. 7Q2 and 7R2, the control 7030 is displayed at a first offset distance from the index knuckle. Displaying the control at an offset distance from a respective portion of the location/view of the hand, such as an index knuckle of the hand, in response to the user directing attention toward the location/view of the hand causes the computer system to automatically place the control at a consistent and predictable location relative to where the user's attention is directed, to reduce the amount of time needed for the user to locate and interact with the control while maintaining visibility of the control and the location/view of the hand.

In some embodiments, while displaying the user interface element with the first spatial relationship to the respective portion of the body of the user that includes the offset by the first distance (e.g., and/or in a first offset direction) from the respective portion of the body of the user, the computer system detects (16044), via the one or more input devices, one or more inputs corresponding to a request to display a second user interface element that is different from the user interface element (e.g., the one or more inputs optionally including a change in orientation of the respective portion of the body of the user). In response to detecting the one or more inputs corresponding to a request to display the second user interface element, the computer systems displays, via the one or more display generation components, the second user interface element (e.g., a status user interface, volume indication, or other user interface as described herein with reference to methods 10000 and 11000) with a second spatial relationship to the respective portion of the body of the user that includes an offset (e.g., in a second offset direction) by a second distance from the respective portion of the body of the user. The second spatial relationship is different from the first spatial relationship, and the second distance is different from the first distance (e.g., as described herein with reference to methods 10000 and 11000). In some embodiments, displaying the status user interface includes replacing display of the user interface element with display of the status user interface. In some embodiments, replacing display of the user interface element with display of the status user interface includes displaying an animated transformation of the user interface element turning into the status user interface (e.g., the user interface element turns over, flips over, and/or or rotates about a vertical axis, to become and/or reveal the status user interface). In some embodiments, the status user interface includes one or more status elements indicating status information (e.g., including system status information such as battery level, wireless communication status, a current time, a current date, and/or a current status of notification(s) associated with the computer system), as described herein with reference to the method 11000. For example, as described with reference to FIGS. 7Q2, 7R2, and 7AO, the computer system 101 replaces a display of the control 7030 with a display of the status user interface 7032 based on an orientation of the hand 7022′, at a second offset distance from the knuckle, different from a first offset distance from the index knuckle (shown in FIGS. 7Q2 and 7R2) due to differences in the size of the control 7030 and the status user interface 7032. Displaying the control and the status user interface with different respective offset distances from a respective portion of the location/view of the hand, such as an index knuckle of the hand, in response to the user directing attention toward the location/view of the hand causes the computer system to automatically place the control and/or the status user interface at consistent and predictable locations relative to where the user's attention is directed, to reduce the amount of time needed for the user to locate and interact with the control (or the status user interface) while maintaining visibility of the control (or status user interface) and the location/view of the hand.

In some embodiments, the respective portion of the body of the user is a hand of the user; and the computer system detects (16046) the one or more inputs corresponding to a request to display the second user interface element includes detecting, via the one or more input devices, a change in orientation of the hand of the user from a first orientation (e.g., an orientation with a palm of the hand facing toward the viewpoint of the user) to a second orientation that is different from the first orientation (e.g., an orientation with the palm of the hand facing away from the viewpoint of the user). In some embodiments, more generally, detecting the one or more inputs corresponding to a request to display the second user interface element includes detecting a change in orientation of the respective portion of the body of the user. For example, as described with respect to 7AO, in response to detecting a hand flip gesture of the hand 7022′ from the palm up configuration in the stage 7154-1 to the palm down configuration in the stage 7154-6, the computer system 101 displays the status user interface 7032. Updating a displayed user interface element if the detected input is or includes a change in orientation of the hand (e.g., based on the hand flipping over, such as from palm up to palm down or vice versa) reduces the number of inputs and amount of time needed to display a respective user interface element and enables different types of system operations to be performed without displaying additional controls.

In some embodiments, while displaying the user interface element corresponding to the location of the respective portion of the body of the user (e.g., the user interface element is the control described herein with reference to other methods described herein, including methods 10000, 11000, and 13000), the computer system detects (16048), via the one or more input devices, a first input (e.g., an air pinch gesture, an air pinch and hold, an air tap gesture, an air pinch and drag detected based on movement of a hand attached to the respective portion of the body of the user, and/or other input). In response to detecting the first input (e.g., and in accordance with a determination that the first input includes an air pinch gesture), the computer system performs a system operation corresponding to the user interface element (e.g., displaying, via the one or more display generation components, a system user interface, an application launching user interface such as a home menu user interface, a notifications user interface, an application launching user interface, a multitasking user interface, a control user interface, a status user interface, a volume indication, and/or another system user interface, as described herein with reference to methods 10000, 11000, and 13000). For example, as described with reference to FIGS. 7AJ-7AL2, 7AO, and 8G-8H, in response to detecting an input performed by the hand 7022′ while the control 7030 is displayed in the viewport, the computer system 101 performs a system operation (e.g., displays the home menu user interface 7031 in FIGS. 7AJ-7AL2, displays the status user interface 7032 in FIG. 7AO, and displays the indicator 8004 in FIGS. 8G-8H). Performing a system operation in response to detecting a particular input, depending on the context and whether certain criteria are met, reduces the number of inputs and amount of time needed to perform the system operation and enables one or more different types of system operations to be conditionally performed in response to one or more different types of inputs without displaying additional controls.

In some embodiments, the first input is (16050) detected while moving the first user interface element relative to the environment in accordance with one or more movement parameters of the movement of the respective portion of the body of the user (e.g., while the first movement criteria are met). In response to detecting the first input, and in accordance with a determination that the first input includes movement that partially satisfies first input criteria (e.g., the first input includes movement that is consistent with progress towards completing a respective type of gesture (e.g., to trigger performance of a system operation corresponding to the user interface element), without fully completing the respective type of gesture), the computer system changes a movement characteristic of the user interface element (e.g., increasing or decreasing an amount by which the user interface element moves in accordance with movement of the respective portion of the body by a respective amount or distance). For example, as described with reference to FIG. 7Q2, a knuckle of the index finger of the hand 7022 moves away from a contact point between the thumb and the finger during the air pinch gesture, and may change a position of the control 7030 in a different manner than would be expected from the performance of the air pinch gesture. In some embodiments, the computer system 101 changes the user interface response to the movement of the knuckle by at least partially forgoing or reversing a change in the position of the control 7030 during the air pinch gesture. Maintaining display of a control corresponding to a location/view of the hand without moving the control during an air pinch gesture causes the computer system to automatically reduce unnecessary changes in the position of the control, and allow the user to continue to interact with the control.

In some embodiments, changing the movement characteristic of the user interface element includes (16052) ceasing to move the user interface element. For example, as described with reference to FIG. 7Q2, a knuckle of the index finger of the hand 7022 moves away from a contact point between the thumb and the finger during the air pinch gesture, and may change a position of the control 7030 in a different manner than would be expected from the performance of the air pinch gesture. In some embodiments, the computer system 101 changes the user interface response to the movement of the knuckle by at least partially forgoing or reversing a change in the position of the control 7030 during the air pinch gesture. Maintaining display of a control corresponding to a location/view of the hand without moving the control during an air pinch gesture causes the computer system to automatically reduce unnecessary changes in the position of the control, and allows the user to continue to interact with the control.

after reducing the movement of the user interface element, the computer system detects (16054), via the one or more input devices, termination of the first input (e.g., a release of the air pinch gesture, and/or after an incomplete air pinch gesture has ended (e.g., without contact having been made between the thumb and the index finger), optionally prior to meeting the first input criteria). In response to detecting the termination of the first input, the computer system reverses (e.g., at least partially reversing, or fully reversing) the change in movement characteristic of the user interface element. For example, as described with reference to FIG. 7Q2, once the air pinch gesture is performed or after an incomplete air pinch gesture has ended (e.g., without contact having been made between the thumb and the index finger), the computer system 101 updates a display location of the control 7030, by moving the control 7030 that is positioned at a center of the zone 7186, optionally with the zone 7186 having a reduced size (e.g., analogous to the fourth scenario 7198-4) based on the movement of the hand 7022′. Moving the control corresponding to the location/view of the hand in accordance with movement of the user's hand (e.g., including resuming moving the control if the movement of the knuckle was unintended or is canceled) causes the computer system to automatically keep the control at a consistent and predictable location relative to the location/view of the hand, to reduce the amount of time needed for the user to locate and interact with the control.

In some embodiments, while continuing to detect the first input, the computer system detects (16056), via the one or more input devices, that the first input satisfies the first input criteria (e.g., an air pinch gesture that is maintained for a threshold amount of time while attention of the user is directed to the location/view of the hand while a palm of the hand is in a palm up orientation prior to a release of the air pinch gesture, an air pinch gesture that is maintained for a threshold amount of time while a palm of the hand is in a palm up orientation, and/or other first input criteria). In response to detecting that the first input satisfies the first input criteria, the computer system ceases to display the user interface element (e.g., and displaying a user interface that optionally is not moved in accordance with movement of the respective portion of the body of the user). For example, as described with reference to FIGS. 7AJ-7AL2, 7AO, and 8G-8H, in response to detecting an input performed by the hand 7022′ while the control 7030 is displayed in the viewport, the computer system 101 performs a system operation (e.g., displays the home menu user interface 7031 in FIGS. 7AJ-7AL2, displays the status user interface 7032 in FIG. 7AO, and displays the indicator 8004 in FIGS. 8G-8H) and ceases to display the control 7030. Performing a system operation in response to detecting a particular input, depending on the context and whether certain criteria are met and ceasing to display a user interface element that was activated to perform the system operation, reduces the number of inputs and amount of time needed to perform the system operation and enables one or more different types of system operations to be conditionally performed in response to one or more different types of inputs without displaying additional controls.

In some embodiments, aspects/operations of methods 10000, 11000, 12000, 13000, 15000, 17000, and 18000 may be interchanged, substituted, and/or added between these methods. For example, the user interface element corresponding to a location of a respective portion of a user's body in the method 16000 is the control, status user interface, respective volume level indication and/or volume level adjustment user interface, or other system user interface corresponding to the location and optionally a view of the hand described in the methods 10000, 11000, 12000, 13000, 15000, 17000, and/or 18000. For brevity, these details are not repeated here.

FIGS. 17A-17D are flow diagrams of an exemplary method 17000 for switching between a wrist-based pointer and a head-based pointer, depending on whether certain criteria are met. In some embodiments, the method 17000 is performed at a computer system (e.g., computer system 101 in FIG. 1) that is in communication with one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, sensors 7101a-7101c, and/or the digital crown 703, in FIGS. 14A-14L, or controller 7111 with buttons 7113, 7115, and/or 7117 in FIGS. 7A-7BE and 8A-8T), and one or more output generation components (e.g., that optionally include one or more display generation components such as a head-mounted display (HMD), a heads-up display, a display, a projector, a touchscreen, or other type of display) (e.g., display generation component 120 in FIGS. 1A, 3, and 4, or the display generation component 7100a in FIGS. 8A-8P). In some embodiments, the method 17000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 17000 are, optionally, combined and/or the order of some operations is, optionally, changed.

While a view of an environment (e.g., a two-dimensional or three-dimensional environment that includes one or more virtual objects and/or one or more representations of physical objects) is available for interaction (e.g., visible via the one or more display generation components) (e.g., using AR, VR, MR, virtual passthrough, or optical passthrough), the computer system detects (17002), via the one or more input devices, a first set of one or more inputs corresponding to interaction with the environment, wherein, when the first set of one or more inputs are detected, an orientation of a first portion of the body of the user (e.g., a wrist of the user) is used to determine where attention of the user is directed in the environment. In some embodiments, the first set of one or more inputs includes a selection input (e.g., an air gesture, a dwell input based on the user's attention toward the respective user interface element being sustained for at least a threshold amount of time, and/or other input). For example, in FIGS. 14C-14D, the computer system 101 detects a pinch gesture performed by the hand 7022, and the orientation of the wrist of the user (e.g., the wrist pointer 1402) is used to determine where attention of the user 7002 is directed.

In response to detecting the first set of one or more inputs, the computer system performs (17004) a first operation (e.g., outputting a response, via the one or more output generation components) associated with a respective user interface element in the environment based on detecting that attention of the user is directed toward the respective user interface element in the environment based on the orientation of the first portion of the body of the user (e.g., in FIG. 14D, in response to detecting the pinch gesture performed by the hand 7022 while the wrist pointer 1402 is directed to the user interface 7106, the computer system 101 traces out the drawing 1411 (e.g., in accordance with the movement of the wrist pointer 1402).

After performing the operation associated with the respective user interface element, the computer system detects (17006), via the one or more input devices, a second set of one or more inputs (e.g., the pinch gesture performed by the hand 7022′ in FIG. 14G). In response to detecting (17008) the second set of one or more inputs (e.g., an air pinch, an air pinch and hold, and/or an air pinch and drag), and in accordance with a determination that the second set of one or more inputs is detected while an orientation of a second portion of the body of the user (e.g., a head of the user or another portion of the body of the user that is different from the first portion of the body of the user) indicates that attention of the user is directed toward a third portion of the body of the user (e.g., toward a location and/or view of the third portion of the body of the user, as described herein with reference to method 10000) (e.g., the third portion of the body of the user being the first portion of the body of the user such as a wrist of the user or a hand of the user, or optionally a different portion of the body of the user that is attached to the first portion of the body of the user such as a hand of the user that is attached to the wrist of the user), the computer system performs (17010) an operation associated with the third portion of the body of the user (e.g., without performing an operation based on attention determined based on an orientation of the first portion of the body of the user).

In some embodiments, the operation associated with the first portion of the body of the user includes opening a home screen user interface, adjusting a volume level, and/or opening a system control user interface, as described herein with reference to methods 10000, 11000, and 13000). In some embodiments, in accordance with a determination that the second set of one or more inputs is detected while the orientation of the second portion of the body of the user does not indicate that attention of the user is directed toward the third portion of the body of the user, the computer system forgoes performing the operation associated with the third portion of the body of the user. For example, in FIG. 14H, in response to detecting the pinch gesture performed by the hand 7022′ while the head pointer 1402 is directed toward the hand 7022′ in FIG. 14G, the computer system 101 displays the home menu user interface 7031 (e.g., performs an operation associated with the hand 7022′). Performing a first operation associated with a respective user interface element based on detecting that attention of the user is directed toward the respective user interface element based on an orientation of a first portion of the body of the user, and performing an operation associated with a third portion of the body of a user in accordance with a determination that a set of one or more inputs is detected while an orientation of a second portion of the body of the user indicates that attention of the user is directed toward the third portion of the body of the user, provides additional control options without cluttering the UI with additional displayed controls (e.g., additional displayed controls for performing the first operation and/or the operation corresponding to the third portion of the body of the user), and increases the efficiency of user interaction with a computer system by allowing different operations to be performed based on different portions of the body of the user (e.g., which allows effective interaction with the computer system even if one or more portions of the body of the user are unavailable or preoccupied), which also makes the computer system more accessible to a wider variety of users by supporting different input mechanisms besides hand- and/or gaze-based inputs.

In some embodiments, in response to detecting the second set of one or more inputs, and in accordance with a determination that the second set of one or more inputs is detected while the orientation of the second portion of the body of the user does not indicate that attention of the user is directed toward the third portion of the body of the user, the computer system performs (17012) an operation based on attention determined based on an orientation of the first portion of the body of the user (e.g., without performing the operation associated with the third portion of the body of the user). Some examples of operations based on attention include selecting a user interface object toward which the attention of the user is directed; moving or resizing a user interface object toward which the attention of the user is directed; launching an application or other user interface corresponding to an affordance or control toward which the attention of the user is directed; and/or performing an application-specific operation corresponding to an application user interface toward which the attention of the user is directed. For example, in FIG. 14L, the head pointer 1402 is disabled (e.g., the orientation of the head of the user 7002 does not indicate that attention of the user is directed toward the hand 7022′ of the user 7002), and the wrist pointer 1404 is enabled. In response to detecting a user input, the computer system performs an operation corresponding to the affordance 1414 (e.g., where the wrist pointer 1404 is directed) and does not perform an operation corresponding to the affordance 1416 (e.g., where the head pointer 1402 is directed). In another example, if the pinch gesture of FIG. 14G were performed while the head pointer 1402 was not directed toward the hand 7022′, the computer system 101 would forgo displaying the home menu user interface 7031 shown in FIG. 14H (e.g., and instead would enable the wrist pointer 1404 and perform an operation based on where the wrist pointer 1404 is directed). Performing an operation based on attention determined based on an orientation of the first portion of the body of the user, when the second set of one or more inputs is detected while the orientation of the second portion of the body of the user does not indicate that attention of the user is directed toward the third portion of the body of the user, reduces the number of inputs needed to perform a contextually relevant operation (e.g., the user does not need to manually enable or disable operations based on attention determined based on the first portion of the body of the user in order to perform operations corresponding to the third portion of the body of the user, or vice versa).

In some embodiments, the first set of one or more inputs includes (17014) a first user input of a respective type (e.g., an air pinch, an air pinch and hold, and/or an air pinch and drag), and the second set of one or more inputs includes a second user input of the respective type (e.g., an air pinch, an air pinch and hold, and/or an air pinch and drag), wherein the second input is different than the first user input. For example, in FIG. 14C, while the wrist pointer 1404 is enabled, the computer system 101 detects a pinch gesture performed by the hand 7022′ (e.g., a pinch gesture is an input of the respective type), and in response, the computer system 101 activates the affordance 1406. In contrast, in FIG. 14G, while the head pointer is enabled, the computer system 101 detects a pinch gesture performed by the hand 7022′ (e.g., a distinct instance of the same type of input as the pinch gesture performed in FIG. 14C, when the wrist pointer 1404 is enabled), and in response, the computer system 101 displays the home menu user interface 7031 (e.g., as shown in FIG. 14H). Performing a first operation associated with a respective user interface element based on detecting that attention of the user is directed toward the respective user interface element based on an orientation of a first portion of the body of the user in response to detecting a first user input of a respective type, and performing an operation associated with a third portion of the body of a user in accordance with a determination that a set of one or more inputs is detected while an orientation of a second portion of the body of the user indicates that attention of the user is directed toward the third portion of the body of the user, in response to detecting a second user input of the respective type, provides additional control options without cluttering the UI with additional displayed controls (e.g., additional displayed controls for performing the first operation and/or the operation corresponding to the third portion of the body of the user), and increases the efficiency of user interaction with a computer system by allowing different operations to be performed based on different portions of the body of the user (e.g., which allows effective interaction with the computer system even if one or more portions of the body of the user are unavailable or preoccupied).

In some embodiments, the respective user interface element is (17016) a user interface element toward which the attention of the user (e.g., based on a gaze, head direction, wrist direction, and/or other pointing manner of the user) is directed when the computer system detects the first set of one or more inputs. For example, in FIGS. 14A-14B, the computer system 101 detects pinch gestures performed by the hand 7022, while the attention of the user (e.g., based on the head pointer 1402) is directed toward the user interface 7106 (e.g., and so the computer system 101 performs functions corresponding to the user interface 7106 in response to detecting the pinch gesture(s) in FIGS. 14A-14B). Performing a first operation associated with a respective user interface element toward which the attention of the user is directed when the compute system detects a first set of one or more inputs, and performing an operation associated with a third portion of the body of a user in accordance with a determination that a set of one or more inputs is detected while an orientation of a second portion of the body of the user indicates that attention of the user is directed toward the third portion of the body of the user, provides additional control options without cluttering the UI with additional displayed controls (e.g., additional displayed controls for performing the first operation and/or the operation corresponding to the third portion of the body of the user), and increases the efficiency of user interaction with a computer system by allowing different operations to be performed based on different portions of the body of the user (e.g., which allows effective interaction with the computer system even if one or more portions of the body of the user are unavailable or preoccupied).

In some embodiments, the first portion of the body of the user is (17018) a portion of an arm of the user (e.g., or a portion of the user's body that includes and/or is predominately focused on the arm of the user; or based on a direction associated with an orientation of the arm of the user). For example, in FIGS. 14C-14D, the wrist pointer 1404 is enabled. The wrist pointer 1404 is based in part on the arm attached to the hand 7022 (e.g., the wrist pointer 1404 is a ray that runs along the arm attached to the hand 7022). Performing a first operation associated with a respective user interface element based on detecting that attention of the user is directed toward the respective user interface element based on an orientation of an arm of the user, and performing an operation associated with a third portion of the body of a user in accordance with a determination that a set of one or more inputs is detected while an orientation of a second portion of the body of the user indicates that attention of the user is directed toward the third portion of the body of the user, provides additional control options without cluttering the UI with additional displayed controls (e.g., additional displayed controls for performing the first operation and/or the operation corresponding to the third portion of the body of the user), and increases the efficiency of user interaction with a computer system by allowing different operations to be performed based on different portions of the body of the user (e.g., which allows effective interaction with the computer system even if one or more portions of the body of the user are unavailable or preoccupied), which also makes the computer system more accessible to a wider variety of users by supporting different input mechanisms.

In some embodiments, the first portion of the body of the user is (17020) a wrist of the user (e.g., or a portion of the user's body that includes and/or is predominately focused on the wrist of the user; or based on a direction associated with an orientation of the wrist of the user). For example, in FIGS. 14C-14D, the wrist pointer 1404 is enabled. The wrist pointer 1404 is based on the wrist of the hand 7022 (e.g., optionally, in combination with the arm connected to the hand 7022). Performing a first operation associated with a respective user interface element based on detecting that attention of the user is directed toward the respective user interface element based on an orientation of a wrist of the user, and performing an operation associated with a third portion of the body of a user in accordance with a determination that a set of one or more inputs is detected while an orientation of a second portion of the body of the user indicates that attention of the user is directed toward the third portion of the body of the user, provides additional control options without cluttering the UI with additional displayed controls (e.g., additional displayed controls for performing the first operation and/or the operation corresponding to the third portion of the body of the user), and increases the efficiency of user interaction with a computer system by allowing different operations to be performed based on different portions of the body of the user (e.g., which allows effective interaction with the computer system even if one or more portions of the body of the user are unavailable or preoccupied), which also makes the computer system more accessible to a wider variety of users by supporting different input mechanisms.

In some embodiments, the second portion of the body of the user is (17022) a head of the user (e.g., or a portion of the user's body that includes and/or is predominately focused on the head of the user; or based on a direction associated with an orientation of the head of the user). For example, in FIGS. 14F-14J, the head pointer 1402 is enabled. The head pointer 1402 is based on a direction and/or orientation of the head of the user 7002. Performing a first operation associated with a respective user interface element based on detecting that attention of the user is directed toward the respective user interface element based on an orientation of a first portion of the body of the user; and performing an operation associated with a third portion of the body of a user in accordance with a determination that a set of one or more inputs is detected while an orientation of a head of the user indicates that attention of the user is directed toward the third portion of the body of the user, provides additional control options without cluttering the UI with additional displayed controls (e.g., additional displayed controls for performing the first operation and/or the operation corresponding to the third portion of the body of the user), and increases the efficiency of user interaction with a computer system by allowing different operations to be performed based on different portions of the body of the user (e.g., which allows effective interaction with the computer system even if one or more portions of the body of the user are unavailable or preoccupied), which also makes the computer system more accessible to a wider variety of users by supporting different input mechanisms.

In some embodiments, the orientation of the second portion of the body of the user is (17024) based on a gaze (e.g., or gaze direction) of the user (e.g., based on eye-tracking and/or gaze-tracking information detected by one or more sensors of the computer system). For example, as described with reference to FIGS. 14A-14B, in some embodiments, the head pointer 1402 is based on a gaze of the user 7002. Performing a first operation associated with a respective user interface element based on detecting that attention of the user is directed toward the respective user interface element based on an orientation of a first portion of the body of the user, and performing an operation associated with a third portion of the body of a user in accordance with a determination that a set of one or more inputs is detected while an orientation of a gaze of the user indicates that attention of the user is directed toward the third portion of the body of the user, provides additional control options without cluttering the UI with additional displayed controls (e.g., additional displayed controls for performing the first operation and/or the operation corresponding to the third portion of the body of the user), and increases the efficiency of user interaction with a computer system by allowing different operations to be performed based on different portions of the body of the user (e.g., which allows effective interaction with the computer system even if one or more portions of the body of the user are unavailable or preoccupied), which also makes the computer system more accessible to a wider variety of users by supporting different input mechanisms.

In some embodiments, the computer system detects (17026), via the one or more input devices, a third set of one or more inputs. In response to detecting the third set of one or more inputs, and in accordance with a determination that the third set of one or more inputs is detected while the orientation of the second portion of the body of the user indicates that attention of the user is directed toward the third portion of the body of the user while the third portion of the body of the user is in a respective orientation, the computer system performs an operation associated with the third portion of the body of the user in the respective orientation (e.g., displaying a control, displaying a status user interface, or adjusting a volume level of the computer system). In some embodiments, the computer system performs a first operation associated with the third portion of the body of the user (e.g., in a first orientation), in accordance with a determination that the orientation of the second portion of the body of the user indicates that attention of the user is directed toward the third portion of the body of the user while the third portion of the body of the user is in a first orientation; and the computer system performs a second operation, different from the first operation, that is associated with the third portion (e.g., in a second orientation), in accordance with a determination that the orientation of the second portion of the body of the user indicates that attention of the user is directed toward the third portion of the body of the user while the third portion of the body of the user is in a second orientation that is different than the first orientation. In some embodiments, the operation associated with the third portion of the body of the user that is performed in response to detecting the second set of one or more inputs (e.g., in accordance with the determination that the second set of one or more inputs is detected while the orientation of the second portion of the body of the user indicates that attention is directed toward the third portion of the body of the user) also requires that the third portion of the body of the user be in the respective orientation in order to be performed. For example, in FIG. 14G, the computer system 101 detects a pinch gesture performed by the hand 7022′ (e.g., a third set of one or more inputs), and the pinch gesture is detected while the head pointer 1402 (e.g., the head of the user 7002 is the second portion of the body of the user) indicates that attention 1400 of the user 7002 is directed toward (e.g., the orientation of the head of the user 7002 indicates that attention of the user is directed toward) the hand 7022′ in the “palm up” orientation (e.g., the third portion of the body of the user is in a respective orientation). Performing an operation associated with the third portion of the body of the user in the respective orientation, in response to detecting a third set of one or more inputs and in accordance with a determination that the third set of one or more inputs is detected while the orientation of the second portion of the body of the user indicates that attention of the user is directed toward the third portion of the body of the user while the third portion of the body of the user is in a respective orientation, automatically performs a contextually appropriate operation without requiring further user input (e.g., the user does not need to manually switch between enabling and/or disabling operations based on attention determined based on the first portion of the body of the user; operations corresponding to the third portion of the body of the user; and/or operations associated with the first portion of the body of the user in the respective orientation).

In some embodiments, the respective orientation is (17028) determined based on the orientation of the third portion of the body of the user relative to a hand of the user (e.g., based on whether the hand of the user is in the first orientation with the palm of a hand facing toward the viewpoint of the user or the second orientation with the palm of the hand facing away from the viewpoint of the user, as described herein with reference to methods 10000, 11000, and 13000). For example, in FIG. 14G, the computer system 101 detects that the hand 7022′ is in the “palm up” orientation. Performing an operation associated with the third portion of the body of the user in the respective orientation, in response to detecting a third set of one or more inputs and in accordance with a determination that the third set of one or more inputs is detected while the orientation of the second portion of the body of the user indicates that attention of the user is directed toward the third portion of the body of the user while the third portion of the body of the user is in a respective orientation determined based on the orientation of the third portion of the body of the user relative to the hand of the user, automatically performs a contextually appropriate operation without requiring further user input (e.g., the user does not need to manually switch between enabling and/or disabling operations based on attention determined based on the first portion of the body of the user; operations corresponding to the third portion of the body of the user; and/or operations associated with the first portion of the body of the user in the respective orientation).

In some embodiments, before detecting the second set of one or more inputs, the computer system detects (17030), via the one or more input devices, that the orientation of the second portion of the body of the user indicates that the attention of the user is directed toward the third portion of the body of the user. In response to detecting that the orientation of the second portion of the body of the user indicates that the attention of the user is directed toward the third portion of the body of the user, the computer system displays, via the one or more display generation components, a user interface element (e.g., a control, a status user interface, or another user interface) corresponding to the third portion of the body of the user (e.g., as described herein with reference to methods 10000, 11000, and 13000. For example, in FIG. 14F, prior to detecting the pinch gesture performed by the hand 7022 in FIG. 14G, the computer system 101 displays the control 7030 (e.g., in response to detecting that the head pointer 1402 is directed toward the hand 7022′ while the hand 7022′ is in the “palm up” orientation). Displaying a user interface element corresponding to the third portion of the body of the user, in response to detecting that the orientation of the second portion of the body of the user indicates that the attention of the user is directed toward the third portion of the body of the user, automatically displays the user interface element when contextually relevant and without requiring further user input (e.g., additional user inputs to display the user interface element, and/or additional user inputs to enable functionality based on the second portion of the body (e.g., functionality tied to the orientation of the second portion of the body of the user indicating that the attention of the user is directed toward a respective location)).

In some embodiments, the user interface element is (17032) a status user interface (e.g., that includes one or more status elements indicating status information (e.g., including system status information such as battery level, wireless communication status, a current time, a current date, and/or a current status of notification(s) associated with the computer system), as described herein with reference to method 11000). For example, in FIG. 14I, the computer system 101 displays the status user interface 7032 (e.g., in response to detecting that the head pointer 1402 is directed toward the hand 7022′ while the hand 7022′ is in the “palm down” orientation). Displaying a status user interface corresponding to the third portion of the body of the user, in response to detecting that the orientation of the second portion of the body of the user indicates that the attention of the user is directed toward the third portion of the body of the user, automatically displays the status user interface when contextually relevant and without requiring further user input (e.g., additional user inputs to display the status user interface, and/or additional user inputs to enable functionality based on the second portion of the body (e.g., functionality tied to the orientation of the second portion of the body of the user indicating that the attention of the user is directed toward a respective location)).

In some embodiments, after displaying the user interface element corresponding to the third portion of the body of the user, the computer system detects (17034), via the one or more input devices, that the orientation of the second portion of the body of the user does not indicate that the attention of the user is directed toward the third portion of the body of the user. In response to detecting that the orientation of the second portion of the body of the user does not indicate that the attention of the user is directed toward the third portion of the body of the user, the computer system ceases to display the user interface element corresponding to the third portion of the body of the user. After ceasing to display the user interface element corresponding to the third portion of the body of the user, the computer system detects, via the one or more input devices, a third set of one or more inputs. In response to detecting the third set of one or more inputs (e.g., and in accordance with a determination that the orientation of the second portion of the body of the user does not indicate that attention of the user is directed toward the third portion of the body of the user at the time when the third set of one or more inputs is detected), the computer system performs a third operation associated with a respective user interface element in the environment toward which the attention of the user is directed based on the orientation of the first portion of the body of the user (e.g., selecting a user interface object toward which the attention of the user is directed, moving or resizing a user interface object toward which the attention of the user is directed; launching an application or other user interface corresponding to a control or affordance toward which the attention of the user is directed, and/or performing an application-specific operation within an application user interface toward which the attention of the user is directed). For example, in FIG. 14K, the computer system 101 detects that the head pointer 1402 is no longer directed toward the hand 7022′, and in response, the computer system 101 switches from the head pointer 1402 to the wrist pointer 1404. As further described with reference to FIGS. 14K-14L, while the respective pointers remain directed toward their respective locations, if the user 7002 performs a user input (e.g., an air pinch, an air tap, or another air gesture), the computer system 101 does not perform operations corresponding to the affordance 1416 in the home menu user interface 7031 (e.g., the user interface and user interface element toward which the head pointer 1402 is directed in FIGS. 14K-14L, as the head pointer 1402 is disabled), and instead performs an operation corresponding to the representation 7014′ of the physical object 7014 (e.g., the object toward which the wrist pointer 1402 is directed in FIG. 14K) if the representation 7014′ of the physical object 7014 is enabled for user interaction, or an operation corresponding to the affordance 1414 (e.g., the object toward which the wrist pointer 1402 is directed in FIG. 14L). Performing a third operation associated with a respective user interface element in the environment toward which the attention of the user is directed based on the orientation of the first portion of the body of the user, after ceasing to display the user interface element corresponding to the third portion of the body of the user, automatically performs contextually relevant operations without requiring further user input (e.g., the user can seamlessly switch between interacting with the computer system via different portions of the user's body, without needing to perform multiple user inputs to enable and/or disable interaction with the computer system for each respective portion of the user's body).

In some embodiments, performing the operation associated with the third portion of the body of the user includes (17036) displaying, via the one or more display generation components, a user interface element (e.g., a control or status user interface, as described herein with reference to methods 10000 and 11000) corresponding to (e.g., a location and/or view of) the third portion of the body of the user. In some embodiments, while displaying the user interface element corresponding to the third portion of the body of the user, the computer system detects a user input (e.g., performed with the third portion of the body of the user), and in response, performs an additional operation associated with the third portion of the body of the user and/or corresponding to the user interface element corresponding to the third portion of the body of the user (e.g., opening a home screen user interface, adjusting a volume level, and/or opening a system control user interface, as described herein with reference to methods 10000 and 11000. For example, in FIG. 14F, in response to detecting that the head pointer 1402 is directed toward the hand 7022′ (e.g., the hand 7022 being the third portion of the body of the user), the computer system 101 displays the control 7030 (e.g., a user interface element corresponding to the third portion of the body of the user). Displaying a user interface element corresponding to the third portion of the body of the user in response to detecting a set of one or more inputs while an orientation of a second portion of the body of the user indicates that attention of the user is directed toward the third portion of the body of the user reduces the number of inputs and amount of time needed to invoke the control and access a plurality of different system operations of the computer system without displaying additional controls.

In some embodiments, in response to detecting the second set of one or more user inputs: in accordance with a determination that the second set of one or more inputs is detected while the orientation of the second portion of the body of the user does not indicate that the attention of the user is directed toward the third portion of the body of the user, the computer system performs (17038) a second operation associated with a respective user interface element in the environment based on detecting that the attention of the user is directed toward the respective user interface element in the environment based on the orientation of the first portion of the body of the user (e.g., selecting a user interface object toward which the attention of the user is directed, moving or resizing a user interface object toward which the attention of the user is directed; launching an application or other user interface corresponding to a control or affordance toward which the attention of the user is directed, and/or performing an application-specific operation within an application user interface toward which the attention of the user is directed); and in accordance with a determination that the second set of one or more inputs is detected while the orientation of the second portion of the body of the user indicates that the attention of the user is directed toward the third portion of the body of the user, the computer system performs the operation associated with the third portion of the body of the user in conjunction with forgoing performing the second operation associated with the respective user interface element in the environment (e.g., displaying a home menu user interface, displaying a system function menu, or displaying a volume indicator). For example, in FIG. 14H, the computer system 101 displays the home menu user interface 7031 (e.g., performs an operation associated with the hand 7022′) because the head pointer 1402 is directed toward the hand 7022′ when the computer system 101 detects the pinch gesture performed by the hand 7022′ in FIG. 14G. In other examples, if the head pointer 1402 is directed toward the hand 7022′, the computer system performs operations associated with the hand 7022′, such as displaying the status user interface 7032) in FIG. 14I in response to detecting a hand flip gesture performed by the hand 7022′, or displaying the volume indicator 8004 and adjusting the volume level in FIG. 14J in response to detecting a pinch and hold gesture performed by the hand 7022′. The computer system 101 does not perform an operation associated with the user interface 7106 (e.g., although the wrist pointer 1404 is directed toward the user interface 7106, the wrist pointer 1404 is disabled in FIGS. 14G-14J). Performing a second operation associated with a respective user interface element toward which attention of the user is directed based on an orientation of the first portion of the body of the user while the orientation of the second portion of the body of the user does not indicate that the attention of the user is directed toward the third portion of the body of the user, and performing an operation associated with the third portion of the body of the user in conjunction with forgoing performing the second operation while the orientation of the second portion of the body of the user indicates that the attention of the user is directed toward the third portion of the body of the user, reduces the number of inputs and amount of time needed to perform contextually relevant operations and enables different types of operations to be conditionally performed without displaying additional controls.

In some embodiments, performing the operation associated with the third portion of the body of the user includes (17040) displaying a system function menu that includes one or more controls for accessing system functions of the computer system (e.g., the system function menu described with reference to the method 10000 and the method 11000). For example, as described with reference to FIG. 14I, while displaying the status user interface 7032, the computer system 101 detects a user input (e.g., an air pinch gesture) to display the system function menu 7044 (e.g., the same system function menu 7044 shown in FIGS. 7K and 7L). Displaying a system function menu that includes one or more controls for accessing system functions of the computer system, in response to detecting a set of one or more inputs while an orientation of a second portion of the body of the user indicates that attention of the user is directed toward the third portion of the body of the user, reduces the number of inputs and amount of time needed to display the status user interface and enables different types of system operations to be performed without displaying additional controls.

In some embodiments, performing the operation associated with the third portion of the body of the user includes (17042) adjusting a respective system parameter (e.g., a system setting, such as a volume level or a display brightness) of the computer system. In some embodiments, the second set of one or more inputs includes movement of the third portion of the body of the user, and the computer system adjusts the respective system parameter of the computer system in accordance with the movement of the third portion of the body of the user. For example, in FIG. 14J, the computer system 101 adjusts a volume level (e.g., and displays the volume indicator 8004), in response to detecting the pinch and hold gesture performed by the hand 7022′ while the head pointer 1402 is directed toward the hand 7022′. Adjusting a respective system parameter of the computer system in response to detecting a set of one or more inputs while an orientation of a second portion of the body of the user indicates that attention of the user is directed toward the third portion of the body of the user reduces the number of inputs and amount of time needed to adjust the volume of one or more outputs of the computer system and enables different types of system operations to be performed without displaying additional controls.

In some embodiments, aspects/operations of methods 10000, 11000, 12000, 13000, 15000, 16000, and 18000 may be interchanged, substituted, and/or added between these methods. For example, the different types of pointers that are based on using the orientation of different portions of the user's body to determine where the user's attention is directed in the method 17000 are used to invoke and/or interact with the system user interfaces described in the methods 10000, 11000, 12000, 13000, 15000, 16000, and/or 18000. For brevity, these details are not repeated here.

FIG. 18 is a flow diagram of an exemplary method 18000 for invoking and interacting with a hand-based control or other user interface of a computer system while holding a controller, in accordance with some embodiments. In some embodiments, the method 18000 is performed at a computer system (e.g., computer system 101 in FIG. 1) that is in communication with one or more display generation components (e.g., a head-mounted display (HMD), a heads-up display, a display, a projector, a touchscreen, or other type of display) (e.g., display generation component 120 in FIGS. 1A, 3, and 4, or the display generation component 7100a in FIGS. 7A-7BE) and one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c, the digital crown 703, and/or controller 7111 with buttons 7113, 7115, and/or 7117 in FIGS. 7A-7BE and 8A-8T). In some embodiments, the method 18000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 18000 are, optionally, combined and/or the order of some operations is, optionally, changed.

While a view of an environment (e.g., a two-dimensional or three-dimensional environment that includes one or more virtual objects and/or one or more representations of physical objects) is visible via the one or more display generation components (e.g., using AR, VR, MR, virtual passthrough or optical passthrough), and while the view of the environment includes a respective object (e.g., a representation of a hand, a representation of a controller, a view of a hand, and/or a view of a controller) that moves (e.g., in the environment) as a hand of a user moves (e.g., in physical space, in a physical environment corresponding to the environment that is visible via the one or more display generation components), the computer system detects (18002), via the one or more input devices, a respective input.

In response to detecting the respective input (18004): in accordance with a determination that first criteria are met, wherein the first criteria include a requirement that the hand of the user is holding a controller (and in some embodiments that the controller is one of the one or more input devices) (e.g., in order for the first criteria to be met), the computer system displays (18006), via the one or more display generation components, a first user interface object (e.g., the control, the status user interface, the control user interface, the control for adjusting a respective volume level of the computer system, as described with reference to FIGS. 7A-7BE, 8A-8T, 9A-9P, and 14A-14L and methods 10000, 11000, 12000, 13000, 15000, 16000, and 17000, or other user interface described herein as being associated with the view of the hand) at a first location relative to the respective object; and, in accordance with a determination that the first criteria are not met (e.g., the hand of the user is not holding a controller), the computer system forgoes (18008) displaying the first user interface object at the first location.

For example, the view of the environment in FIGS. 7Q1 and 7Q3 includes hand 7022′ that moves as hand 7022 of user 7002 moves. The computer system 101 detects a respective input that includes the attention 7010 of the user 7002 being directed toward the hand 7022′. In response to the respective input, the control 7030 is displayed at a first location relative to hand 7022′ in FIG. 7Q3 because hand 7022′ in FIG. 7Q3 is holding controller 7111′, whereas the control 7030 is not displayed at the same first location relative to hand 7022′ in FIG. 7Q1 because hand 7022′ in FIG. 7Q1 is not holding a controller.

Displaying a user interface object, such as a control, status user interface, or other affordance for accessing different system user interfaces and/or system operations of the computer system, at a particular location relative to an object that corresponds to a user's hand and moves as the hand moves, even if the hand is holding a controller, reduces the amount of time needed to invoke the user interface object and access different system user interfaces and/or system operations of the computer system by not requiring the user to remove the controller from their hand.

In some embodiments, in response to detecting the respective input: in accordance with a determination that second criteria are met, wherein the second criteria include a requirement that the hand of the user is not holding a controller (e.g., the first criteria are not met), the computer system displays the first user interface object at a second location relative to the respective object, wherein the second location is different from the first location (e.g., the second location is further from the respective object than the first location is from the respective object or the second location is closer to the respective object than the first location is to the respective object). For example, in FIG. 7Q1, because hand 7022′ is not holding a controller, the control 7030 is not displayed at the first location of FIG. 7Q3, and is instead displayed at a different, second location relative to hand 7022′. In some embodiments, the second criteria require that the hand is in a respective pose and oriented with a palm of the hand facing toward a viewpoint of the user, and/or that the attention of the user is directed toward the location of the hand, as described with reference to FIGS. 7A-7BE, 8A-8T, 9A-9P, and 14A-14L and methods 10000, 11000, 12000, 13000, 15000, 16000, and 17000. In some embodiments, if neither the first criteria nor the second criteria are met, the computer system forgoes displaying the first user interface object (e.g., at any location), as described herein with reference to FIGS. 7I and 7J1, for example. Displaying the user interface object (e.g., for accessing different system user interfaces and/or system operations of the computer system) at different locations relative to the object that corresponds to the user's hand and moves as the hand moves, based on whether the hand is holding a controller or not, reduces the amount of time needed to invoke the user interface object and access different system user interfaces and/or system operations of the computer system by not requiring the user to remove the controller, while automatically adjusting the positioning of the user interface object as needed to accommodate a controller.

In some embodiments, displaying the first user interface object at the first location includes: in accordance with a determination that a respective portion of the controller is at a first controller location (e.g., a first physical location in the physical space), displaying the first user interface object at a first spatial location in the environment that is at the first location relative to the respective object; and, in accordance with a determination that the respective portion of the controller is at a second controller location that is different from the first controller location (e.g., a different, second physical location in the physical space), displaying the first user interface object at a second spatial location in the environment that is at the first location relative to the respective object, wherein the second spatial location in the environment is different from the first spatial location in the environment. For example, the control 7030 is repositioned based on the movement of the controller 7111′ held by the hand 7022′ in FIGS. 7Q3-7Q4, and the status user interface 7032 optionally exhibits analogous behavior, as described with reference to FIGS. 7Q1-7S and operation 11020 of method 11000. In another example, the transition between displaying control 7030 in stage 7154-1 and displaying status user interface 7032 in stage 7154-6 of FIG. 7AO would be based on a position of a portion of controller 7111′ if hand 7022′ were holding controller 7111′. In yet another example, although the hand 7022′ is not holding a controller in FIG. 8K, the movement of the indicator 8004 (e.g., in a horizontal direction, relative to the display generation component 7100a) in accordance with movement (e.g., horizontal movement) of the hand 7022′ would similarly occur if hand 7022′ were holding a controller 7111′. While the user's hand is holding a controller, displaying the user interface object at a location, relative to the object that corresponds to the user's hand and moves as the hand moves, that is based on the location of a respective portion of the controller causes the computer system to automatically adjust the positioning of the user interface object as needed to accommodate the controller and in some embodiments provides improved visual feedback that the controller can be used to interact with the user interface object.

In some embodiments, the first user interface object includes an affordance that provides access to a home menu user interface (e.g., a control as described with reference to FIGS. 7A-7BE, 8A-8T, 9A-9P, and 14A-14L and methods 10000, 11000, 12000, 13000, 15000, 16000, and 17000, such as control 7030 of FIG. 7Q that is activatable to display home menu user interface 7031 as described herein with reference to FIGS. 7AK and FIGS. 7AL1-7AL2). Including an affordance that provides access to a home menu user interface in the user interface object that is displayed relative to the object that corresponds to the user's hand and moves as the hand moves reduces the amount of time needed to access the home menu user interface.

In some embodiments, the first user interface object includes an affordance that provides access to status information (e.g., including system status information such as battery level, wireless communication status, a current time, a current date, and/or a current status of notification(s) associated with the computer system). For example, status user interface 7032 of FIGS. 7AO-7AP provides access to (e.g., and includes) system status information (e.g., and also provides access to system function menu 7044 in FIG. 7AQ with status information 7058 as in FIG. 7J3). Including an affordance that provides access to status information (e.g., for the computer system) in the user interface object that is displayed relative to the object that corresponds to the user's hand and moves as the hand moves reduces the amount of time needed to access the status information.

In some embodiments, the first user interface object includes a status user interface that includes status information for the computer system (e.g., a status user interface as described with reference to FIGS. 7A-7BE, 8A-8T, 9A-9P, and 14A-14L and methods 10000, 11000, 12000, 13000, 15000, 16000, and 17000, that includes one or more status elements indicating status information, including system status information, such as status user interface 7032 of FIGS. 7AO-7AP). Including a status user interface that includes or otherwise provides access to status information (e.g., for the computer system) in the user interface object that is displayed relative to the object that corresponds to the user's hand and moves as the hand moves reduces the amount of time needed to access the status information for the computer system.

In some embodiments, detecting the respective input includes detecting a change in orientation of the hand from a first orientation with a palm of the hand facing toward a viewpoint of the user to a second orientation with the palm of the hand facing away from the viewpoint of the user. In some embodiments, as described with reference to FIGS. 7A-7BE and 8A-8T and methods 10000, 11000, 15000, 16000, and 17000, the computer system transitions from displaying a control (e.g., corresponding to the location of the respective object) such as control 7030, while the hand is in the first orientation with the palm of the hand facing toward the viewpoint of the user, to displaying the status user interface such as status user interface 7032 in response to detecting the change in orientation of the hand to the second orientation with the palm of the hand facing away from the viewpoint of the user. Displaying the user interface object (e.g., that includes a status user interface or otherwise provides access to status information) that is displayed relative to the object that corresponds to the user's hand and moves as the hand moves in response to a change in orientation (e.g., flip) of the hand, and without requiring the user to remove the controller from their hand, reduces the amount of time needed to access the status information.

In some embodiments, the one or more input devices include the controller (e.g., controller 7111 of FIGS. 7Q, FIGS. 7AL, and FIGS. 7AP and 8Q-8T). In some embodiments, while displaying the first user interface object at the first location relative to the respective object (e.g., in accordance with the determination that the hand of the user is holding a controller), the computer system detects, via the controller, an input (e.g., performed using the hand that is holding the controller and/or using one or more input elements such as a button, knob, joystick, touch-sensitive surface, and/or other input element of the controller, such as button 7113, button 7115, and/or button 7117 of controller 7111 in FIG. 7Q). In some embodiments, the detected input is performed using the same hand relative to whose view the first user interface object is displayed (e.g., at the first location if the hand is holding a controller, or at the second location if the hand is not holding a controller). In some embodiments, in response to detecting the input, the computer system performs an operation associated with the first user interface object. In some embodiments, the operation performed is an operation associated with the control, the status user interface, the control user interface, the control for adjusting a respective volume level of the computer system, as described with reference to FIGS. 7A-7BE, 8A-8T, 9A-9P, and 14A-14L and methods 10000, 11000, 12000, 13000, 15000, 16000, and 17000, or other user interface described herein as being associated with the view of the hand. In some embodiments, the different associated operations described herein are performed in response to different types of inputs via the controller (e.g., a button press versus a button press-and-hold versus a rotation of the controller, and/or other type of input), optionally corresponding respectively to different types of inputs via the hand.

For example, while the control is displayed, in response to detecting a button press via the controller, the same system user interface (e.g., an application launching user interface such as a home menu user interface, a notifications user interface, a multitasking user interface, a control user interface, and/or other operation system user interface) is displayed as if an air pinch gesture were detected as described herein with reference to method 10000. For example, in FIGS. 7AL1-7AL2, the computer system 101 ceases to display control 7030 and displays home menu user interface 7031 in response to detecting the press of button 7117 of controller 7111 (e.g., where the same hand 7022 both holds the controller 7111 and performs the button press of controller 7111), as if a pinch gesture by hand 7022 had been detected while control 7030 was displayed. In another example, while the status user interface is displayed, in response to detecting a button press via the controller, the same control user interface that provides access to a plurality of controls corresponding to different functions (e.g., system functions) of the computer system is displayed as if a selection input were detected. For example, in FIGS. 7AP-7AQ, the computer system 101 ceases to display status user interface 7032 and displays system function menu 7044 in response to detecting the press of button 7117 of controller 7111, as if a pinch gesture by hand 7022 had been detected while status user interface 7032 was displayed. In another example, while the control is displayed, in response to detecting a change in orientation of the hand holding the controller from a first orientation with the palm of the hand facing toward the viewpoint of the user to a second orientation (e.g., with the palm of the hand facing away from the viewpoint of the user), the same status user interface is displayed as if the hand were not holding the controller (e.g., as described herein with reference to FIG. 7AO). In another example, while the control or the status user interface is displayed (e.g., in some embodiments regardless of which one is displayed), in response to detecting a button press-and-hold via the controller, the same control for adjusting a respective volume level of the computer system is displayed as if an air long pinch gesture were detected (e.g., and movement of the hand while the button continues to be pressed changes the respective volume level, just as with an air long pinch-and-drag if the hand were not holding the controller). For example, in FIGS. 8Q-8T, the computer system 101 ceases to display control 7030 and displays volume indicator 8004 in response to detecting the long press of button 7117 of controller 7111, and changes the volume level for the computer system 101 in response to detecting the movement of the input (e.g., based on detecting movement of the hand 7022 and/or movement of the controller 7111) while the long press of button 7117 is maintained. While the user's hand is holding a controller, enabling the user to provide inputs via the controller to interact with the user interface object, displayed relative to the object that corresponds to the user's hand and moves as the hand moves, to perform an associated operation reduces the amount of time needed to access different system user interfaces and/or system operations of the computer system.

In some embodiments, the controller includes a button, and detecting the input via the controller includes detecting a press of the button (e.g., a press of button 7117 of controller 7111 in FIGS. 7AL and FIG. 7AP, analogous to the air pinch gesture of method 10000 or the selection input of method 11000). Performing the associated operation in response to a press of a button of the controller reduces the amount of time needed to access different system user interfaces and/or system operations of the computer system.

In some embodiments, detecting the input via the controller includes detecting movement of the controller while detecting the press of the button (e.g., due to movement of the hand while continuing to press the button), and performing the operation associated with the first user interface object in response to detecting the input includes changing a respective volume level of the computer system (e.g., an audio output volume level and/or tactile output volume level, optionally for content from a respective application (application volume level) or for content systemwide (system volume level)) in accordance with (e.g., based on a direction and/or magnitude of) the movement of the controller (e.g., analogous to movement of the hand during the air long pinch gesture of method 10000 or the first air gesture of method 13000). For example, in FIGS. 8Q-8T, the computer system 101 detects movement of controller 7111 while detecting the press of button 7117 of controller 7111, and in response the computer system 101 changes the volume level for the computer system 101 accordingly. In some embodiments, performing the operation associated with the first user interface object in response to detecting the input includes displaying a visual indication of the respective volume level (e.g., indicator 8004 of FIGS. 8A-8T), as described with reference to methods 10000 and 13000. Changing the volume level of the computer system in response to movement of the controller while a button of the controller is pressed reduces the amount of time needed to access different system user interfaces and/or system operations of the computer system.

In some embodiments, detecting the respective input includes detecting, via the one or more input devices, that attention of the user (e.g., gaze or an attention metric based on a gaze, head direction, wrist direction, or other pointing manner of the user) is directed toward a location of the hand of the user (e.g., toward a location of the respective object in the view of the environment, where the location of the respective object in the view of the environment corresponds to the location of the hand of the user in physical space). For example, as described herein with reference to FIGS. 7Q3, 7AL1, and 8Q, the displaying of the control 7030 is due at least in part to the attention 7010 of the user 7002 being directed toward the hand 7022′. In another example, the displaying of the status user interface 7032 in FIG. 7AP (e.g., whether the hand 7022′ is holding the controller 7111′ or not) is due at least in part to the attention 7010 of the user 7002 being directed toward the hand 7022′. In some embodiments, if the attention of the user is not directed toward the location of the hand of the user, the first user interface object is not displayed (e.g., whether the hand of the user is holding a controller or not). Displaying the user interface object relative to an object that corresponds to a user's hand and moves as the hand moves, at least partially in response to a user directing attention toward the hand, even if the hand is holding a controller, reduces the amount of time needed to invoke the user interface object and access different system user interfaces and/or system operations of the computer system by not requiring the user to remove the controller from their hand.

In some embodiments, the first criteria include a requirement that the hand of the user is holding the controller within a first range of poses of the hand of the user. In some embodiments, in response to detecting the respective input: in accordance with a determination that third criteria are met, wherein the third criteria include a requirement that the hand of the user is not holding a controller (e.g., the first criteria are not met) and that the hand of the user is within a second range of poses that is different from the first range of poses, the computer system displays, via the one or more display generation components, the first user interface object at a respective location (e.g., where the respective location is in some embodiments the first location or in some embodiments a second location that is different from the first location). In some embodiments, in response to detecting the respective input: in accordance with a determination that the third criteria are not met, the computer system forgoes displaying, via the one or more display generation components, the first user interface object at the respective location. For example, FIG. 7AL4 illustrates an example range of hand poses (e.g., between the hand pose of representation 7143-6 and the hand pose of representation 7143-4) for which the control 7030 is displayed (e.g., at the location shown in FIG. 7Q3) if the hand 7022 is holding a controller 7111 (e.g., and outside of which the control 7030 is not displayed at the location shown in FIG. 7Q3). In contrast, FIG. 7AL3 illustrates an example range of hand poses (e.g., between the hand pose of representation 7143-6 and the hand pose of representation 7143-4) for which the control 7030 is displayed (e.g., at the location shown in FIG. 7Q1) if the hand 7022 is not holding a controller (e.g., and outside of which the control 7030 is not displayed at the location shown in FIG. 7Q1), where the example range of hand poses in FIG. 7AL3 is different from the example range of hand poses in FIG. 7AL4. In some embodiments, if neither the first criteria nor the third criteria are met, the computer system forgoes displaying the first user interface object (e.g., at any location). In some embodiments, the third criteria correspond to the second criteria of method 18000. Displaying the user interface object (e.g., for accessing different system user interfaces and/or system operations of the computer system) for different ranges of hand poses of the user based on whether the hand is holding a controller or not causes the computer system to automatically account for differences, in accuracy of determining whether the hand pose meets criteria for displaying the user interface object, between when the hand is holding a controller and when the hand is not holding a controller.

In some embodiments, the first range of poses includes one or more poses that are not included in the second range of poses. In some embodiments, the first range of poses is a wider range of poses than is the second range of poses. For example, the range of poses for which control 7030 is displayed in FIG. 7AL4 includes the hand pose of representation 7143-6 and the hand pose of 7143-4, which are not included in the range of poses for which control 7030 is displayed in FIG. 7AL3. Displaying the user interface object (e.g., for accessing different system user interfaces and/or system operations of the computer system) for a wider range of hand poses of the user when the hand is holding a controller causes the computer system to automatically account for reduced accuracy and/or other differences in determining whether the hand pose meets criteria for displaying the user interface object when the hand is holding a controller.

In some embodiments, in response to detecting the respective input: in accordance with a determination that the hand of the user is holding a controller within a third range of poses of the hand of the user, wherein the third range of poses is different from the first range of poses, the computer system displays, via the one or more display generation components, a second user interface object at a third location relative to the respective object, wherein the second user interface object is different from the first user interface object. In some embodiments, in accordance with a determination that the hand of the user is holding a controller outside of the third range of poses of the hand of the user, the computer system forgoes displaying the second user interface object at the third location. In some embodiments, the first user interface object is the control (e.g., control 7030 as described with reference to FIGS. 7A-7BE, 8A-8T, 9A-9P, and 14A-14L and methods 10000, 11000, 12000, 13000, 15000, 16000, and 17000), and the second user interface object is the status user interface (e.g., status user interface 7032 as described with reference to FIGS. 7A-7BE, 8A-8T, 9A-9P, and 14A-14L and methods 10000, 11000, 12000, 13000, 15000, 16000, and 17000), or vice versa. For example, FIG. 7AL6 illustrates an example range of hand poses (e.g., between the hand pose of representation 7147-1 and the hand pose of representation 7147-5) for which the status user interface 7032 is displayed (e.g., at the location 7023 shown in FIG. 7AP) if the hand 7022 is holding a controller 7111 (e.g., and outside of which the status user interface 7032 is not displayed at the location 7023 shown in FIG. 7AP). In some embodiments, the third location (e.g., location 7023 in FIG. 7AP) is different from the first location (e.g., the location of control 7030 relative to hand 7022′ in FIG. 7Q3).

In some embodiments, in response to detecting the respective input: in accordance with a determination that the hand of the user is not holding a controller and that the hand of the user is within a fourth range of poses that is different from the second range of poses, the computer system displays, via the one or more display generation components, the second user interface object at a fourth location relative to the respective object (e.g., the same as or different from the third location, and the same as or different from the respective location). In some embodiments, in accordance with a determination that the hand of the user is not holding a controller and that the hand of the user is outside of the fourth range of poses of the hand of the user, the computer system forgoes displaying the second user interface object at the fourth location. For example, in contrast to FIG. 7AL6, FIG. 7AL5 illustrates an example range of hand poses (e.g., between the hand pose of representation 7141-5 and the hand pose of representation 7145-4) for which the status user interface 7032 is displayed (e.g., at the location of status user interface 7032 shown in FIG. 7AP, which is different from the location 7023 in FIG. 7AP and different from the location of control 7030 relative to hand 7022′ in FIG. 7Q1) if the hand 7022 is not holding a controller (e.g., and outside of which the status user interface 7032 is not displayed at the location of status user interface 7032 shown in FIG. 7AP), where the example range of hand poses in FIG. 7AL5 is different from the example range of hand poses in FIG. 7AL6.

Displaying a different user interface object, such as a status user interface as opposed to a control for accessing different system user interfaces and/or system operations of the computer system, for different ranges of hand poses of the user based on whether the hand is holding a controller or not causes the computer system to automatically account for differences, in accuracy of determining whether the hand pose meets criteria for displaying the different user interface object, between when the hand is holding a controller and when the hand is not holding a controller.

In some embodiments, aspects/operations of methods 10000, 11000, 12000, 13000, 15000, 16000, and 17000 may be interchanged, substituted, and/or added between these methods. For example, the user is able to invoke and interact with the same system user interfaces, such as the control, status user interface, control user interface, and respective volume level indication and/or volume level adjustment user interface, as described in the methods 10000, 11000, 12000, 13000, 15000, 16000, and/or 17000, whether the user is holding a controller as in the method 18000 or not holding a controller as described in the methods 10000, 11000, 12000, 13000, 15000, 16000, and/or 17000. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve accuracy and reliability when detecting where a user's attention is directed, what hand gestures a user is performing (e.g., and in what orientation the user's hand(s) are in), and/or where to display user interfaces and user interface objects when requested or invoked. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to accuracy and reliability when detecting where a user's attention is directed, what hand gestures a user is performing (e.g., and in what orientation the user's hand(s) are in), and/or where to display user interfaces and user interface objects when requested or invoked. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of hand and/or eye enrollment, and/or determining head and/or torso direction, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, functionality based on attention of the user and/or hand gestures performed by the user are still enabled without hand and/or eye enrollment, and functionality based on head and/or torso direction information are still enabled and/or are provided with alternative implementations, using methods that do not rely on such information specifically (e.g., inputs via mechanical input mechanisms, approximations based on other body parts such as a head, torso, arm, and/or wrist direction, and/or approximations based on ambient environment information acquired by one or more hardware sensors).

1-126. (canceled)

127. A method, comprising:
at a computer system that is in communication with one or more display generation components and one or more input devices:
while a view of an environment is visible via the one or more display generation components, and while the view of the environment includes a respective object that moves as a hand of a user moves, detecting, via the one or more input devices, a respective input; and
in response to detecting the respective input:
in accordance with a determination that first criteria are met, wherein the first criteria include a requirement that the hand of the user is holding a controller, displaying, via the one or more display generation components, a first user interface object at a first location relative to the respective object; and
in accordance with a determination that the first criteria are not met, forgoing displaying the first user interface object at the first location.

128. The method of claim 127, including:
in response to detecting the respective input:
in accordance with a determination that second criteria are met, wherein the second criteria include a requirement that the hand of the user is not holding a controller, displaying the first user interface object at a second location relative to the respective object, wherein the second location is different from the first location.

129. The method of claim 127, wherein displaying the first user interface object at the first location includes:
in accordance with a determination that a respective portion of the controller is at a first controller location, displaying the first user interface object at a first spatial location in the environment that is at the first location relative to the respective object; and
in accordance with a determination that the respective portion of the controller is at a second controller location that is different from the first controller location, displaying the first user interface object at a second spatial location in the environment that is at the first location relative to the respective object, wherein the second spatial location in the environment is different from the first spatial location in the environment.

130. The method of claim 127, wherein the first user interface object includes an affordance that provides access to a home menu user interface.

131. The method of claim 127, wherein the first user interface object includes an affordance that provides access to status information.

132. The method of claim 127, wherein the first user interface object includes a status user interface that includes status information for the computer system.

133. The method of claim 132, wherein detecting the respective input includes detecting a change in orientation of the hand from a first orientation with a palm of the hand facing toward a viewpoint of the user to a second orientation with the palm of the hand facing away from the viewpoint of the user.

134. The method of claim 127, wherein the one or more input devices include the controller, and the method includes:
while displaying the first user interface object at the first location relative to the respective object, detecting, via the controller, an input; and
in response to detecting the input, performing an operation associated with the first user interface object.

135. The method of claim 134, wherein the controller includes a button, and detecting the input via the controller includes detecting a press of the button.

136. The method of claim 135, wherein:
detecting the input via the controller includes detecting movement of the controller while detecting the press of the button; and
performing the operation associated with the first user interface object in response to detecting the input includes changing a respective volume level of the computer system in accordance with the movement of the controller.

137. The method of claim 127, wherein detecting the respective input includes detecting, via the one or more input devices, that attention of the user is directed toward a location of the hand of the user.

138. The method of claim 127, wherein:
the first criteria include a requirement that the hand of the user is holding the controller within a first range of poses of the hand of the user; and
the method includes, in response to detecting the respective input:
in accordance with a determination that third criteria are met, wherein the third criteria include a requirement that the hand of the user is not holding a controller and that the hand of the user is within a second range of poses that is different from the first range of poses, displaying, via the one or more display generation components, the first user interface object at a respective location; and
in accordance with a determination that the third criteria are not met, forgoing displaying, via the one or more display generation components, the first user interface object at the respective location.

139. The method of claim 138, wherein the first range of poses includes one or more poses that are not included in the second range of poses.

140. The method of claim 138, including:
in response to detecting the respective input:
in accordance with a determination that the hand of the user is holding a controller within a third range of poses of the hand of the user, wherein the third range of poses is different from the first range of poses, displaying, via the one or more display generation components, a second user interface object at a third location relative to the respective object, wherein the second user interface object is different from the first user interface object; and
in accordance with a determination that the hand of the user is not holding a controller and that the hand of the user is within a fourth range of poses that is different from the second range of poses, displaying, via the one or more display generation components, the second user interface object at a fourth location relative to the respective object.

141. A computer system that is in communication with one or more display generation components and one or more input devices, the computer system comprising:
one or more processors; and
memory storing one or more programs configured to be executed by the one or more processors, the one or more programs including instructions for:
while a view of an environment is visible via the one or more display generation components, and while the view of the environment includes a respective object that moves as a hand of a user moves, detecting, via the one or more input devices, a respective input; and
in response to detecting the respective input:
in accordance with a determination that first criteria are met, wherein the first criteria include a requirement that the hand of the user is holding a controller, displaying, via the one or more display generation components, a first user interface object at a first location relative to the respective object; and
in accordance with a determination that the first criteria are not met, forgoing displaying the first user interface object at the first location.

142. A computer-readable storage medium storing one or more programs configured to be executed by one or more processors of a computer system that is in communication with one or more display generation components and one or more input devices, the one or more programs including instructions for:
while a view of an environment is visible via the one or more display generation components, and while the view of the environment includes a respective object that moves as a hand of a user moves, detecting, via the one or more input devices, a respective input; and
in response to detecting the respective input:
in accordance with a determination that first criteria are met, wherein the first criteria include a requirement that the hand of the user is holding a controller, displaying, via the one or more display generation components, a first user interface object at a first location relative to the respective object; and
in accordance with a determination that the first criteria are not met, forgoing displaying the first user interface object at the first location.
